(19) United States
(12) Patent Application Publication
(10) Pub. No.: US 2004/0235959 A1
(43) Pub. Date: Nov. 25, 2004

(54) Insecticidal diamides

(76) Inventors: George Philip Lahm, Wilmington, DE (US); Thomas Paul Selby, Wilmington, DE (US)

Correspondence Address: E I du Pont de Nemours & Company, Legal Patents, Wilmington, DE, 19898, US

(21) Appl. No.: 10/485,096

(22) PCT Filed: Sep. 17, 2002
(86) PCT No.: PCT/US02/29468

(30) Foreign Application Priority Data
Sep. 21, 2001 (US) 60324083

(51) Int. Cl. A01N 37/18

(52) U.S. Cl. 514/616

(57) ABSTRACT

This invention pertains to a method for controlling an invertebrate pest comprising contacting the invertebrate pest or its environment with a biologically effective amount of a compound of Formula I including all geometric and stereoisomers, N-oxides and agriculturally suitable salts thereof (e.g. in a composition comprising a compound of Formula I) wherein J is a phenyl ring, a naphthyl ring system, a 5- or 6-membered heteroaromatic ring or an aromatic 8-, 9- or 10-membered fused heterobicyclic ring system wherein each ring or ring system is optionally substituted with 1 to 4 R [symbol] 5?; K is —C(&equals;A)NR [symbol] 2?- or —NR [symbol] 2?C(&equals;A)-; L is —NR [symbol] 1?C(&equals;B)-R [symbol] 3? or —NR [symbol] 1?SO?2 [symbol] -R [symbol] 3?; A and B are independently O or S; and R [symbol] 1?, R [symbol] 2?, R [symbol] 3?, R [symbol] 4?, R [symbol] 5? and n are as defined in the disclosure. Also disclosed are certain compositions for controlling an invertebrate pest comprising a biologically effective amount of a compound of Formula I, an N-oxide thereof or an agriculturally suitable salt thereof. Also disclosed are certain compounds of Formula I, N-oxides and agriculturally suitable salts thereof.

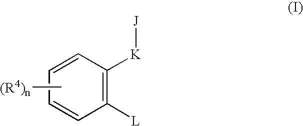

### FIELD OF THE INVENTION

This invention relates to certain diamides, their N-oxides, agriculturally suitable salts and compositions, and methods of their use for controlling invertebrate pests in both agronomic and nonagronomic environments.

### BACKGROUND OF THE INVENTION

The control of invertebrate pests such as arthropods is extremely important in achieving high crop efficiency. Damage by invertebrate pests to growing and stored agronomic crops can cause significant reduction in productivity and thereby result in increased costs to the consumer. The control of invertebrate pests in forestry, greenhouse crops, ornamentals, nursery crops, stored food and fiber products, livestock, household, and public and animal health is also important. Many products are commercially available for these purposes, but the need continues for new compounds that are more effective, less costly, less toxic, environmentally safer or have different modes of action.

NL 9202078 discloses N-acyl anthranilic acid derivatives of Formula i as insecticides

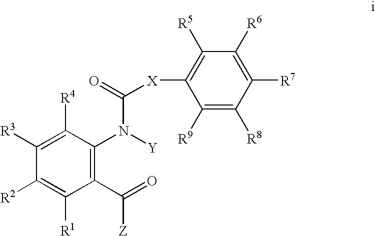

wherein, inter alia,

X is a direct bond;

Y is H or C₁-C₆ alkyl;

Z is NH₂, NH(C₁-C₃ alkyl) or N(C₁-C₃ alkyl)₂; and

R¹ through R⁹ are independently H, halogen, C₁-C₆ alkyl, phenyl, hydroxy, C₁-C₆ alkoxy or C₁-C₇ acyloxy.

U.S. Pat. No. 3,907,892 discloses certain N-fluoroalkanoyl-o-phenylenediamines as insecticides.

### SUMMARY OF THE INVENTION

This invention involves compounds of Formula I (including all geometric and stereoisomers) N-oxides and agriculturally suitable salts thereof

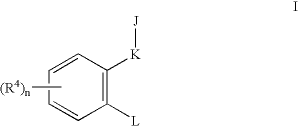

wherein

J is a phenyl ring, a naphthyl ring system, a 5- or 6-membered heteroaromatic ring or an aromatic 8-, 9- or 10-membered fused heterobicyclic ring system wherein each ring or ring system is optionally substituted with 1 to 4 R⁵;

K is —C(=A)NR² or —NR²C(=A)-;

L is —NR¹C(=B)—R³ or —NR¹SO₂—R³;

A and B are independently O or S;

R¹ is H; or C₁-C₆ alkyl, C₂-C₆ alkenyl, C₂-C₆ alkynyl or C₃-C₆ cycloalkyl, each optionally substituted with one or more substituents selected from the group consisting of halogen, CN, NO₂, hydroxy, C₁-C₄ alkoxy, C₁-C₄ alkylthio, C₁-C₄ alkylsulfinyl, C₁-C₄ alkylsulfonyl, C₂-C₄ alkoxycarbonyl, C₁-C₄ alkylamino, C₂-C₈ dialkylamino and C₃-C₆ cycloalkylamino; or

R¹ is C₂-C₆ alkylcarbonyl, C₂-C₆ alkoxycarbonyl, C₂-C₆ alkylaminocarbonyl or C₃-C₈ dialkylaminocarbonyl;

R² is H, C₁-C₆ alkyl, C₂-C₆ alkenyl, C₂-C₆ alkynyl, C₃-C₆ cycloalkyl, C₁-C₄ alkoxy, C₁-C₄ alkylamino, C₂-C₈ dialkylamino, C₃-C₆ cycloalkylamino, C₂-C₆ alkoxycarbonyl or C₂-C₆ alkylcarbonyl;

R³ is C₁-C₆ alkyl, C₂-C₆ alkenyl, C₂-C₆ alkynyl or C₃-C₆ cycloalkyl, each optionally substituted with one or more substituents selected from the group consisting of halogen, CN, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₂-C₆ alkoxycarbonyl, C₂-C₆ alkylcarbonyl, C₃-C₆ trialkylsilyl, phenyl, phenoxy and 5- or 6-membered heteroaromatic rings, each phenyl, phenoxy and 5- or 6-membered heteroaromatic ring optionally substituted with one to three substituents independently selected from R⁶; C₁-C₄ alkoxy, C₁-C₄ alkylamino; C₂-C₈ dialkylamino; C₁-C₄ alkoxy(C₁-C₄ alkyl)amino; C₃-C₆ cycloalkylamino; C₂-C₆ alkoxycarbonyl or C₂-C₆ alkylcarbonyl; or

R¹ and R³ can be taken together with —NC(=B)— or —NSO₂— moiety to which they are attached to form a ring comprising 2 to 6 atoms of carbon and optionally one additional atom of nitrogen, sulfur or oxygen, said ring optionally substituted with 1 to 4 substituents selected from the group consisting of C₁-C₂ alkyl, halogen, CN, NO₂ and C₁-C₂ alkoxy;

each R⁴ is independently H, C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₃-C₆ trialkylsilyl, or a phenyl ring optionally substituted with one to three substituents independently selected from R⁶;

each R⁵ is independently C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, CO₂H, CONH₂, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl, C₃-C₆ trialkylsilyl; or

each R⁵ is independently a phenyl, benzyl, benzoyl, phenoxy, 5- or 6-membered heteroaromatic ring or an aromatic 8-, 9- or 10-membered fused heterobicyclic ring system, each phenyl, benzyl, benzoyl, phenoxy, heteroaromatic ring and aromatic fused heterobicyclic ring system optionally substituted with one to three substituents independently selected from R⁶; or

two R⁵ groups when attached to adjacent carbon atoms can be taken together as —OCF₂O—, —CF₂CF₂O— or —OCF₂CF₂O—;

each R⁶ is independently C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl; and

n is 1, 2, 3 or 4;

provided that L is other than —NHC(═O)— and R³ is other than C₁-C₆ alkyl substituted with one or more fluorine moieties.

A method is provided for controlling an invertebrate pest comprising contacting the invertebrate pest or its environment with a biologically effective amount of a compound of Formula I, an N-oxide thereof or an agriculturally suitable salt thereof (e.g., as a composition described herein).

This invention also provides a composition for controlling an invertebrate pest comprising a biologically effective amount of a compound of Formula I, an N-oxide thereof or an agriculturally suitable salt thereof; and at least one additional component selected from the group consisting of surfactants, solid diluents and liquid diluents.

This invention also provides a composition comprising a biologically effective amount of a compound of Formula I, an N-oxide thereof or an agriculturally suitable salt thereof; and an effective amount of at least one additional biologically active compound or agent This invention also provides compounds of Formula I (including all geometric and stereoisomers), N-oxides or agriculturally suitable salts thereof, wherein each R⁵ is R^{5a} or R^{5b};

J is a phenyl ring, a naphthyl ring system, a 5- or 6-membered heteroaromatic ring or an aromatic 8-, 9- or 10-membered fused heterobicyclic ring system wherein each ring or ring system is substituted with R^{5a} and optionally substituted with 1 to 3 R^{5b};

K is —C(=A)NR²— or —NR²C(=A)-;

L is —NR¹C(=B)—R³ or —NR¹SO₂—R³;

A and B are independently O or S;

R¹ is H or C₁-C₄ all;

R² is H or C₁-C₄ alkyl;

R³ is C₁-C₄ alkyl optionally substituted with halogen, CN, OCH₃, or S(O)ₚCH₃;

R^{5a} and R^{5b} are each independently C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₂-C₄ alkoxycarbonyl or C₃-C₈ dialkylaminocarbonyl; or a phenyl, benzyl, or a 5- or 6-membered heteroaromatic ring, each phenyl, benzyl, and heteroaromatic ring optionally substituted with one to three substituents independently selected from R⁶;

R^{5a} is attached to the J at a position ortho to K;

each R⁶ is independently halogen, CN, NO₂, C₁-C₄ alkyl, C₂-C₄ alkenyl, C₂-C₄ alkynyl, C₃-C₆ cycloalkyl, C₁-C₄ haloalkyl, C₁-C₄ alkoxy or C₁-C₄ haloalkoxy, and

p is 0, 1 or 2; provided that L is other than —NHC(═OH)— and R³ is other than C₁-C₆ alkyl substituted with one or more fluorine moieties.

### DETAILS OF THE INVENTION

In the above recitations, the term “alkyl”, used either alone or in compound words such as “alkylthio” or “haloalkyl” includes straight-chain or branched alkyl, such as, methyl, ethyl, n-propyl, i-propyl, or the different butyl, pentyl or hexyl isomers. “Alkenyl” includes straight-chain or branched alkenes such as 1-propenyl, 2-propenyl, and the different butenyl, pentenyl and hexenyl isomers. “Alkenyl” also includes polyenes such as 1,2-propadienyl and 2,4-hexadienyl. “Alkynyl” includes straight-chain or branched alkynes such as 1-propynyl, 2-propynyl and the different butynyl, pentynyl and hexynyl isomers. “Alkynyl” can also include moieties comprised of multiple triple bonds such as 2,5-hexadiynyl. “Alkoxy” includes, for example, methoxy, ethoxy, n-propyloxy, isopropyloxy and the different butoxy, pentoxy and hexyloxy isomers. “Alkoxyalkyl” denotes alkoxy substitution on alkyl. Examples of “alkoxyalkyl” include CH₃OCH₂, CH₃OCH₂CH₂, CH₃CH₂OCH₂, CH₃CH₂CH₂CH₂OCH₂ and CH₃CH₂OCH₂CH₂. “Alkylthio” includes branched or straight-chain alkylthio moieties such as methylthio, ethylthio, and the different propylthio, butylthio, pentylthio and hexylthio isomers. “Cycloalkyl” includes, for example, cyclopropyl, cyclobutyl, cyclopentyl and cyclohexyl.

The term “heterocyclic ring” or heterocyclic ring system” denotes rings or ring systems in which at least one ring atom is not carbon and comprises 1 to 4 heteroatoms independently selected from the group consisting of nitrogen, oxygen and sulfur, provided that each heterocyclic ring contains no more than 4 nitrogens, no more than 2 oxygens and no more than 2 sulfurs. The heterocyclic ring can be attached through any available carbon or nitrogen by replacement of hydrogen on said carbon or nitrogen. The term “aromatic ring system” denotes fully unsaturated carbocycles and heterocycles in which the polycyclic ring system is aromatic (where aromatic indicates that the Hückel rule is satisfied for the ring system). The term “heteroaromatic ring” denotes fully aromatic rings in which at least one ring atom is not carbon and comprises 1 to 4 heteroatoms independently selected from the group consisting of nitrogen, oxygen and sulfur, provided that each heterocyclic ring contains no more than 4 nitrogens, no more than 2 oxygens and no more than 2 sulfurs (where aromatic indicates that the Hückel rule is satisfied). The heterocyclic ring can be attached through any available carbon or nitrogen by replacement of hydrogen on said carbon or nitrogen. The term “aromatic heterocyclic ring system” includes fully aromatic heterocycles and heterocycles in which at least one ring of a polycyclic ring system is aromatic (where aromatic indicates that the Hückel rule is satisfied). The term “fused heterobicyclic ring system” includes a ring system comprised of two fused rings in which at least one ring atom is not carbon and can be aromatic or non aromatic, as defined above.

The term “halogen”, either alone or in compound words such as “haloalkyl”, includes fluorine, chlorine, bromine or iodine. Further, when used in compound words such as “haloalkyl”, said alkyl may be partially or fully substituted with halogen atoms which may be the same or different Examples of “haloalkyl” include F₃C, ClCH₂, CF₃CH₂ and CF₃CCl₂. The terms “haloalkenyl”, “haloalkynyl”, “haloalkoxy”, and the like, are defined analogously to the term “haloalkyl”. Examples of “haloalkenyl” include (Cl)₂C═CHCH₂ and CF₃CH₂CH═CHCH₂. Examples of “haloalkynyl” include HC≡CCHCl, CF₃C—C, CCl₃C≡C and FCH₂C≡CCH₂. Examples of “haloalkoxy” include CF₃O, CCl₃CH₂O, HCF₂CH₂CH₂O and CF₃CH₂O.

The total number of carbon atoms in a substituent group is indicated by the “Cᵢ-Cⱼ” prefix where i and j are numbers from 1 to 8. For example, C₁-C₃ alkylsulfonyl designates methylsulfonyl through propylsulfonyl; C₂ alkoxyalkyl designates CH₃OCH₂; C₃ alkoxyalkyl designates, for example, CH₃CH(OCH₃), CH₃OCH₂CH₂ or CH₃CH₂OCH₂; and C₄ alkoxyalkyl designates the various isomers of an alkyl group substituted with an alkoxy group containing a total of four carbon atoms, examples including CH₃CH₂CH₂OCH₂ and CH₃CH₂OCH₂CH₂. In the above recitations, when a compound of Formula 1 contains a heterocyclic ring, all substituents are attached to this ring through any available carbon or nitrogen by replacement of a hydrogen on said carbon or nitrogen.

When a group contains a substituent which can be hydrogen, for example R³, then, when this substituent is taken as hydrogen, it is recognized that this is equivalent to said group being unsubstituted.

Compounds of this invention can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. Accordingly, the compounds of the invention may be present as a mixture of stereoisomers, individual stereoisomers, or as an optically active form.

The present invention comprises compounds selected from Formula I, N-oxides and agriculturally suitable salts thereof. One skilled in the art will appreciate that not all nitrogen containing heterocycles can form N-oxides since the nitrogen requires an available lone pair for oxidation to the oxide; one skilled in the art will recognize those nitrogen containing heterocycles which can form N-oxides. One skilled in the art will also recognize that tertiary amines can form N-oxides. Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dinethydioxirane. These methods for the preparation of N-oxides have been extensively described and reviewed in the literature, see for example: T. L. Gilchrist in Comprehensive Organic Synthesis, vol. 7, pp 748-750, S. V. Ley, Ed., Pergamon Press; M. Tisler and B. Stanovnik in Comprehensive Heterocyclic Chemistry, vol. 3, pp 18-19, A. J. Boulton and A. McKillop, Eds., Pergamon Press; M. R. Grimmett and B. R. T. Keene in Advances in Heterocyclic Chemistry, vol. 43, pp 139-151, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

The salts of the compounds of the invention include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids.

Preferred methods for reasons of better activity and/or ease of synthesis are:

Preferred 1. Methods comprising compounds of Formula I wherein K is —C(=A)NR²— and A and B are both O.

Preferred 2. Methods comprising compounds of Formula I wherein K is —NR²C(-A)— and A and B are both O.

Preferred 3. Methods of Preferred 1 or Preferred 2 wherein

J is a phenyl ring or a 5- or 6-membered heteroaromatic ring selected from the group consisting of J-1, J-2, J-3 and J-4, each J ring optionally substituted with 1 to 3 R⁵

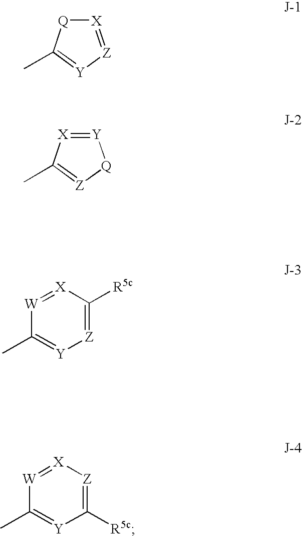

Q is O, S or NR^{5c};

W, X, Y and Z are independently N or CR^{5c}, provided that in J-3 and J-4 at least one of W, X, Y or Z is N;

R¹ and R² are each independently H, C₁-C₄ alkyl, C₂-C₄ alkenyl, C₂-C₄ alkynyl, C₃-C₆ cycloalkyl, C₂-C₆ alkylcarbonyl or C₂-C₆ alkoxycarbonyl;

R³ is C₁-C₆ alkyl, C₂-C₆ alkenyl, C₂-C₆ alkynyl or C₃-C₆ cycloalkyl each optionally substituted with one or more substituents selected from the group consisting of halogen, CN, C₁-C₂ alkoxy, C₁-C₂ alkylthio, C₁-C₂ alkylsulfinyl and C₁-C₂ alkylsulfonyl;

each R⁴ is independently C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl or C₁-C₄ haloalkylsulfonyl;

each R⁵ is independently C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₂-C₄ alkoxycarbonyl or C₃-C₈ dialkylaminocarbonyl; or

each R⁵ is independently a phenyl, benzyl or a 5- or 6-membered heteroaromatic ring, each ring optionally substituted with one to three substituents independently selected from R⁶; or

two R⁵ groups when attached to adjacent carbon atoms can be taken together as —OCF₂O—, —CF₂CF₂O— or —OCF₂CF₂O—;

R^{5c} is H or R⁵;

each R⁶ is independently C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl; and

n is 1 or 2.

Preferred 4. Methods of Preferred 3 wherein

each R⁵ is R^{5a} or R^{5b};

J is substituted with R^{5a} and optionally substituted with 1 to 2 R^{5b};

R¹ and R² are each independently H or C₁-C₄ alkyl;

R³ is C₁-C₄ alkyl optionally substituted with halogen, CN, OCH₃, or S(O)ₚCH₃;

R^{5a} group is attached to the J at the position ortho to K;

R^{5a} and R^{5b} are each independently C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₂-C₄ alkoxycarbonyl or C₃-C₈ dialkylaminocarbonyl; or a phenyl, benzyl, or a 5- or 6-membered heteroaromatic ring, each ring optionally substituted with one to three substituents independently selected from R⁶;

each R⁶ is independently halogen, CN, NO₂, C₁-C₄ alkyl, C₂-C₄ alkenyl, C₂-C₄ alkynyl, C₃-C₆ cycloalkyl, C₁-C₄ haloalkyl, C₁-C₄ alkoxy or C₁-C₄ haloalkoxy; and

p is 0, 1 or 2.

Preferred 5. Methods of Preferred 0.4 wherein J is phenyl, pyrazole, pyrrole, pyridine or pyrimidine.

Preferred 6. Methods of Preferred 5 wherein

R¹ and R² are each H;

one R⁴ is selected from the group consisting of C₁-C₃ alkyl, CF₃, OCF₃, OCHF₂, S(O)ₚCF₃, S(O)ₚCHF₂ and halogen and an optional second R⁴ is selected from the group consisting of halogen, C₁-C₃ alkyl and C₁-C₃ haloalkyl.

Preferred 7. Methods of Preferred 6 wherein

J is J-1;

Q is NR^{5a};

X is N or CH;

Y is CH;

Z is CR^{5b};

R^{5a} is a phenyl or 2-pyridyl ring substituted with one or two substituents selected from the group consisting of halogen, C₁-C₄ alkyl, C₁-C₄ haloalkyl or C₁-C₄ haloalkoxy; and

R^{5b} is halogen or CF₃.

The method of this invention includes embodiments which involve contacting the invertebrate pest or its environment with a biologically effective amount of a composition comprising a compound of Formula I, an N-oxide or an agriculturally suitable salt thereof and a biologically effective amount of at least one additional compound or agent for controlling invertebrate pests.

This invention also relates to compositions for controlling an invertebrate pest comprising a biologically effective amounts of a compound of Formula I, an N-oxide or an agriculturally suitable salt thereof and at least one of a surfactant, a solid diluent or a liquid diluent. The preferred compositions of the present invention are those which comprise the compounds of the above preferred methods.

This invention also pertains to certain compounds of Formula I as defined above, including all geometric and stereoisomers, N-oxides or agriculturally suitable salts thereof. The preferred compounds of this invention for reasons of better activity and/or ease of synthesis are:

Preferred A. Compounds of Formula I wherein

J is a phenyl ring or a 5- or 6-membered heteroaromatic ring selected from the group consisting of J-1, J-2, J-3 and J-4, each J ring substituted R^{5a} with and optionally with 1 to 2 R^{5b}

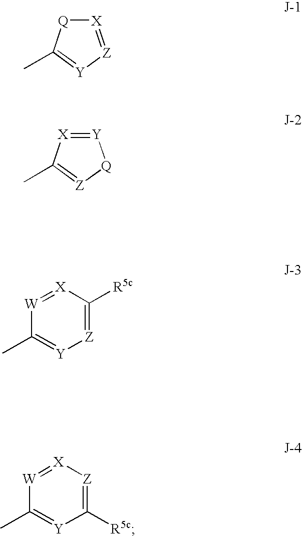

Q is O, S or NR^{5c};

W, X, Y and Z are independently N or CR^{5c}, provided that in J-3 and J-4 at least one of W, X, Y or Z is N;

R¹ and R² are each independently H or C₁-C₄ alkyl;

R³ is C₁-C₄ alkyl optionally substituted with halogen, CN, OCH₃, or S(O)ₚCH₃;

each R⁴ is independently C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl or C₁-C₄ haloalkylsulfonyl;

R^{5a} is attached to the J at the position ortho to K;

R^{5a} and R^{5b} are each independently C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₂-C₄ alkoxycarbonyl or C₃-C₈ dialkylaminocarbonyl; or a phenyl, benzyl, or a 5- or 6-membered heteroaromatic ring, each ring optionally substituted with one to three substituents independently selected from R⁶;

R^{5c} is H or R^{5a};

each R⁶ is independently halogen, CN, NO₂, C₁-C₄ alkyl, C₂-C₄ alkenyl, C₂-C₄ alkynyl, C₃-C₆ cycloalkyl, C₁-C₄ haloalkyl, C₁-C₄ alkoxy or C₁-C₄ haloalkoxy,

n is 1 or 2; and

p is 0, 1 or 2.

Preferred B. Compounds of Preferred A wherein J is phenyl, pyrazole, pyrrole, pyridine or pyrimidine.

Preferred C. Compounds of Preferred B wherein

R¹ and R² are each H;

one R⁴ is selected from the group consisting of C₁-C₃ alkyl, CF₃, OCF₃, OCHF₂, S(O)ₚCF₃, S(O)ₚCHF₂ and halogen and an optional second R⁴ is selected from the group consisting of halogen, C₁-C₃ alkyl and C₁-C₃ haloalkyl.

Preferred D. Compounds of Preferred C wherein

J is J-1;

Q is NR^{5a};

X is N or CH;

Y is CH;

Z is CR^{5b};

R^{5a} is a phenyl or 2-pyridyl ring substituted with one or two substituents selected from the group consisting of halogen, C₁-C₄ alkyl, C₁-C₄ haloalkyl or C₁-C₄ haloalkoxy, and

R^{5b} is halogen or CF₃.

As noted above, J is a phenyl ring, a naphthyl ring system, a 5- or 6-membered heteroaromatic ring or an aromatic 8-, 9- or 10-membered fused heterobicyclic ring system wherein each ring or ring system is optionally substituted with 1 to 4 R⁵. The term “optionally substituted” in connection with these J groups refers to groups which are unsubstituted or have at least one non-hydrogen substituent that does not extinguish the activity for controlling invertebrate pests possessed by the unsubstituted analog. An example of phenyl optionally substituted with 1 to 4 R⁵ is the ring illustrated as U-1 in Exhibit 1, wherein R^{v} is R⁵ or H and r is an integer from 1 to 4. An example of a naphthyl group optionally substituted with 1 to 4 R⁵ is illustrated as U-85 in Exhibit 1, wherein R^{v} is R⁵ or H and r is an integer from 1 to 4. Examples of 5- or 6-membered heteroaromatic rings optionally substituted with 1 to 4 R⁵ include the rings U-2 through U-53 illustrated in Exhibit 1 wherein R^{v} is R⁵ or H and r is an integer from 1 to 4. Note that J-1 through J-4 above also denote 5- or 6-membered heteroaromatic rings. Note that U-2 through U-20 are examples of J-1, U-21 through U-35 and U-40 are examples of J-2, U-41 through U-48 are examples of J-3 and U-49 through U-53 are examples of J-4. Examples of aromatic 8-, 9- or 10-membered fused heterobicyclic ring systems optionally substituted with 1 to 4 R⁵ include U-54 through U-84 illustrated in Exhibit 1 wherein R^{v} is R⁵ or H and r is an integer from 1 to 4.

Although R^{v} groups are shown in the structures U-1 through U-85, it is noted that they can be H, which is equivalent R⁵ to optional not being present. Note that when R^{v} is H when attached to an atom, this is the same as if said atom is unsubstituted. The nitrogen atoms that require substitution to fill their valence are substituted with H or R^{v}. Note that some U groups can only be substituted with less than 4 R^{v} groups (e.g. U-14, U-15, U-18 through U-21 and U-32 through U-34 can only be substituted with one R^{v}). Note that when the attachment point between (R^{v})ᵣ and the U group is illustrated as floating, (R^{v})ᵣ can be attached to any available carbon atom of the U group. Note that when the attachment point on the U group is illustrated as floating, the U group can be attached to the remainder of Formula I through any available carbon of the U group by replacement of a hydrogen atom.

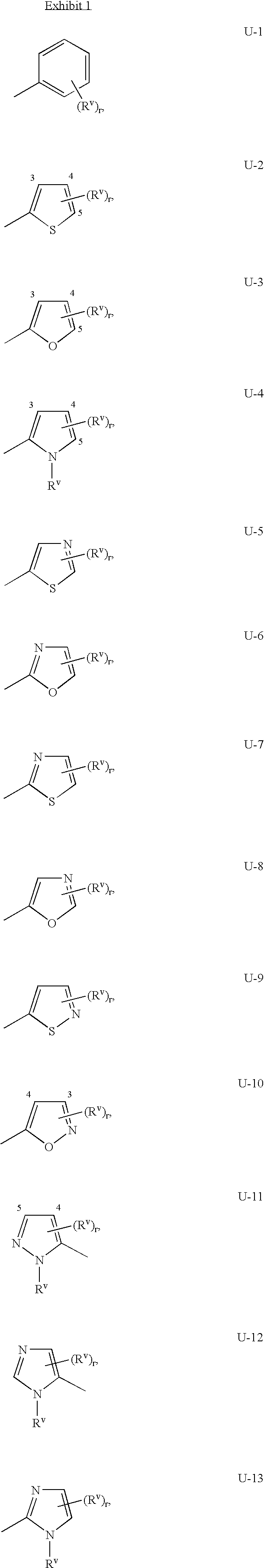

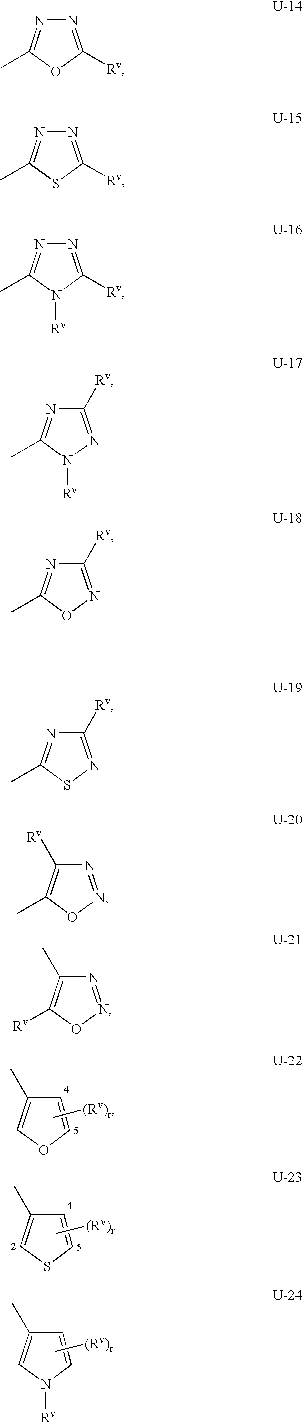

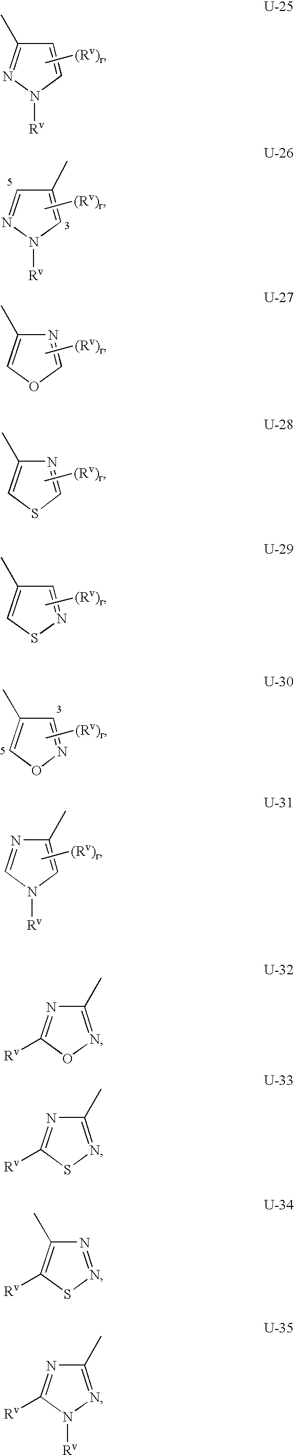

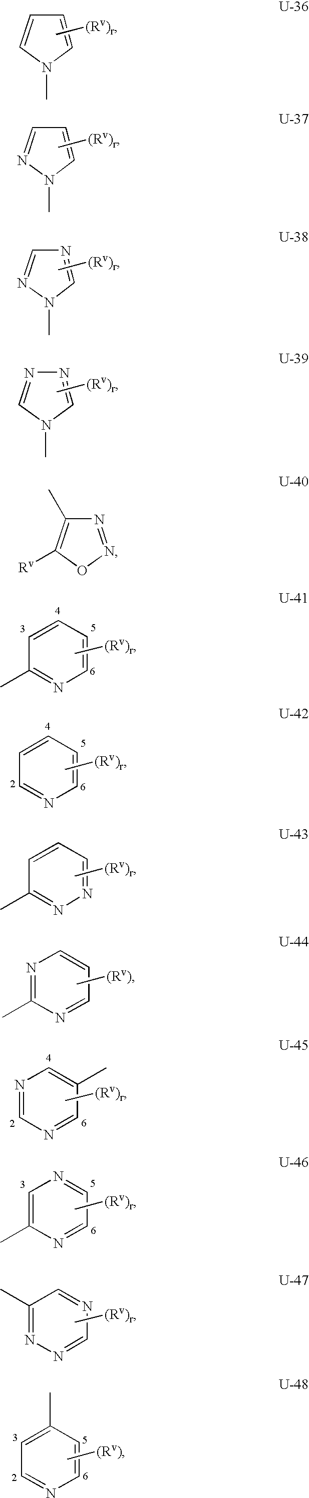

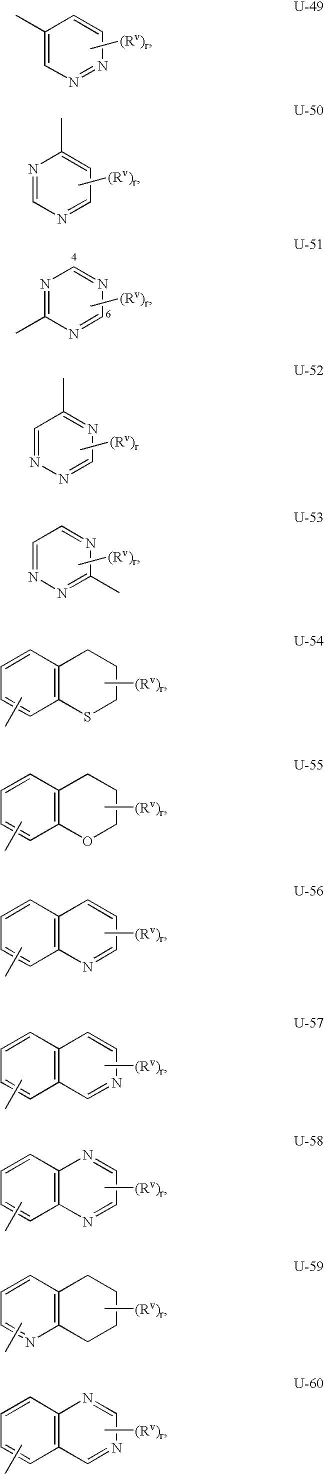

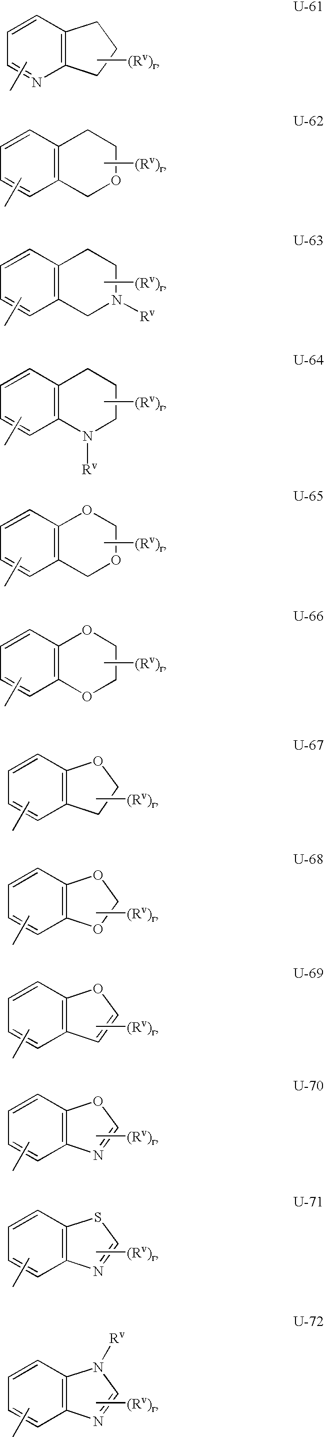

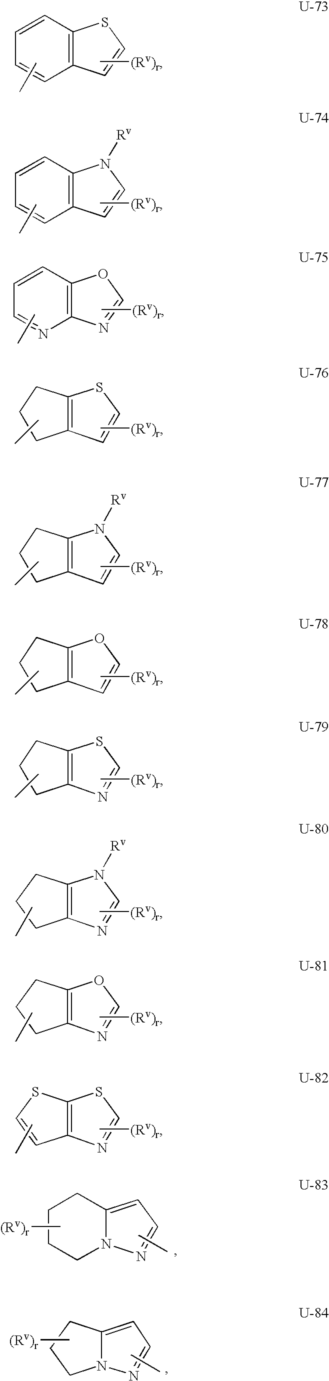

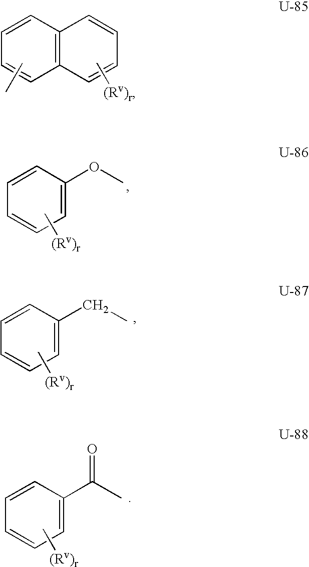

As noted above, R³ can be (among others) C₁-C₆ alkyl, C₂-C₆ alkenyl, C₂-C₆ alkynyl, C₃-C₆ cycloalkyl, each optionally substituted with one or more substituents selected from the group consisting of a phenyl ring, phenoxy or 5- or 6-membered heteroaromatic ring, each ring optionally substituted with one to three substituents independently selected from R⁶; C₁-C₄ alkoxy; C₁-C₄ alkylamino; C₂-C₈ dialkylamino; C₁-C₄ alkoxy(C₁-C₄ alky)lamino; C₃-C₆ cycloalkylamino; C₂-C₆ alkoxycarbonyl or C₂-C₆ alkylcarbonyl. Examples of the substituent rings of R³ include the rings illustrated as U-1 through U-53 and U-86 illustrated in Exhibit 1, except that such rings are optionally substituted with 1 to 3 substituents independently selected from R⁶ rather than RV.

As noted above, each R⁵ can be independently (among others) phenyl, benzyl, benzoyl, phenoxy, 5- or 6-membered heteroaromatic ring or an aromatic 8-, 9- or 10-membered fused heterobicyclic ring system, each ring optionally substituted with one to three substituents independently selected from R⁶. Examples of such R⁵ groups include the rings or ring systems illustrated as U-1 through U-88 illustrated in Exhibit 1, except that such rings are optionally substituted with 1 to 3 substituents independently selected from R⁶ rather than R^{v}.

The compounds of Formula I can be prepared by one or more of the following methods and variations as described in Schemes 1-34. The definitions of R¹ through R⁶, J, K, L and n in the compounds of Formula I and Formulae 2-57 below are as defined above in the Summary of the Invention unless indicated otherwise. Compounds of Formulae Ia-Ie, 2a, 5a-e, 13a-e and 49a-b are various subsets of the compounds of Formula I, 2, 5, 13 and 49.

Compounds of Formula Ia can be prepared by coupling of an amine of Formula 2 with an acid chloride of Formula 3 in the presence of an acid scavenger to provide the compound of Formula Ia as shown in Scheme 1. Typical acid scavengers include amine bases such as triethylamine, N,N-diisopropylethylamine and pyridine; other scavengers include hydroxides such as sodium and potassium hydroxide and carbonates such as sodium carbonate and potassium carbonate. In certain instances it is useful to use polymer-supported acid scavengers such as polymer-bound N,N-diisopropylethylamine and polymer-bound 4-(dimethyl)aminopyridine. The coupling can be run in a suitable inert solvent such as tetrahydrofuran, dioxane, diethyl ether or dichloromethane to afford the anilide of Formula Ia.

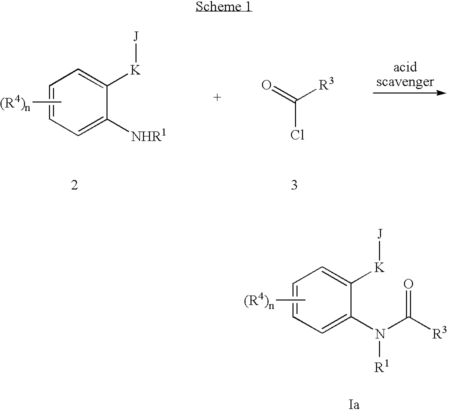

As illustrated in Scheme 2, an alternate procedure for the preparation of compounds of Formula Ia involves coupling of an amine of Formula 2 with an acid of Formula 4 in the presence of a dehydrating agent such as 1,3-dicyclohexylcarbodiimide (DCC). Polymer supported reagents are again useful here, such as polymer-bound 1,3-cyclohexyl-carbodiimide. Synthetic procedures of Schemes 1 and 2 are representative examples of useful methods for the preparation of Formula I compounds; the synthetic literature is extensive for this type of reaction.

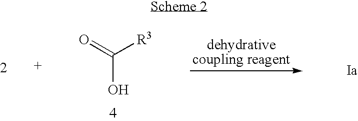

One skilled in the art will also realize that acid chlorides of Formula 3 can be prepared from acids of Formula 4 by numerous well-known methods. For example, acid chlorides of Formula 3 are readily made from carboxylic acids of Formula 4 by reacting the carboxylic acid 4 with thionyl chloride or oxalyl chloride in an inert solvent such as toluene or dichloromethane in the presence of a catalytic amount of N,N-dimethylformamide.

Amines of Formula 2a are typically available from the corresponding nitro compounds of Formula 5 via catalytic hydrogenation of the nitro group as shown in Scheme 3. Typical procedures involve reduction with hydrogen in the presence of a metal catalyst such as palladium on carbon or platinum oxide and in hydroxylic solvents such as ethanol and isopropanol. They can also be prepared by reduction with zinc in acetic acid. These procedures are well documented in the chemical literature. R¹ substituents such as alkyl, substituted alkyl and the like can generally be introduced at this stage through the generally preferred method of reductive alkylation of the amine. A commonly employed procedure is to combine the aniline 2a with an aldehyde in the presence of a reducing agent such as sodium cyanoborohydride to produce the Formula 2 compounds where R¹ is alkyl, alkenyl, alkyl or substituted derivatives thereof.

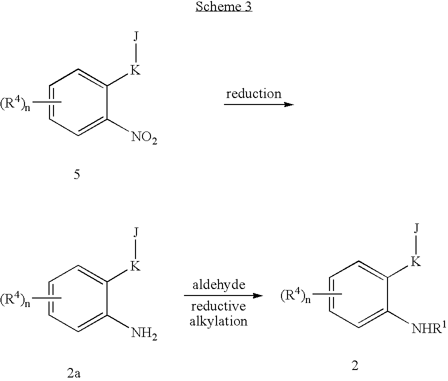

As illustrated in Scheme 4, nitrobenzenes of Formula 5a can be prepared by reaction of amines of Formula 6 with acid chlorides of Formula 7 by methods analogous to those described in Scheme 1.

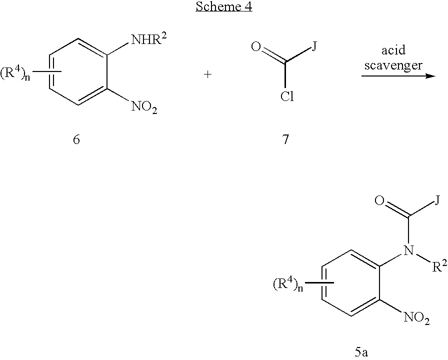

As shown in Scheme 5, amines of Formula 6 (where R² is other than H) can be prepared by reductive alkylation of primary amines of Formula 8 by methods analogous to those described in Scheme 3.

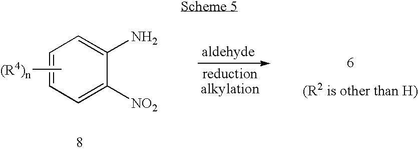

Scheme 6 shows that compounds of Formula 5b can be alkylated with a suitable alkylation agent such as an alkyl halide in the presence of a base such as sodium hydride or n-butyllithium in an inert solvent such as tetrahydrofuran or N,N-dimethylformamide (DMF) to afford anilides of Formula 5a wherein R² is other than hydrogen. This procedure is especially applicable for preparing compounds of Formula 5a in which R² is alkyl, alkenyl or alkynyl.

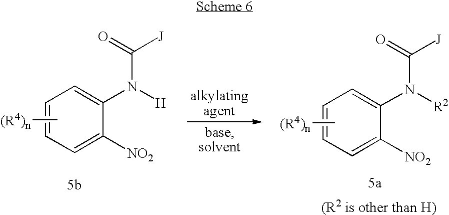

The preparation of thioanilides of Formula 5c is outlined in Scheme 7. Reacting an anilide of Formula 5a (where R² is H, alkyl and the like) with phosphorous pentasulfide or Lawesson's Reagent (i.e. 2,4-bis(4-methoxyphenyl)-1,3-dithia-2,4-diphosphetane-2,4-disulfide) in a suitable solvent such as pyridine at room temperature or on heating affords a thioanilide of Formula 5c.

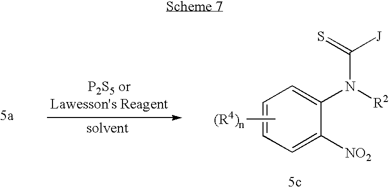

In addition, thioanilides of Formula Ib may be prepared from corresponding anilides of Formula Ia by methods described in Scheme 8.

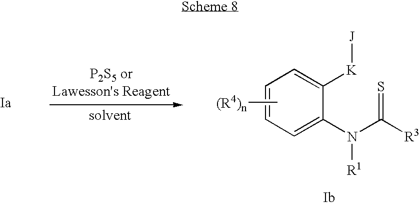

Compounds of Formula Ic can be prepared by reacting an amine of Formula 2 with a sulfonyl chloride of Formula 9 in the presence of an acid scavenger. Typical acid scavengers include amine bases such as triethylamine, N,N-diisopropylethylamine and pyridine; other scavengers include hydroxides such as sodium and potassium hydroxide and carbonates such as sodium carbonate and potassium carbonate. In certain instances it is useful to use polymer-supported acid scavengers such as polymer-bound N,N-diisopropylethylamine and polymer-bound 4-(dimethyl)aminopyridine.

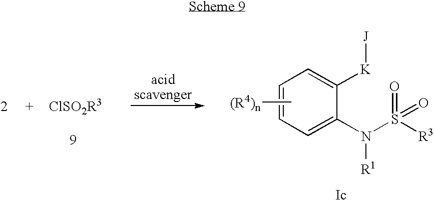

Thioamides of Formula 5e can be prepared from corresponding amides of Formula 5d by methods analogous to those illustrated in Scheme 7.

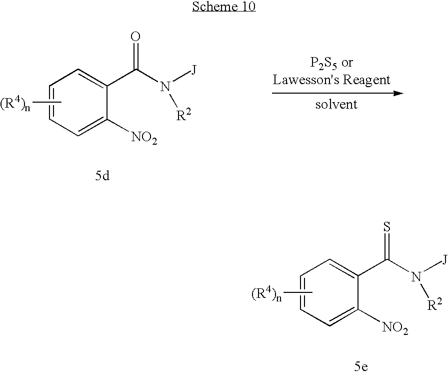

Amides of Formula 5d wherein R² is H can be prepared from acid chlorides of Formula 10 or from carboxylic acids of Formula 11 by methods analogous to those illustrated in Schemes 1 and 2, respectively.

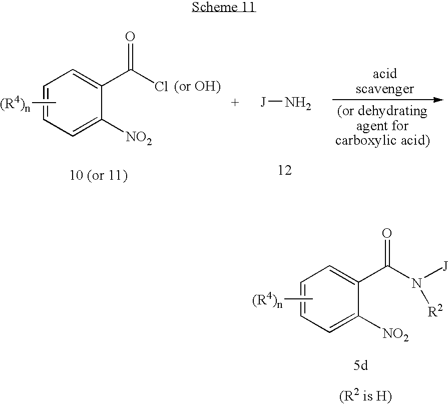

Amides of Formula 5d (wherein R² is other than H) can be prepared from corresponding amides of Formula 5d by methods analogous to those illustrated in Scheme 6.

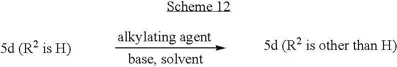

Amines of Formula 12 can be prepared from carboxylic acids of Formula 13 (or corresponding acid chloride derivatives) using Curtius, Schmitt or Lossen conditions. These name reactions are well documented in the literature. For some representative reaction conditions, refer to, e.g., R. C. Larock, Comprehensive Organic Transformations, 1989, VCH Publishers, pp. 431-2.

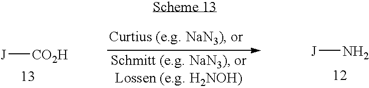

Amines of Formula 12 can also be prepared by reduction of appropriate nitro compounds of Formula 14 by methods analogous to those illustrated in Scheme 3.

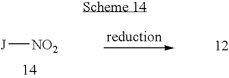

Benzoic acids of Formula 13a (J is optionally substituted phenyl) are generally well known in the art as are procedures for their preparation. One particularly useful subset of benzoic acids of this invention are 2-methyl-4-perfluoroalkyl benzoic acids of Formula 13a (one R⁵ is e.g. CF₃, C₂F₅, C₃F₇). The synthesis for these compounds is outlined in Schemes 15-19. Benzoic acids of Formula 13a may be prepared from the benzonitriles of Formula 15 by hydrolysis. The conditions used may involve the use of a base such as an alkaline metal hydroxide or alkoxide (e.g. potassium or sodium hydroxide) in a solvent such as water, ethanol or ethylene glycol (e.g. J. Chem. Soc. 1948, 1025). Alternatively, the hydrolysis may be carried out using an acid such as sulfuric acid or phosphoric acid in a suitable solvent such as water (e.g. Org. Synth. 1955, Coll Vol. 3, 557). The choice of the conditions is contingent on the stability of R⁵ to the reaction conditions; elevated temperatures are usually employed to achieve this transformation.

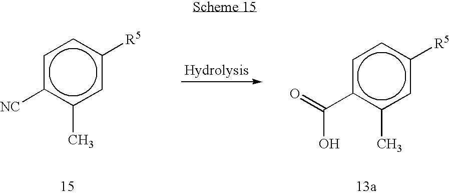

Nitriles of Formula 15 can be prepared from anilines of Formula 16 by the classical sequence involving diazotization and treatment of the intermediate diazonium salt with a copper cyanide salt (e.g. J. Amer. Chem. Soc. 1902, 24, 1035).

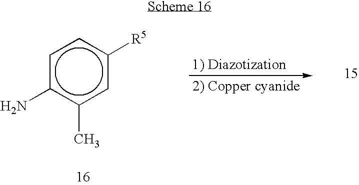

Anilines of Formula 16 may be prepared from compounds of Formula 17. This transformation may be achieved by a well-known procedure that employs Raney Nickel (Org. Synth. Coll. Vol VI, 581). Alternatively, the same transformation may be effected by the use of a suitable catalyst such as palladium in the presence of hydrogen. The reaction is usually conducted at pressures between 10² to 10⁵ kPa in a suitable organic solvent such as, but not limited to, toluene. Elevated temperatures of 80-110° C. are usually required to achieve the transformation. As one skilled in the art will realize, numerous chemical modifications of the thioether moiety are possible and may be employed when necessary to facilitate this transformation.

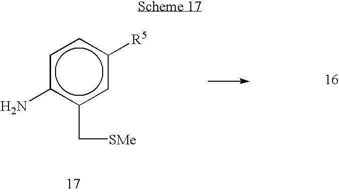

Compounds of Formula 17 maybe prepared from iminosulfuranes of Formula 18. The transformation may be achieved in a protic solvent such as methanol or water, in a non-protic solvent such as dichloromethane or toluene in the presence of a suitable base such as triethylamine (e.g. Org. Synth. Coll. Vol. VI, 581) or sodium methoxide, or in a combination of a protic solvent, a protic solvent and a base. The temperature at which the reaction is conducted is usually in the range 40-110° C. As one skilled in the art will realize, suitable salts of compounds of Formula 18 such as, but not limited to a hydrochloride, a sulfate or a bisulfate may also be employed, provided that the appropriate amount of base is first used to generate the free base 18. This may be done as a separate step or as an integral part of the step involving the transformation of compounds of Formula 18 to compounds of Formula 17.

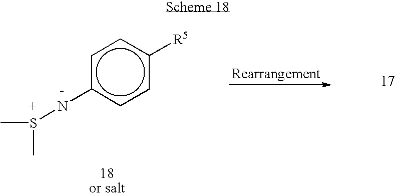

Compounds of Formula 18 may be prepared from anilines of Formula 19 by reaction with dimethyl sulfide and a suitable chlorinating agent such as, but not limited to N-chlorosuccinimide (e.g. Org. Synth. Coll. Vol. VI, 581), chlorine or N-chlorobenzotriazole. Alternatively, anilines of Formula 19 may be treated with dimethyl sulfoxide which has been “activated” by treatment with an agent such as acetic anhydride, trifluoroacetic, anhydride, trifluoromethanesulfonic anhydride, cyclohexylcarbodiimide, sulfur trioxide, or phosphorus pentoxide. The reaction is conducted in a suitable organic solvent such as dichloromethane or dimethyl sulfoxide. The reaction is conducted at a temperature of −70° C. to 25° C.; the optimum temperature is dependent on the solvent and reagent used.

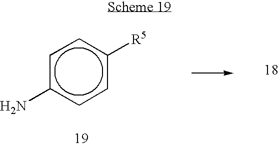

Heterocyclic acids 13, where J is equal to an optionally substituted heterocycle, can be prepared by procedures outlined in Schemes 20-25. Both general and specific references to a wide variety of heterocyclic acids including thiophenes, furans, pyridines, pyrimidines, triazoles, imidazoles, pyrazoles, thiazoles, oxazoles, isothiazoles, thiadiazoles, oxadiazoles, triazines, pyrazines, pyridazines, and isoxazoles can be found in the following compendia: Rodd's Chemistry of Chemistry of Carbon Compounds, Vol. IVa to IV1., S. Coffey editor, Elsevier Scientific Publishing, New York, 1973; Comprehensive Heterocyclic Chemistry, Vol. 1-7, A. R. Katritzky and C. W. Rees editors, Pergamon Press, NewYork, 1984; Comprehensive Heterocyclic Chemistry II, Vol. 1-9, A. R. Katritzky, C. W. Rees, and E. F. Scriven editors, Pergamon Press, NewYork, 1996; and the series, The Chemistry of Heterocyclic Compounds, E. C. Taylor, editor, Wiley, New York. Particularly useful heterocyclic acids of this invention include pyridine acids, pyrimidine acids and pyrazole acids. Procedures for the synthesis of representative examples of each are detailed in Schemes 20-25. A variety of heterocyclic acids and general methods for their synthesis may be found in World Patent Application WO 98/57397.

The synthesis of representative pyridine acids of Formula 13b is depicted in Scheme 20. This procedure involves the known synthesis of pyridines from β-ketoesters and 4-aminobutenones of Formula 23. Substituent groups R⁵(d) and R⁵(e) include e.g. alkyl and haloalkyl. For leading references to this method see, Synthesis, 1999, (7), 1216-1222 and Heterocycles, 1997, 46, 129-132.

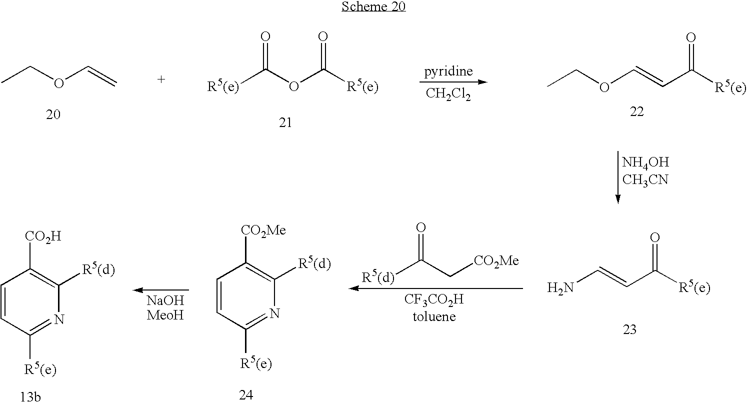

The synthesis of representative pyrimidine acids of Formula 13c is depicted in Scheme 21. This procedure involves the known synthesis of pyrimidines from vinylidene-β-ketoesters of Formula 26 and amidines. Substituent groups R⁵(d) and R⁵(e) include e.g. alkyl and haloalkyl. For a leading reference to this method see, Bull. Soc. Chim. Fr., 1987, (2),318-324.

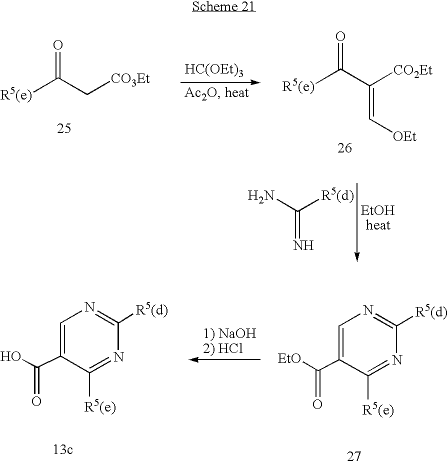

Syntheses of representative pyrazole acids of Formula 13d are depicted in Schemes 22-25. The synthesis of 13d in Scheme 22 involves as the key step introduction of the R⁵(e) substituent via alkylation of the pyrazole of Formula 28. The alkylating agent R⁵(e)-Lg (wherein Lg is a leaving group such as Cl, Br, I, sulfonates such asp-toluenesulfonate or methanesulfonate or sulfates such as —OSO₂R⁵(e)) includes R⁵(e) groups such as C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, C₂-C₆ alkylcarbonyl, C₂-C₆ alkoxycarbonyl, C₃-C₈ dialkylaminocarbonyl, C₃-C₆ trialkylsilyl; and a phenyl, benzyl, benzoyl, 5- or 6-membered heteroaromatic ring or an aromatic 8-, 9- or 10-membered fused heterobicyclic ring system, each ring or ring system optionally substituted. Oxidation of the methyl group affords the pyrazole carboxylic acid. Some of the more preferred R⁵(d) groups include haloalkyl.

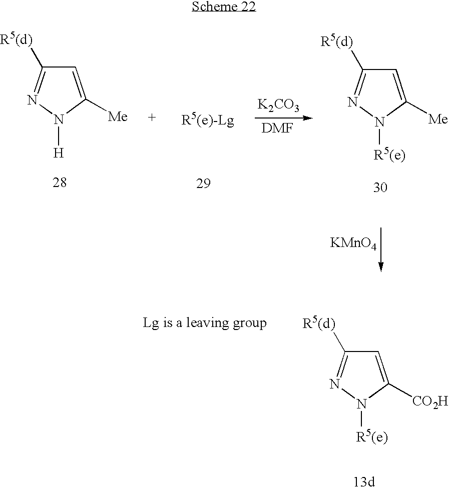

Some pyrazole acids may be prepared via metallation and carboxylation of pyrazoles of Formula 32 as the key step (Scheme 23). The R⁵(e) group is introduced in a manner similar to that of Scheme 22, i.e. via alkylation with a R⁵(e) alkylating agent. Representative R⁵(d) groups include such as cyano and haloalkyl.

Other pyrazoles of Formula 13d can be prepared via reaction of an optionally substituted phenyl hydrazine 33 with a pyruvate 34 to yield pyrazole esters 35 (Scheme 24). Hydrolysis of the ester affords the pyrazole acids 13d. This procedure is particularly useful for the preparation of compounds where R⁵(e) is optionally substituted phenyl and R⁵(d) is haloalkyl.

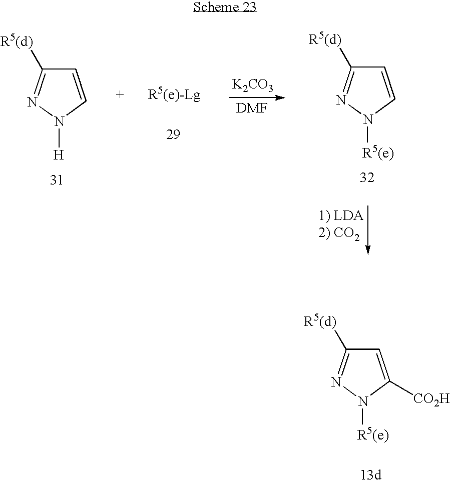

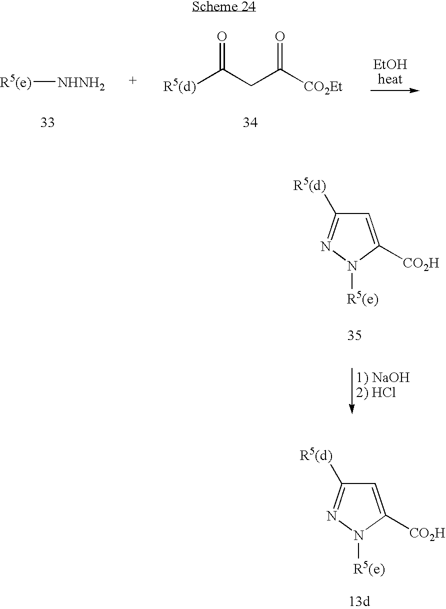

Pyrazole acids of Formula 13d can also be prepared via 3+2 cycloaddition of an appropriately substituted nitrilimine with either substituted propiolates of Formula 37 or acrylates of Formula 39 as shown in Scheme 25. Cycloaddition with acrylates requires additional oxidation of the intermediate pyrazoline to the pyrazole. Hydrolysis of the ester 35 affords the pyrazole acids 13d. Preferred iminohalides for this reaction include the trifluoromethyl iminochloride 40) and the iminodibromide (41). Compounds such as 40 are known (J. Heterocycl. Chem. 1985, 22(2), 565-8). Compounds such as 41 are available by known methods (Tetrahedron Letters 1999, 40, 2605). These procedures are particularly useful for the preparation of compounds where R⁵(e) is optionally substituted phenyl and R⁵(d) is haloalkyl or bromo.

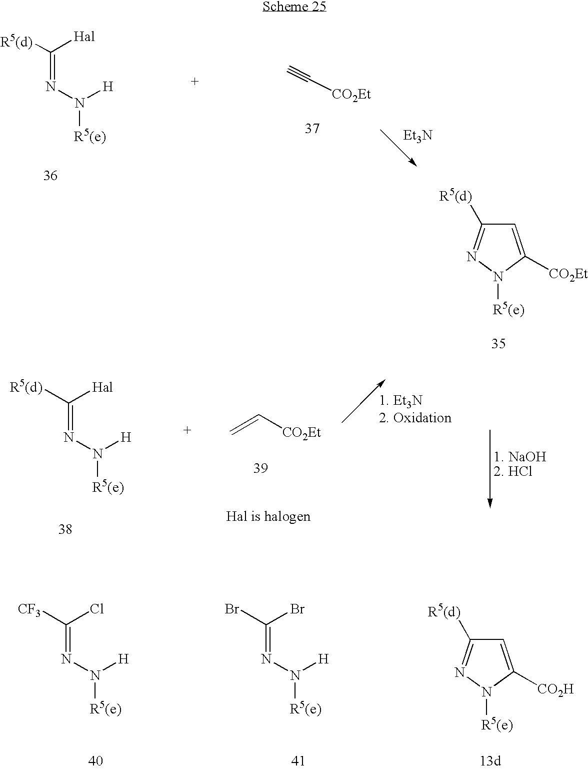

Pyrazole amines of Formula 12a can be prepared via reaction of an optionally substituted phenyl hydrazine 33 with a ketonitrile of Formula 42. This cyclization reaction is well documented in the literature. For leading references and some representative reaction conditions see, PCT Publication WO01/004115 and Synthesis, 1997, (3), 337-341. For reaction conditions also see Example 7 of this invention.

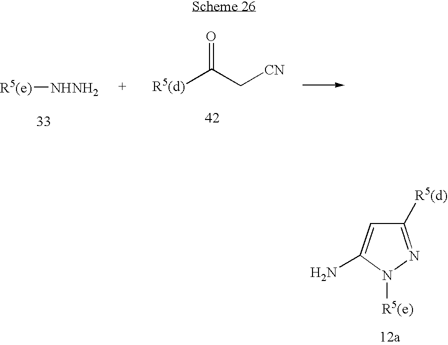

Compounds of Formula Id can be prepared by treatment of a benzoxazinone 43 with an amine 12 as shown in Scheme 27. The general reaction of benzoxazinones with amines to produce anthranilamides is well documented in the chemical literature. For a review of benzoxazinone chemistry see Jakobsen et al., Biorganic and Medicinal Chemistry 2000, 8, 2095-2103 and references cited within. For representative reaction methods to prepare benzoxazinones 43 see Journal of Heterocyclic Chemistry, 2000, 37(4), 725-729 and Tetrahedron, 1995, 51(7), 1861-6.

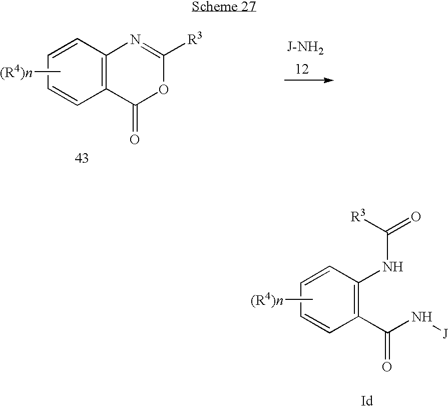

Compounds of Formula Ie can be prepared by methods depicted in Scheme 28. Acylation of amine 44 followed by reduction of the nitro group affords amine of Formula 46. Coupling of an amine 46 with an acid chloride 7 gives a compound of Formula Ie by methods analogous to those described in Scheme 1. Compounds of Formula 44 can be prepared by reduction alkylation by methods analogous to those described in Scheme 3. The acylation reaction can be achieved by coupling with acid chlorides 3 or acids 4 by methods analogous to those described in Scheme 1 and Scheme 2.

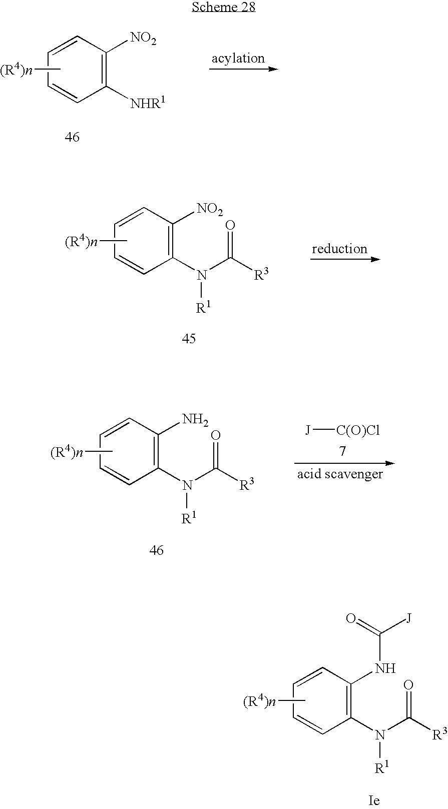

Pyrazolecarboxylic acids of Formula 13e wherein R⁵ is CF₃ can be prepared by the method outlined in Scheme 29.

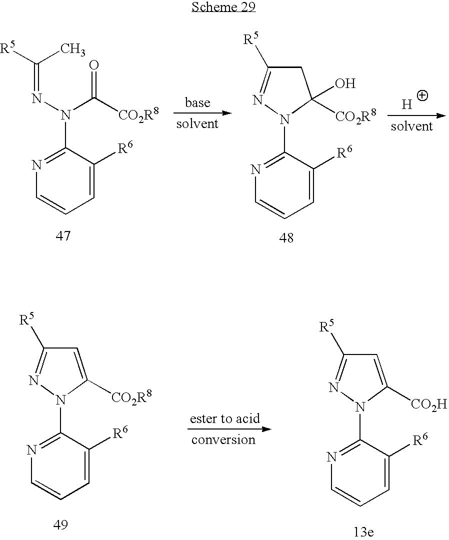

Reaction of a compound of Formula 47 wherein R⁸ is C₁₋₄ alkyl with a suitable base in a suitable organic solvent affords the cyclized product of Formula 48 after neutralization with an acid such as acetic acid. The suitable base can be, for example but not limitation, sodium hydride, potassium t-butoxide, dimsyl sodium (CH₃S(O)CH₂, Na⁺), alkali metal (such as lithium, sodium or potassium) carbonates or hydroxides, tetraalkyl (such as methyl, ethyl or butyl)ammonium fluorides or hydroxides, or 2-tert-butylimino-2-diethylamino-1,3-dimethyl-perhydro-1,3,2-diazaphosphonine. The suitable organic solvent can be, for example but not limitation, acetone, acetonitrile, tetrahydrofuran, dichloromethane, dimethylsulfoxide, or N,N-dimethylformamide. The cyclization reaction is usually conducted in a temperature range from about 0 to 120° C. The effects of solvent, base, temperature and addition time are all interdependent, and choice of reaction conditions is important to minimize the formation of byproducts. A preferred base is tetrabutylammonium fluoride.

Dehydration of the compound of Formula 48 to give the compound of Formula 49, followed by converting the carboxylic ester function to carboxylic acid, affords the compound of Formula 13e. The dehydration is effected by treatment with a catalytic amount of a suitable acid. This catalytic acid can be, for example but not limitation, sulfuric acid. The reaction is generally conducted using an organic solvent. As one skilled in the art will realize, dehydration reactions may be conducted in a wide variety of solvents in a temperature range generally between about 0 and 200° C., more preferably between about 0 and 100° C.). For the dehydration in the method of Scheme 9, a solvent comprising acetic acid and temperatures of about 65° C. are preferred. Carboxylic ester compounds can be converted to carboxylic acid compounds by numerous methods including nucleophilic cleavage under anhydrous conditions or hydrolytic methods involving the use of either acids or bases (see T. W. Greene and P. G. M. Wuts, Protective Groups in Organic Synthesis, 2nd ed., John Wiley & Sons, Inc., New York, 1991, pp. 224-269 for a review of methods). For the method of Scheme 9, base-catalyzed hydrolytic methods are preferred. Suitable bases include alkali metal (such as lithium, sodium or potassium) hydroxides. For example, the ester can be dissolved in a mixture of water and an alcohol such as ethanol. Upon treatment with sodium hydroxide or potassium hydroxide, the ester is saponified to provide the sodium or potassium salt of the carboxylic acid. Acidification with a strong acid, such as hydrochloric acid or sulfuric acid, yields the carboxylic acid of Formula 13e. The carboxylic acid can be isolated by methods known to those skilled in the art, including crystallization, extraction and distillation.

Compounds of Formula 47 can be prepared by the method outlined in Scheme 30.

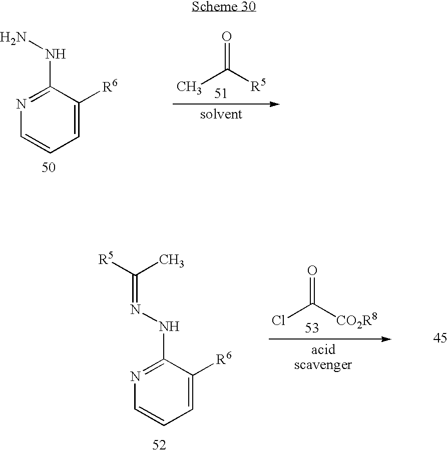

wherein R⁵ is CF₃ and R⁸ is C₁-C₄ alkyl.

Treatment of a hydrazine compound of Formula 50 with a ketone of Formula 51 in a solvent such as water, methanol or acetic acid gives the hydrazone of Formula 52. One skilled in the art will recognize that this reaction may require catalysis by an optional acid and may also require elevated temperatures depending on the molecular substitution pattern of the hydrazone of Formula 52. Reaction of the hydrazone of Formula 52 with the compound of Formula 53 in a suitable organic solvent such as, for example but not limitation, dichloromethane or tetrahydrofuran in the presence of an acid scavenger such as triethylamine provides the compound of Formula 47. The reaction is usually conducted at a temperature between about 0 and 100° C. Further experimental details for the method of Scheme 30 are illustrated in Example 8. Hydrazine compounds of Formula 50 can be prepared by standard methods, such as by contacting the corresponding 2-halo pyridine with hydrazine.

As an alternative to the method illustrated in Scheme 29, pyrazolecarboxylic acids of Formula 13e wherein R⁵ is Cl or Br can also be prepared by the method outlined in Scheme 31.

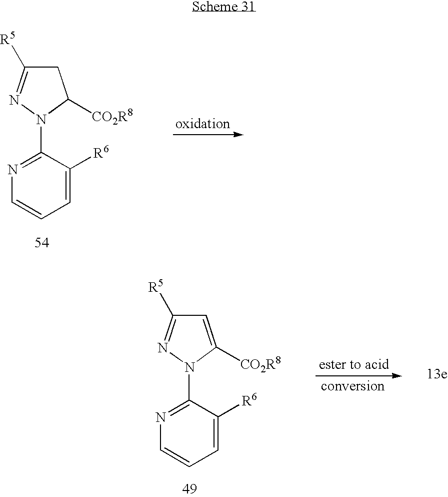

wherein R⁸ is C₁-C₄ alkyl.

Oxidization of the compound of Formula 54 optionally in the presence of acid to give the compound of Formula 49 followed by conversion of the carboxylic ester function to the carboxylic acid provides the compound of Formula 13e. The oxidizing agent can be hydrogen peroxide, organic peroxides, potassium persulfate, sodium persulfate, ammonium persulfate, potassium monopersulfate (e.g., Oxone®) or potassium permanganate. To obtain complete conversion, at least one equivalent of oxidizing agent versus the compound of Formula 54 should be used, preferably between about one to two equivalents. This oxidation is typically carried out in the presence of a solvent. The solvent can be an ether, such as tetrahydrofuran, p-dioxane and the like, an organic ester, such as ethyl acetate, dimethyl carbonate and the like, or a polar aprotic organic such as N-dimethylformamide, acetonitrile and the like. Acids suitable for use in the oxidation step include inorganic acids, such as sulfuric acid, phosphoric acid and the like, and organic acids, such as acetic acid, benzoic acid and the like. The acid, when used, should be used in greater than 0.1 equivalents versus the compound of Formula 54. To obtain complete conversion, one to five equivalents of acid can be used. The preferred oxidant is potassium persulfate and the oxidation is preferably carried out in the presence of sulfuric acid. The reaction can be carried out by mixing the compound of Formula 54 in the desired solvent and, if used, the acid. The oxidant can then be added at a convenient rate. The reaction temperature is typically varied from as low as about 0° C. up to the boiling point of the solvent in order to obtain a reasonable reaction time to complete the reaction, preferably less than 8 hours. The desired product, a compound of Formula 49 can be isolated by methods known to those skilled in the art, including crystallization, extraction and distillation. Methods suitable for converting the ester of Formula 49 to the carboxylic acid of Formula 13e are already described for Scheme 29.

Compounds of Formula 54 can be prepared from corresponding compounds of Formula 55 as shown in Scheme 32.

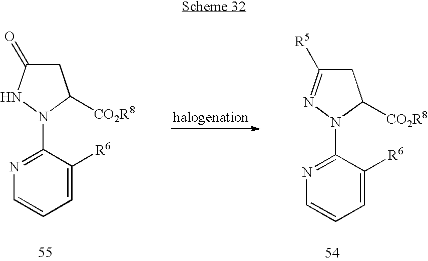

wherein R⁸ is C₁-C₄ alkyl.

Treatment of a compound of Formula 55 with a halogenating reagent, usually in the presence of a solvent, affords the corresponding halo compound of Formula 54. Halogenating reagents that can be used include phosphorus oxyhalides, phosphorus trihalides, phosphorus pentahalides, thionyl chloride, dihalotrialkylphophoranes, dihalodiphenylphosphoranes, oxalyl chloride and phosgene. Preferred are phosphorus oxyhalides and phosphorus pentahalides. To obtain complete conversion, at least 0.33 equivalents of phosphorus oxyhalide versus the compound of Formula 55 should be used, preferably between about 0.33 and 1.2 equivalents. To obtain complete conversion, at least 0.20 equivalents of phosphorus pentahalide versus the compound of Formula 55 should be used, preferably between about 0.20 and 1.0 equivalents. Compounds of Formula 55 wherein R⁸ is C₁-C₄ alkyl are preferred for this reaction. Typical solvents for this halogenation include halogenated alkanes, such as dichloromethane, chloroform, chlorobutane and the like, aromatic solvents, such as benzene, xylene, chlorobenzene and the like, ethers, such as tetrahydrofuran, p-dioxane, diethyl ether, and the like, and polar aprotic solvents such as acetonitrile, N,N-dimethylformamide, and the like. Optionally, an organic base, such as triethylamine, pyridine, N,N-dimethylaniline or the like, can be added. Addition of a catalyst, such as N,N-dimethylformamide, is also an option. Preferred is the process in which the solvent is acetonitrile and a base is absent. Typically, neither a base nor a catalyst is required when acetonitrile solvent is used. The preferred process is conducted by mixing the compound of Formula 55 in acetonitrile. The halogenating reagent is then added over a convenient time, and the mixture is then held at the desired temperature until the reaction is complete. The reaction temperature is typically between 20° C. and the boiling point of acetonitrile, and the reaction time is typically less than 2 hours. The reaction mass is then neutralized with an inorganic base, such as sodium bicarbonate, sodium hydroxide and the like, or an organic base, such as sodium acetate. The desired product, a compound of Formula 54, can be isolated by methods known to those skilled in the art, including crystallization, extraction and distillation.

Alternatively, compounds of Formula 54 wherein R⁵ is Br or Cl can be prepared by treating the corresponding compounds of Formula 54 wherein R⁵ is a different halogen (e.g., Cl for making Formula 54 wherein R⁵ is Br) or a sulfonate group such as p-toluenesulfonate, benzenesulfonate and methanesulfonate with hydrogen bromide or hydrogen chloride, respectively. By this method the R⁵ halogen or sulfonate substituent on the Formula 54 starting compound is replaced with Br or Cl from hydrogen bromide or hydrogen chloride, respectively. The reaction is conducted in a suitable solvent such as dibromomethane, dichloromethane or acetonitrile. The reaction can be conducted at or near atmospheric pressure or above atmospheric pressure in a pressure vessel. When R⁵ in the starting compound of Formula 54 is a halogen such as Cl, the reaction is preferably conducted in such a way that the hydrogen halide generated from the reaction is removed by sparging or other suitable means. The reaction can be conducted between about 0 and 100° C., most conveniently near ambient temperature (e.g., about 10 to 40° C.), and more preferably between about 20 and 30° C. Addition of a Lewis acid catalyst (such as aluminum tribromide for preparing Formula 54 wherein R⁵ is Br) can facilitate the reaction. The product of Formula 54 is isolated by the usual methods known to those skilled in the art, including extraction, distillation and crystallization.

Starting compounds of Formula 54 wherein R⁵ is Cl or Br can be prepared from corresponding compounds of Formula 55 as already described. Starting compounds of Formula 54 wherein R⁵ is a sulfonate group can likewise be prepared from corresponding compounds of Formula 54 by standard methods such as treatment with a sulfonyl chloride (e.g., p-toluenesulfonyl chloride) and base such as a tertiary amine (e.g., triethylamine) in a suitable solvent such as dichloromethane.

Pyrazolecarboxylic acids of Formula 13e wherein R⁵ is OCH₂CF₃ can be prepared by the method outlined in Scheme 33.

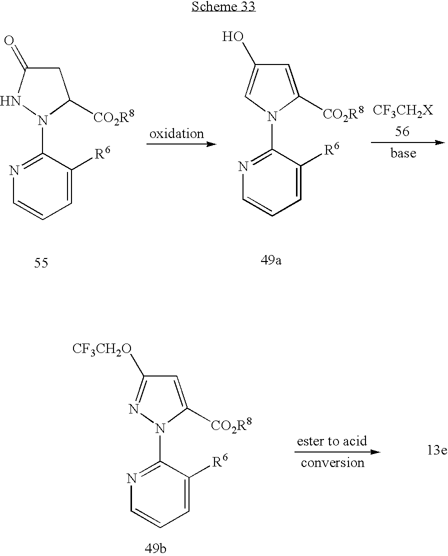

wherein R⁸ is C₁-C₄ alkyl, and X is a leaving group. In this method, instead of being halogenated as shown in Scheme 32, the compound of Formula 55 is oxidized to the compound of Formula 49a. The reaction conditions for this oxidation are as already described for the conversion of the compound of Formula 54 to the compound of Formula 49 in Scheme 31.

The compound of Formula 49a is then alkylated to form the compound of Formula 49b by contact with an alkylating agent CF₃CH₂X (56) in the presence of a base. In the alkylating agent 56, X is a nucleophilic reaction leaving group such as halogen (e.g., Br, I), OS(O)₂CH₃ (methanesulfonate), OS(O)₂CF₃, OS(O)₂Ph-p-CH₃ (p-toluenesulfonate), and the like; methanesulfonate works well. The reaction is conducted in the presence of at least one equivalent of a base. Suitable bases include inorganic bases, such as alkali metal (such as lithium, sodium or potassium) carbonates and hydroxides, and organic bases, such as triethylamine, diisopropylethylamine and 1,8-diazabicyclo[5.4.0]undec-7-ene. The reaction is generally conducted in a solvent, which can comprise alcohols, such as methanol and ethanol, halogenated alkanes, such as dichloromethane, aromatic solvents, such as benzene, toluene and chlorobenzene, ethers, such as tetrahydrofuran, and polar aprotic solvents, such as acetonitrile, such as such as acetonitrile, N,N-diethylformamide, and the like. Alcohols and polar aprotic solvents are preferred for use with inorganic bases. Potassium carbonate as base and acetonitrile as solvent are preferred. The reaction is generally conducted between about 0 and 150° C., with most typically between ambient temperature and 100° C. The product of Formula 49b can be isolated by conventional techniques such as extraction. The ester of Formula 49b can then be converted to the carboxylic acid of Formula 13e by the methods already described for the conversion of Formula 49 to Formula 13e in Scheme 29.

Compounds of Formula 55 can be prepared from compounds of Formula 50 as outlined in Scheme 34.

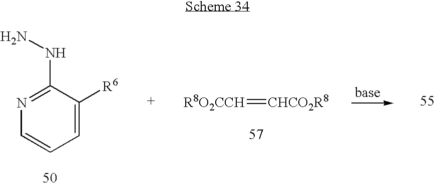

wherein R⁸ is C₁-C₄ alkyl.

In this method, a hydrazine compound of Formula 50 is contacted with a compound of Formula 57 (a fumarate ester or maleate ester or a mixture thereof may be used) in the presence of a base and a solvent. The base is typically a metal alkoxide salt, such as sodium methoxide, potassium methoxide, sodium ethoxide, potassium ethoxide, potassium tert-butoxide, lithium tert-butoxide, and the like. Greater than 0.5 equivalents of base versus the compound of Formula 50 should be used, preferably between 0.9 and 1.3 equivalents. Greater than 1.0 equivalents of the compound of Formula 57 should be used, preferably between 1.0 to 1.3 equivalents. Polar protic and polar aprotic organic solvents can be used, such as alcohols, acetonitrile, tetrahydrofuran, N,N-dimethylformamide, dimethyl sulfoxide and the like. Preferred solvents are alcohols such as methanol and ethanol. It is especially preferred that the alcohol be the same as that making up the fumarate or maleate ester and the alkoxide base. The reaction is typically conducted by mixing the compound of Formula 18 and the base in the solvent. The mixture can be heated or cooled to a desired temperature and the compound of Formula 57 added over a period of time. Typically reaction temperatures are between 0° C. and the boiling point of the solvent used. The reaction may be conducted under greater than atmospheric pressure in order to increase the boiling point of the solvent. Temperatures between about 30 and 90° C. are generally preferred. The addition time can be as quick as heat transfer allows. Typical addition times are between 1 minute and 2 hours. Optimum reaction temperature and addition time vary depending upon the identities of the compounds of Formula 50 and Formula 57. After addition, the reaction mixture can be held for a time at the reaction temperature. Depending upon the reaction temperature, the required hold time may be from 0 to 2 hours. Typical hold times are 10 to 60 minutes. The reaction mass then can be acidified by adding an organic acid, such as acetic acid and the like, or an inorganic acid, such as hydrochloric acid, sulfuric acid and the like. Depending on the reaction conditions and the means of isolation, the —CO₂R⁸ function on the compound of Formula 55 may be hydrolyzed to —CO₂H; for example, the presence of water in the reaction mixture can promote such hydrolysis. If the carboxylic acid (—CO₂H) is formed, it can be converted back to —CO₂R⁸ wherein R⁸ is C₁-C₄ alkyl using esterification methods well-known in the art. The desired product, a compound of Formula 55, can be isolated by methods known to those skilled in the art, such as crystallization, extraction or distillation.

It is recognized that some reagents and reaction conditions described above for preparing compounds of Formula I may not be compatible with certain functionalities present in the intermediates. In these instances, the incorporation of protection/deprotection sequences or functional group interconversions into the synthesis will aid in obtaining the desired products. The use and choice of the protecting groups will be apparent to one skilled in chemical synthesis (see, for example, Greene, T. W.; Wuts, P. G. M. Protective Groups in Organic Synthesis, 2nd ed.; Wiley: N.Y., 1991). One skilled in the art will recognize that, in some cases, after the introduction of a given reagent as it is depicted in any individual scheme, it may be necessary to perform additional routine synthetic steps not described in detail to complete the synthesis of compounds of Formula I. One skilled in the art will also recognize that it may be necessary to perform a combination of the steps illustrated in the above schemes in an order other than that implied by the particular sequence presented to prepare the compounds of Formula I.

One skilled in the art will also recognize that compounds of Formula I and the intermediates described herein can be subjected to various electrophilic, nucleophilic, radical, organometallic, oxidation, and reduction reactions to add substituents or modify existing substituents.

Without further elaboration, it is believed that one skilled in the art using the preceding description can utilize the present invention to its fullest extent. The following Examples are, therefore, to be construed as merely illustrative, and not limiting of the disclosure in any way whatsoever. Percentages are by weight except for chromatographic solvent mixtures or where otherwise indicated. Parts and percentages for chromatographic solvent mixtures are by volume unless otherwise indicated. ¹H NMR spectra are reported in ppm downfield from tetramethylsilane; s is singlet, d is doublet, t is triplet, q is quartet, m is multiplet, dd is doublet of doublets, dt is doublet of triplets, br s is broad singlet.

### EXAMPLE 1

### 1-(2-Chlorophenyl)-N-[3-methyl-2-[(2-methyl-1-oxopropyl)amino]phenyl]-3-(trifluoromethyl)-1H-pyrazole-5-carboxamide

Step A: Preparation of 1-(2-Chlorophenyl)-5-(2-furanyl)-3-(trifuormethyl -1H-pyrazole

To a solution of 4,4,4-trifluoro-1-(2-furyl)-1,3-butanedione (30.0 g, 146 mmol) in glacial acetic acid (65 mL) was added sodium acetate (12.1 g, 148 mmol). The mixture was cooled to about 25° C., 2-chlorophenylhydrazine hydrochloride (25.6 g, 145 mmol) was added portionwise and, following a mild exotherm, the mixture was heated to 60° C. for 4 h, then cooled to 25° C. The mixture was diluted with dichloromethane (400 mL), and the organic phase was washed with water (3×250 mL), saturated aqueous sodium carbonate (2×250 mL) and brine, then dried over magnesium sulfate and evaporated under reduced pressure to yield 43.2 g of the title compound as a brown oil.

¹H NMR (CDCl₃) δ 7.6 (m,5H), 6.9 (1H), 5.7 (d, 1H).

Step B: Preparation of 1-(2-Chlorophenyl)-3-(trifluoromethyl)-1H-pyrazole-5-carboxylic Acid

To a suspension containing the title compound of Step A (43.2 g, 138 mmol) in acetonitrile (415 mL) was added sodium dihydrogen phosphate monohydrate (92.4 g, 669 mmol) over about 0.25 h. After stirring at room temperature for 0.5 h, the mixture was cooled to about 5° C. and a solution containing sodium chlorite (181.7 g, 2.0 mmol) in 430 mL of water was added dropwise over 1 h while keeping the reaction temperature at less than 10° C. [Note: an aqueous sodium hydroxide scrubber was attached to scrub an evolving yellow off-gas.] Following completion of addition the suspension was stirred at 5° C. for about 1 h, at 25° C. overnight, then acidified to pH 1 by dropwise addition of concentrated hydrochloric acid (150 mL), then extracted with ethyl acetate (1×500 mL, then 2×250 mL). The combined ethyl acetate extracts were added dropwise to an aqueous sodium metasulfite solution (228.5 g in 1.05 L water) at a reaction temperature of less than 20° C. The suspension was partitioned and the aqueous layer extracted with ethyl acetate (2×100 mL). The organic layers were combined, dried over magnesium sulfate and evaporated under reduced pressure. The residue was triturated with hexane:diethyl ether (99:1, 100 mL) to yield 32.9 g of the title compound as a solid.

¹H NMR (DMSO-d₆) δ 13.9 (bs,1H), 7.7(m,5H).

Step C: Preparation of 1-(2-Chlorophenyl —N-(3-methyl-2-nitrophenyl)-3-(trifluoromethyl)-1H-pyrazole-5-carboxamide

To a mixture of the title compound of Step B (1.2 g, 3.4 mmol) in dichloromethane (15 mL) was added oxalyl chloride (0.5 g, 3.7 mmol) followed by about 2 drops of N,N-dimethylformamide. After an initial exotherm the suspension was stirred at room temperature under N₂ for 0.4 h, then evaporated under reduced pressure to afford an oil residue. This residue was dissolved in tetrahydrofuran (20 mL), 2-methyl-6-nitroaniline (0.5 g, 152.2 mmol) was added followed by N,N-diisopropylethylamine (0.7 g, 129.5 mmol), and the suspension was stirred at room temperature under N₂ overnight. The crude mixture was evaporated under reduced pressure and the residue was purified by flash column chromatography on silica gel with hexane:ethyl acetate (2:1) as eluant to yield 200 mg of the title compound as a solid; m.p. 215-220° C.

¹H NMR (CDCl₃) δ 2.3 (s,3H), 6.3-6.6 (s,1H), 7.4-7.6 (m,7H), 8.0 (d,1H).

Step D: Preoaration of N-(2-Amino-3-methylphenl)-1-(2-chlorophenyl)-3-(trifluoromethyl)-1H-pyrazole-5-carboxamide

The title compound of Step C (1.0 g, 2.3 mmol) was dissolved in ethyl acetate (50 mL) and hydrogenated over 10% palladium on carbon (200 mg, 1.8 mmol) in a Parr Shaker (45 psi) for 3 h. Following work up by filtering the reaction mixture through Celite® diatomaceous filter aid and evaporating the filtrate under reduced pressure, the oil residue was slurried in hexane and filtered to yield 1.0 g of the title compound as an off-white solid; m.p. 165-167° C.

¹H NMR (CDCl₃) δ 2.2 (s,3H), 3.6 (m,2H), 6.7 (m,1H), 6.9 (m,1H), 7.1 (m,1H), 7.2 (m,1H), 7.4 (m,2H), 7.5, (m,2H), 8.1 (bs,1H).

Step E: Preparation of 1-(2-Chlorophenyl —N-[3-methyl-2-[(2-methyl-1-oxopropyl)amino]phenyl]-3-(trifluoromethyl)-1H-pyrazole-5-carboxamide

To a suspension containing the title compound of Step D (0.6 g, 1.5 mmol) in tetrahydrofuran (20 mL) was added isobutryl chloride (0.25 g, 2.3 mmol) followed by I-diisopropylethylamine (0.5 g, 3.9 mmol). The suspension was stirred overnight at 25° C. then diluted with 1N HCl (100 mL) and ethyl acetate (100 mL). The organic layer was separated, washed with 1N HCl, water, saturated aqueous sodium bicarbonate and brine (each wash about 50 mL), then dried over magnesium sulfate and evaporated under reduced pressure to yield 0.6 g of the title compound, a compound of the invention, as a solid; m.p. 240-242° C.

¹H NMR (CDCl₃) δ 1.3 (d,6H), 2.5(s,3H), 2.6 (m,1H), 7.0-7.6 (m,9H), 9.5 (s,1H).

### EXAMPLE 2

### 2-Methyl-6-[(2-methyl-1-oxopropyl)amino]-N-[2-methyl-4-(trifluoromethyl)phenyl]benzamide

Step A: Preparation of 2-Methyl-N-[2-methyl-4-(trifluoromethyl)phenyl]-6-nitrobenzamide

A mixture of 2-methyl-6-nitrobenzoic acid (9.0 g, 49.7 mmol) and thionyl chloride (62 mL)) was heated at reflux in toluene (100 mL) for 2.5 h then cooled to 25° C. The suspension was evaporated under reduced pressure, then azeotroped with toluene. The residue, dissolved in tetrahydrofuran (10 mL), was added dropwise to a solution containing 2-amino-5-trifluoromethyltoluene (2.89 g 16.5 mmol) and triethylamine (2.02 g, 20 mmol) in tetrahydrofurn (20 mL). The suspension was stirred 72 h at 25° C., then poured into water and extracted with ethyl acetate (2×20 mL). The combined organic extracts were evaporated onto silica gel and purified by medium pressure liquid chromatography on silica gel (gradient from 100% hexane to 1:1 hexane:ethyl acetate as eluants) to yield 1.22 g of the title compound.

¹H NMR (CDCl₃) δ 2.4 (s,3H), 2.6 (s,3H), 7.5-7.7 (m,5H), 8.1 (m,1H), 8.2 (m,1H).

Step B: Preparation of 2-Amino-6-N-[2-methyl-4-(trifluoromethyl)phenyl]benzamide

The title compound of Step A (2.73 g, 7.7 mmol) was dissolved in ethanol (25 mL) and hydrogenated over palladium on carbon (0.2 g) using a Parr Shaker (350 kPa) for 16 h. After filtering the reaction suspension through Celite®, the white pad was washed with diethyl ether. The combined organic layers were evaporated under reduced pressure to yield 2.4 g of the title compound as a semi-solid.

¹H NMR (CDCl₃) δ 2.4 (m,6H), 6.8 (m,3H), 7.1 (m,1H), 7.4-7.7 (m,4H), 8.3 (m,1H).

Step C: Preparation of 2-Methyl-6-[(2-methyl-1-oxopropyl)amino]-N-[2-methyl-4-trifluoromethyl)phenyl]benzamide

Isobutyryl chloride (51.8 mg, 0.5 mmol) was added to a solution containing the title compound of Step B (0.15 g, 0.5 mmol) and N,N-diisopropylethylamine (0.13 g, 1.0 mmol) in chloroform (5 mL). The suspension was stirred at 25° C. overnight then diluted with 1N HCl. After stirring about 1 h, the suspension was filtered through a 0.45 micron PTFE membrane, and the filtrate was evaporated under reduced pressure to yield 0.08 g of the title compound, a compound of the invention, as a solid; m.p. >230° C.

¹H NMR (DMSO-D₆) δ 1.0 (d,6H), 2.5 (s,3H), 2.4 (s,3H), 2.6 (m,1H), 7.1 (m,1H), 7.3 (m,1H), 7.6 (m,2H), 7.9 (m,2H), 9.3 (bs,1H), 9.9 (s,1H).

### EXAMPLE 3

### 2-Methyl-6-[(2-methyl-1-oxopropyl)amino]-N-[2-methyl-4-(trifiuoromethoxy)phenyl]benzamide

Step A: Preparation of 2-Methyl-N-[2-methyl-4-(trifluoromethoxy)phenyl]-6-nitrobenzamide

By the procedure of Example 2 (Step A), 2-methyltrifluoromethoxylaniline (3.15 g, 16.5 mmol) was reacted with 2-methyl-6-nitrobenzoyl chloride (3.3 g, 16.5 mmol) and triethylamine (2.02 g, 20 mmol) in tetrahydrofuran (30 mL). Following completion of reaction the reaction suspension was poured into excess water and extracted several times with ethyl acetate. The combined extracts were dried over magnesium sulfate and evaporated under reduced pressure to afford a solid. The solid was further purified by triturating with a hexane:diethyl ether solution to yield 2.73 g of the title compound.

¹H NMR (CDCl₃) δ 2.3 (s,3H), 2.6 (s,3H), 7.1 (m,3H), 7.5 (m,1H), 7.6 (m,1H), 7.9 (m,1H), 8.1 (m,1H).

Step B: Preparation of 2-Amino-6-N-[2-methyl-4-(trifluoromethoxy)-phenyl]benzamide

By the procedure of Example 2 (Step B), the title compound of Example 3 (Step A) (2.73 g, 7.7 mmol) was hydrogenated to afford 2.4 g of the title compound as a semisolid.

¹H NMR (CDCl₃) δ 2.3 (s,3H), 2.5 (s,3H), 6.6 (m,2H), 7.1 (m,6H), 7.4 (bs,1H), 8.0 (m,1H).

Step C: Preparation of 2-Methyl-6-[(2-methyl-1-oxopropyl)amno-N-[2-methyl-4-(trifluoromethoxy)phenyl]benzamide

Isobutyryl chloride (0.16 g, 1.2 mmol) was added to a solution containing the title compound of Step B (0.2 g, 0.6 mmol) and N,N-diisopropylethylamine (0.16 g, 1.2 mmol) in dichloromethane (5 mL). After the reaction was stirred at 25° C. overnight, the suspension was poured into water and extracted several times with ethyl acetate. The combined extracts were dried over magnesium sulfate and evaporated under reduced pressure to yield 0.13 g of the title compound, a compound of the invention, as a solid; m.p. >230° C.

¹H NMR (DMSO-d₆) δ 1.0 (d,6H), 2.3 (s,3H), 2.4 (s,3H), 2.6 (m,1H), 7.1 (m,1H), 7.2-7.4 (m,4H), 7.7 (m,1H), 9.3 (s,1H), 9.8 (s,1H).

### EXAMPLE 4

### 3-Chloro-2-[(2-methyl-1-oxopropyl)amino]-N-[4-(trifluoromethoxy)phenyl]benzamide

Step A: Preparation of 3-Chloro-2-nitro-N-[4-(trifluoromethoxy)phenyl]benzamide

Phosphorus pentachloride (2.14 g, 10.2 mmol) was added portionwise to a mixture of 3-chloro-2-nitrobenzoic acid (2.0 g, 9.7 mmol) in dichloromethane (30 mL). After the addition was complete and gas evolution ceased, the solution was stirred at room temperature for 0.5 h then evaporated under reduced pressure. Residual phosphorus oxychloride was further removed under reduced pressured with toluene to yield 2.1 g of the corresponding benzoyl chloride as a solid. A solution containing the benzoyl chloride (1.0 g, 4.4 mmol) in dichloromethane (10 mL) was added dropwise to a solution containing 4-trifluoromethoxyaniline (0.79 g, 4.4 mmol) and triethylamine (0.45 g, 4.4 mmol) in dichloromethane (3 mL). The suspension was stirred at room temperature for 0.5 h then poured into excess water and extracted several times with ethyl acetate. The combined organic extracts were washed with water, dried over magnesium sulfate and evaporated under reduced pressure to yield a solid. This solid was washed with hexane:diethyl ether (1:1) to yield 1.38 g of the title compound as a solid; m.p. 171-172° C.

¹H NMR (CDCl₃) δ 7.2 (m,3H), 7.5-7.7 (m,4H), 7.8 (bs,1H).

Step B: Preparation of 2-Amino-3-chloro-N-[4-(trifluoromethoxy)phenyl]benzamide

To a solution of sodium borohydride (26 mg, 0.68 mmol) in ethanol (1 mL) was added a suspension containing copper(II) acetylacetonate (20.0 mg, 0.08 mmol) in 2-propanol (1 mL), followed by a suspension containing the title compound of Step A (0.25 g, 0.6 mmol) in 2-propanol (3 mL), followed by a solution of sodium borohydride (2.0 mg, 78 mmol) in ethanol (2 mL). The reaction mixture was stirred at 25° C. for 7 h, then poured into dilute aqueous ammonium chloride and extracted several times with ethyl acetate. The combined organic extracts were dried over magnesium chloride and evaporated under reduced pressure to yield 0.18 g of the title compound.

¹H NMR (CDCl₃) δ 7.3 (m,5H), 7.4 (m,2H), 7.6 (m,2H), 7.8 (bs, 1H).

Step C: Preparation of 3-Chloro-2-[(2-methyl-1-oxopropyl)amino]-N-[4-(trifluoromethoxy)phenyl]benzamide

Isobutyryl chloride (57 mg, 0.5 mmol) was added to a mixture of the title compound of Step B (0.18 g,0.5 mmol) and triethylamine (54.0 mg, 0.5 mmol) in dichloromethane (3 mL). After stirring for 1.5 h an additional 5 drops of isobutyryl chloride and 5 drops of triethylamine were added. The suspension was stirred for 2 h then poured into water and extracted several times with ethyl acetate. The combined extracts were washed with water and then dried over magnesium sulfate and evaporated under reduced pressure. The residue was further purified by flash column chromatography on silica gel with hexane:ethyl acetate (2:1) as eluants to yield 40.0 mg of the title compound, a compound of the invention, as a solid; m.p. 230-233° C.

¹H NMR (DMSO-D₆) δ 1.0 (d,6H), 2.6 (m,1H), 7.3-7.4 (m,3H), 7.5 (m,1H), 7.7 (m,1H), 7.8 (m,2H), 9.6 (s,1H), 10.4 (s,1H).

### EXAMPLE 5

### 1-(3-Chloro-pyridinyl)-N-[2-methyl-6-[(2-methyl-1-oxoproyl)amino]phenyl]-3-(trifluoromethyl)-1H-pyrazole-5-carboxamide

Step A: Preparation of 1-(3-Chloro-pyridinyl)-N-(2-methyl-6-nitrophenyl)-3-(trifluoromethyl)-1H-pyrazole-5-carboxamide

To a suspension of 1-(3-chloro-2-pyridinyl)-3-(trifluoromethyl)-1H-pyrazole-5-carboxylic acid (2.875 g, 9.86 mmol) stirring in dichloromethane (30 mL) at 0° C. was added oxalyl chloride (5.16 mL, 59.2 mmol) dropwise followed by N,N-dimethylformamide (1 drop). The stirred solution was then heated to reflux and after stirring at this temperature for 1 hour, the solution was concentrated to dryness under reduced pressure. The residue was then dissolved in tetrahydrofuran (30 mL) and to the stirred solution was added 2-methyl-6-nitroaniline. The solution was then cooled to 0° C. and N,N-diisopropylethylamine (8.60 mL, 49.3 mmol) was added dropwise. The stirred solution was then heated to reflux, and was stirred at this temperature for 42 hours then concentrated to dryness under reduced pressure. The residue was then dissolved in ethyl acetate (30 mL), and the solution was washed with 1N HCl (10 mL), saturated aqueous sodium hydrogencarbonate (10 mL) and brine (10 mL), dried (MgSO₄) and concentrated under reduced pressure to leave a yellow solid. This product was dissolved in acetonitrile (6 mL) with stirring, aqueous ammonia (6 mL) was added and the solution was stirred at ambient temperature for 2 hours and then concentrated to dryness under reduced pressure. The product was purified by flash column chromatography over silica gel (3:1 heptanes-ethyl acetate eluent) to give the title compound as a yellow solid (1.53 g).

¹H NMR (CDCl₃) δ 2.21 (s, 3H), 7.18 (s, 1H), 7.27 (t, 1H), 7.38 (m, 1H), 7.47 (d, 1H), 7.84 (d, 1H), 7.85 (d, 1H), 8.42 (dd, 1H), 9.16 (s, 1H).

Step B: Preparation of N-(2-Amine-6-methylphenyl)-1-(3-chloro-2-pyridinyl)-3-(trifluoromethyl)-1H-pyrazole-5-carboxamide

A flask containing a stirring suspension of 10% Pd on carbon (69 mg) in ethanol (5 mL) was evacuated/filled with nitrogen (×3). To the suspension was then added a solution of 1-(3-chloro-pyridinyl)-N-(2-methyl-6-nitrophenyl)-3-(trifluoromethyl)-1H-pyrazole-5-carboxamide (i.e. the product of Step A) (1.38 g, 3.25 mmol) in ethanol (9 mL). The flask was then evacuated/filled with nitrogen (×3) then evacuated/filled with hydrogen (×3). The reaction mixture was stirred at ambient temperature for 18 hours then filtered through Celite® and the filter bed was washed with ethanol (2×3 mL). The filtrate was concentrated under reduced pressure to give the title compound as an off-white solid (1.306 g).

Step C: Preparation of 1-(3-Chloro-pyridinyl)-N-[2-methyl-6-[(2-methyl-1-oxopropyl)amino]phenyl]-3-(trifluoromethyl)-1H-pyrazole-5-carboxamide

To a stirred solution of isobutyryl chloride (0.053 mL, 0.505 mmol) in tetrahydrofuran was added N-(2-amine-6-methylphenyl)-1-(3-chloro-2-pyridinyl)-3-(trifluoromethyl)-1H-pyrazole-5-carboxamide (i.e. the product of Step B) (0.20 g, 0.505 mmol). The solution was then cooled to 0° C., and diisopropylethylamine (0.60 mL, 3.59 mmol) was added dropwise. The stirred solution was then allowed to warm to ambient temperature over 18 hours, and was then concentrated to dryness under reduced pressure. The residue was then dissolved in ethyl acetate (10 mL), and the solution was washed with 1N HCl (10 mL), saturated aqueous sodium hydrogen carbonate (10 mL) and brine (10 mL), dried (MgSO₄) and concentrated under reduced pressure to leave a yellow solid. This product was purified by slurrying in hot tert-butyl methyl ether (5 mL) to give the title compound, a compound of the invention, as a solid (216 mg) melting at 215-217° C.

¹HNMR (CDCl₃) δ 1.11 (s, 3H), 1.13 (s, 3H), 2.20 (s, 3H), 2.44 (m, 1H), 6.89 (dd, 1H), 7.05 (s, 1H), 7.07 (d, 1H), 7.15 (s, 1H), 7.35 (m, 1H), 7.48 (s, 1H), 7.81 (dd, 1H), 8.41 (dd, 1H), 9.06 (s, 1H).

### EXAMPLE 6

### 1-(3-Chloro-2-pyridinyl)-N-[3-methyl-2-[(2-methyl-1-oxopropyl)amino]phenyl]-3-(trifluoromethyl)-1H-pyrazole-5-carboxamide

Step A: Preparation of 2-Methyl-N-(2-methyl-6-nitrophenyl)-propanamide

To a solution of 2-methyl-6-nitroaniline (2.5 g, 16.4 mmol) stirring in dichloromethane (22.5 mL) at 0° C. was added pyridine (2.5 mL) followed by isobutyryl chloride (1.72 mL, 16.4 mmol) dropwise. The solution was allowed to warm to ambient temperature over 2 hours. After stirring at ambient temperature for a further 48 hours, dichloromethane (10 mL) was added followed by saturated aqueous sodium hydrogencarbonate (30 mL). The aqueous phase was then separated and extracted with dichloromethane (20 mL). The organic extracts were then combined, dried (MgSO₄) and concentrated under reduced pressure to give the title compound as a yellow solid (3.54 g).

Step B: Preparation of N-(2-Amino-6-methylphenyl)-2-methylpropanamide

A flask containing a stirred suspension of 10% Pd on carbon (25 mg) in ethanol (5 mL) was evacuated/filled with nitrogen (×3). To the suspension was then added a solution of 2-methyl-N-(2-methyl-6-nitrophenyl)-propanamide (i.e. the product of Step A) (2.54 g, 11.4 mmol) in ethanol (45 mL). The flask was then evacuated/filled with nitrogen (×3) then evacuated/filled with hydrogen (×3). The reaction mixture was stirred at ambient temperature for 35 minutes then filtered through Celite® and the filter bed was washed with ethanol (2×5 mL). The filtrate was concentrated under reduced pressure to give the title compound as an off-white solid (2.19 g).

Step C: Preparation of 1-(3-Chloro-pyridinyl)-N-[3-methyl-2-[(2-methyl-1-oxopropyl)amino]phenyl]-3-(trifluoromethyl)-1H-pyrazole-5-carboxamide

To a suspension of 1-(3-chloro-2-pyridinyl)-3-(trifluoromethyl)-1H-pyrazole-5-carboxylic acid (0.1 g, 0.42 mmol) stirring in dichloromethane (4 mL) at 0° C. was added oxalyl chloride (0.31 g, 2.44 mmol) dropwise followed by N,N-dimethylformamide (1 drop). The stirred solution was then heated to reflux and after stirring at this temperature for 1 hour, the solution was concentrated to dryness under reduced pressure. The residue was then dissolved in tetrahydrofuran (10 mL) and to the stirred solution was added N-(2-amino-6-methylphenyl)-2-methylpropanamide (i.e. the product of Step B). The solution was then cooled to 0° C. and N,N-diisopropylethylamine (0.52 mL, 2.99 mmol) was added dropwise. The solution was then allowed to warm to ambient temperature over 18 hours, and concentrated to dryness under reduced pressure. The residue was then dissolved in ethyl acetate (10 mL), and the solution was washed with 1N HCl (10 mL), saturated aqueous sodium hydrogen carbonate (10 mL) and brine (10 mL), dried (MgSO₄) and concentrated under reduced pressure to leave a yellow solid. This product was purified by flash column chromatography over silica gel (1:1 heptanes-ethyl acetate eluent) then by recrystallisation from ethyl acetate to give the title compound, a compound of the invention, as a solid (70 mg) melting at 219-220° C.

¹H NMR (CDCl₃) δ 1.27 (s, 3H), 1.29 (s, 3H), 2.29 (s, 3H), 2.66 (m, 1H), 7.02 (s, 1H), 7.08 (s, 1H), 7.10 (d, 1H), 7.25 (s, 1H), 7.33 (d, 1H), 7.39 (m, 1H), 7.84 (dd, 1H), 8.44 (dd, 1H), 9.50 (s, 1H).

### Example 7

### N-[1-(2-Chlorophenyl)-3-(trifluoromethyl)-1H-pyrazol-5-yl]-2-methyl-6-[(2-methyl-1-oxopropyl)amino]benzamide

Step A: Preparation of 4,4,4-trifluoro-3-oxo-butanenitrile (alternatively named 4,4,4-trifluoroacetoacetonitrile)

To a 500 mL 3-necked-flask equipped with a nitrogen bubbler and two septa was added lithium diisopropylamide (LDA) (18.4 mL, 0.172 mol, 2M in heptanes), and the reaction mixture was cooled to −72° C. A 0° C. solution of trifluoromethyl acetate (10.0 g, 0.078 mol), acetonitrile (6.41 g, 0.156 mol), and THF (100 mL) was added dropwise under nitrogen using an addition funnel. After 45 minutes, the solution was allowed to warm to room temperature over 1 to 2 hours, quenched with cold water (250 mL), and the organic solvents evaporated. The aqueous layer was then washed with diethyl ether (3×250 mL), acidified to pH 2 with concentrated HCl and washed with methylene chloride (3×250 mL). Subsequently, the aqueous layer was extracted with diethyl ether (3×250 mL). The diethyl ether extraction was dried with sodium sulfate and concentrated to afford the title compound as a clear, orange oil (1.38 g, 0.010 mol, 32% yield).

¹H NMR (CD₃OD, 300 MHz) δ 2.96 (2H, s).

Step B: Preparation of 1 (2-Chlorophenyl)-3-(trifluoromethyl)-1H-pyrazole-5-amine

To a Personal Chemistry (Personal Chemistry Inc., Boston, Mass., USA) 10 mL reaction vessel was added 2-chlorophenylhydrazine (0.392 g, 2.19 mmol), ethanol (2.5 mL), and 5 drops of glacial acetic acid. A solution of 4,4,4-trifluoro-3-oxo-butanenitrile (i.e. the product of Step A) (0.300 g, 2.19 mmol) in ethanol (1 mL) was added and the tube was then sealed and heated at 150° C. for 30 minutes in the microwave. The resulting crude mixture was concentrated and purified using silica gel chromatography (ethyl acetate/hexane, 1:4), to afford the title compound as a yellow solid (0.179 g, 0.684 mmol, 31% yield).

¹H NMR (CDCl₃, 300 MHz) δ 3.82 (2H, br), 5.85 (1H, s), 7.45-7.60 (4H, m).

Step C: Preparation of 5-Methyl-2-(1-methylethyl)₄H-3,1-benzoxazin-4-one

To a 500 mL round bottom flask was added 2-amino-6-methylbenzoic acid (5.00 g, 0.033 mol) and THF (200 mL). Isobutyryl chloride (7.049 g, 0.066 mol) and triethylamine (10.04 g, 0.099 mol) were added and the reaction mixture was stirred at room temperature overnight. After removal of the solvent, the compound was purified by silica gel chromatography (ethyl acetate/hexane, 1:9), to yield the title compound as a white solid (4.85 g, 0.024 mol, 72% yield).

¹H NMR (CDCl₃, 300 MHz) δ 1.35 (6H, d), 2.78 (3H, s), 2.90 (1H, septet), 7.21 (1H, d), 7.40 (1H, d), 7.64 (1H, t).

Step D: Preparation of N-[1-(2-Chlorophenyl)-3-(trifluoromethyl]-1H-pyrazol-5-yl]-2-methyl-6-[(2-methyl-1-oxopropyl)amino]benzamide

Sodium hydride (0.2 g, 7.9 mmol, 95% purity) was added under nitrogen to a 10 mL flask charged with 1-(2-chlorophenyl)-3-(trifluoromethyl)-1H-pyrazole-5-amine (i.e. the product of Step B) (0.200 g, 0.76 mmol) and DMF (5 mL). After stirring at room temperature for 5 minutes, 5-methyl-2-(1-methylethyl)-4H-3,1-benzoxazin-4-one (i.e. the product of Step C) (0.155 g, 0.76 mmol) was added. The reaction was monitored by TLC (Thin Layer Chromatography), quenched with 10 drops of water and purified directly by silica gel preparative TLC (1:4 ethyl acetate/hexane) to yield the title compound, a compound of the invention, as a white solid (0.135 g, 0.29 mmol, 38% yield).

¹H NMR (CDCl₃, 300 MHz) δ 1.08 (6H, d), 2.14 (3H, s), 2.38 (1H, m), 6.91 (1H, d), 7.07 (1H, s), 7.02 (1H, t), 7.41-7.59 (5H, m), 8.28 (1H, br), 8.36 (1H, br).

The following Example 8 illustrates an preparation of 1-(3-chloro-2-pyridinyl)-3-(trifluoromethyl)-1H-pyrazole-5-carboxylic acid, which can be used to prepare, for example, 1-(3-chloro-pyridinyl)-N-[2-methyl-6-[(2-methyl-1-oxopropyl)amino]phenyl]-3-(trifluoromethyl)-1H-pyrazole-5-carboxamide, by further steps illustrated in Examples 5.

### EXAMPLE 8

### Preparation of 1-(3-chloro-2-pyridinyl)-3-(trifluoromethyl)-1H-pyrazole-5-carboxylic Acid

Step A: Preparation of 3-chloro-2(1H-pyridinone (2.2.2-trifluoro-1-methylethylidene)hydrazone

1,1,1-Trifluoroacetone (7.80 g, 69.6 mmol) was added to 3-chloro-2(1H)-pyridinone hydrazone (alternatively named (3-chloro-pyridin-2-yl)-hydrazine) (10 g, 69.7 mmol) at 20-25° C. After the addition was complete, the mixture was stirred for about 10 minutes. The solvent was removed under reduced pressure and the mixture partitioned between ethyl acetate (100 mL) and saturated aqueous sodium carbonate solution (100 mL). The organic layer was dried and evaporated. Chromatography on silica gel (eluted with ethyl acetate) gave the product as an off-white solid (11 g, 66% yield), m.p. 64-64.5° C. (after crystallization from ethyl acetate/hexanes).

IR (nujol) ν 1629, 1590, 1518, 1403, 1365, 1309, 1240, 1196, 1158, 1100, 1032, 992, 800 cm⁻¹.

¹H NMR (CDCl₃) δ 2.12 (s, 3H), 6.91-6.86 (m, 1H), 7.64-7.61 (m, 1H), 8.33-8.32 (m, 2H).

MS m/z 237 (M⁺).

Step B: Preparation of ethyl hydrogen ethanedioate (3-chloro-2-pyridinyl)(2,2,2-trifluoro-1-methylethylidene)hydrazide (alternatively named ethyl hydrogen ethanedioate (3-chloro-2-pyridinyl)(2,2,2-trifluoro-1-methylethylidene)hydrazine)

Triethylamine (20.81 g, 0.206 mol) was added to 3-chloro-2(1H)-pyridinone (2,2,2-trifluoro-1-methylethylidene)hydrazone (i.e. the product of Step A) (32.63 g, 0.137 mol) in dichloromethane (68 mL) at 0° C. Ethyl chlorooxoacetate (18.75 g, 0.137 mol) in dichloromethane (69 mL) was added dropwise to the mixture at 0° C. The mixture was allowed to warm to 25° C. over about 2 hours. The mixture was cooled to 0° C. and a further portion of ethyl chlorooxoacetate (3.75 g, 27.47 mmol) in dichloromethane (14 mL) was added dropwise. After about an additional 1 hour, the mixture was diluted with dichloromethane (about 450 mL), and the mixture was washed with water (2×150 mL). The organic layer was dried and evaporated. Chromatography on silica gel (eluted with 1:1 ethyl acetate-hexanes) gave the product as a solid (42.06 g, 90% yield), m.p. 73.0-73.5° C. (after crystallization from ethyl acetate/hexanes).

IR (nujol) ν 1751, 1720, 1664, 1572, 1417, 1361, 1330, 1202, 1214, 1184, 1137, 1110, 1004, 1043, 1013, 942, 807, 836 cm⁻¹.

¹HNMR (DMSO-d₆, 115° C.) 1.19 (t, 3H), 1.72 (br s, 3H), 4.25 (q, 2H), 7.65 (dd, J=8.3, 4.7 Hz, 1H), 8.20 (dd, J=7.6, 1.5 Hz, 1H), 8.55 (d, J=3.6 Hz, 1H).

MS m/z 337 (M⁺).

Step C: Preparation of ethyl 1-(3-chloro-2-pyridinyl)-4,5-dihydro-5-hydroxy-3-(trifluoromethyl)-1H-pyrazole-5-carboxylate

Ethyl hydrogen ethanedioate (3-chloro-2-pyridinyl)(2,2,2-trifluoro-1-methyl-ethylidene)hydrazide (i.e. the product of Step B) (5 g, 14.8 mmol) in dimethyl sulfoxide (25 mL) was added to tetrabutylammonium fluoride hydrate (10 g) in dimethyl sulfoxide (25 mL) over 8 hours. When the addition was complete, the mixture was poured into acetic acid (3.25 g) in water (25 mL). After stirring at 25° C. overnight, the mixture was then extracted with toluene (4×25 mL), and the combined toluene extracts were washed with water (50 mL), dried and evaporated to give a solid. Chromatography on silica gel (eluted with 1:2 ethyl acetate-hexanes) gave the product as a solid (2.91 g, 50% yield, containing about 5% of 3-chloro-2(1H)-pyridinone (2,2,2-trifluoro-1-methylethylidene)hydrazone), m.p. 78-78.5° C. (after recrystallization from ethyl acetate/hexanes).

IR (nujol) ν 3403, 1726, 1618, 1582, 1407, 1320, 1293, 1260, 1217, 1187, 1150, 1122, 1100, 1067, 1013, 873, 829 cm⁻¹.

¹HNMR (CDCl₃) δ 1.19 (s, 3H), 3.20 (½ of ABZ pattern, J=18 Hz, 1H), 3.42 (½ of ABZ pattern, J=18 Hz, 1H), 4.24 (q, 2H), 6.94 (dd, J=7.9, 4.9 Hz, 1H), 7.74 (dd, J=7.7, 1.5 Hz, 1H), 8.03 (dd, J=4.7, 1.5 Hz, 1H). MS m/z 319 (M⁺).

Step D: Preparation of ethyl 1-(3-chloro-2-pyridinyl)-3-(trifluoromethyl)-1H-pyrazole-5-carboxylate

Sulfuric acid (concentrated, 2 drops) was added to ethyl 1-(3-chloro-2-pyridinyl)-4,5-dihydro-5-hydroxy-3-(trifluoromethyl)-1H-pyrazole-5-carboxylate (i.e. the product of Step C) (1 g, 2.96 mmol) in acetic acid (10 mL) and the mixture was warmed to 65° C. for about 1 hour. The mixture was allowed to cool to 25° C. and most of the acetic acid was removed under reduced pressure. The mixture was partitioned between saturated aqueous sodium carbonate solution (100 mL) and ethyl acetate (100 mL). The aqueous layer was further extracted with ethyl acetate (100 mL). The combined organic extracts were dried and evaporated to give the product as an oil (0.66 g, 77% yield).

IR (neat) ν 3147, 2986, 1734, 1577, 1547, 1466, 1420, 1367, 1277, 1236, 1135, 1082, 1031, 973, 842, 802 cm⁻¹.

¹HNMR (CDCl₃) δ 1.23 (t, 3H), 4.25 (q, 2H), 7.21 (s, 1H), 7.48 (dd, J=8.1, 4.7 Hz, 1H), 7.94 (dd, J=6.6, 2 Hz, 1H), 8.53 (dd, J=4.7, 1.5 Hz, 1H).

MS m/z 319 (M⁺).

Step E: Preparation of 1-(3-chloro-2-pyridinyl)-3-(trifluoromethyl)-1H-pyrazole-5-carboxylic Acid

Potassium hydroxide (0.5 g, 85%, 2.28 mmol) in water (1 mL) was added to ethyl 1-(3-chloro-2-pyridinyl)-3-(trifluoromethyl)-1H-pyrazole-5-carboxylate (i.e. the product of Step D) (0.66 g, 2.07 mmol) in ethanol (3 mL). After about 30 minutes, the solvent was removed under reduced pressure, and the mixture was dissolved in water (40 mL). The solution was washed with ethyl acetate (20 mL). The aqueous layer was acidified with concentrated hydrochloric acid and was extracted with ethyl acetate (3×20 mL). The combined extracts were dried and evaporated to give the product as a solid (0.53 g, 93% yield), m.p. 178-179° C. (after crystallization from hexanes-ethyl acetate). IR (nujol) ν 1711, 1586, 1565, 1550, 1440, 1425, 1292, 1247, 1219, 1170, 1135, 1087, 1059, 1031, 972, 843, 816 cm⁻¹.

¹H NMR (DMSO-d₆) δ 7.61 (s, 1H), 7.77 (m, 1H), 8.30 (d, 1H), 8.60 (s, 1H).

By the procedures described herein together with methods known in the art, the following compounds of Tables 1 to 20 can be prepared. The following abbreviations are used in the Tables which follow: t is tertiary, s is secondary, n is normal, i is iso, c is cyclo, Me is methyl, Et is ethyl, Pr is propyl, i-Pr is isopropyl, Bu is butyl, Ph is phenyl, OMe is methoxy, OEt is ethoxy, SMe is methyltbio, SEt is ethylthio, CN is cyano, and S(O)₂Me is methylsulfonyl.

TABLE 1

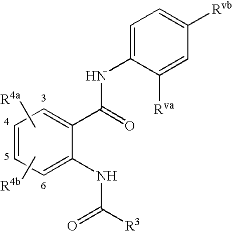

| R³ | R^{4a} | R^{4b} | R^{va} | R^{vb} |
|---|---|---|---|---|
| Me | 3-Me | H | H | CF₃ |
| Et | 3-Me | 5-Me | H | OCF₃ |
| i-Pr | 3-Me | H | H | OCF₃ |
| t-Bu | 3-Me | 5-Cl | Me | Br |
| Me | 3-Me | H | Et | Br |
| Et | 3-Me | H | Me | Cl |
| i-Pr | 3-Me | 5-Br | Et | Cl |
| t-Bu | 3-Me | H | Me | I |
| propargyl | 3-Me | H | Me | CF₃ |
| cyclopropyl | 3-Me | H | Me | OCF₃ |
| i-Pr | 3-Me | 5-Cl | Me | CF₃ |
| t-Bu | 3-Me | H | Me | SCF₃ |
| Me | 3-Me | 5-CN | Me | SCHF₂ |
| Et | 3-Me | H | Me | OCHF₂ |
| i-Pr | 3-Me | H | Me | CF₃ |
| t-Bu | 3-Me | H | Me | C₂F₅ |
| propargyl | 3-Me | H | Me | C₂F₅ |
| cyclopropyl | 3-Me | H | Et | CF₃ |
| i-Pr | 3-Me | H | n-Pr | CF₃ |
| t-Bu | 3-Me | 5-Br | i-Pr | CF₃ |
| Me | 3-Me | H | Cl | CF₃ |
| Et | 3-Me | H | F | CF₃ |
| i-Pr | 3-Me | H | Me | SMe |
| t-Bu | 3-Me | 5-Cl | Me | OMe |
| Me | 3-Me | H | Me | OEt |
| Et | 3-Me | H | Me | n-C₃F₇ |
| i-Pr | 3-Me | H | Me | i-C₃F₇ |
| t-Bu | 3-Me | 5-F | Me | Et |
| propargyl | 3-Me | H | Me | OCF₂CHF₂ |
| Et | 3-Me | H | Me | SCF₂CHF₂ |
| i-Pr | 3-Me | H | Me | SO₂Me |
| t-Bu | 3-Me | 5-Cl | Me | SO₂CF₃ |
| Me | 3-Me | H | CF₃ | CF₃ |
| Et | 3-Me | H | CF₃ | Me |
| i-Pr | 3-Me | H | OMe | CF₃ |
| t-Bu | 3-Me | H | H | CF₃ |
| cyclopropyl | 3-Me | 5-Br | H | OCHF₂ |
| Et | 3-Me | H | H | C₂F₅ |
| i-Pr | 3-Me | 5-Me | H | C₂F₅ |
| t-Bu | 3-Me | H | H | OCF₃ |
| Me | 3-Me | H | H | OCF₂CHF₂ |
| Et | 3-Me | H | H | SCF₂CHF₂ |
| i-Pr | 3-Me | 5-Cl | H | n-C₃F₇ |
| t-Bu | 3-Me | H | H | i-C₃F₇ |
| propargyl | 3-Me | H | H | Br |
| Et | 3-Me | H | H | Cl |
| i-Pr | 3-Me | H | H | SCF₃ |
| t-Bu | 3-Me | 5-Br | Ph | CF₃ |
| cyclopropyl | 3-Me | H | Ph | Cl |
| Et | 3-Me | H | Ph | Br |
| i-Pr | 3-Me | H | 2-pyridyl | CF₃ |
| t-Bu | 3-Me | H | 2-pyridyl | Cl |
| Me | 3-Me | H | 2-ClPh | CF₃ |
| Et | 3-Me | 5-Cl | 2-ClPh | OCF₃ |
| i-Pr | 3-Me | H | 2-ClPh | Br |
| t-Bu | 3-Me | H | 2-ClPh | Cl |
| Me | 3-Me | H | 2-ClPh | SCHF₂ |
| propargyl | 3-Me | H | 2-BrPh | CF₃ |
| i-Pr | 3-Me | 5-CN | 2-MePh | CF₃ |
| t-Bu | 3-Me | H | 2-CNPh | CF₃ |
| Me | 3-Me | H | 2-FPh | CF₃ |
| Et | 3-Me | H | 2,6-F₂Ph | CF₃ |
| i-Pr | 3-Me | 5-Br | 2,4-F₂Ph | CF₃ |
| t-Bu | 3-Me | H | 2,5-F₂Ph | CF₃ |
| Me | 3-Me | 5-I | 2-MeOPh | CF₃ |
| Et | 3-Me | H | 3-Cl-2-pyridyl | CF₃ |
| i-Pr | 3-Me | 5-Me | 3-Cl-2-pyridyl | OCF₃ |
| t-Bu | 3-Me | H | 3-Cl-2-pyridyl | Br |
| propargyl | 3-Me | H | 3-Cl-2-pyridyl | Cl |
| Et | 3-Me | 5-Br | 3-Cl-2-pyridyl | SCHF₂ |
| i-Pr | 3-Me | H | 3-F-2-pyridyl | CF₃ |
| t-Bu | 3-Me | H | 3-CF₃-2-pyridyl | CF₃ |
| Me | 3-Me | H | 3-Me-2-pyridyl | CF₃ |
| Et | 3-Me | H | 3-Br-2-pyridyl | CF₃ |
| i-Pr | 3-Me | 5-Cl | 3-Br-2-pyridyl | OCF₃ |
| t-Bu | 3-Me | H | 3-Br-2-pyridyl | Br |
| i-Pr | 3-Me | H | 3-Br-2-pyridyl | Cl |
| Me | 6-Me | H | H | CF₃ |
| Et | 6-Me | 4-Me | H | OCF₃ |
| i-Pr | 6-Me | H | H | OCF₃ |
| t-Bu | 6-Me | Cl | Me | Br |
| Me | 6-Me | H | Et | Br |
| Et | 6-Me | H | Me | Cl |
| i-Pr | 6-Me | 4-Br | Et | Cl |
| t-Bu | 6-Me | H | Me | I |
| propargyl | 6-Me | H | Me | CF₃ |
| cyclopropyl | 6-Me | H | Me | OCF₃ |
| i-Pr | 6-Me | 4-Cl | Me | CF₃ |
| t-Bu | 6-Me | H | Me | SCF₃ |
| Me | 6-Me | H | Me | SCHF₂ |
| Et | 6-Me | H | Me | OCHF₂ |
| i-Pr | 6-Me | 4-CN | Me | CF₃ |
| t-Bu | 6-Me | H | Me | C₂F₅ |
| propargyl | 6-Me | H | Me | C₂F₅ |
| cyclopropyl | 6-Me | H | Et | CF₃ |
| i-Pr | 6-Me | H | n-Pr | CF₃ |
| t-Bu | 6-Me | 4-Br | i-Pr | CF₃ |
| Me | 6-Me | H | Cl | CF₃ |
| Et | 6-Me | H | F | CF₃ |
| i-Pr | 6-Me | H | Me | SMe |
| t-Bu | 6-Me | 4-Cl | Me | OMe |
| Me | 6-Me | H | Me | OEt |
| Et | 6-Me | H | Me | n-C₃F₇ |
| i-Pr | 6-Me | H | Me | i-C₃F₇ |
| t-Bu | 6-Me | 4-F | Me | Et |
| propargyl | 6-Me | H | Me | OCF₂CHF₂ |
| Et | 6-Me | H | Me | SCF₂CHF₂ |
| i-Pr | 6-Me | H | Me | SO₂Me |
| t-Bu | 6-Me | 4-Cl | Me | SO₂CF₃ |
| Me | 6-Me | H | CF₃ | CF₃ |
| Et | 6-Me | H | CF₃ | Me |
| i-Pr | 6-Me | H | OMe | CF₃ |
| t-Bu | 6-Me | H | H | CF₃ |
| cyclopropyl | 6-Me | 4-Br | H | OCHF₂ |
| Et | 6-Me | H | H | C₂F₅ |
| i-Pr | 6-Me | H | H | C₂F₅ |
| t-Bu | 6-Me | 4-Me | H | OCF₃ |
| Me | 6-Me | H | H | OCF₂CHF₂ |
| Et | 6-Me | H | H | SCF₂CHF₂ |
| i-Pr | 6-Me | 4-Cl | H | n-C₃F₇ |
| t-Bu | 6-Me | H | H | i-C₃F₇ |
| propargyl | 6-Me | H | H | Br |
| Et | 6-Me | H | H | Cl |
| i-Pr | 6-Me | H | H | SCF₃ |
| t-Bu | 6-Me | 4-Br | Ph | CF₃ |
| cyclopropyl | 6-Me | H | Ph | Cl |
| Et | 6-Me | H | Ph | Br |
| i-Pr | 6-Me | H | 2-pyridyl | CF₃ |
| t-Bu | 6-Me | H | 2-pyridyl | Cl |
| Me | 6-Me | H | 2-ClPh | CF₃ |
| Et | 6-Me | 4-Cl | 2-ClPh | OCF₃ |
| i-Pr | 6-Me | H | 2-ClPh | Br |
| t-Bu | 6-Me | 4-CN | 2-ClPh | Cl |
| Me | 6-Me | H | 2-ClPh | SCHF₂ |
| propargyl | 6-Me | H | 2-BrPh | CF₃ |
| i-Pr | 6-Me | H | 2-MePh | CF₃ |
| t-Bu | 6-Me | H | 2-CNPh | CF₃ |
| Me | 6-Me | H | 2-FPh | CF₃ |
| Et | 6-Me | H | 2,6-F₂Ph | CF₃ |
| i-Pr | 6-Me | 4-Br | 2,4-F₂Ph | CF₃ |
| t-Bu | 6-Me | H | 2,5-F₂Ph | CF₃ |
| Me | 6-Me | 4-I | 2-MeOPh | CF₃ |
| Et | 6-Me | H | 3-Cl-2-pyridyl | CF₃ |
| i-Pr | 6-Me | H | 3-Cl-2-pyridyl | OCF₃ |
| t-Bu | 6-Me | H | 3-Cl-2-pyridyl | Br |
| propargyl | 6-Me | H | 3-Cl-2-pyridyl | Cl |
| Et | 6-Me | 4-Br | 3-Cl-2-pyridyl | SCHF₂ |
| i-Pr | 6-Me | H | 3-F-2-pyridyl | CF₃ |
| t-Bu | 6-Me | H | 3-CF₃-2-pyridyl | CF₃ |
| Me | 6-Me | H | 3-Me-2-pyridyl | CF₃ |
| Et | 6-Me | H | 3-Br-2-pyridyl | CF₃ |
| i-Pr | 6-Me | 4-Cl | 3-Br-2-pyridyl | OCF₃ |
| t-Bu | 6-Me | H | 3-Br-2-pyridyl | Br |
| i-Pr | 6-Me | H | 3-Br-2-pyridyl | Cl |
| Me | 3-Cl | H | H | CF₃ |
| Et | 3-Br | 5-Me | H | OCF₃ |
| i-Pr | 3-Cl | H | H | OCF₃ |
| t-Bu | 3-Cl | 5-Cl | Me | Br |
| Me | 3-Cl | H | Et | Br |
| Et | 3-Cl | H | Me | Cl |
| i-Pr | 3-Cl | 5-Br | Et | Cl |
| t-Bu | 3-Cl | H | Me | I |
| propargyl | 3-Cl | H | Me | CF₃ |
| cyclopropyl | 3-Cl | H | Me | OCF₃ |
| i-Pr | 3-Cl | 5-Cl | Me | CF₃ |
| t-Bu | 3-Cl | H | Me | SCF₃ |
| Me | 3-F | H | Me | SCHF₂ |
| Et | 3-Cl | H | Me | OCHF₂ |
| i-Pr | 3-Cl | 5-CN | Me | CF₃ |
| t-Bu | 3-Cl | H | Me | C₂F₅ |
| propargyl | 3-Cl | H | Me | C₂F₅ |
| cyclopropyl | 3-Cl | H | Et | CF₃ |
| i-Pr | 3-Cl | H | n-Pr | CF₃ |
| t-Bu | 3-Cl | 5-Br | i-Pr | CF₃ |
| Me | 3-Cl | H | Cl | CF₃ |
| Et | 3-Br | H | F | CF₃ |
| i-Pr | 3-Cl | H | Me | SMe |
| t-Bu | 3-Cl | 5-Cl | Me | OMe |
| Me | 3-Cl | H | Me | OEt |
| Et | 3-Cl | H | Me | n-C₃F₇ |
| i-Pr | 3-Cl | H | Me | i-C₃F₇ |
| t-Bu | 3-Cl | 5-F | Me | Et |
| propargyl | 3-Cl | H | Me | OCF₂CHF₂ |
| Et | 3-Cl | H | Me | SCF₂CHF₂ |
| i-Pr | 3-Br | H | Me | SO₂Me |
| t-Bu | 3-Cl | 5-Cl | Me | SO₂CF₃ |
| Me | 3-Cl | H | CF₃ | CF₃ |
| Et | 3-CN | H | CF₃ | Me |
| i-Pr | 3-Cl | H | OMe | CF₃ |
| t-Bu | 3-Cl | H | H | CF₃ |
| cyclopropyl | 3-Cl | 5-Br | H | OCHF₂ |
| Et | 3-Cl | H | H | C₂F₅ |
| i-Pr | 3-Cl | H | H | C₂F₅ |
| t-Bu | 3-Cl | H | H | OCF₃ |
| Me | 3-F | H | H | OCF₂CHF₂ |
| Et | 3-Cl | H | H | SCF₂CHF₂ |
| i-Pr | 3-Cl | 5-Cl | H | n-C₃F₇ |
| t-Bu | 3-Cl | H | H | i-C₃F₇ |
| propargyl | 3-Cl | H | H | Br |
| Et | 3-Cl | H | H | Cl |
| i-Pr | 3-Cl | H | H | SCF₃ |
| t-Bu | 3-Cl | 5-Br | Ph | CF₃ |
| cyclopropyl | 3-Cl | H | Ph | Cl |
| Et | 3-Cl | H | Ph | Br |
| i-Pr | 3-Br | H | 2-pyridyl | CF₃ |
| t-Bu | 3-Cl | H | 2-pyridyl | Cl |
| Me | 3-Cl | H | 2-ClPh | CF₃ |
| Et | 3-Cl | 5-Cl | 2-ClPh | OCF₃ |
| i-Pr | 3-Cl | H | 2-ClPh | Br |
| t-Bu | 3-I | H | 2-ClPh | Cl |
| Me | 3-Cl | 5-Me | 2-ClPh | SCHF₂ |
| propargyl | 3-Cl | H | 2-BrPh | CF₃ |
| i-Pr | 3-Cl | H | 2-MePh | CF₃ |
| t-Bu | 3-Cl | 5-CN | 2-CNPh | CF₃ |
| Me | 3-Cl | H | 2-FPh | CF₃ |
| Et | 3-Cl | H | 2,6-F₂Ph | CF₃ |
| i-Pr | 3-Cl | 5-Br | 2,4-F₂Ph | CF₃ |
| t-Bu | 3-F | H | 2,5-F₂Ph | CF₃ |
| Me | 3-Cl | 5-I | 2-MeOPh | CF₃ |
| Et | 3-Cl | H | 3-Cl-2-pyridyl | CF₃ |
| i-Pr | 3-CN | H | 3-Cl-2-pyridyl | OCF₃ |
| t-Bu | 3-Cl | H | 3-Cl-2-pyridyl | Br |
| propargyl | 3-Cl | H | 3-Cl-2-pyridyl | Cl |
| Et | 3-Cl | 5-Br | 3-Cl-2-pyridyl | SCHF₂ |
| i-Pr | 3-Cl | H | 3-F-2-pyridyl | CF₃ |
| t-Bu | 3-Br | H | 3-CF₃-2-pyridyl | CF₃ |
| Me | 3-Cl | H | 3-Me-2-pyridyl | CF₃ |
| Et | 3-Cl | H | 3-Br-2-pyridyl | CF₃ |
| i-Pr | 3-Cl | 5-Cl | 3-Br-2-pyridyl | OCF₃ |
| t-Bu | 3-Cl | H | 3-Br-2-pyridyl | Br |
| i-Pr | 3-Cl | H | 3-Br-2-pyridyl | Cl |
| Me | 6-Cl | H | H | CF₃ |
| Et | 6-Br | 4-Me | H | OCF₃ |
| i-Pr | 6-Cl | H | H | OCF₃ |
| t-Bu | 6-Cl | Cl | Me | Br |
| Me | 6-Cl | H | Et | Br |
| Et | 6-Cl | H | Me | Cl |
| i-Pr | 6-F | 4-Br | Et | Cl |
| t-Bu | 6-Cl | H | Me | I |
| propargyl | 6-Cl | H | Me | CF₃ |
| cyclopropyl | 6-Cl | H | Me | OCF₃ |
| i-Pr | 6-Cl | 4-Cl | Me | CF₃ |
| t-Bu | 6-Cl | H | Me | SCF₃ |
| Me | 6-Cl | H | Me | SCHF₂ |
| Et | 6-Cl | H | Me | OCHF₂ |
| i-Pr | 6-I | 4-CN | Me | CF₃ |
| t-Bu | 6-Cl | H | Me | C₂F₅ |
| propargyl | 6-Cl | H | Me | C₂F₅ |
| cyclopropyl | 6-Cl | H | Et | CF₃ |
| i-Pr | 6-Cl | H | n-Pr | CF₃ |
| t-Bu | 6-Cl | 4-Br | i-Pr | CF₃ |
| Me | 6-Cl | H | Cl | CF₃ |
| Et | 6-F | H | F | CF₃ |
| i-Pr | 6-Cl | H | Me | SMe |
| t-Bu | 6-Cl | 4-Cl | Me | OMe |
| Me | 6-Cl | H | Me | OEt |
| Et | 6-I | H | Me | n-C₃F₇ |
| i-Pr | 6-Cl | H | Me | i-C₃F₇ |
| t-Bu | 6-Cl | 4-F | Me | Et |
| propargyl | 6-Cl | H | Me | OCF₂CHF₂ |
| Et | 6-Cl | H | Me | SCF₂CHF₂ |
| i-Pr | 6-Cl | H | Me | SO₂Me |
| t-Bu | 6-Cl | 4-Cl | Me | SO₂CF₃ |
| Me | 6-Cl | H | CF₃ | CF₃ |
| Et | 6-Cl | H | CF₃ | Me |
| i-Pr | 6-Cl | H | OMe | CF₃ |
| t-Bu | 6-Br | H | H | CF₃ |
| cyclopropyl | 6-Cl | 4-Br | H | OCHF₂ |
| Et | 6-Cl | H | H | C₂F₅ |
| i-Pr | 6-Cl | H | H | C₂F₅ |
| t-Bu | 6-F | 4-Me | H | OCF₃ |
| Me | 6-Cl | H | H | OCF₂CHF₂ |
| Et | 6-Cl | H | H | SCF₂CHF₂ |
| i-Pr | 6-CN | 4-Cl | H | n-C₃F₇ |
| t-Bu | 6-Cl | H | H | i-C₃F₇ |
| propargyl | 6-Cl | H | H | Br |
| Et | 6-Cl | H | H | Cl |
| i-Pr | 6-Cl | H | H | SCF₃ |
| t-Bu | 6-Cl | 4-Br | Ph | CF₃ |
| cyclopropyl | 6-Cl | H | Ph | Cl |
| Et | 6-F | H | Ph | Br |
| i-Pr | 6-Cl | H | 2-pyridyl | CF₃ |
| t-Bu | 6-Cl | H | 2-pyridyl | Cl |
| Me | 6-Cl | H | 2-ClPh | CF₃ |
| Et | 6-Br | 4-Cl | 2-ClPh | OCF₃ |
| i-Pr | 6-Cl | H | 2-ClPh | Br |
| t-Bu | 6-Cl | H | 2-ClPh | Cl |
| Me | 6-Cl | H | 2-ClPh | SCHF₂ |
| propargyl | 6-Cl | H | 2-BrPh | CF₃ |
| i-Pr | 6-Br | H | 2-MePh | CF₃ |
| t-Bu | 6-Cl | 4-CN | 2-CNPh | CF₃ |
| Me | 6-Cl | H | 2-FPh | CF₃ |
| Et | 6-Cl | H | 2,6-F₂Ph | CF₃ |
| i-Pr | 6-Cl | 4-Br | 2,4-F₂Ph | CF₃ |
| t-Bu | 6-CN | H | 2,5-F₂Ph | CF₃ |
| Me | 6-Cl | 4-I | 2-MeOPh | CF₃ |
| Et | 6-Cl | H | 3-Cl-2-pyridyl | CF₃ |
| i-Pr | 6-Br | H | 3-Cl-2-pyridyl | OCF₃ |
| t-Bu | 6-Cl | H | 3-Cl-2-pyridyl | Br |
| propargyl | 6-Cl | H | 3-Cl-2-pyridyl | Cl |
| Et | 6-Cl | 4-Br | 3-Cl-2-pyridyl | SCHF₂ |
| i-Pr | 6-Cl | H | 3-F-2-pyridyl | CF₃ |
| t-Bu | 6-Cl | H | 3-CF₃-2-pyridyl | CF₃ |
| Me | 6-Cl | H | 3-Me-2-pyridyl | CF₃ |
| Et | 6-Cl | H | 3-Br-2-pyridyl | CF₃ |
| i-Pr | 6-Cl | 4-Cl | 3-Br-2-pyridyl | OCF₃ |
| t-Bu | 6-Cl | H | 3-Br-2-pyridyl | Br |
| i-Pr | 6-Cl | H | 3-Br-2-pyridyl | Cl |

TABLE 2

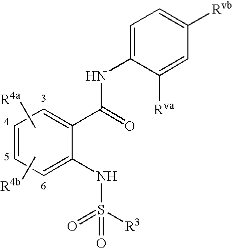

| R³ | R^{4a} | R^{4b} | R^{va} | R^{vb} |
|---|---|---|---|---|
| Me | 3-Me | H | H | CF₃ |
| Et | 3-Me | 5-Me | H | OCF₃ |
| i-Pr | 3-Me | H | H | OCF₃ |
| t-Bu | 3-Me | 5-Cl | Me | Br |
| Me | 3-Me | H | Et | Br |
| Et | 3-Me | H | Me | Cl |
| i-Pr | 3-Me | 5-Br | Et | Cl |
| t-Bu | 3-Me | H | Me | I |
| propargyl | 3-Me | H | Me | CF₃ |
| cyclopropyl | 3-Me | H | Me | OCF₃ |
| i-Pr | 3-Me | 5-Cl | Me | CF₃ |
| t-Bu | 3-Me | H | Me | SCF₃ |
| Me | 3-Me | 5-CN | Me | SCHF₂ |
| Et | 3-Me | H | Me | OCHF₂ |
| i-Pr | 3-Me | H | Me | CF₃ |
| t-Bu | 3-Me | H | Me | C₂F₅ |
| propargyl | 3-Me | H | Me | C₂F₅ |
| cyclopropyl | 3-Me | H | Et | CF₃ |
| i-Pr | 3-Me | H | n-Pr | CF₃ |
| t-Bu | 3-Me | 5-Br | i-Pr | CF₃ |
| Me | 3-Me | H | Cl | CF₃ |
| Et | 3-Me | H | F | CF₃ |
| i-Pr | 3-Me | H | Me | SMe |
| t-Bu | 3-Me | 5-Cl | Me | OMe |
| Me | 3-Me | H | Me | OEt |
| Et | 3-Me | H | Me | n-C₃F₇ |
| i-Pr | 3-Me | H | Me | i-C₃F₇ |
| t-Bu | 3-Me | 5-F | Me | Et |
| propargyl | 3-Me | H | Me | OCF₂CHF₂ |
| Et | 3-Me | H | Me | SCF₂CHF₂ |
| i-Pr | 3-Me | H | Me | SO₂Me |
| t-Bu | 3-Me | 5-Cl | Me | SO₂CF₃ |
| Me | 3-Me | H | CF₃ | CF₃ |
| Et | 3-Me | H | CF₃ | Me |
| i-Pr | 3-Me | H | OMe | CF₃ |
| t-Bu | 3-Me | H | H | CF₃ |
| cyclopropyl | 3-Me | 5-Br | H | OCHF₂ |
| EL | 3-Me | H | H | C₂F₅ |
| i-Pr | 3-Me | 5-Me | H | C₂F₅ |
| t-Bu | 3-Me | H | H | OCF₃ |
| Me | 3-Me | H | H | OCF₂CHF₂ |
| Et | 3-Me | H | H | SCF₂CHF₂ |
| i-Pr | 3-Me | 5-Cl | H | n-C₃F₇ |
| t-Bu | 3-Me | H | H | i-C₃F₇ |
| propargyl | 3-Me | H | H | Br |
| Et | 3-Me | H | H | Cl |
| i-Pr | 3-Me | H | H | SCF₃ |
| t-Bu | 3-Me | 5-Br | Ph | CF₃ |
| cyclopropyl | 3-Me | H | Ph | Cl |
| Et | 3-Me | H | Ph | Br |
| i-Pr | 3-Me | H | 2-pyridyl | CF₃ |
| t-Bu | 3-Me | H | 2-pyridyl | Cl |
| Me | 3-Me | H | 2-ClPh | CF₃ |
| Et | 3-Me | 5-Cl | 2-ClPh | OCF₃ |
| i-Pr | 3-Me | H | 2-ClPh | Br |
| t-Bu | 3-Me | H | 2-ClPh | Cl |
| Me | 3-Me | H | 2-ClPh | SCHF₂ |
| propargyl | 3-Me | H | 2-BrPh | CF₃ |
| i-Pr | 3-Me | 5-CN | 2-MePh | CF₃ |
| t-Bu | 3-Me | H | 2-CNPh | CF₃ |
| Me | 3-Me | H | 2-FPh | CF₃ |
| Et | 3-Me | H | 2,6-F₂Ph | CF₃ |
| i-Pr | 3-Me | 5-Br | 2,4-F₂Ph | CF₃ |
| t-Bu | 3-Me | H | 2,5-F₂Ph | CF₃ |
| Me | 3-Me | 5-I | 2-MeOPh | CF₃ |
| Et | 3-Me | H | 3-Cl-2-pyridyl | CF₃ |
| i-Pr | 3-Me | 5-Me | 3-Cl-2-pyridyl | OCF₃ |
| t-Bu | 3-Me | H | 3-Cl-2-pyridyl | Br |
| propargyl | 3-Me | H | 3-Cl-2-pyridyl | Cl |
| Et | 3-Me | 5-Br | 3-Cl-2-pyridyl | SCHF₂ |
| i-Pr | 3-Me | H | 3-F-2-pyridyl | CF₃ |
| t-Bu | 3-Me | H | 3-CF₃-2-pyridyl | CF₃ |
| Me | 3-Me | H | 3-Me-2-pyridyl | CF₃ |
| Et | 3-Me | H | 3-Br-2-pyridyl | CF₃ |
| i-Pr | 3-Me | 5-Cl | 3-Br-2-pyridyl | OCF₃ |
| t-Bu | 3-Me | H | 3-Br-2-pyridyl | Br |
| i-Pr | 3-Me | H | 3-Br-2-pyridyl | Cl |
| Me | 6-Me | H | H | CF₃ |
| Et | 6-Me | 4-Me | H | OCF₃ |
| i-Pr | 6-Me | H | H | OCF₃ |
| t-Bu | 6-Me | Cl | Me | Br |
| Me | 6-Me | H | Et | Br |
| Et | 6-Me | H | Me | Cl |
| i-Pr | 6-Me | 4-Br | Et | Cl |
| t-Bu | 6-Me | H | Me | I |
| propargyl | 6-Me | H | Me | CF₃ |
| cyclapropyl | 6-Me | H | Me | OCF₃ |
| i-Pr | 6-Me | 4-Cl | Me | CF₃ |
| t-Bu | 6-Me | H | Me | SCF₃ |
| Me | 6-Me | H | Me | SCHF₂ |
| Et | 6-Me | H | Me | OCHF₂ |
| i-Pr | 6-Me | 4-CN | Me | CF₃ |
| t-Bu | 6-Me | H | Me | C₂F₅ |
| propargyl | 6-Me | H | Me | C₂F₅ |
| cyclopropyl | 6-Me | H | Et | CF₃ |
| i-Pr | 6-Me | H | n-Pr | CF₃ |
| t-Bu | 6-Me | 4-Br | i-Pr | CF₃ |
| Me | 6-Me | H | Cl | CF₃ |
| Et | 6-Me | H | F | CF₃ |
| i-Pr | 6-Me | H | Me | SMe |
| t-Bu | 6-Me | 4-Cl | Me | OMe |
| Me | 6-Me | H | Me | OEt |
| Et | 6-Me | H | Me | n-C₃F₇ |
| i-Pr | 6-Me | H | Me | i-C₃F₇ |
| t-Bu | 6-Me | 4-F | Me | Et |
| propargyl | 6-Me | H | Me | OCF₂CHF₂ |
| Et | 6-Me | H | Me | SCF₂CHF₂ |
| i-Pr | 6-Me | H | Me | SO₂Me |
| t-Bu | 6-Me | 4-Cl | Me | SO₂CF₃ |
| Me | 6-Me | H | CF₃ | CF₃ |
| Et | 6-Me | H | CF₃ | Me |
| i-Pr | 6-Me | H | OMe | CF₃ |
| t-Bu | 6-Me | H | H | CF₃ |
| cyclopropyl | 6-Me | 4-Br | H | OCHF₂ |
| Et | 6-Me | H | H | C₂F₅ |
| i-Pr | 6-Me | H | H | C₂F₅ |
| t-Bu | 6-Me | 4-Me | H | OCF₃ |
| Me | 6-Me | H | H | OCF₂CHF₂ |
| Et | 6-Me | H | H | SCF₂CHF₂ |
| i-Pr | 6-Me | 4-Cl | H | n-C₃F₇ |
| t-Bu | 6-Me | H | H | i-C₃F₇ |
| propargyl | 6-Me | H | H | Br |
| Et | 6-Me | H | H | Cl |
| i-Pr | 6-Me | H | H | SCF₃ |
| t-Bu | 6-Me | 4-Br | Ph | CF₃ |
| cyclopropyl | 6-Me | H | Ph | Cl |
| Et | 6-Me | H | Ph | Br |
| i-Pr | 6-Me | H | 2-pyridyl | CF₃ |
| t-Bu | 6-Me | H | 2-pyridyl | Cl |
| Me | 6-Me | H | 2-ClPh | CF₃ |
| Et | 6-Me | 4-Cl | 2-ClPh | OCF₃ |
| i-Pr | 6-Me | H | 2-ClPh | Br |
| t-Bu | 6-Me | 4-CN | 2-ClPh | Cl |
| Me | 6-Me | H | 2-ClPh | SCHF₂ |
| propargyl | 6-Me | H | 2-BrPh | CF₃ |
| i-Pr | 6-Me | H | 2-MePh | CF₃ |
| t-Bu | 6-Me | H | 2-CNPh | CF₃ |
| Me | 6-Me | H | 2-FPh | CF₃ |
| Et | 6-Me | H | 2,6-F₂Ph | CF₃ |
| i-Pr | 6-Me | 4-Br | 2,4-F₂Ph | CF₃ |
| t-Bu | 6-Me | H | 2,5-F₂Ph | CF₃ |
| Me | 6-Me | 4-I | 2-MeOPh | CF₃ |
| Et | 6-Me | H | 3-Cl-2-pyridyl | CF₃ |
| i-Pr | 6-Me | H | 3-Cl-2-pyridyl | OCF₃ |
| t-Bu | 6-Me | H | 3-Cl-2-pyridyl | Br |
| propargyl | 6-Me | H | 3-Cl-2-pyridyl | Cl |
| Et | 6-Me | 4-Br | 3-Cl-2-pyridyl | SCHF₂ |
| i-Pr | 6-Me | H | 3-F-2-pyridyl | CF₃ |
| t-Bu | 6-Me | H | 3-CF₃-2-pyridyl | CF₃ |
| Me | 6-Me | H | 3-Me-2-pyridyl | CF₃ |
| Et | 6-Me | H | 3-Br-2-pyridyl | CF₃ |
| i-Pr | 6-Me | 4-Cl | 3-Br-2-pyridyl | OCF₃ |
| t-Bu | 6-Me | H | 3-Br-2-pyridyl | Br |
| i-Pr | 6-Me | H | 3-Br-2-pyridyl | Cl |
| Me | 3-Cl | H | H | CF₃ |
| Et | 3-Br | 5-Me | H | OCF₃ |
| i-Pr | 3-Cl | H | H | OCF₃ |
| t-Bu | 3-Cl | 5-Cl | Me | Br |
| Me | 3-Cl | H | Et | Br |
| Et | 3-Cl | H | Me | Cl |
| i-Pr | 3-Cl | 5-Br | Et | Cl |
| t-Bu | 3-Cl | H | Me | I |
| propargyl | 3-Cl | H | Me | CF₃ |
| cyclopropyl | 3-Cl | H | Me | OCF₃ |
| i-Pr | 3-Cl | 5-Cl | Me | CF₃ |
| t-Bu | 3-Cl | H | Me | SCF₃ |
| Me | 3-F | H | Me | SCHF₂ |
| Et | 3-Cl | H | Me | OCHF₂ |
| i-Pr | 3-Cl | 5-CN | Me | CF₃ |
| t-Bu | 3-Cl | H | Me | C₂F₅ |
| propargyl | 3-Cl | H | Me | C₂F₅ |
| cyclopropyl | 3-Cl | H | Et | CF₃ |
| i-Pr | 3-Cl | H | n-Pr | CF₃ |
| t-Bu | 3-Cl | 5-Br | i-Pr | CF₃ |
| Me | 3-Cl | H | Cl | CF₃ |
| Et | 3-Br | H | F | CF₃ |
| i-Pr | 3-Cl | H | Me | SMe |
| t-Bu | 3-Cl | 5-Cl | Me | OMe |
| Me | 3-Cl | H | Me | OEt |
| Et | 3-Cl | H | Me | n-C₃F₇ |
| i-Pr | 3-Cl | H | Me | i-C₃F₇ |
| t-Bu | 3-Cl | 5-F | Me | Et |
| propargyl | 3-Cl | H | Me | OCF₂CHF₂ |
| Et | 3-Cl | H | Me | SCF₂CHF₂ |
| i-Pr | 3-Br | H | Me | SO₂Me |
| t-Bu | 3-Cl | 5-Cl | Me | SO₂CF₃ |
| Me | 3-Cl | H | CF₃ | CF₃ |
| Et | 3-CN | H | CF₃ | Me |
| i-Pr | 3-Cl | H | OMe | CF₃ |
| t-Bu | 3-Cl | H | H | CF₃ |
| cyclopropyl | 3-Cl | 5-Br | H | OCHF₂ |
| Et | 3-Cl | H | H | C₂F5 |
| i-Pr | 3-Cl | H | H | C₂F5 |
| t-Bu | 3-Cl | H | H | OCF₃ |
| Me | 3-F | H | H | OCF₂CHF₂ |
| Et | 3-Cl | H | H | SCF₂CHF₂ |
| i-Pr | 3-Cl | 5-Cl | H | n-C₃F₇ |
| t-Bu | 3-Cl | H | H | i-C₃F₇ |
| propargyl | 3-Cl | H | H | Br |
| Et | 3-Cl | H | H | Cl |
| i-Pr | 3-Cl | H | H | SCF₃ |
| t-Bu | 3-Cl | 5-Br | Ph | CF₃ |
| cyclopropyl | 3-Cl | H | Ph | Cl |
| Et | 3-Cl | H | Ph | Br |
| i-Pr | 3-Br | H | 2-pyridyl | CF₃ |
| t-Bu | 3-Cl | H | 2-pyridyl | Cl |
| Me | 3-Cl | H | 2-ClPh | CF₃ |
| Et | 3-Cl | 5-Cl | 2-ClPh | OCF₃ |
| i-Pr | 3-Cl | H | 2-ClPh | Br |
| t-Bu | 3-I | H | 2-ClPh | Cl |
| Me | 3-Cl | 5-Me | 2-ClPh | SCHF₂ |
| propargyl | 3-Cl | H | 2-BrPh | CF₃ |
| i-Pr | 3-Cl | H | 2-MePh | CF₃ |
| t-Bu | 3-Cl | 5-CN | 2-CNPh | CF₃ |
| Me | 3-Cl | H | 2-FPh | CF₃ |
| Et | 3-Cl | H | 2,6-F₂Ph | CF₃ |
| i-Pr | 3-Cl | 5-Br | 2,4-F₂Ph | CF₃ |
| t-Bu | 3-F | H | 2,5-F₂Ph | CF₃ |
| Me | 3-Cl | 5-I | 2-MeOPh | CF₃ |
| Et | 3-Cl | H | 3-Cl-2-pyridyl | CF₃ |
| i-Pr | 3-CN | H | 3-Cl-2-pyridyl | OCF₃ |
| t-Bu | 3-Cl | H | 3-Cl-2-pyridyl | Br |
| propargyl | 3-Cl | H | 3-Cl-2-pyridyl | Cl |
| Et | 3-Cl | 5-Br | 3-Cl-2-pyridyl | SCHF₂ |
| i-Pr | 3-Cl | H | 3-F-2-pyridyl | CF₃ |
| t-Bu | 3-Br | H | 3-CF₃-2-pyridyl | CF₃ |
| Me | 3-Cl | H | 3-Me-2-pyridyl | CF₃ |
| Et | 3-Cl | H | 3-Br-2-pyridyl | CF₃ |
| i-Pr | 3-Cl | 5-Cl | 3-Br-2-pyridyl | OCF₃ |
| t-Bu | 3-Cl | H | 3-Br-2-pyridyl | Br |
| i-Pr | 3-Cl | H | 3-Br-2-pyridyl | Cl |
| Me | 6-Cl | H | H | CF₃ |
| Et | 6-Br | 4-Me | H | OCF₃ |
| i-Pr | 6-Cl | H | H | OCF₃ |
| t-Bu | 6-Cl | Cl | Me | Br |
| Me | 6-Cl | H | Et | Br |
| Et | 6-Cl | H | Me | Cl |
| i-Pr | 6-F | 4-Br | Et | Cl |
| t-Bu | 6-Cl | H | Me | I |
| propargyl | 6-Cl | H | Me | CF₃ |
| cyclopropyl | 6-Cl | H | Me | OCF₃ |
| i-Pr | 6-Cl | 4-Cl | Me | CF₃ |
| t-Bu | 6-Cl | H | Me | SCF₃ |
| Me | 6-Cl | H | Me | SCHF₂ |
| Et | 6-Cl | H | Me | OCHF₂ |
| i-Pr | 6-I | 4-CN | Me | CF₃ |
| t-Bu | 6-Cl | H | Me | C₂F₅ |
| propargyl | 6-Cl | H | Me | C₂F₅ |
| cyclopropyl | 6-Cl | H | Et | CF₃ |
| i-Pr | 6-Cl | H | n-Pr | CF₃ |
| t-Bu | 6-Cl | 4-Br | i-Pr | CF₃ |
| Me | 6-Cl | H | Cl | CF₃ |
| Et | 6-F | H | F | CF₃ |
| i-Pr | 6-Cl | H | Me | SMe |
| t-Bu | 6-Cl | 4-Cl | Me | OMe |
| Me | 6-Cl | H | Me | OEt |
| Et | 6-I | H | Me | n-C₃F₇ |
| i-Pr | 6-Cl | H | Me | i-C₃F₇ |
| t-Bu | 6-Cl | 4-F | Me | Et |
| propargyl | 6-Cl | H | Me | OCF₂CHF₂ |
| Et | 6-Cl | H | Me | SCF₂CHF₂ |
| i-Pr | 6-Cl | H | Me | SO₂Me |
| t-Bu | 6-Cl | 4-Cl | Me | SO₂CF₃ |
| Me | 6-Cl | H | CF₃ | CF₃ |
| Et | 6-Cl | H | CF₃ | Me |
| i-Pr | 6-Cl | H | OMe | CF₃ |
| t-Bu | 6-Br | H | H | CF₃ |
| cyclopropyl | 6-Cl | 4-Br | H | OCHF₂ |
| Et | 6-Cl | H | H | C₂F₅ |
| i-Pr | 6-Cl | H | H | C₂F₅ |
| t-Bu | 6-F | 4-Me | H | OCF₃ |
| Me | 6-Cl | H | H | OCF₂CHF₂ |
| Et | 6-Cl | H | H | SCF₂CHF₂ |
| i-Pr | 6-CN | 4-Cl | H | n-C₃F₇ |
| t-Bu | 6-Cl | H | H | i-C₃F₇ |
| propargyl | 6-Cl | H | H | Br |
| Et | 6-Cl | H | H | Cl |
| i-Pr | 6-Cl | H | H | SCF₃ |
| t-Bu | 6-Cl | 4-Br | Ph | CF₃ |
| cyclopropyl | 6-Cl | H | Ph | Cl |
| Et | 6-F | H | Ph | Br |
| i-Pr | 6-Cl | H | 2-pyridyl | CF₃ |
| t-Bu | 6-Cl | H | 2-pyridyl | Cl |
| Me | 6-Cl | H | 2-ClPh | CF₃ |
| Et | 6-Br | 4-Cl | 2-ClPh | OCF₃ |
| i-Pr | 6-Cl | H | 2-ClPh | Br |
| t-Bu | 6-Cl | H | 2-ClPh | Cl |
| Me | 6-Cl | H | 2-ClPh | SCHF₂ |
| propargyl | 6-Cl | H | 2-BrPh | CF₃ |
| i-Pr | 6-Br | H | 2-MePh | CF₃ |
| t-Bu | 6-Cl | 4-CN | 2-CNPh | CF₃ |
| Me | 6-Cl | H | 2-FPh | CF₃ |
| Et | 6-Cl | H | 2,6-F₂Ph | CF₃ |
| i-Pr | 6-Cl | 4-Br | 2,4-F₂Ph | CF₃ |
| t-Bu | 6-CN | H | 2,5-F₂Ph | CF₃ |
| Me | 6-Cl | 4-I | 2-MeOPh | CF₃ |
| Et | 6-Cl | H | 3-Cl-2-pyridyl | CF₃ |
| i-Pr | 6-Br | H | 3-Cl-2-pyridyl | OCF₃ |
| t-Bu | 6-Cl | H | 3-Cl-2-pyridyl | Br |
| propargyl | 6-Cl | H | 3-Cl-2-pyridyl | Cl |
| Et | 6-Cl | 4-Br | 3-Cl-2-pyridyl | SCHF₂ |
| i-Pr | 6-Cl | H | 3-F-2-pyridyl | CF₃ |
| t-Bu | 6-Cl | H | 3-CF₃-2-pyridyl | CF₃ |
| Me | 6-Cl | H | 3-Me-2-pyridyl | CF₃ |
| Et | 6-Cl | H | 3-Br-2-pyridyl | CF₃ |
| i-Pr | 6-Cl | 4-Cl | 3-Br-2-pyridyl | OCF₃ |
| t-Bu | 6-Cl | H | 3-Br-2-pyridyl | Br |
| i-Pr | 6-Cl | H | 3-Br-2-pyridyl | Cl |

TABLE 3

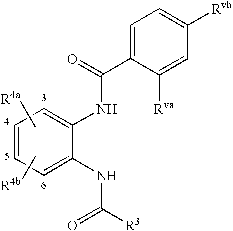

| R³ | R^{4a} | R^{4b} | R^{va} | R^{vb} |
|---|---|---|---|---|
| Me | 3-Me | H | H | CF₃ |
| Et | 3-Me | 5-Me | H | OCF₃ |
| i-Pr | 3-Me | H | H | OCF₃ |
| t-Bu | 3-Me | 5-Cl | Me | Br |
| Me | 3-Me | H | Et | Br |
| Et | 3-Me | H | Me | Cl |
| i-Pr | 3-Me | 5-Br | Et | Cl |
| t-Bu | 3-Me | H | Me | I |
| propargyl | 3-Me | H | Me | CF₃ |
| cyclopropyl | 3-Me | H | Me | OCF₃ |
| i-Pr | 3-Me | 5-Cl | Me | CF₃ |
| t-Bu | 3-Me | H | Me | SCF₃ |
| Me | 3-Me | 5-CN | Me | SCHF₂ |
| Et | 3-Me | H | Me | OCHF₂ |
| i-Pr | 3-Me | H | Me | CF₃ |
| t-Bu | 3-Me | H | Me | C₂F₅ |
| propargyl | 3-Me | H | Me | C₂F₅ |
| cyclopropyl | 3-Me | H | Et | CF₃ |
| i-Pr | 3-Me | H | n-Pr | CF₃ |
| t-Bu | 3-Me | 5-Br | i-Pr | CF₃ |
| Me | 3-Me | H | Cl | CF₃ |
| Et | 3-Me | H | F | CF₃ |
| i-Pr | 3-Me | H | Me | SMe |
| t-Bu | 3-Me | 5-Cl | Me | OMe |
| Me | 3-Me | H | Me | OEt |
| Et | 3-Me | H | Me | n-C₃F₇ |
| i-Pr | 3-Me | H | Me | i-C₃F₇ |
| t-Bu | 3-Me | 5-F | Me | Et |
| propargyl | 3-Me | H | Me | OCF₂CHF₂ |
| Et | 3-Me | H | Me | SCF₂CHF₂ |
| i-Pr | 3-Me | H | Me | SO₂Me |
| t-Bu | 3-Me | 5-Cl | Me | SO₂CF₃ |
| Me | 3-Me | H | CF₃ | CF₃ |
| Et | 3-Me | H | CF₃ | Me |
| i-Pr | 3-Me | H | OMe | CF₃ |
| t-Bu | 3-Me | H | H | CF₃ |
| cyclopropyl | 3-Me | 5-Br | H | OCHF₂ |
| Et | 3-Me | H | H | C₂F₅ |
| i-Pr | 3-Me | 5-Me | H | C₂F₅ |
| t-Bu | 3-Me | H | H | OCF₃ |
| Me | 3-Me | H | H | OCF₂CHF₂ |
| Et | 3-Me | H | H | SCF₂CHF₂ |
| i-Pr | 3-Me | 5-Cl | H | n-C₃F₇ |
| t-Bu | 3-Me | H | H | i-C₃F₇ |
| propargyl | 3-Me | H | H | Br |
| Et | 3-Me | H | H | Cl |
| i-Pr | 3-Me | H | H | SCF₃ |
| t-Bu | 3-Me | 5-Br | Ph | CF₃ |
| cyclopropyl | 3-Me | H | Ph | Cl |
| Et | 3-Me | H | Ph | Br |
| i-Pr | 3-Me | H | 2-pyridyl | CF₃ |
| t-Bu | 3-Me | H | 2-pyridyl | Cl |
| Me | 3-Me | H | 2-ClPh | CF₃ |
| Et | 3-Me | 5-Cl | 2-ClPh | OCF₃ |
| i-Pr | 3-Me | H | 2-ClPh | Br |
| t-Bu | 3-Me | H | 2-ClPh | Cl |
| Me | 3-Me | H | 2-ClPh | SCHF₂ |
| propargyl | 3-Me | H | 2-BrPh | CF₃ |
| i-Pr | 3-Me | 5-CN | 2-MePh | CF₃ |
| t-Bu | 3-Me | H | 2-CNPh | CF₃ |
| Me | 3-Me | H | 2-FPh | CF₃ |
| Et | 3-Me | H | 2,6-F₂Ph | CF₃ |
| i-Pr | 3-Me | 5-Br | 2,4-F₂Ph | CF₃ |
| t-Bu | 3-Me | H | 2,5-F₂Ph | CF₃ |
| Me | 3-Me | 5-I | 2-MeOPh | CF₃ |
| Et | 3-Me | H | 3-Cl-2-pyridyl | CF₃ |
| i-Pr | 3-Me | 5-Me | 3-Cl-2-pyridyl | OCF₃ |
| t-Bu | 3-Me | H | 3-Cl-2-pyridyl | Br |
| propargyl | 3-Me | H | 3-Cl-2-pyridyl | Cl |
| Et | 3-Me | 5-Br | 3-Cl-2-pyridyl | SCHF₂ |
| i-Pr | 3-Me | H | 3-F-2-pyridyl | CF₃ |
| t-Bu | 3-Me | H | 3-CF₃-2-pyridyl | CF₃ |
| Me | 3-Me | H | 3-Me-2-pyridyl | CF₃ |
| Et | 3-Me | H | 3-Br-2-pyridyl | CF₃ |
| i-Pr | 3-Me | 5-Cl | 3-Br-2-pyridyl | OCF₃ |
| t-Bu | 3-Me | H | 3-Br-2-pyridyl | Br |
| i-Pr | 3-Me | H | 3-Br-2-pyridyl | Cl |
| Me | 6-Me | H | H | CF₃ |
| Et | 6-Me | 4-Me | H | OCF₃ |
| i-Pr | 6-Me | H | H | OCF₃ |
| t-Bu | 6-Me | Cl | Me | Br |
| Me | 6-Me | H | Et | Br |
| Et | 6-Me | H | Me | Cl |
| i-Pr | 6-Me | 4-Br | Et | Cl |
| t-Bu | 6-Me | H | Me | I |
| propargyl | 6-Me | H | Me | CF₃ |
| cyclopropyl | 6-Me | H | Me | OCF₃ |
| i-Pr | 6-Me | 4-Cl | Me | CF₃ |
| t-Bu | 6-Me | H | Me | SCF₃ |
| Me | 6-Me | H | Me | SCHF₂ |
| Et | 6-Me | H | Me | OCHF₂ |
| i-Pr | 6-Me | 4-CN | Me | CF₃ |
| t-Bu | 6-Me | H | Me | C₂F₅ |
| propargyl | 6-Me | H | Me | C₂F₅ |
| cyclopropyl | 6-Me | H | Et | CF₃ |
| i-Pr | 6-Me | H | n-Pr | CF₃ |
| t-Bu | 6-Me | 4-Br | i-Pr | CF₃ |
| Me | 6-Me | H | Cl | CF₃ |
| Et | 6-Me | H | F | CF₃ |
| i-Pr | 6-Me | H | Me | SMe |
| t-Bu | 6-Me | 4-Cl | Me | OMe |
| Me | 6-Me | H | Me | OEt |
| Et | 6-Me | H | Me | n-C₃F₇ |
| i-Pr | 6-Me | H | Me | i-C₃F₇ |
| t-Bu | 6-Me | 4-F | Me | Et |
| propargyl | 6-Me | H | Me | OCF₂CHF₂ |
| Et | 6-Me | H | Me | SCF₂CHF₂ |
| i-Pr | 6-Me | H | Me | SO₂Me |
| t-Bu | 6-Me | 4-Cl | Me | SO₂CF₃ |
| Me | 6-Me | H | CF₃ | CF₃ |
| Et | 6-Me | H | CF₃ | Me |
| i-Pr | 6-Me | H | OMe | CF₃ |
| t-Bu | 6-Me | H | H | CF₃ |
| cyclopropyl | 6-Me | 4-Br | H | OCHF₂ |
| Et | 6-Me | H | H | C₂F₅ |
| i-Pr | 6-Me | H | H | C₂F₅ |
| t-Bu | 6-Me | 4-Me | H | OCF₃ |
| Me | 6-Me | H | H | OCF₂CHF₂ |
| Et | 6-Me | H | H | SCF₂CHF₂ |
| i-Pr | 6-Me | 4-Cl | H | n-C₃F₇ |
| t-Bu | 6-Me | H | H | i-C₃F₇ |
| propargyl | 6-Me | H | H | Br |
| Et | 6-Me | H | H | Cl |
| i-Pr | 6-Me | H | H | SCF₃ |
| t-Bu | 6-Me | 4-Br | Ph | CF₃ |
| cyclopropyl | 6-Me | H | Ph | Cl |
| Et | 6-Me | H | Ph | Br |
| i-Pr | 6-Me | H | 2-pyridyl | CF₃ |
| t-Bu | 6-Me | H | 2-pyridyl | Cl |
| Me | 6-Me | H | 2-ClPh | CF₃ |
| Et | 6-Me | 4-Cl | 2-ClPh | OCF₃ |
| i-Pr | 6-Me | H | 2-ClPh | Br |
| t-Bu | 6-Me | 4-CN | 2-ClPh | Cl |
| Me | 6-Me | H | 2-ClPh | SCHF₂ |
| propargyl | 6-Me | H | 2-BrPh | CF₃ |
| i-Pr | 6-Me | H | 2-MePh | CF₃ |
| t-Bu | 6-Me | H | 2-CNPh | CF₃ |
| Me | 6-Me | H | 2-FPh | CF₃ |
| Et | 6-Me | H | 2,6-F₂Ph | CF₃ |
| i-Pr | 6-Me | 4-Br | 2,4-F₂Ph | CF₃ |
| t-Bu | 6-Me | H | 2,5-F₂Ph | CF₃ |
| Me | 6-Me | 4-I | 2-MeOPh | CF₃ |
| Ft | 6-Me | H | 3-Cl-2-pyridyl | CF₃ |
| i-Pr | 6-Me | H | 3-Cl-2-pyridyl | OCF₃ |
| t-Bu | 6-Me | H | 3-Cl-2-pyridyl | Br |
| propargyl | 6-Me | H | 3-Cl-2-pyridyl | Cl |
| Et | 6-Me | 4-Br | 3-Cl-2-pyridyl | SCHF₂ |
| i-Pr | 6-Me | H | 3-F-2-pyridyl | CF₃ |
| t-Bu | 6-Me | H | 3-CF₃-2-pyridyl | CF₃ |
| Me | 6-Me | H | 3-Me-2-pyridyl | CF₃ |
| Et | 6-Me | H | 3-Br-2-pyridyl | CF₃ |
| i-Pr | 6-Me | 4-Cl | 3-Br-2-pyridyl | OCF₃ |
| t-Bu | 6-Me | H | 3-Br-2-pyridyl | Br |
| i-Pr | 6-Me | H | 3-Br-2-pyridyl | Cl |
| Me | 3-Cl | H | H | CF₃ |
| Et | 3-Br | 5-Me | H | OCF₃ |
| i-Pr | 3-Cl | H | H | OCF₃ |
| t-Bu | 3-Cl | 5-Cl | Me | Br |
| Me | 3-Cl | H | Et | Br |
| Et | 3-Cl | H | Me | Cl |
| i-Pr | 3-Cl | 5-Br | Et | Cl |
| t-Bu | 3-Cl | H | Me | I |
| propargyl | 3-Cl | H | Me | CF₃ |
| cyclopropyl | 3-Cl | H | Me | OCF₃ |
| i-Pr | 3-Cl | 5-Cl | Me | CF₃ |
| t-Bu | 3-Cl | H | Me | SCF₃ |
| Me | 3-F | H | Me | SCHF₂ |
| Et | 3-Cl | H | Me | OCHF₂ |
| i-Pr | 3-Cl | 5-CN | Me | CF₃ |
| t-Bu | 3-Cl | H | Me | C₂F₅ |
| propargyl | 3-Cl | H | Me | C₂F₅ |
| cyclopropyl | 3-Cl | H | Et | CF₃ |
| i-Pr | 3-Cl | H | n-Pr | CF₃ |
| t-Bu | 3-Cl | 5-Br | i-Pr | CF₃ |
| Me | 3-Cl | H | Cl | CF₃ |
| Et | 3-Br | H | F | CF₃ |
| i-Pr | 3-Cl | H | Me | SMe |
| t-Bu | 3-Cl | 5-Cl | Me | OMe |
| Me | 3-Cl | H | Me | OEt |
| Et | 3-Cl | H | Me | n-C₃F₇ |
| i-Pr | 3-Cl | H | Me | i-C₃F₇ |
| t-Bu | 3-Cl | 5-F | Me | Et |
| propargyl | 3-Cl | H | Me | OCF₂CHF₂ |
| Et | 3-Cl | H | Me | SCF₂CHF₂ |
| i-Pr | 3-Br | H | Me | SO₂Me |
| t-Bu | 3-Cl | 5-Cl | Me | SO₂CF₃ |
| Me | 3-Cl | H | CF₃ | CF₃ |
| Et | 3-CN | H | CF₃ | Me |
| i-Pr | 3-Cl | H | OMe | CF₃ |
| t-Bu | 3-Cl | H | H | CF₃ |
| cyclopropyl | 3-Cl | 5-Br | H | OCHF₂ |
| Et | 3-Cl | H | H | C₂F₅ |
| i-Pr | 3-Cl | H | H | C₂F₅ |
| t-Bu | 3-Cl | H | H | OCF₃ |
| Me | 3-F | H | H | OCF₂CHF₂ |
| Et | 3-Cl | H | H | SCF₂CHF₂ |
| i-Pr | 3-Cl | 5-Cl | H | n-C₃F₇ |
| t-Bu | 3-Cl | H | H | i-C₃F₇ |
| propargyl | 3-Cl | H | H | Br |
| Et | 3-Cl | H | H | Cl |
| i-Pr | 3-Cl | H | H | SCF₃ |
| t-Bu | 3-Cl | 5-Br | Ph | CF₃ |
| cyclopropyl | 3-Cl | H | Ph | Cl |
| Et | 3-Cl | H | Ph | Br |
| i-Pr | 3-Br | H | 2-pyridyl | CF₃ |
| t-Bu | 3-Cl | H | 2-pyridyl | Cl |
| Me | 3-Cl | H | 2-ClPh | CF₃ |
| Et | 3-Cl | 5-Cl | 2-ClPh | OCF₃ |
| i-Pr | 3-Cl | H | 2-ClPh | Br |
| t-Bu | 3-I | H | 2-ClPh | Cl |
| Me | 3-Cl | 5-Me | 2-ClPh | SCHF₂ |
| propargyl | 3-Cl | H | 2-BrPh | CF₃ |
| i-Pr | 3-Cl | H | 2-MePh | CF₃ |
| t-Bu | 3-Cl | 5-CN | 2-CNPh | CF₃ |
| Me | 3-Cl | H | 2-FPh | CF₃ |
| Et | 3-Cl | H | 2,6-F₂Ph | CF₃ |
| i-Pr | 3-Cl | 5-Br | 2,4-F₂Ph | CF₃ |
| t-Bu | 3-F | H | 2,5-F₂Ph | CF₃ |
| Me | 3-Cl | 5-I | 2-MeOPh | CF₃ |
| Et | 3-Cl | H | 3-Cl-2-pyridyl | CF₃ |
| i-Pr | 3-CN | H | 3-Cl-2-pyridyl | OCF₃ |
| t-Bu | 3-Cl | H | 3-Cl-2-pyridyl | Br |
| propargyl | 3-Cl | H | 3-Cl-2-pyridyl | Cl |
| Et | 3-Cl | 5-Br | 3-Cl-2-pyridyl | SCHF₂ |
| i-Pr | 3-Cl | H | 3-F-2-pyridyl | CF₃ |
| t-Bu | 3-Br | H | 3-CF₃-2-pyridyl | CF₃ |
| Me | 3-Cl | H | 3-Me-2-pyridyl | CF₃ |
| Et | 3-Cl | H | 3-Br-2-pyridyl | CF₃ |
| i-Pr | 3-Cl | 5-Cl | 3-Br-2-pyridyl | OCF₃ |
| t-Bu | 3-Cl | H | 3-Br-2-pyridyl | Br |
| i-Pr | 3-Cl | H | 3-Br-2-pyridyl | Cl |
| Me | 6-Cl | H | H | CF₃ |
| Et | 6-Br | 4-Me | H | OCF₃ |
| i-Pr | 6-Cl | H | H | OCF₃ |
| t-Bu | 6-Cl | Cl | Me | Br |
| Me | 6-Cl | H | Et | Br |
| Et | 6-Cl | H | Me | Cl |
| i-Pr | 6-F | 4-Br | Et | Cl |
| t-Bu | 6-Cl | H | Me | I |
| propargyl | 6-Cl | H | Me | CF₃ |
| cyclopropyl | 6-Cl | H | Me | OCF₃ |
| i-Pr | 6-Cl | 4-Cl | Me | CF₃ |
| t-Bu | 6-Cl | H | Me | SCF₃ |
| Me | 6-Cl | H | Me | SCHF₂ |
| Et | 6-Cl | H | Me | OCHF₂ |
| i-Pr | 6-I | 4-CN | Me | CF₃ |
| t-Bu | 6-Cl | H | Me | C₂F₅ |
| propargyl | 6-Cl | H | Me | C₂F₅ |
| cyclopropyl | 6-Cl | H | Et | CF₃ |
| i-Pr | 6-Cl | H | n-Pr | CF₃ |
| t-Bu | 6-Cl | 4-Br | i-Pr | CF₃ |
| Me | 6-Cl | H | Cl | CF₃ |
| Et | 6-F | H | F | CF₃ |
| i-Pr | 6-Cl | H | Me | SMe |
| t-Bu | 6-Cl | 4-Cl | Me | OMe |
| Me | 6-Cl | H | Me | OEt |
| Et | 6-I | H | Me | n-C₃F₇ |
| i-Pr | 6-Cl | H | Me | i-C₃F₇ |
| t-Bu | 6-Cl | 4-F | Me | Et |
| propargyl | 6-Cl | H | Me | OCF₂CHF₂ |
| Et | 6-Cl | H | Me | SCF₂CHF₂ |
| i-Pr | 6-Cl | H | Me | SO₂Me |
| t-Bu | 6-Cl | 4-Cl | Me | SO₂CF₃ |
| Me | 6-Cl | H | CF₃ | CF₃ |
| Et | 6-Cl | H | CF₃ | Me |
| i-Pr | 6-Cl | H | OMe | CF₃ |
| t-Bu | 6-Br | H | H | CF₃ |
| cyclopropyl | 6-Cl | 4-Br | H | OCHF₂ |
| Et | 6-Cl | H | H | C₂F₅ |
| i-Pr | 6-Cl | H | H | C₂F₅ |
| t-Bu | 6-F | 4-Me | H | OCF₃ |
| Me | 6-Cl | H | H | OCF₂CHF₂ |
| Et | 6-Cl | H | H | SCF₂CHF₂ |
| i-Pr | 6-CN | 4-Cl | H | n-C₃F₇ |
| t-Bu | 6-Cl | H | H | i-C₃F₇ |
| propargyl | 6-Cl | H | H | Br |
| Et | 6-Cl | H | H | Cl |
| i-Pr | 6-Cl | H | H | SCF₃ |
| t-Bu | 6-Cl | 4-Br | Ph | CF₃ |
| cyclopropyl | 6-Cl | H | Ph | Cl |
| Et | 6-F | H | Ph | Br |
| i-Pr | 6-Cl | H | 2-pyridyl | CF₃ |
| t-Bu | 6-Cl | H | 2-pyridyl | Cl |
| Me | 6-Cl | H | 2-ClPh | CF₃ |
| Et | 6-Br | 4-Cl | 2-ClPh | OCF₃ |
| i-Pr | 6-Cl | H | 2-ClPh | Br |
| t-Bu | 6-Cl | H | 2-ClPh | Cl |
| Me | 6-Cl | H | 2-ClPh | SCHF₂ |
| propargyl | 6-Cl | H | 2-BrPh | CF₃ |
| i-Pr | 6-Br | H | 2-MePh | CF₃ |
| t-Bu | 6-Cl | 4-CN | 2-CNPh | CF₃ |
| Me | 6-Cl | H | 2-FPh | CF₃ |
| Et | 6-Cl | H | 2,6-F₂Ph | CF₃ |
| i-Pr | 6-Cl | 4-Br | 2,4-F₂Ph | CF₃ |
| t-Bu | 6-CN | H | 2,5-F₂Ph | CF₃ |
| Me | 6-Cl | 4-I | 2-MeOPh | CF₃ |
| Et | 6-Cl | H | 3-Cl-2-pyridyl | CF₃ |
| i-Pr | 6-Br | H | 3-Cl-2-pyridyl | OCF₃ |
| t-Bu | 6-Cl | H | 3-Cl-2-pyridyl | Br |
| propargyl | 6-Cl | H | 3-Cl-2-pyridyl | Cl |
| Et | 6-Cl | 4-Br | 3-Cl-2-pyridyl | SCHF₂ |
| i-Pr | 6-Cl | H | 3-F-2-pyridyl | CF₃ |
| t-Bu | 6-Cl | H | 3-CF₃-2-pyridyl | CF₃ |
| Me | 6-Cl | H | 3-Me-2-pyridyl | CF₃ |
| Et | 6-Cl | H | 3-Br-2-pyridyl | CF₃ |
| i-Pr | 6-Cl | 4-Cl | 3-Br-2-pyridyl | OCF₃ |
| t-Bu | 6-Cl | H | 3-Br-2-pyridyl | Br |
| i-Pr | 6-Cl | H | 3-Br-2-pyridyl | Cl |

TABLE 4

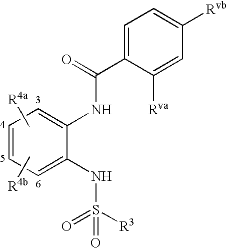

| R³ | R^{4a} | R^{4b} | R^{va} | R^{vb} |
|---|---|---|---|---|
| Me | 3-Me | H | H | CF₃ |
| Et | 3-Me | 5-Me | H | OCF₃ |
| i-Pr | 3-Me | H | H | OCF₃ |
| t-Bu | 3-Me | 5-Cl | Me | Br |
| Me | 3-Me | H | Et | Br |
| Et | 3-Me | H | Me | Cl |
| i-Pr | 3-Me | 5-Br | Et | Cl |
| t-Bu | 3-Me | H | Me | I |
| propargyl | 3-Me | H | Me | CF₃ |
| cyclopropyl | 3-Me | H | Me | OCF₃ |
| i-Pr | 3-Me | 5-Cl | Me | CF₃ |
| t-Bu | 3-Me | H | Me | SCF₃ |
| Me | 3-Me | 5-CN | Me | SCHF₂ |
| Et | 3-Me | H | Me | OCHF₂ |
| i-Pr | 3-Me | H | Me | CF₃ |
| t-Bu | 3-Me | H | Me | C₂F₅ |
| propargyl | 3-Me | H | M3 | C₂F₅ |
| cyclopropyl | 3-Me | H | Et | CF₃ |
| i-Pr | 3-Me | H | n-Pr | CF₃ |
| t-Bu | 3-Me | 5-Br | i-Pr | CF₃ |
| Me | 3-Me | H | Cl | CF₃ |
| Et | 3-Me | H | F | CF₃ |
| i-Pr | 3-Me | H | Me | SMe |
| t-Bu | 3-Me | 5-Cl | Me | OMe |
| Me | 3-Me | H | Me | OEt |
| Et | 3-Me | H | Me | n-C₃F₇ |
| i-Pr | 3-Me | H | Me | i-C₃F₇ |
| t-Bu | 3-Me | 5-F | Me | Et |
| propargyl | 3-Me | H | Me | OCF₂CHF₂ |
| Et | 3-Me | H | Me | SCF₂CHF₂ |
| i-Pr | 3-Me | H | Me | SO₂Me |
| t-Bu | 3-Me | 5-Cl | Me | SO₂CF₃ |
| Me | 30Me | H | CF₃ | CF₃ |
| Et | 3-Me | H | CF₃ | Me |
| i-Pr | 3-Me | H | OMe | CF₃ |
| t-Bu | 3-Me | H | H | CF₃ |
| cyclopropyl | 3-Me | 5-Br | H | OCHF₂ |
| Et | 3-Me | H | H | C₂F₅ |
| i-Pr | 3-Me | 5-Me | H | C₂F₅ |
| t-Bu | 3-Me | H | H | OCF₃ |
| Me | 3-Me | H | H | OCF₂CHF₂ |
| Et | 3-Me | H | H | SCF₂CHF₂ |
| i-Pr | 3-Me | 5-Cl | H | n-C₃H₇ |
| t-Bu | 3-Me | H | H | i-C₃F₇ |
| propargyl | 3-Me | H | H | Br |
| Et | 3-Me | H | H | Cl |
| i-Pr | 3-Me | H | H | SCF₃ |
| t-Bu | 3-Me | 5-Br | Ph | CF₃ |
| cyclopropyl | 3-Me | H | Ph | Cl |
| Et | 3-Me | H | Ph | Br |
| i-Pr | 3-Me | H | 2-pyridyl | CF₃ |
| t-Bu | 3-Me | H | 2-pyridyl | Cl |
| Me | 3-Me | H | 2-ClPh | CF₃ |
| Et | 3-Me | 5-Cl | 2-ClPh | OCF₃ |
| i-Pr | 3-Me | H | 2-ClPh | Br |
| t-Bu | 3-Me | H | 2-ClPh | Cl |
| Me | 3-Me | H | 2-ClPh | SCHF₂ |
| propargyl | 3-Me | H | 2-BrPh | CF₃ |
| i-Pr | 3-Me | 5-CN | 2-MePh | CF₃ |
| t-Bu | 3-Me | H | 2-CNPh | CF₃ |
| Me | 3-Me | H | 2-FPh | CF₃ |
| Et | 3-Me | H | 2,6-F₂Ph | CF₃ |
| i-Pr | 3-Me | 5-Br | 2,4-F₂Ph | CF₃ |
| t-Bu | 3-Me | H | 2,5-F₂Ph | CF₃ |
| Me | 3-Me | 5-I | 2-MeOPh | CF₃ |
| Et | 3-Me | H | 2-Cl-2-pyridyl | CF₃ |
| i-Pr | 3-Me | 5-Me | 3-Cl-2-pyridyl | OCF₃ |
| t-Bu | 3-Me | H | 3-Cl-2-pyridyl | Br |
| propargyl | 3-Me | H | 3-Cl-2-pyridyl | Cl |
| Et | 3-Me | 5-Br | 3-Cl-2-pyridyl | SCHF₂ |
| i-Pr | 3-Me | H | 3-F-2-pyridyl | CF₃ |
| t-Bu | 3-Me | H | 3-CF₃-2-pyridyl | CF₃ |
| Me | 3-Me | H | 3-Me-2-pyridyl | CF₃ |
| Et | 3-Me | H | 3-Br-2-pyridyl | CF₃ |
| i-Pr | 3-Me | 5-Cl | 3-Br-2-pyridyl | OCF₃ |
| t-Bu | 3-Me | H | 3-Br-2-pyridyl | Br |
| i-Pr | 3-Me | H | 3-Br-2-pyridyl | Cl |
| Me | 6-Me | H | H | CF₃ |
| Et | 6-Me | 4-Me | H | OCF₃ |
| i-Pr | 6-Me | H | H | OCF₃ |
| t-Bu | 6-Me | Cl | Me | Br |
| Me | 6-Me | H | Et | Br |
| Et | 6-Me | H | Me | Cl |
| i-Pr | 6-Me | 4-Br | Et | Cl |
| t-Bu | 6-Me | H | Me | I |
| propargyl | 6-Me | H | Me | CF₃ |
| cyclopropyl | 6-Me | H | Me | OCF₃ |
| i-Pr | 6-Me | 4-Cl | Me | CF₃ |
| t-Bu | 6-Me | H | Me | SCF₃ |
| Me | 6-Me | H | Me | SCHF₂ |
| Et | 6-Me | H | Me | OCHF₂ |
| i-Pr | 6-Me | 4-CN | Me | CF₃ |
| t-Bu | 6-Me | H | Me | C₂F₅ |
| propargyl | 6-Me | H | Me | C₂F₅ |
| cyclopropyl | 6-Me | H | Et | CF₃ |
| i-Pr | 6-Me | H | n-Pr | CF₃ |
| t-Bu | 6-Me | 4-Br | i-Pr | CF₃ |
| Me | 6-Me | H | Cl | CF₃ |
| Et | 6-Me | H | F | CF₃ |
| i-Pr | 6-Me | H | Me | SMe |
| t-Bu | 6-Me | 4-Cl | Me | OMe |
| Me | 6-Me | H | Me | OEt |
| Et | 6-Me | H | Me | n-C₃F₇ |
| i-Pr | 6-Me | H | Me | i-C₃F₇ |
| t-Bu | 6-Me | 4-F | Me | Et |
| propargyl | 6-Me | H | Me | OCF₂CHF₂ |
| Et | 6-Me | H | Me | SCF₂CHF₂ |
| i-Pr | 6-Me | H | Me | SO₂Me |
| t-Bu | 6-Me | 4-Cl | Me | SO₂CF₃ |
| Me | 6-Me | H | CF₃ | CF₃ |
| Et | 6-Me | H | CF₃ | Me |
| i-Pr | 6-Me | H | OMe | CF₃ |
| i-Bu | 6-Me | H | H | CF₃ |
| cyclopropyl | 6-Me | 4-Br | H | OCHF₂ |
| Et | 6-Me | H | H | C₂F₅ |
| i-Pr | 6-Me | H | H | C₂F₅ |
| t-Bu | 6-Me | 4-Me | H | OCF₃ |
| Me | 6-Me | H | H | OCF₂CHF₂ |
| Et | 6-Me | H | H | SCF₂CHF₂ |
| i-Pr | 6-Me | 4-Cl | H | n-C₃F₇ |
| t-Bu | 6-Me | H | H | i-C₃F₇ |
| propargyl | 6-Me | H | H | Br |
| Et | 6-Me | H | H | Cl |
| i-Pr | 6-Me | H | H | SCF₃ |
| t-Bu | 6-Me | 4-Br | Ph | CF₃ |
| cyclopropyl | 6-Me | H | Ph | Cl |
| Et | 6-Me | H | Ph | Br |
| i-Pr | 6-Me | H | 2-pyridyl | CF₃ |
| t-Bu | 6-Me | H | 2-pyridyl | Cl |
| Me | 6-Me | H | 2-ClPh | CF₃ |
| Et | 6-Me | 4-Cl | 2-ClPh | OCF₃ |
| i-Pr | 6-Me | H | 2-ClPh | Br |
| t-Bu | 6-Me | 4-CN | 2-ClPh | Cl |
| Me | 6-Me | H | 2-ClPh | SCHF₂ |
| propargyl | 6-Me | H | 2-BrPh | CF₃ |
| i-Pr | 6-Me | H | 2-MePh | CF₃ |
| t-Bu | 6-Me | H | 2-CNPh | CF₃ |
| Me | 6-Me | H | 2-FPh | CF₃ |
| Et | 6-Me | H | 2,6-F₂Ph | CF₃ |
| i-Pr | 6-Me | 4-Br | 2,4-F₂Ph | CF₃ |
| t-Bu | 6-Me | H | 2,5-F₂Ph | CF₃ |
| Me | 6-Me | 4-I | 2-MeOPh | CF₃ |
| Et | 6-Me | H | 2-Cl-2-pyridyl | CF₃ |
| i-Pr | 6-Me | H | 2-Cl-2-pyridyl | OCF₃ |
| t-Bu | 6-Me | H | 2-Cl-2-pyridyl | Br |
| propargyl | 6-Me | H | 3-Cl-2-pyridyl | Cl |
| Et | 6-Me | 4-Br | 3-Cl-2-pyridyl | SCHF₂ |
| i-Pr | 6-Me | H | 3-F-2-pyridyl | CF₃ |
| t-Bu | 6-Me | H | 2-CF₃-2-pyridyl | CF₃ |
| Me | 6-Me | H | 3-Me-2-pyridyl | CF₃ |
| Et | 6-Me | H | 3-Br-2-pyridyl | CF₃ |
| i-Pr | 6-Me | 4-Cl | 3-Br-2-pyridyl | OCF₃ |
| t-Bu | 6-Me | H | 3-Br-2-pyridyl | Br |
| i-Pr | 6-Me | H | 3-Br-2-pyridyl | Cl |
| Me | 3-Cl | H | H | CF₃ |
| Et | 3-Br | 5-Me | H | OCF₃ |
| i-Pr | 3-Cl | H | H | OCF₃ |
| t-Bu | 3-Cl | 5-Cl | Me | Br |
| Me | 3-Cl | H | Et | Br |
| Et | 3-Cl | H | Me | Cl |
| i-Pr | 3-Cl | 5-Br | Et | Cl |
| t-Bu | 3-Cl | H | Me | I |
| propargyl | 3-Cl | H | Me | CF₃ |
| cyclopropyl | 3-Cl | H | Me | OCF₃ |
| i-Pr | 3-Cl | 5-Cl | Me | CF₃ |
| t-Bu | 3-Cl | H | Me | SCF₃ |
| Me | 3-F | H | Me | SCHF₂ |
| Et | 3-Cl | H | Me | OCHF₂ |
| i-Pr | 3-Cl | 5-CN | Me | CF₃ |
| t-Bu | 3-Cl | H | Me | C₂F₅ |
| propargyl | 3-Cl | H | Me | C₂F₅ |
| cyclopropyl | 3-Cl | H | Et | CF₃ |
| i-Pr | 3-Cl | H | n-Pr | CF₃ |
| t-Bu | 3-Cl | 5-Br | i-Pr | CF₃ |
| Me | 3-Cl | H | Cl | CF₃ |
| Et | 3-Br | H | F | CF₃ |
| i-Pr | 3-Cl | H | Me | SMe |
| t-Bu | 3-Cl | 5-Cl | Me | OMe |
| Me | 3-Cl | H | Me | OEt |
| Et | 3-Cl | H | Me | n-C₃F₇ |
| i-Pr | 3-Cl | H | Me | i-C₃F₇ |
| t-Bu | 3-Cl | 5-F | Me | Et |
| peopargyl | 3-Cl | H | Me | OCF₂CHF₂ |
| Et | 3-Cl | H | Me | SCF₂CHF₂ |
| i-Pr | 3-Br | H | Me | SO₂Me |
| t-Bu | 3-Cl | 5-Cl | Me | SO₂CF₃ |
| Me | 3-Cl | H | CF₃ | CF₃ |
| Et | 3-CN | H | CF₃ | Me |
| i-pr | 3-Cl | H | OMe | CF₃ |
| t-Bu | 3-Cl | H | H | CF₃ |
| cyclopropyl | 3-Cl | 5-Br | H | OCHF₂ |
| Et | 3-Cl | H | H | C₂F₅ |
| i-Pr | 3-Cl | H | H | C₂F₅ |
| t-Bu | 3-Cl | H | H | OCF₃ |
| Me | 3-F | H | H | OCF₂CHF₂ |
| Et | 3-Cl | H | H | SCF₂CHF₂ |
| i-Pr | 3-Cl | 5-Cl | H | n-C₃F₇ |
| t-Bu | 3-Cl | H | H | i-C₃F₇ |
| propargyl | 3-Cl | H | H | Br |
| Et | 3-Cl | H | H | Cl |
| i-Pr | 3-Cl | H | H | SCF₃ |
| t-Bu | 3-Cl | 5-Br | Ph | CF₃ |
| cyclopropyl | 3-Cl | H | Ph | Cl |
| Et | 3-Cl | H | Ph | Br |
| i-Pr | 3-Br | H | 2-pyridyl | CF₃ |
| t-Bu | 3-Cl | H | 2-pyridyl | Cl |
| Me | 3-Cl | H | 2-ClPh | CF₃ |
| Et | 3-Cl | 5-Cl | 2-ClPh | OCF₃ |
| i-Pr | 3-Cl | H | 2-ClPh | Br |
| t-Bu | 3-I | H | 2-ClPh | Cl |
| Me | 3-Cl | 5-Me | 2-ClPh | SCHF₂ |
| propargyl | 3-Cl | H | 2-BrPh | CF₃ |
| i-Pr | 3-Cl | H | 2-MePh | CF₃ |
| t-Bu | 3-Cl | 5-CN | 2-CNPh | CF₃ |
| Me | 3-Cl | H | 2-FPh | CF₃ |
| Et | 3-Cl | H | 2,6-F₂Ph | CF₃ |
| i-Pr | 3-Cl | 5-Br | 2,4-F₂Ph | CF₃ |
| t-Bu | 3-F | H | 2,5-F₂Ph | CF₃ |
| Me | 3-Cl | 5-I | 2-MeOPh | CF₃ |
| Et | 3-Cl | H | 3-Cl-2-pyridyl | CF₃ |
| i-Pr | 3-CN | H | 3-Cl-2-pyridyl | OCF₃ |
| t-Bu | 3-Cl | H | 3-Cl-2-pyridyl | Br |
| propargyl | 3-Cl | H | 3-Cl-2-pyridyl | Cl |
| Et | 3-Cl | 5-Br | 3-Cl-2-pyridyl | SCHF₂ |
| i-Pr | 3-Cl | H | 3-F-2-pyridyl | CF₃ |
| t-Bu | 3-Br | H | 3-CF₃-2-pyridyl | CF₃ |
| Me | 3-Cl | H | 3-Me-2-pyridyl | CF₃ |
| Et | 3-Cl | H | 3-Br-2-pyridyl | CF₃ |
| i-Pr | 3-Cl | 5-Cl | 3-Br-2-pyridyl | OCF₃ |
| t-Bu | 3-Cl | H | 3-Br-2-pyridyl | Br |
| i-Pr | 3-Cl | H | 3-Br-2-pyridyl | Cl |
| Me | 6-Cl | H | H | CF₃ |
| Et | 6-Br | 4-Me | H | OCF₃ |
| i-Pr | 6-Cl | H | H | OCF₃ |
| t-Bu | 6-Cl | Cl | Me | Br |
| Me | 6-Cl | H | Et | Br |
| Et | 6-Cl | H | Me | Cl |
| i-Pr | 6-F | 4-Br | Et | Cl |
| t-Bu | 6-Cl | H | Me | I |
| propargyl | 6-Cl | H | Me | CF₃ |
| cyclopropyl | 6-Cl | H | Me | OCF₃ |
| i-Pr | 6-Cl | 4-Cl | Me | CF₃ |
| t-Bu | 6-Cl | H | Me | SCF₃ |
| Me | 6-Cl | H | Me | SCHF₂ |
| Et | 6-Cl | H | Me | OCHF₂ |
| i-Pr | 6-I | 4-CN | Me | CF₃ |
| t-Bu | 6-Cl | H | Me | C₂F₅ |
| propargyl | 6-Cl | H | Me | C₂F₅ |
| cyclopropyl | 6-Cl | H | Et | CF₃ |
| i-Pr | 6-Cl | H | n-Pr | CF₃ |
| t-Bu | 6-Cl | 4-Br | i-Pr | CF₃ |
| Me | 6-Cl | H | Cl | CF₃ |
| Et | 6-F | H | F | CF₃ |
| i-Pr | 6-Cl | H | Me | SMe |
| t-Bu | 6-Cl | 4-Cl | Me | OMe |
| Me | 6-Cl | H | Me | OEt |
| Et | 6-I | H | Me | n-C₃F₇ |
| i-Pr | 6-Cl | H | Me | i-C₃F₇ |
| t-Bu | 6-Cl | 4-F | Me | Et |
| propargyl | 6-Cl | H | Me | OCF₂CHF₂ |
| Et | 6-Cl | H | Me | SCF₂CHF₂ |
| i-Pr | 6-Cl | H | Me | SO₂Me |
| t-Bu | 6-Cl | 4-Cl | Me | SO₂CF₃ |
| Me | 6-Cl | H | CF₃ | CF₃ |
| Et | 6-Cl | H | CF₃ | Me |
| i-Pr | 6-Cl | H | OMe | CF₃ |
| t-Bu | 6-Br | H | H | CF₃ |
| cyclopropyl | 6-Cl | 4-Br | H | OCHF₂ |
| Et | 6-Cl | H H | C₂F₅ | |
| i-Pr | 6-Cl | H | H | C₂F₅ |
| t-Bu | 6-F | 4-Me | H | OCF₃ |
| Me | 6-Cl | H | H | OCF₂CHF₂ |
| Et | 6-Cl | H | H | SCF₂CHF₂ |
| i-Pr | 6-CN | 4-Cl | H | n-C₃F₇ |
| t-Bu | 6-Cl | H | H | i-C₃F₇ |
| propargyl | 6-Cl | H | H | Brf |
| Et | 6-Cl | H | H | Cl |
| i-Pr | 6-Cl | H | H | SCF₃ |
| t-Bu | 6-Cl | 4-Br | Ph | CF₃ |
| cyclopropyl | 6-Cl | H | Ph | Cl |
| Et | 6-F | H | Ph | Br |
| i-Pr | 6-Cl | H | 2-pyridyl | CF₃ |
| t-Bu | 6-Cl | H | 2-pyridyl | Cl |
| Me | 6-Cl | H | 2-ClPh | CF₃ |
| Et | 6-Br | 4-Cl | 2-ClPh | OCF₃ |
| i-Pr | 6-Cl | H | 2-ClPh | Br |
| t-Bu | 6-Cl | H | 2-ClPh | Cl |
| Me | 6-Cl | H | 2-ClPh | SCHD₂ |
| propargyl | 6-Cl | H | 2-BrPh | CF₃ |
| i-Pr | 6-Br | H | 2-MePh | CF₃ |
| t-Bu | 6-Cl | 4-CN | 2-CNPh | CF₃ |
| Me | 6-Cl | H | 2-FPh | CF₃ |
| Et | 6-Cl | H | 2,6-F₂Ph | CF₃ |
| i-Pr | 6-Cl | 4-Br | 2,4-F₂Ph | CF₃ |
| t-Bu | 6-CN | H | 2,5-F₂Ph | CF₃ |
| Me | 6-Cl | 4-I | 2-MeOPh | CF₃ |
| Et | 6-Cl | H | 3-Cl-2-pyridyl | CF₃ |
| i-Pr | 6-Br | H | 3-Cl-2-pyridyl | OCF₃ |
| t-Bu | 6-Cl | H | 3-Cl-2-pyridyl | Br |
| propargyl | 6-Cl | H | 3-Cl-2-pyridyl | Cl |
| Et | 6-Cl | 4-Br | 3-Cl-2-pyridyl | SCHF₂ |
| i-Pr | 6-Cl | H | 3-F-2-pyridyl | CF₃ |
| t-Bu | 6-Cl | H | 3-CF₃-2-pyridyl | CF₃ |
| Me | 6-Cl | H | 3-Me-2-pyridyl | CF₃ |
| Et | 6-Cl | H | 3-Br-2-pyridyl | CF₃ |
| i-Pr | 6-Cl | 4-Cl | 3-Br-2-pyridyl | OCF₃ |
| t-Bu | 6-Cl | H | 3-Br-2-pyridyl | Br |
| i-Pr | 6-Cl | H | 3-Br-2-pyridyl | Cl |

TABLE 5

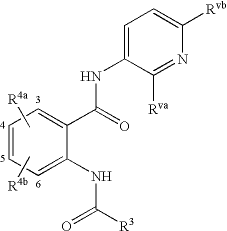

| R³ | R^{4a} | R^{4b} | R^{va} | R^{vb} |
|---|---|---|---|---|
| Me | 3-Me | H | H | CF₃ |
| Et | 3-Me | 5-Me | H | OCF₃ |
| i-Pr | 3-Me | H | H | OCF₃ |
| t-Bu | 3-Me | 5-Cl | Me | Br |
| Me | 3-Me | H | Et | Br |
| Et | 3-Me | H | Me | Cl |
| i-Pr | 3-Me | 5-Br | Et | Cl |
| t-Bu | 3-Me | H | Me | I |
| propargyl | 3-Me | H | Me | CF₃ |
| cyclopropyl | 3-Me | H | Me | OCF₃ |
| i-Pr | 3-Me | 5-Cl | Me | CF₃ |
| t-Bu | 3-Me | H | Me | SCF₃ |
| Me | 3-Me | 5-CN | Me | SCHF₂ |
| Et | 3-Me | H | Me | OCHF₂ |
| i-Pr | 3-Me | H | Me | CF₃ |
| t-Bu | 3-Me | H | Me | C₂F₅ |
| propargyl | 3-Me | H | Me | C₂F₅ |
| cyclopropyl | 3-Me | H | Et | CF₃ |
| i-Pr | 3-Me | H | n-Pr | CF₃ |
| t-Bu | 3-Me | 5-Br | i-Pr | CF₃ |
| Me | 3-Me | H | Cl | CF₃ |
| Et | 3-Me | H | F | CF₃ |
| i-Pr | 3-Me | H | Me | SMe |
| t-Bu | 3-Me | 5-Cl | Me | OMe |
| Me | 3-Me | H | Me | OEt |
| Et | 3-Me | H | Me | n-C₃F₇ |
| i-pr | 3-Me | H | Me | i-C₃F₇ |
| t-Bu | 3-Me | 5-F | Me | Et |
| propargyl | 3-Me | H | Me | OCF₂CHF₂ |
| Et | 3-Me | H | Me | SCF₂CHF₂ |
| i-Pr | 3-Me | H | Me | SO₂Me |
| t-Bu | 3-Me | 5-Cl | Me | SO₂CF₃ |
| Me | 3-Me | H | CF₃ | CF₃ |
| Et | 3-Me | H | CF₃ | Me |
| i-Pr | 3-Me | H | OMe | CF₃ |
| t-Bu | 3-Me | H | H | CF₃ |
| cyclopropyl | 3-Me | 5-Br | H | OCHF₂ |
| Et | 3-Me | H | H | C₂F₅ |
| i-Pr | 3-Me | 5-Me | H | C₂F₅ |
| t-Bu | 3-Me | H | H | OCF₃ |
| Me | 3-Me | H | H | OCF₂CHF₂ |
| Et | 3-Me | H | H | SCF₂CHF₂ |
| i-Pr | 3-Me | 5-Cl | H | n-C₃F₇ |
| t-Bu | 3-Me | H | H | i-C₃H₇ |
| propargyl | 3-Me | H | H | Br |
| Et | 3-Me | H | H | Cl |
| i-Pr | 3-Me | H | H | SCF₃ |
| t-Bu | 3-Me | 5-Br | Ph | CF₃ |
| cyclopropyl | 3-Me | H | Ph | Cl |
| Et | 3-Me | H | Ph | Br |
| i-Pr | 3-Me | H | 2-pyridyl | CF₃ |
| t-Bu | 3-Me | H | 2-pyridyl | Cl |
| Me | 3-Me | H | 2-ClPh | CF₃ |
| Et | 3-Me | 5-Cl | 2-ClPh | OCF₃ |
| i-pr | 3-Me | H | 2-ClPh | Br |
| t-Bu | 3-Me | H | 2-ClPh | Cl |
| Me | 3-Me | H | 2-ClPh | SCHF₂ |
| propargyl | 3-Me | H | 2-BrPh | CF₃ |
| i-Pr | 3-Me | 5-CN | 2-MePh | CF₃ |
| t-Bu | 3-Me | H | 2-CNPh | CF₃ |
| Me | 3-Me | H | 2-FPh | CF₃ |
| Et | 3-Me | H | 2,6-F₂Ph | CF₃ |
| i-Pr | 3-Me | 5-Br | 2,4-F₂Ph | CF₃ |
| t-Bu | 3-Me | H | 2,6-F₂Ph | CF₃ |
| Me | 3-Me | 5-I | 2-MeOPh | CF₃ |
| Et | 3-Me | H | 3-Cl-2-pyridyl | CF₃ |
| i-Pr | 3-Me | 5-Me | 3-Cl-2-pyridyl | OCF₃ |
| t-Bu | 3-Me | H | 3-Cl-2-pyridyl | Br |
| propargyl | 3-Me | H | 3-Cl-2-pyridyl | Cl |
| Et | 3-Me | 5-Br | 3-Cl-2-pyridyl | SCHF₂ |
| i-Pr | 3-Me | H | 3-F-2-pyridyl | CF₃ |
| t-Bu | 3-Me | H | 3-CF₃-2-pyridyl | CF₃ |
| Me | 3-Me | H | 3-Me-2-pyridyl | CF₃ |
| Et | 3-Me | H | 3-Br-2-pyridyl | CF₃ |
| i-Pr | 3-Me | 5-Cl | 3-Br-2-pyridyl | OCF₃ |
| t-Bu | 3-Me | H | 3-Br-2-pyridyl | Br |
| i-Pr | 3-Me | H | 3-Br-2-pyridyl | Cl |
| Me | 6-Me | H | H | CF₃ |
| Et | 6-Me | 4-Me | H | OCF₃ |
| i-Pr | 6-Me | H | H | OCF₃ |
| t-Bu | 6-Me | Cl | Me | Br |
| Me | 6-Me | H | Et | Br |
| Et | 6-Me | H | Me | Cl |
| i-Pr | 6-Me | 4-Br | Et | Cl |
| t-Bu | 6-Me | H | Me | I |
| propargyl | 6-Me | H | Me | CF₃ |
| cyclopropyl | 6-Me | H | Me | OCF₃ |
| i-pr | 6-Me | 4-Cl | Me | CF₃ |
| t-Bu | 6-Me | H | Me | SCF₃ |
| Me | 6-Me | H | Me | SCHF₂ |
| Et | 6-Me | H | Me | OCHF₂ |
| i-Pr | 6-Me | 4-CN | Me | CF₃ |
| t-Bu | 6-Me | H | Me | C₂F₅ |
| propargyl | 6-Me | H | Me | C₂F₅ |
| cyclopropyl | 6-Me | H | Et | CF₃ |
| i-pr | 6-Me | H | n-Pr | CF₃ |
| t-Bu | 6-Me | 4-Br | i-Pr | CF₃ |
| Me | 6-Me | H | Cl | CF₃ |
| Et | 6-Me | H | F | CF₃ |
| i-Pr | 6-Me | H | Me | SMe |
| t-Bu | 6-Me | 4-Cl | Me | OMe |
| Me | 6-Me | H | Me | OEt |
| Et | 6-Me | H | Me | n-C₃F₇ |
| i-Pr | 6-Me | H | Me | i-C₃F₇ |
| t-Bu | 6-Me | 4-F | Me | Et |
| propargyl | 6-Me | H | Me | OCF₂CHF₂ |
| Et | 6-Me | H | Me | SCF₂CHF₂ |
| i-Pr | 6-Me | H | Me | SO₂Me |
| t-Bu | 6-Me | 4-Cl | Me | SO₂CF₃ |
| Me | 6-Me | H | CF₃ | CF₃ |
| Et | 6-Me | H | CF₃ | Me |
| i-Pr | 6-Me | H | OMe | CF₃ |
| t-Bu | 6-Me | H | H | CF₃ |
| cyclopropyl | 6-Me | 4-Br | H | OCHF₂ |
| Et | 6-Me | H | H | C₂F₅ |
| i-Pr | 6-Me | H | H | C₂F₅ |
| t-Bu | 6-Me | 4-Me | H | OCF₃ |
| Me | 6-Me | H | H | OCF₂CHF₂ |
| Et | 6-Me | H | H | SCF₂CHF₂ |
| i-Pr | 6-Me | 4-Cl | H | n-C₃F₇ |
| t-Bu | 6-Me | H | H | i-C₃F₇ |
| propargvyl | 6-Me | H | H | Br |
| Et | 6-Me | H | H | Cl |
| i-Pr | 6-Me | H | H | SCF₃ |
| t-Bu | 6-Me | 4-Br | Ph | CF₃ |
| cyclopropyl | 6-Me | H | Ph | Cl |
| Et | 6-Me | H | Ph | Br |
| i-Pr | 6-Me | H | 2-pyridyl | CF₃ |
| t-Bu | 6-Me | H | 2-pyridyl | Cl |
| Me | 6-Me | H | 2-ClPh | CF₃ |
| Et | 6-Me | 4-Cl | 2-ClPh | OCF₃ |
| i-Pr | 6-Me | H | 2-ClPh | Br |
| t-Bu | 6-Me | 4-CN | 2-ClPh | Cl |
| Me | 6-Me | H | 2-ClPh | SCHF₂ |
| propargyl | 6-Me | H | 2-BrPh | CF₃ |
| i-Pr | 6-Me | H | 2-MePh | CF₃ |
| t-Bu | 6-Me | H | 2-CNPh | CF₃ |
| Me | 6-Me | H | 2-FPh | CF₃ |
| Et | 6-Me | H | 2,6-F₂Ph | CF₃ |
| i-Pr | 6-Me | 4-Br | 2,4-F₂Ph | CF₃ |
| t-Bu | 6-Me | H | 2,6-F₂Ph | CF₃ |
| Me | 6-Me | 4-I | 2-MeOPh | CF₃ |
| Et | 6-Me | H | 3-Cl-2-pyridyl | CF₃ |
| i-Pr | 6-Me | H | 3-Cl-2-pyridyl | OCF₃ |
| t-Bu | 6-Me | H | 3-Cl-2-pyridyl | Br |
| propargyl | 6-Me | H | 3-Cl-2-pyridyl | Cl |
| Et | 6-Me | 4-Br | 3-Cl-2-pyridyl | SCHF₂ |
| i-Pr | 6-Me | H | 3-F-2-pyridyl | CF₃ |
| t-Bu | 6-Me | H | 3-CF₃-2-pyridyl | CF₃ |
| Me | 6-Me | H | 3-Me-2-pyridyl | CF₃ |
| Et | 6-Me | H | 3-Br-2-pyridyl | CF₃ |
| i-Pr | 6-Me | 4-Cl | 3-Br-2-pyridyl | OCF₃ |
| t-Bu | 6-Me | H | 3-Br-2-pyridyl | Br |
| i-pr | 6-Me | H | 3-Br-2-pyridyl | Cl |
| Me | 3-Cl | H | H | CF₃ |
| Et | 3-Br | 5-Me | H | OCF₃ |
| i-pr | 3-Cl | H | H | OCF₃ |
| t-Bu | 3-Cl | 5-Cl | Me | Br |
| Me | 3-Cl | H | Et | Br |
| Et | 3-Cl | H | Me | Cl |
| i-pr | 3-Cl | 5-Br | Et | Cl |
| t-Bu | 3-Cl | H | Me | I |
| propargyl | 3-Cl | H | Me | CF₃ |
| cyclopropyl | 3-Cl | H | Me | OCF₃ |
| i-Pr | 3-Cl | 5-Cl | Me | CF₃ |
| t-Bu | 3-Cl | H | Me | SCF₃ |
| Me | 3-F | H | Me | SCHF₂ |
| Et | 3-Cl | H | Me | OCHF₂ |
| i-Pr | 3-Cl | 5-CN | Me | CF₃ |
| t-Bu | 3-Cl | H | Me | C₂F₅ |
| propargyl | 3-Cl | H | Me | C₂F₅ |
| cyclopropyl | 3-Cl | H | Et | CF₃ |
| i-Pr | 3-Cl | H | n-Pr | CF₃ |
| t-Bu | 3-Cl | 5-Br | i-pr | CF₃ |
| Me | 3-Cl | H | Cl | CF₃ |
| Et | 3-Br | H | F | CF₃ |
| i-Pr | 3-Cl | H | Me | SMe |
| t-Bu | 3-Cl | 5-Cl | Me | OMe |
| Me | 3-Cl | H | Me | OEt |
| Et | 3-Cl | H | Me | n-C₃F₇ |
| i-Pr | 3-Cl | H | Me | i-C₃F₇ |
| t-Bu | 3-Cl | 5-F | Me | Et |
| propargvyl | 3-Cl | H | Me | OCF₂CHF₂ |
| Et | 3-Cl | H | Me | SCF₂CHF₂ |
| i-pr | 3-Br | H | Me | SO₂Me |
| t-Bu | 3-Cl | 5-Cl | Me | SO₂CF₃ |
| Me | 3-Cl | H | CF₃ | CF₃ |
| Et | 3-CN | H | CF₃ | Me |
| i-pr | 3-Cl | H | OMe | CF₃ |
| t-Bu | 3-Cl | H | H | CF₃ |
| cyclopropyl | 3-Cl | 5-Br | H | OCHF₂ |
| Et | 3-Cl | H | H | C₂F₅ |
| i-Pr | 3-Cl | H | H | C₂F₅ |
| t-Bu | 3-Cl | H | H | OCF₃ |
| Me | 3-F | H | H | OCF₂CHF₂ |
| Et | 3-Cl | H | H | SCF₂CHF₂ |
| i-pr | 3-Cl | 5-Cl | H | n-C₃F₇ |
| t-Bu | 3-Cl | H | H | i-C₃F₇ |
| propargyl | 3-Cl | H | H | Br |
| Et | 3-Cl | H | H | Cl |
| i-Pr | 3-Cl | H | H | SCF₃ |
| t-Bu | 3-Cl | 5-Br | Ph | CF₃ |
| cyclopropyl | 3-Cl | H | Ph | Cl |
| Et | 3-Cl | H | Ph | Br |
| i-Pr | 3-Br | H | 2-pyridyl | CF₃ |
| t-Bu | 3-Cl | H | 2-pyridyl | Cl |
| Me | 3-Cl | H | 2-ClPh | CF₃ |
| Et | 3-Cl | 5-Cl | 2-ClPh | OCF₃ |
| i-Pr | 3-Cl | H | 2-ClPh | Br |
| t-Bu | 3-I | H | 2-ClPh | Cl |
| Me | 3-Cl | 5-Me | 2-ClPh | SCHF₂ |
| propargyl | 3-Cl | H | 2-BrPh | CF₃ |
| i-Pr | 3-Cl | H | 2-MePh | CF₃ |
| t-Bu | 3-Cl | 5-CN | 2-CNPh | CF₃ |
| Me | 3-Cl | H | 2-FPh | CF₃ |
| Et | 3-Cl | H | 2,6-F₂Ph | CF₃ |
| i-Pr | 3-Cl | 5-Br | 2,4-F₂Ph | CF₃ |
| t-Bu | 3-F | H | 2,5-F₂Ph | CF₃ |
| Me | 3-Cl | 5-I | 2-MeOPh | CF₃ |
| Et | 3-Cl | H | 3-Cl-2-pyridyl | CF₃ |
| i-Pr | 3-Cn | H | 3-Cl-2-pyridyl | OCF₃ |
| t-Bu | 3-Cl | H | 3-Cl-2-pyridyl | Br |
| propargyl | 3-Cl | H | 3-Cl-2-pyridyl | Cl |
| Et | 3-Cl | 5-Br | 3-Cl-2-pyridyl | SCHF₂ |
| i-Pr | 3-Cl | H | 3-F-2-pyridyl | CF₃ |
| t-Bu | 3-Br | H | 3-CF₃-2-pyridyl | CF₃ |
| Me | 3-Cl | H | 3-Me-2-pyridyl | CF₃ |
| Et | 3-Cl | H | 3-Br-2-pyridyl | CF₃ |
| i-Pr | 3-Cl | 5-Cl | 3-Br-2-pyridyl | OCF₃ |
| t-Bu | 3-Cl | H | 3-Br-2-pyridyl | Br |
| i-Pr | 3-Cl | H | 3-Br-2-pyridyl | Cl |
| Me | 6-Cl | H | H | CF₃ |
| Et | 6-Br | 4-Me | H | OCF₃ |
| i-Pr | 6-Cl | H | H | OCF₃ |
| t-Bu | 6-Cl | Cl | Me | Br |
| Me | 6-Cl | H | Et | Br |
| Et | 6-Cl | H | Me | Cl |
| i-Pr | 6-F | 4-Br | Et | Cl |
| t-Bu | 6-Cl | H | Me | I |
| propargyl | 6-Cl | H | Me | CF₃ |
| cyclopropyl | 6-Cl | H | Me | OCF₃ |
| i-Pr | 6-Cl | 4-Cl | Me | CF₃ |
| t-Bu | 6-Cl | H | Me | SCF₃ |
| Me | 6-Cl | H | Me | SCHF₂ |
| Et | 6-Cl | H | Me | OCHF₂ |
| i-Pr | 6-I | 4-CN | Me | CF₃ |
| t-Bu | 6-Cl | H | Me | C₂F₅ |
| propargyl | 6-Cl | H | Me | C₂F₅ |
| cyclopropyl | 6-Cl | H | Et | CF₃ |
| i-Pr | 6-Cl | H | n-Pr | CF₃ |
| t-Bu | 6-Cl | 4-Br | i-pr | CF₃ |
| Me | 6-Cl | H | Cl | CF₃ |
| Et | 6-F | H | F | CF₃ |
| i-Pr | 6-Cl | H | Me | SMe |
| t-Bu | 6-Cl | 4-Cl | Me | OMe |
| Me | 6-Cl | H | Me | OEt |
| Et | 6-I | H | Me | n-C₃F₇ |
| i-Pr | 6-Cl | H | Me | i-C₃F₇ |
| t-Bu | 6-Cl | 4-F | Me | Et |
| propargyl | 6-Cl | H | Me | OCF₂CHF₂ |
| Et | 6-Cl | H | Me | SCF₂CHF₂ |
| i-Pr | 6-Cl | H | Me | SO₂Me |
| t-Bu | 6-Cl | 4-Cl | Me | SO₂CF₃ |
| Me | 6-Cl | H | CF₃ | CF₃ |
| Et | 6-Cl | H | CF₃ | Me |
| i-Pr | 6-Cl | H | OMe | CF₃ |
| t-Bu | 6-Br | H | H | CF₃ |
| cyclopropyl | 6-Cl | 4-Br | H | OCHF₂ |
| Et | 6-Cl | H | H | C₂F₅ |
| i-Pr | 6-Cl | H | H | C₂F₅ |
| t-Bu | 6-F | 4-Me | H | OCF₃ |
| Me | 6-Cl | H | H | OCF₂CHF₂ |
| Et | 6-Cl | H | H | SCF₂CHF₂ |
| i-Pr | 6-CN | 4-Cl | H | n-C₃F₇ |
| t-Bu | 6-Cl | H | H | i-C₃F₇ |
| propargyl | 6-Cl | H | H | Br |
| Et | 6-Cl | H | H | Cl |
| i-Pr | 6-Cl | H | H | SCF₃ |
| t-Bu | 6-Cl | 4-Br | Ph | CF₃ |
| cyclopropyl | 6-Cl | H | Ph | Cl |
| Et | 6-F | H | Ph | Br |
| i-Pr | 6-Cl | H | 2-pyridyl | CF₃ |
| t-Bu | 6-Cl | H | 2-pyridyl | Cl |
| Me | 6-Cl | H | 2-ClPh | CF₃ |
| Et | 6-Br | 4-Cl | 2-ClPh | OCF₃ |
| i-Pr | 6-Cl | H | 2-ClPh | Br |
| t-Bu | 6-Cl | H | 2-ClPh | Cl |
| Me | 6-Cl | H | 2-ClPh | SCHF₂ |
| propargyl | 6-Cl | H | 2-BrPh | CF₃ |
| i-Pr | 6-Br | H | 2-MePh | CF₃ |
| t-Bu | 6-Cl | 4-CN | 2-CNPh | CF₃ |
| Me | 6-Cl | H | 2-FPh | CF₃ |
| Et | 6-Cl | H | 2,6-F₂Ph | CF₃ |
| i-Pr | 6-Cl | 4-Br | 2,4-F₂Ph | CF₃ |
| t-Bu | 6-CN | H | 2,6-F₂Ph | CF₃ |
| Me | 6-Cl | 4-I | 2-MeOPh | CF₃ |
| Et | 6-Cl | H | 3-Cl-2-pyridyl | CF₃ |
| i-Pr | 6-Br | H | 3-Cl-2-pyridyl | OCF₃ |
| t-Bu | 6-Cl | H | 3-Cl-2-pyridyl | Br |
| propargyl | 6-Cl | H | 3-Cl-2-pyridyl | Cl |
| Et | 6-Cl | 4-Br | 3-Cl-2-pyridyl | SCHF₂ |
| i-Pr | 6-Cl | H | 3-F-2-pyridyl | CF₃ |
| t-Bu | 6-Cl | H | 3-CF₃-2-pyridyl | CF₃ |
| Me | 6-Cl | H | 3-Me-2-pyridyl | CF₃ |
| Et | 6-Cl | H | 3-Br-2-pyridyl | CF₃ |
| i-pr | 6-Cl | 4-Cl | 3-Br-2-pyridyl | OCF₃ |
| t-Bu | 6-Cl | H | 3-Br-2-pyridyl | Br |
| i-Pr | 6-Cl | H | 3-Br-2-pyridyl | Cl |

TABLE 6

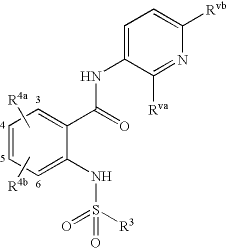

| R³ | R^{4a} | R^{4b} | R^{va} | R^{vb} |
|---|---|---|---|---|
| Me | 3-Me | H | H | CF₃ |
| Et | 3-Me | 3-Me | H | OCF₃ |
| i-Pr | 3-Me | H | H | OCF₃ |
| t-Bu | 3-Me | 5-Cl | Me | Br |
| Me | 3-Me | H | Et | Br |
| Et | 3-Me | H | Me | Cl |
| i-Pr | 3-Me | 5-Br | Et | Cl |
| t-Bu | 3-Me | H | Me | I |
| propargyl | 3-Me | H | Me | CF₃ |
| cyclopropyl | 3-Me | H | Me | OCF₃ |
| i-Pr | 3-Me | 5-Cl | Me | CF₃ |
| t-Bu | 3-Me | H | Me | SCF₃ |
| Me | 3-Me | 5-CN | Me | SCHF₂ |
| Et | 3-Me | H | Me | OCHF₂ |
| i-Pr | 3-Me | H | Me | CF₃ |
| t-Bu | 3-Me | H | Me | C₂F₅ |
| propargyl | 3-Me | H | Me | C₂F₅ |
| cyclopropyl | 3-Me | H | Et | CF₃ |
| i-Pr | 3-Me | H | n-Pr | CF₃ |
| t-Bu | 3-Me | 5-Br | i-Pr | CF₃ |
| Me | 3-Me | H | Cl | CF₃ |
| Et | 3-Me | H | F | CF₃ |
| i-Pr | 3-Me | H | Me | SMe |
| t-Bu | 3-Me | 5-Cl | Me | OMe |
| Me | 3-Me | H | Me | OEt |
| Et | 3-Me | H | Me | n-C₃F₇ |
| i-Pr | 3-Me | H | Me | i-C₃F₇ |
| t-Bu | 3-Me | 5-F | Me | Et |
| propargyl | 3-Me | H | Me | OCF₂CHF₂ |
| Et | 3-Me | H | Me | SCF₂CHF₂ |
| i-pr | 3-Me | H | Me | SO₂Me |
| t-Bu | 3-Me | 5-Cl | Me | SO₂CF₃ |
| Me | 3-Me | H | CF₃ | CF₃ |
| Et | 3-Me | H | CF₃ | Me |
| i-Pr | 3-Me | H | OMe | CF₃ |
| t-Bu | 3-Me | H | H | CF₃ |
| cyclopropyl | 3-Me | 5-Br | H | OCHF₂ |
| Et | 3-Me | H | H | C₂F₅ |
| i-Pr | 3-Me | 5-Me | H | C₂F₅ |
| t-Bu | 3-Me | H | H | OCF₃ |
| Me | 3-Me | H | H | OCF₂CHF₂ |
| Et | 3-Me | H | H | SCF₂CHF₂ |
| i-Pr | 3-Me | 5-Cl | H | n-C₃F₇ |
| t-Bu | 3-Me | H | H | i-C₃F₇ |
| propargyl | 3-Me | H | H | Br |
| Et | 3-Me | H | H | Cl |
| i-Pr | 3-Me | H | H | SCF₃ |
| t-Bu | 3-Me | 5-Br | Ph | CF₃ |
| cyclopropyl | 3-Me | H | Ph | Cl |
| Et | 3-Me | H | Ph | Br |
| i-Pr | 3-Me | H | 2-pyridyl | CF₃ |
| t-Bu | 3-Me | H | 2-pyridyl | Cl |
| Me | 3-Me | H | 2-ClPh | CF₃ |
| Et | 3-Me | 5-Cl | 2-ClPh | OCF₃ |
| i-Pr | 3-Me | H | 2-ClPh | Br |
| t-Bu | 3-Me | H | 2-ClPh | Cl |
| Me | 3-Me | H | 2-ClPh | SCHF₂ |
| propargyl | 3-Me | H | 2-BrPh | CF₃ |
| i-Pr | 3-Me | 5-CN | 2-MePh | CF₃ |
| t-Bu | 3-Me | H | 2-CNPh | CF₃ |
| Me | 3-Me | H | 2-FPh | CF₃ |
| Et | 3-Me | H | 2,6-F₂Ph | CF₃ |
| i-Pr | 3-Me | 5-Br | 2,4-F₂Ph | CF₃ |
| t-Bu | 3-Me | H | 2,5-F₂Ph | CF₃ |
| Me | 3-Me | 5-I | 2-MeOPh | CF₃ |
| Et | 3-Me | H | 3-Cl-2-pyridyl | CF₃ |
| i-Pr | 3-Me | 5-Me | 3-Cl-2-pyridyl | OCF₃ |
| t-Bu | 3-Me | H | 3-Cl-2-pyridyl | Br |
| propargyl | 3-Me | H | 3-Cl-2-pyridyl | Cl |
| Et | 3-Me | 5-Br | 3-Cl-2-pyridyl | SCHF₂ |
| i-Pr | 3-Me | H | 3-F-2-pyridyl | CF₃ |
| t-Bu | 3-Me | H | 3-CF₃-2-pyridyl | CF₃ |
| Me | 3-Me | H | 3-Me-2-pyridyl | CF₃ |
| Et | 3-Me | H | 3-Br-2-pyridyl | CF₃ |
| i-Pr | 3-Me | 5-Cl | 3-Br-2-pyridyl | OCF₃ |
| t-Bu | 3-Me | H | 3-Br-2-pyridyl | Br |
| i-Pr | 3-Me | H | 3-Br-2-pyridyl | Cl |
| Me | 6-Me | H | H | CF₃ |
| Et | 6-Me | 4-Me | H | OCF₃ |
| i-Pr | 6-Me | H | H | OCF₃ |
| t-Bu | 6-Me | Cl | Me | Br |
| Me | 6-Me | H | Et | Br |
| Et | 6-Me | H | Me | Cl |
| i-Pr | 6-Me | 4-Br | Et | Cl |
| t-Bu | 6-Me | H | Me | I |
| propargyl | 6-Me | H | Me | CF₃ |
| cyclopropyl | 6-Me | H | Me | OCF₃ |
| i-pr | 6-Me | 4-Cl | Me | CF₃ |
| t-Bu | 6-Me | H | Me | SCF₃ |
| Me | 6-Me | H | Me | SCHF₂ |
| Et | 6-Me | H | Me | OCHF₂ |
| i-Pr | 6-Me | 4-CN | Me | CF₃ |
| t-Bu | 6-Me | H | Me | C₂F₅ |
| propargyl | 6-Me | H | Me | C₂F₅ |
| cyclopropyl | 6-Me | H | Et | CF₃ |
| i-Pr | 6-Me | H | n-Pr | CF₃ |
| t-Bu | 6-Me | 4-Br | i-Pr | CF₃ |
| Me | 6-Me | H | Cl | CF₃ |
| Et | 6-Me | H | F | CF₃ |
| i-Pr | 6-Me | H | Me | SMe |
| t-Bu | 6-Me | 4-Cl | Me | OMe |
| Me | 6-Me | H | Me | OEt |
| Et | 6-Me | H | Me | n-C₃F₇ |
| i-Pr | 6-Me | H | Me | i-C₃F₇ |
| t-Bu | 6-Me | 4-F | Me | Et |
| propargyl | 6-Me | H | Me | OCF₂CHF₂ |
| Et | 6-Me | H | Me | SCF₂CHF₂ |
| i-Pr | 6-Me | H | Me | SO₂Me |
| t-Bu | 6-Me | 4-Cl | Me | SO₂CF₃ |
| Me | 6-Me | H | CF₃ | CF₃ |
| Et | 6-Me | H | CF₃ | Me |
| i-Pr | 6-Me | H | OMe | CF₃ |
| t-Bu | 6-Me | H | H | CF₃ |
| cyclopropyl | 6-Me | 4-Br | H | OCHF₂ |
| Et | 6-Me | H | H | C₂F₅ |
| i-Pr | 6-Me | H | H | C₂F₅ |
| t-Bu | 6-Me | 4-Me | H | OCF₃ |
| Me | 6-Me | H | H | OCF₂CHF₂ |
| Et | 6-Me | H | H | SCF₂CHF₂ |
| i-Pr | 6-Me | 4-Cl | H | n-C₃F₇ |
| t-Bu | 6-Me | H | H | i-C₃H₇ |
| propargyl | 6-Me | H | H | Br |
| Et | 6-Me | H | H | Cl |
| i-Pr | 6-Me | H | H | SCF₃ |
| t-Bu | 6-Me | 4-Br | Ph | CF₃ |
| cyclopropyl | 6-Me | H | Ph | Cl |
| Et | 6-Me | H | Ph | Br |
| i-pr | 6-Me | H | 2-pyridyl | CF₃ |
| t-Bu | 6-Me | H | 2-pyridyl | Cl |
| Me | 6-Me | H | 2-ClPh | CF₃ |
| Et | 6-Me | 4-Cl | 2-ClPh | OCF₃ |
| i-Pr | 6-Me | H | 2-ClPh | Br |
| t-Bu | 6-Me | 4-CN | 2-ClPh | Cl |
| Me | 6-Me | H | 2-ClPh | SCHF₂ |
| propargyl | 6-Me | H | 2-BrPh | CF₃ |
| i-Pr | 6-Me | H | 2-MePh | CF₃ |
| t-Bu | 6-Me | H | 2-CNPh | CF₃ |
| Me | 6-Me | H | 2-FPh | CF₃ |
| Et | 6-Me | H | 2,6-F₂Ph | CF₃ |
| i-Pr | 6-Me | 4-Br | 2,4-F₂Ph | CF₃ |
| t-Bu | 6-Me | H | 2,6-F₂Ph | CF₃ |
| Me | 6-Me | 4-I | 2-MeOPh | CF₃ |
| Et | 6-Me | H | 3-Cl-2-pyridyl | OCF₃ |
| t-Bu | 6-Me | H | 3-Cl-2-pyridyl | Br |
| propargyl | 6-Me | H | 3-Cl-2-pyridyl | Cl |
| Et | 6-Me | 4-Br | 3-Cl-2-pyridyl | SCHF₂ |
| i-Pr | 6-Me | H | 3-F-2-pyridyl | CF₃ |
| t-Bu | 6-Me | H | 3-CF₃-2-pyridyl | CF₃ |
| Me | 6-Me | H | 3-Me-2-pyridyl | CF₃ |
| Et | 6-Me | H | 3-Br-2-pyridyl | CF₃ |
| i-Pr | 6-Me | 4-Cl | 3-Br-2-pyridyl | OCF₃ |
| t-Bu | 6-Me | H | 3-Br-2-pyridyl | Br |
| i-Pr | 6-Me | H | 3-Br-2-pyridyl | Cl |
| Me | 3-Cl | H | H | CF₃ |
| Et | 3-Br | 5-Me | H | OCF₃ |
| i-Pr | 3-Cl | H | H | OCF₃ |
| t-Bu | 3-Cl | 5-Cl | Me | Br |
| Me | 3-Cl | H | Et | Br |
| Et | 3-Cl | H | Me | Cl |
| i-Pr | 3-Cl | 5-Br | Et | Cl |
| t-Bu | 3-Cl | H | Me | I |
| propargyl | 3-Cl | H | Me | CF₃ |
| cyclopropyl | 3-Cl | H | Me | OCF₃ |
| i-Pr | 3-Cl | 5-Cl | Me | CF₃ |
| t-Bu | 3-Cl | H | Me | SCF₃ |
| Me | 3-F | H | Me | SCHF₂ |
| Et | 3-Cl | H | Me | OCHF₂ |
| i-Pr | 3-Cl | 5-CN | Me | CF₃ |
| t-Bu | 3-Cl | H | Me | C₂F₅ |
| propargyl | 3-Cl | H | Me | C₂F₅ |
| cyclopropyl | 3-Cl | H | Et | CF₃ |
| i-Pr | 3-Cl | H | n-Pr | CF₃ |
| t-Bu | 3-Cl | 5-Br | i-Pr | CF₃ |
| Me | 3-Cl | H | Cl | CF₃ |
| Et | 3-Br | H | F | CF₃ |
| i-Pr | 3-Cl | H | Me | SMe |
| t-Bu | 3-Cl | 5-Cl | Me | OMe |
| Me | 3-Cl | H | Me | OEt |
| Et | 3-Cl | H | Me | n-C₃F₇ |
| i-Pr | 3-Cl | H | Me | i-C₃F₇ |
| t-Bu | 3-Cl | 5-F | Me | Et |
| propargyl | 3-Cl | H | Me | OCF₂CHF₂ |
| Et | 3-Cl | H | Me | SCF₂CHF₂ |
| i-Pr | 3-Br | H | Me | SO₂Me |
| t-Bu | 3-Cl | 5-Cl | Me | SO₂CF₃ |
| Me | 3-Cl | H | CF₃ | CF₃ |
| Et | 3-CN | H | CF₃ | Me |
| i-Pr | 3-Cl | H | OMe | CF₃ |
| t-Bu | 3-Cl | H | H | CF₃ |
| cyclopropyl | 3-Cl | 5-Br | H | OCHF₂ |
| Et | 3-Cl | H | H | C₂F₅ |
| i-Pr | 3-Cl | H | H | C₂F₅ |
| t-Bu | 3-Cl | H | H | OCF₃ |
| Me | 3-F | H | H | OCF₂CHF₂ |
| Et | 3-Cl | H | H | SCF₂CHF₂ |
| i-Pr | 3-Cl | 5-Cl | H | n-C₃F₇ |
| t-Bu | 3-Cl | H | H | i-C₃H₇ |
| propargyl | 3-Cl | H | H | Br |
| Et | 3-Cl | H | H | Cl |
| i-Pr | 3-Cl | H | H | SCF₃ |
| t-Bu | 3-Cl | 5-Br | Ph | CF₃ |
| cyclopropyl | 3-Cl | H | Ph | Cl |
| Et | 3-Cl | H | Ph | Br |
| i-Pr | 3-Br | H | 2-pyridyl | CF₃ |
| t-Bu | 3-Cl | H | 2-pyridyl | Cl |
| Me | 3-Cl | H | 2-ClPh | CF₃ |
| Et | 3-Cl | 5-Cl | 2-ClPh | OCF₃ |
| i-Pr | 3-Cl | H | 2-ClPh | Br |
| t-Bu | 3-I | H | 2-ClPh | Cl |
| Me | 3-Cl | 5-Me | 2-ClPh | SCHF₂ |
| propargyl | 3-Cl | H | 2-BrPh | CF₃ |
| i-Pr | 3-Cl | H | 2-MePh | CF₃ |
| t-Bu | 3-Cl | 5-CN | 2-CNPh | CF₃ |
| Me | 3-Cl | H | 2-FPh | CF₃ |
| Et | 3-Cl | H | 2,6-F₂Ph | CF₃ |
| i-Pr | 3-Cl | 5-Br | 2,4-F₂Ph | CF₃ |
| t-Bu | 3-F | H | 2,5-F₂Ph | CF₃ |
| Me | 3-Cl | 5-I | 2-MeOPh | CF₃ |
| Et | 3-Cl | H | 3-Cl-2-pyridyl | CF₃ |
| i-Pr | 3-CN | H | 3-Cl-2-pyridyl | OCF₃ |
| t-Bu | 3-Cl | H | 3-Cl-2-pyridyl | Br |
| propargyl | 3-Cl | H | 3-Cl-2-pyridyl | Cl |
| Et | 3-Cl | 5-Br | 3-Cl-2-pyridyl | SCHF₂ |
| i-Pr | 3-Cl | H | 3-F-2-pyridyl | CF₃ |
| t-Bu | 3-Br | H | 3-CF₃-2-pyridyl | CF₃ |
| Me | 3-Cl | H | 3-Me-2-pyridyl | CF₃ |
| Et | 3-Cl | H | 3-Br-2-pyridyl | CF₃ |
| i-Pr | 3-Cl | 5-Cl | 3-Br-2-pyridyl | OCF₃ |
| t-Bu | 3-Cl | H | 3-Br-2-pyridyl | Br |
| i-Pr | 3-Cl | H | 3-Br-2-pyridyl | Cl |
| Me | 6-Cl | H | H | CF₃ |
| Et | 6-Br | 4-Me | H | OCF₃ |
| i-Pr | 6-Cl | H | H | OCF₃ |
| t-Bu | 6-Cl | Cl | Me | Br |
| Me | 6-Cl | H | Et | Br |
| Et | 6-Cl | H | Me | Cl |
| i-Pr | 6-F | 4-Br | Et | Cl |
| t-Bu | 6-Cl | H | Me | I |
| propargyl | 6-Cl | H | Me | CF₃ |
| cyclopropyl | 6-Cl | H | Me | OCF₃ |
| i-Pr | 6-Cl | 4-Cl | Me | CF₃ |
| t-Bu | 6-Cl | H | Me | SCF₃ |
| Me | 6-Cl | H | Me | SCHF₂ |
| Et | 6-Cl | H | Me | OCHF₂ |
| i-Pr | 6-I | 4-CN | Me | CF₃ |
| t-Bu | 6-Cl | H | Me | C₂F₅ |
| propargyl | 6-Cl | H | Me | C₂F₅ |
| cyclopropyl | 6-Cl | H | Et | CF₃ |
| i-Pr | 6-Cl | H | n-Pr | CF₃ |
| t-Bu | 6-Cl | 4-Br | i-Pr | CF₃ |
| Me | 6-Cl | H | Cl | CF₃ |
| Et | 6-F | H | F | CF₃ |
| i-Pr | 6-Cl | H | Me | SMe |
| t-Bu | 6-Cl | 4-Cl | Me | OMe |
| Me | 6-Cl | H | Me | OEt |
| Et | 6-I | H | Me | n-C₃F₇ |
| i-Pr | 6-Cl | H | Me | i-C₃F₇ |
| t-Bu | 6-Cl | 4-F | Me | Et |
| propargyl | 6-Cl | H | Me | OCF₂CHF₂ |
| Et | 6-Cl | H | Me | SCF₂CHF₂ |
| i-Pr | 6-Cl | H | Me | SO₂Me |
| t-Bu | 6-Cl | 4-Cl | Me | SO₂CF₃ |
| Me | 6-Cl | H | CF₃ | CF₃ |
| Et | 6-Cl | H | CF₃ | Me |
| i-Pr | 6-Cl | H | OMe | CF₃ |
| t-Bu | 6-Br | H | H | CF₃ |
| cyclopropyl | 6-Cl | 4-Br | H | OCHF₂ |
| Et | 6-Cl | H | H | C₂F₅ |
| i-Pr | 6-Cl | H | H | C₂F₅ |
| t-Bu | 6-F | 4-Me | H | OCF₃ |
| Me | 6-Cl | H | H | OCF₂CHF₂ |
| Et | 6-Cl | H | H | SCF₂CHF₂ |
| i-Pr | 6-CN | 4-Cl | H | n-C₃F₇ |
| t-Bu | 6-Cl | H | H | i-C₃F₇ |
| propargyl | 6-Cl | H | H | Br |
| Et | 6-Cl | H | H | Cl |
| i-Pr | 6-Cl | H | H | SCF₃ |
| t-Bu | 6-Cl | 4-Br | Ph | CF₃ |
| cyclopropyl | 6-Cl | H | Ph | Cl |
| Et | 6-F | H | Ph | Br |
| i-Pr | 6-Cl | H | 2-pyridyl | CF₃ |
| t-Bu | 6-Cl | H | 2-pyridyl | Cl |
| Me | 6-Cl | H | 2-ClPh | CF₃ |
| Et | 6-Br | 4-Cl | 2-ClPh | OCF₃ |
| i-Pr | 6-Cl | H | 2-ClPh | Br |
| t-Bu | 6-Cl | H | 2-ClPh | Cl |
| Me | 6-Cl | H | 2-ClPh | SCHF₂ |
| propargyl | 6-Cl | H | 2-BrPh | CF₃ |
| i-Pr | 6-Br | H | 2-MePh | CF₃ |
| t-Bu | 6-Cl | 4-CN | 2-CNPh | CF₃ |
| Me | 6-Cl | H | 2-FPh | CF₃ |
| Et | 6-Cl | H | 2,6-F₂Ph | CF₃ |
| i-Pr | 6-Cl | 4-Br | 2,4-F₂Ph | CF₃ |
| t-Bu | 6-CN | H | 2,6-F₂Ph | CF₃ |
| Me | 6-Cl | 4-I | 2-MeOPh | CF₃ |
| Et | 6-Cl | H | 3-Cl-2-pyridyl | CF₃ |
| i-Pr | 6-Br | H | 3-Cl-2-pyridyl | OCF₃ |
| t-Bu | 6-Cl | H | 3-Cl-2-pyridyl | Br |
| propargyl | 6-Cl | H | 3-Cl-2-pyridyl | Cl |
| Et | 6-Cl | 4-Br | 3-Cl-2-pyridyl | SCHF₂ |
| i-Pr | 6-Cl | H | 3-F-2-pyridyl | CF₃ |
| t-Bu | 6-Cl | H | 3-CF₃-2-pyridyl | CF₃ |
| Me | 6-Cl | H | 3-Me-2-pyridyl | CF₃ |
| Et | 6-Cl | H | 3-Br-2-pyridyl | CF₃ |
| i-Pr | 6-Cl | 4-Cl | 3-Br-2-pyridyl | OCF₃ |
| t-Bu | 6-Cl | H | 3-Br-2-pyridyl | Br |
| i-Pr | 6-Cl | H | 3-Br-2-pyridyl | Cl |

TABLE 7

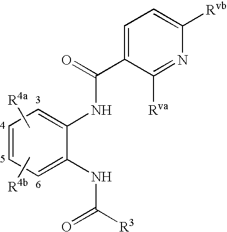

| R³ | R^{4a} | R^{4b} | R^{va} | R^{vb} |
|---|---|---|---|---|
| Me | 3-Me | H | H | CF₃ |
| Et | 3-Me | 5-Me | H | OCF₃ |
| i-Pr | 3-Me | H | H | OCF₃ |
| t-Bu | 3-Me | 5-Cl | Me | Br |
| Me | 3-Me | H | Et | Br |
| Et | 3-Me | H | Me | Cl |
| i-Pr | 3-Me | 5-Br | Et | Cl |
| t-Bu | 3-Me | H | Me | I |
| propargyl | 3-Me | H | Me | CF₃ |
| cyclopropyl | 3-Me | H | Me | OCF₃ |
| i-Pr | 3-Me | 5-Cl | Me | CF₃ |
| t-Bu | 3-Me | H | Me | SCF₃ |
| Me | 3-Me | 5-CN | Me | SCHF₂ |
| Et | 3-Me | H | Me | OCHF₂ |
| i-Pr | 3-Me | H | Me | CF₃ |
| t-Bu | 3-Me | H | Me | C₂F₅ |
| propargyl | 3-Me | H | Me | C₂F₅ |
| cyclopropyl | 3-Me | H | Et | CF₃ |
| i-Pr | 3-Me | H | n-Pr | CF₃ |
| t-Bu | 3-Me | 5-Br | i-Pr | CF₃ |
| Me | 3-Me | H | Cl | CF₃ |
| Et | 3-Me | H | F | CF₃ |
| i-Pr | 3-Me | H | Me | SMe |
| t-Bu | 3-Me | 5-Cl | Me | OMe |
| Me | 3-Me | H | Me | OEt |
| Et | 3-Me | H | Me | n-C₃F₇ |
| i-Pr | 3-Me | H | Me | i-C₃F₇ |
| t-Bu | 3-Me | 5-F | Me | Et |
| propargyl | 3-Me | H | Me | OCF₂CHF₂ |
| Et | 3-Me | H | Me | SCF₂CHF₂ |
| i-Pr | 3-Me | H | Me | SO₂Me |
| t-Bu | 3-Me | 5-Cl | Me | SO₂CF₃ |
| Me | 3-Me | H | CF₃ | CF₃ |
| Et | 3-Me | H | CF₃ | Me |
| i-Pr | 3-Me | H | OMe | CF₃ |
| t-Bu | 3-Me | H | H | CF₃ |
| cyclopropyl | 3-Me | 5-Br | H | OCHF₂ |
| Et | 3-Me | H | H | C₂F₅ |
| i-Pr | 3-Me | 5-Me | H | C₂F₅ |
| t-Bu | 3-Me | H | H | OCF₃ |
| Me | 3-Me | H | H | OCF₂CHF₂ |
| Et | 3-Me | H | H | SCF₂CHF₂ |
| i-Pr | 3-Me | 5-Cl | H | n-C₃F₇ |
| t-Bu | 3-Me | H | H | i-C₃F₇ |
| propargyl | 3-Me | H | H | Br |
| Et | 3-Me | H | H | Cl |
| i-Pr | 3-Me | H | H | SCF₃ |
| t-Bu | 3-Me | 5-Br | Ph | CF₃ |
| cyclopropyl | 3-Me | H | Ph | Cl |
| Et | 3-Me | H | Ph | Br |
| i-Pr | 3-Me | H | 2-pyridyl | CF₃ |
| t-Bu | 3-Me | H | 2-pyridyl | Cl |
| Me | 3-Me | H | 2-ClPh | CF₃ |
| Et | 3-Me | 5-Cl | 2-ClPh | OCF₃ |
| i-Pr | 3-Me | H | 2-ClPh | Br |
| t-Bu | 3-Me | H | 2-ClPh | Cl |
| Me | 3-Me | H | 2-ClPh | SCHF₂ |
| propargyl | 3-Me | H | 2-BrPh | CF₃ |
| i-Pr | 3-Me | 5-CN | 2-MePh | CF₃ |
| t-Bu | 3-Me | H | 2-CNPh | CF₃ |
| Me | 3-Me | H | 2-FPh | CF₃ |
| Et | 3-Me | H | 2,6-F₂Ph | CF₃ |
| i-Pr | 3-Me | 5-Br | 2,4-F₂Ph | CF₃ |
| t-Bu | 3-Me | H | 2,5-F₂Ph | CF₃ |
| Me | 3-Me | 5-I | 2-MeOPh | CF₃ |
| Et | 3-Me | H | 3-Cl-2-pyridyl | CF₃ |
| i-Pr | 3-Me | 5-Me | 3-Cl-2-pyridyl | OCF₃ |
| t-Bu | 3-Me | H | 3-Cl-2-pyridyl | Br |
| propargyl | 3-Me | H | 3-Cl-2-pyridyl | Cl |
| Et | 3-Me | 5-Br | 3-Cl-2-pyridyl | SCHF₂ |
| i-Pr | 3-Me | H | 3-F-2-pyridyl | CF₃ |
| t-Bu | 3-Me | H | 3-CF₃-2-pyridyl | CF₃ |
| Me | 3-Me | H | 3-Me-2-pyridyl | CF₃ |
| Et | 3-Me | H | 2-Br-2-pyridyl | CF₃ |
| i-Pr | 3-Me | 5-Cl | 3-Br-2-pyridyl | OCF₃ |
| t-Bu | 3-Me | H | 3-Br-2-pyridyl | Br |
| i-Pr | 3-Me | H | 2-Br-2-pyridyl | Cl |
| Me | 6-Me | H | H | CF₃ |
| Et | 6-Me | 4-Me | H | OCF₃ |
| i-Pr | 6-Me | H | H | OCF₃ |
| t-Bu | 6-Me | Cl | Me | Br |
| Me | 6-Me | H | Et | Br |
| Et | 6-Me | H | Me | Cl |
| i-Pr | 6-Me | 4-Br | Et | Cl |
| t-Bu | 6-Me | H | Me | I |
| propargyl | 6-Me | H | Me | CF₃ |
| cyclopropyl | 6-Me | H | Me | OCF₃ |
| i-Pr | 6-Me | 4-Cl | Me | CF₃ |
| t-Bu | 6-Me | H | Me | SCF₃ |
| Me | 6-Me | H | Me | SCHF₂ |
| Et | 6-Me | H | Me | OCHF₂ |
| i-Pr | 6-Me | 4-CN | Me | CF₃ |
| t-Bu | 6-Me | H | Me | C₂F₅ |
| propargyl | 6-Me | H | Me | C₂F₅ |
| cyclopropyl | 6-Me | H | Et | CF₃ |
| i-Pr | 6-Me | H | n-Pr | CF₃ |
| t-Bu | 6-Me | 4-Br | i-Pr | CF₃ |
| Me | 6-Me | H | Cl | CF₃ |
| Et | 6-Me | H | F | CF₃ |
| i-Pr | 6-Me | H | Me | SMe |
| t-Bu | 6-Me | 4-Cl | Me | OMe |
| Me | 6-Me | H | Me | OEt |
| Et | 6-Me | H | Me | n-C₃F₇ |
| i-Pr | 6-Me | H | Me | i-C₃F₇ |
| t-Bu | 6-Me | 4-F | Me | Et |
| propargyl | 6-Me | H | Me | OCF₂CHF₂ |
| Et | 6-Me | H | Me | SCF₂CHF₂ |
| i-Pr | 6-Me | H | Me | SO₂Me |
| t-Bu | 6-Me | 4-Cl | Me | SO₂CF₃ |
| Me | 6-Me | H | CF₃ | CF₃ |
| Et | 6-Me | H | CF₃ | Me |
| i-Pr | 6-Me | H | OMe | CF₃ |
| t-Bu | 6-Me | H | H | CF₃ |
| cyclopropyl | 6-Me | 4-Br | H | OCHF₂ |
| Et | 6-Me | H | H | C₂F₅ |
| i-Pr | 6-Me | H | H | C₂F₅ |
| t-Bu | 6-Me | 4-Me | H | OCF₃ |
| Me | 6-Me | H | H | OCF₂CHF₂ |
| Et | 6-Me | H | H | SCF₂CHF₂ |
| i-Pr | 6-Me | 4-Cl | H | n-C₃F₇ |
| t-Bu | 6-Me | H | H | i-C₃F₇ |
| propargyl | 6-Me | H | H | Br |
| Et | 6-Me | H | H | Cl |
| i-Pr | 6-Me | H | H | SCF₃ |
| t-Bu | 6-Me | 4-Br | Ph | CF₃ |
| cyclopropyl | 6-Me | H | Ph | Cl |
| Et | 6-Me | H | Ph | Br |
| i-Pr | 6-Me | H | 2-pyridyl | CF₃ |
| t-Bu | 6-Me | H | 2-pyridyl | Cl |
| Me | 6-Me | H | 2-ClPh | CF₃ |
| Et | 6-Me | 4-Cl | 2-ClPh | OCF₃ |
| i-Pr | 6-Me | H | 2-ClPh | Br |
| t-Bu | 6-Me | 4-CN | 2-ClPh | Cl |
| Me | 6-Me | H | 2-ClPh | SCHF₂ |
| propargyl | 6-Me | H | 2-BrPh | CF₃ |
| i-Pr | 6-Me | H | 2-MePh | CF₃ |
| t-Bu | 6-Me | H | 2-CNPh | CF₃ |
| Me | 6-Me | H | 2-FPh | CF₃ |
| Et | 6-Me | H | 2,6-F₂Ph | CF₃ |
| i-Pr | 6-Me | 4-Br | 2,4-F₂Ph | CF₃ |
| t-Bu | 6-Me | H | 2,6-F₂Ph | CF₃ |
| Me | 6-Me | 4-I | 2-MeOPh | CF₃ |
| Et | 6-Me | H | 3-Cl-2-pyridyl | CF₃ |
| i-Pr | 6-Me | H | 3-Cl-2-pyridyl | OCF₃ |
| t-Bu | 6-Me | H | 3-Cl-2-pyridyl | Br |
| propargyl | 6-Me | H | 3-Cl-2-pyridyl | Cl |
| Et | 6-Me | 4-Br | 3-Cl-2-pyridyl | SCHF₂ |
| i-Pr | 6-Me | H | 3-F-2-pyridyl | CF₃ |
| t-Bu | 6-Me | H | 3-CF₃-2-pyridyl | CF₃ |
| Me | 6-Me | H | 3-Me-2-pyridyl | CF₃ |
| Et | 6-Me | H | 3-Br-2-pyridyl | CF₃ |
| i-Pr | 6-Me | 4-Cl | 3-Br-2-pyridyl | OCF₃ |
| t-Bu | 6-Me | H | 3-Br-2-pyridyl | Br |
| i-Pr | 6-Me | H | 3-Br-2-pyridyl | Cl |
| Me | 3-Cl | H | H | CF₃ |
| Et | 3-Br | 5-Me | H | OCF₃ |
| i-Pr | 3-Cl | H | H | OCF₃ |
| t-Bu | 3-Cl | 5-Cl | Me | Br |
| Me | 3-Cl | H | Et | Br |
| Et | 3-Cl | H | Me | Cl |
| i-Pr | 3-Cl | 5-Br | Et | Cl |
| t-Bu | 3-Cl | H | Me | I |
| propargyl | 3-Cl | H | Me | CF₃ |
| cyclopropyl | 3-Cl | H | Me | OCF₃ |
| i-Pr | 3-Cl | 5-Cl | Me | CF₃ |
| t-Bu | 3-Cl | H | Me | SCF₃ |
| Me | 3-F | H | Me | SCHF₂ |
| Et | 3-Cl | H | Me | OCHF₂ |
| i-Pr | 3-Cl | 5-CN | Me | CF₃ |
| t-Bu | 3-Cl | H | Me | C₂F₅ |
| propargyl | 3-Cl | H | Me | C₂F₅ |
| cyclopropyl | 3-Cl | H | Et | CF₃ |
| i-Pr | 3-Cl | H | n-Pr | CF₃ |
| t-Bu | 3-Cl | 5-Br | i-Pr | CF₃ |
| Me | 3-Cl | H | Cl | CF₃ |
| Et | 3-Br | H | F | CF₃ |
| i-Pr | 3-Cl | H | Me | SMe |
| t-Bu | 3-Cl | 5-Cl | Me | OMe |
| Me | 3-Cl | H | Me | OEt |
| Et | 3-Cl | H | Me | n-C₃F₇ |
| i-Pr | 3-Cl | H | Me | i-C₃F₇ |
| t-Bu | 3-Cl | 5-F | Me | Et |
| propargyl | 3-Cl | H | Me | OCF₂CHF₂ |
| Et | 3-Cl | H | Me | SCF₂CHF₂ |
| i-Pr | 3-Br | H | Me | SO₂Me |
| t-Bu | 3-Cl | 5-Cl | Me | SO₂CF₃ |
| Me | 3-Cl | H | CF₃ | CF₃ |
| Et | 3-CN | H | CF₃ | Me |
| i-Pr | 3-Cl | H | OMe | CF₃ |
| t-Bu | 3-Cl | H | H | CF₃ |
| cyclopropyl | 3-Cl | 5-Br | H | OCHF₂ |
| Et | 3-Cl | H | H | C₂F₅ |
| i-Pr | 3-Cl | H | H | C₂F₅ |
| t-Bu | 3-Cl | H | H | OCF₃ |
| Me | 3-F | H | H | OCF₂CHF₂ |
| Et | 3-Cl | H | H | SCF₂CHF₂ |
| i-Pr | 3-Cl | 5-Cl | H | n-C₃F₇ |
| t-Bu | 3-Cl | H | H | i-C₃F₇ |
| propargyl | 3-Cl | H | H | Br |
| Et | 3-Cl | H | H | Cl |
| i-Pr | 3-Cl | H | H | SCF₃ |
| t-Bu | 3-Cl | 5-Br | Ph | CF₃ |
| cyclopropyl | 3-Cl | H | Ph | Cl |
| Et | 3-Cl | H | Ph | Br |
| i-Pr | 3-Br | H | 2-pyridyl | CF₃ |
| t-Bu | 3-Cl | H | 2-pyridyl | Cl |
| Me | 3-Cl | H | 2-ClPh | CF₃ |
| Et | 3-Cl | 5-Cl | 2-ClPh | OCF₃ |
| i-Pr | 3-Cl | H | 2-ClPh | Br |
| t-Bu | 3-I | H | 2-ClPh | Cl |
| Me | 3-Cl | 5-Me | 2-ClPh | SCHF₂ |
| propargyl | 3-Cl | H | 2-BrPh | CF₃ |
| i-Pr | 3-Cl | H | 2-MePh | CF₃ |
| t-Bu | 3-Cl | 5-CN | 2-CNPh | CF₃ |
| Me | 3-Cl | H | 2-FPh | CF₃ |
| Et | 3-Cl | H | 2,6-F₂Ph | CF₃ |
| i-Pr | 3-Cl | 5-Br | 2,4-F₂Ph | CF₃ |
| t-Bu | 3-F | H | 2,6-F₂Ph | CF₃ |
| Me | 3-Cl | 5-I | 2-MeOPh | CF₃ |
| Et | 3-Cl | H | 3-Cl-2-pyriodyl | CF₃ |
| i-Pr | 3-CN | H | 3-Cl-2-pyridyl | OCF₃ |
| t-Bu | 3-Cl | H | 3-Cl-2-pyridyl | Br |
| propargyl | 3-Cl | H | 3-Cl-2-pyridyl | Cl |
| Et | 3-Cl | 5-Br | 3-Cl-2-pyridyl | SCHF₂ |
| i-Pr | 3-Cl | H | 3-F-2-pyridyl | CF₃ |
| t-Bu | 3-Br | H | 3-CF₃-2-pyridyl | CF₃ |
| Me | 3-Cl | H | 3-Me-2-pyridyl | CF₃ |
| Et | 3-Cl | H | 3-Br-2-pyridyl | CF₃ |
| i-Pr | 3-Cl | 5-Cl | 3-Br-2-pyridyl | OCF₃ |
| t-Bu | 3-Cl | H | 3-Br-2-pyridyl | Br |
| i-Pr | 3-Cl | H | 3-Br-2-pyridyl | Cl |
| Me | 6-Cl | H | H | CF₃ |
| Et | 6-Br | 4-Me | H | OCF₃ |
| i-Pr | 6-Cl | H | H | OCF₃ |
| t-Bu | 6-Cl | Cl | Me | Br |
| Me | 6-Cl | H | Et | Br |
| Et | 6-Cl | H | Me | Cl |
| i-Pr | 6-F | 4-Br | Et | Cl |
| t-Bu | 6-Cl | H | Me | I |
| propargyl | 6-Cl | H | Me | CF₃ |
| cyclopropyl | 6-Cl | H | Me | OCF₃ |
| i-Pr | 6-Cl | 4-Cl | Me | CF₃ |
| t-Bu | 6-Cl | H | Me | SCF₃ |
| Me | 6-Cl | H | Me | SCHF₂ |
| Et | 6-Cl | H | Me | OCHF₂ |
| i-Pr | 6-I | 4-CN | Me | CF₃ |
| t-Bu | 6-Cl | H | Me | C₂F₅ |
| propargyl | 6-Cl | H | Me | C₂F₅ |
| cyclopropyl | 6-Cl | H | Et | CF₃ |
| i-Pr | 6-Cl | H | n-Pr | CF₃ |
| t-Bu | 6-Cl | 4-Br | i-Pr | CF₃ |
| Me | 6-Cl | H | Cl | CF₃ |
| Et | 6-F | H | F | CF₃ |
| i-Pr | 6-Cl | H | Me | SMe |
| t-Bu | 6-Cl | 4-Cl | Me | OMe |
| Me | 6-Cl | H | Me | OEt |
| Et | 6-I | H | Me | n-C₃F₇ |
| i-Pr | 6-Cl | H | Me | i-C₃F₇ |
| t-Bu | 6-Cl | 4-F | Me | Et |
| propargyl | 6-Cl | H | Me | OCF₂CHF₂ |
| Et | 6-Cl | H | Me | SCF₂CHF₂ |
| i-Pr | 6-Cl | H | Me | SO₂Me |
| t-Bu | 6-Cl | 4-Cl | Me | SO₂CF₃ |
| Me | 6-Cl | H | CF₃ | CF₃ |
| Et | 6-Cl | H | CF₃ | Me |
| i-Pr | 6-Cl | H | OMe | CF₃ |
| t-Bu | 6-Br | H | H | CF₃ |
| cyclopropyl | 6-Cl | 4-Br | H | OCHF₂ |
| Et | 6-Cl | H | H | C₂F₅ |
| i-Pr | 6-Cl | H | H | C₂F₅ |
| t-Bu | 6-F | 4-Me | H | OCF₃ |
| Me | 6-Cl | H | H | OCF₂CHF₂ |
| Et | 6-Cl | H | H | SCF₂CHF₂ |
| i-Pr | 6-CN | 4-Cl | H | n-C₃F₇ |
| t-Bu | 6-Cl | H | H | i-C₃F₇ |
| propargyl | 6-Cl | H | H | Br |
| Et | 6-Cl | H | H | Cl |
| i-Pr | 6-Cl | H | H | SCF₃ |
| t-Bu | 6-Cl | 4-Br | Ph | CF₃ |
| cycloprooyl | 6-Cl | H | Ph | Cl |
| Et | 6-F | H | Ph | Br |
| i-Pr | 6-Cl | H | 2-pyridyl | CF₃ |
| t-Bu | 6-Cl | H | 2-pyridyl | Cl |
| Me | 6-Cl | H | 2-ClPh | CF₃ |
| Et | 6-Br | 4-Cl | 2-ClPh | OCF₃ |
| i-Pr | 6-Cl | H | 2-ClPh | Br |
| t-Bu | 6-Cl | H | 2-ClPh | Cl |
| Me | 6-Cl | H | 2-ClPh | SCHF₂ |
| propargyl | 6-Cl | H | 2-BrPh | CF₃ |
| i-Pr | 6-Br | H | 2-MePh | CF₃ |
| t-Bu | 6-Cl | 4-CN | 2-CNPh | CF₃ |
| Me | 6-Cl | H | 2-FPh | CF₃ |
| Et | 6-Cl | H | 2,6-F₂Ph | CF₃ |
| i-Pr | 6-Cl | 4-Br | 2,4-F₂Ph | CF₃ |
| t-Bu | 6-CN | H | 2,6-F₂Ph | CF₃ |
| Me | 6-Cl | 4-I | 2-MeOPh | CF₃ |
| Et | 6-Cl | H | 3-Cl-2-pyridyl | CF₃ |
| i-Pr | 6-Br | H | 3-Cl-2-pyridyl | OCF₃ |
| t-Bu | 6-Cl | H | 3-Cl-2-pyridyl | Br |
| propargyl | 6-Cl | H | 3-Cl-2-pyridyl | Cl |
| Et | 6-Cl | 4-Br | 3-Cl-2-pyridyl | SCHF₂ |
| i-Pr | 6-Cl | H | 3-F-2-pyridyl | CF₃ |
| t-Bu | 6-Cl | H | 3-CF₃-2-pyridyl | CF₃ |
| Me | 6-Cl | H | 3-Me-2-pyridyl | CF₃ |
| Et | 6-Cl | H | 3-Br-2-pyridyl | CF₃ |
| i-Pr | 6-Cl | 4-Cl | 3-Br-2-pyridyl | OCF₃ |
| t-Bu | 6-Cl | H | 3-Br-2-pyridyl | Br |
| i-Pr | 6-Cl | H | 3-Br-2-pyridyl | Cl |

TABLE 8

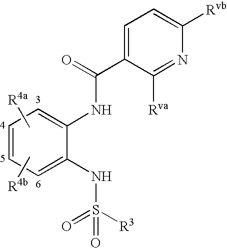

| R³ | R^{4a} | R^{4b} | R^{va} | R^{vb} |
|---|---|---|---|---|
| Me | 3-Me | H | H | CF₃ |
| Et | 3-Me | 5-Me | H | OCF₃ |
| i-Pr | 3-Me | H | H | OCF₃ |
| t-Bu | 3-Me | 5-Cl | Me | Br |
| Me | 3-Me | H | Et | Br |
| Et | 3-Me | H | Me | Cl |
| i-Pr | 3-Me | 5-Br | Et | Cl |
| t-Bu | 3-Me | H | Me | I |
| propargyl | 3-Me | H | Me | CF₃ |
| cyclopropyl | 3-Me | H | Me | OCF₃ |
| i-Pr | 3-Me | 5-Cl | Me | CF₃ |
| t-Bu | 3-Me | H | Me | SCF₃ |
| Me | 3-Me | 5-CN | Me | SCHF₂ |
| Et | 3-Me | H | Me | OCHF₂ |
| i-Pr | 3-Me | H | Me | CF₃ |
| t-Bu | 3-Me | H | Me | C₂F₅ |
| propargyl | 3-Me | H | Me | C₂F₅ |
| cyclopropyl | 3-Me | H | Et | CF₃ |
| i-Pr | 3-Me | H | n-Pr | CF₃ |
| t-Bu | 3-Me | 5-Br | i-Pr | CF₃ |
| Me | 3-Me | H | Cl | CF₃ |
| Et | 3-Me | H | F | CF₃ |
| i-Pr | 3-Me | H | Me | SMe |
| t-Bu | 3-Me | 5-Cl | Me | OMe |
| Me | 3-Me | H | Me | OEt |
| Et | 3-Me | H | Me | n-C₃F₇ |
| i-Pr | 3-Me | H | Me | i-C₃F₇ |
| t-Bu | 3-Me | 5-F | Me | Et |
| propargyl | 3-Me | H | Me | OCF₂CHF₂ |
| Et | 3-Me | H | Me | SCF₂CHF₂ |
| i-Pr | 3-Me | H | Me | SO₂Me |
| t-Bu | 3-Me | 5-Cl | Me | SO₂CF₃ |
| Me | 3-Me | H | CF₃ | CF₃ |
| Et | 3-Me | H | CF₃ | Me |
| i-Pr | 3-Me | H | OMe | CF₃ |
| t-Bu | 3-Me | H | H | CF₃ |
| cyclopropyl | 3-Me | 5-Br | H | OCHF₂ |
| Et | 3-Me | H | H | C₂F₅ |
| i-Pr | 3-Me | 5-Me | H | C₂F₅ |
| t-Bu | 3-Me | H | H | OCF₃ |
| Me | 3-Me | H | H | OCF₂CHF₂ |
| Et | 3-Me | H | H | SCF₂CHF₂ |
| i-Pr | 3-Me | 5-Cl | H | n-C₃F₇ |
| t-Bu | 3-Me | H | H | i-C₃F₇ |
| propargyl | 3-Me | H | H | Br |
| Et | 3-Me | H | H | Cl |
| i-Pr | 3-Me | H | H | SCF₃ |
| t-Bu | 3-Me | 5-Br | Ph | CF₃ |
| cyclopropyl | 3-Me | H | Ph | Cl |
| Et | 3-Me | H | Ph | Br |
| i-Pr | 3-Me | H | 2-pyridyl | CF₃ |
| t-Bu | 3-Me | H | 2-pyridyl | Cl |
| Me | 3-Me | H | 2-ClPh | CF₃ |
| Et | 3-Me | 5-Cl | 2-ClPh | OCF₃ |
| i-Pr | 3-Me | H | 2-ClPh | Br |
| t-Bu | 3-Me | H | 2-ClPh | Cl |
| Me | 3-Me | H | 2-ClPh | SCHF₂ |
| propargyl | 3-Me | H | 2-BrPh | CF₃ |
| i-Pr | 3-Me | 5-CN | 2-MePh | CF₃ |
| t-Bu | 3-Me | H | 2-CNPh | CF₃ |
| Me | 3-Me | H | 2-FPh | CF₃ |
| Et | 3-Me | H | 2,6-F₂Ph | CF₃ |
| i-Pr | 3-Me | 5-Br | 2,4-F₂Ph | CF₃ |
| t-Bu | 3-Me | H | 2,6-F₂Ph | CF₃ |
| Me | 3-Me | 5-I | 3-MeOPh | CF₃ |
| Et | 3-Me | H | 3-Cl-2-pyridyl | CF₃ |
| i-Pr | 3-Me | 5-Me | 3-Cl-2-pyridyl | OCF₃ |
| t-Bu | 3-Me | H | 3-Cl-2-pyridyl | Br |
| propargyl | 3-Me | H | 3-Cl-2-pyridyl | Cl |
| Et | 3-Me | 5-Br | 3-Cl-2-pyridyl | SCHF₂ |
| i-Pr | 3-Me | H | 3-F-2-pyridyl | CF₃ |
| t-Bu | 3-Me | H | 3-CF₃-2-pyridyl | CF₃ |
| Me | 3-Me | H | 3-Me-2-pyridyl | CF₃ |
| Et | 3-Me | H | 3-Br-2-pyridyl | CF₃ |
| i-Pr | 3-Me | 5-Cl | 3-Br-2-pyridyl | OCF₃ |
| t-Bu | 3-Me | H | 3-Br-2-pyridyl | Br |
| i-Pr | 3-Me | H | 3-Br-2-pyridyl | Cl |
| Me | 6-Me | H | H | CF₃ |
| Et | 6-Me | 4-Me | H | OCF₃ |
| i-Pr | 6-Me | H | H | OCF₃ |
| t-Bu | 6-Me | Cl | Me | Br |
| Me | 6-Me | H | Et | Br |
| Et | 6-Me | H | Me | Cl |
| i-Pr | 6-Me | 4-Br | Et | Cl |
| t-Bu | 6-Me | H | Me | I |
| propargyl | 6-Me | H | Me | CF₃ |
| cyclopropyl | 6-Me | H | Me | OCF₃ |
| i-Pr | 6-Me | 4-Cl | Me | CF₃ |
| t-Bu | 6-Me | H | Me | SCF₃ |
| Me | 6-Me | H | Me | SCHF₂ |
| Et | 6-Me | H | Me | OCHF₂ |
| i-Pr | 6-Me | 4-CN | Me | CF₃ |
| t-Bu | 6-Me | H | Me | C₂F₅ |
| propargyl | 6-Me | H | Me | C₂F₅ |
| cyclopropyl | 6-Me | H | Et | CF₃ |
| i-Pr | 67-Me | H | n-Pr | CF₃ |
| t-Bu | 6-Me | 4-Br | i-Pr | CF₃ |
| Me | 6-Me | H | Cl | CF₃ |
| Et | 6-Me | H | F | CF₃ |
| i-Pr | 6-Me | H | Me | SMe |
| t-Bu | 6-Me | 4-Cl | Me | OMe |
| Me | 6-Me | H | Me | OEt |
| Et | 6-Me | H | Me | n-C₃F₇ |
| i-Pr | 6-Me | H | Me | i-C₃F₇ |
| t-Bu | 6-Me | 4-F | Me | Et |
| propargyl | 6-Me | H | Me | OCF₂CHF₂ |
| Et | 6-Me | H | Me | SCF₂CHF₂ |
| i-Pr | 6-Me | H | Me | SO₂Me |
| t-Bu | 6-Me | 4-Cl | Me | SO₂CF₃ |
| Me | 6-Me | H | CF₃ | CF₃ |
| Et | 6-Me | H | CF₃ | Me |
| i-Pr | 6-Me | H | OMe | CF₃ |
| t-Bu | 6-Me | H | H | CF₃ |
| cyclopropyl | 6-Me | 4-Br | H | OCHF₂ |
| Et | 6-Me | H | H | C₂F₅ |
| i-Pr | 6-Me | H | H | C₂F₅ |
| t-Bu | 6-Me | 4-Me | H | OCF₃ |
| Me | 6-Me | H | H | OCF₂CHF₂ |
| Et | 6-Me | H | H | SCF₂CHF₂ |
| i-Pr | 6-Me | 4-Cl | H | n-C₃F₇ |
| t-Bu | 6-Me | H | H | i-C₃F₇ |
| propargyl | 6-Me | H | H | Br |
| Et | 6-Me | H | H | Cl |
| i-Pr | 6-Me | H | H | SCF₃ |
| t-Bu | 6-Me | 4-Br | Ph | CF₃ |
| cyclopropyl | 6-Me | H | Ph | Cl |
| Et | 6-Me | H | Ph | Br |
| i-Pr | 6-Me | H | 2-pyridyl | CF₃ |
| t-Bu | 6-Me | H | 2-pyridyl | Cl |
| Me | 6-Me | H | 2-ClPh | CF₃ |
| Et | 6-Me | 4-Cl | 2-ClPh | OCF₃ |
| i-Pr | 6-Me | H | 2-ClPh | Br |
| t-Bu | 6-Me | 4-CN | 2-ClPh | Cl |
| Me | 6-Me | H | 2-ClPh | SCHF₂ |
| propargyl | 6-Me | H | 2-BrPh | CF₃ |
| i-Pr | 6-Me | H | 2-MePh | CF₃ |
| t-Bu | 6-Me | H | 2-CNPh | CF₃ |
| Me | 6-Me | H | 2-FPh | CF₃ |
| Et | 6-Me | H | 2,6-F₂Ph | CF₃ |
| i-Pr | 6-Me | 4-Br | 2,4-F₂Ph | CF₃ |
| t-Bu | 6-Me | H | 2,6-F₂Ph | CF₃ |
| Me | 6-Me | 4-I | 2-MeOPh | CF₃ |
| Et | 6-Me | H | 3-Cl-2-pyridyl | CF₃ |
| i-Pr | 6-Me | H | 3-Cl-2-pyridyl | OCF₃ |
| t-Bu | 6-Me | H | 3-Cl-2-pyridyl | Br |
| propargyl | 6-Me | H | 3-Cl-2-pyridyl | Cl |
| Et | 6-Me | 4-Br | 3-Cl-2-pyridyl | SCHF₂ |
| i-Pr | 6-Me | H | 3-F-2-pyridyl | CF₃ |
| t-Bu | 6-Me | H | 3-CF₃-2-pyridyl | CF₃ |
| Me | 6-Me | H | 3-Me-2-pyridyl | CF₃ |
| Et | 6-Me | H | 3-Br-2-pyridyl | CF₃ |
| i-Pr | 6-Me | 4-Cl | 3-Br-2-pyridyl | OCF₃ |
| t-Bu | 6-Me | H | 3-Br-2-pyridyl | Br |
| i-Pr | 6-Me | H | 3-Br-2-pyridyl | Cl |
| Me | 3-Cl | H | H | CF₃ |
| Et | 3-Br | 5-Me | H | OCF₃ |
| i-Pr | 3-Cl | H | H | OCF₃ |
| t-Bu | 3-Cl | 5-Cl | Me | Br |
| Me | 3-Cl | H | Et | Br |
| Et | 3-Cl | H | Me | Cl |
| i-Pr | 3-Cl | 5-Br | Et | Cl |
| t-Bu | 3-Cl | H | Me | I |
| propargyl | 3-Cl | H | Me | CF₃ |
| cyclopropyl | 3-Cl | H | Me | OCF₃ |
| i-Pr | 3-Cl | 5-Cl | Me | CF₃ |
| t-Bu | 3-Cl | H | Me | SCF₃ |
| Me | 3-F | H | Me | SCHF₂ |
| Et | 3-Cl | H | Me | OCHF₂ |
| i-Pr | 3-Cl | 5-CN | Me | CF₃ |
| t-Bu | 3-Cl | H | Me | C₂F₅ |
| propargyl | 3-Cl | H | Me | C₂F₅ |
| cyclopropyl | 3-Cl | H | Et | CF₃ |
| i-Pr | 3-Cl | H | n-Pr | CF₃ |
| t-Bu | 3-Cl | 5-Br | i-Pr | CF₃ |
| Me | 3-Cl | H | Cl | CF₃ |
| Et | 3-Br | H | F | CF₃ |
| i-Pr | 3-Cl | H | Me | SMe |
| t-Bu | 3-Cl | 5-Cl | Me | OMe |
| Me | 3-Cl | H | Me | OEt |
| Et | 3-Cl | H | Me | n-C₃F₇ |
| i-Pr | 3-Cl | H | Me | i-C₃F₇ |
| t-Bu | 3-Cl | 5-F | Me | Et |
| propargyl | 3-Cl | H | Me | OCF₂CHF₂ |
| Et | 3-Cl | H | Me | SCF₂CHF₂ |
| i-Pr | 3-Br | H | Me | SO₂Me |
| t-Bu | 3-Cl | 5-Cl | Me | SO₂CF₃ |
| Me | 3-Cl | H | CF₃ | CF₃ |
| Et | 3-CN | H | CF₃ | Me |
| i-Pr | 3-Cl | H | OMe | CF₃ |
| t-Bu | 3-Cl | H | H | CF₃ |
| cyclopropyl | 3-Cl | 5-Br | H | OCHF₂ |
| Et | 3-Cl | H | H | C₂F₅ |
| i-Pr | 3-Cl | H | H | C₂F₅ |
| t-Bu | 3-Cl | H | H | OCF₃ |
| Me | 3-F | H | H | OCF₂CHF₂ |
| Et | 3-Cl | H | H | SCF₂CHF₂ |
| i-Pr | 3-Cl | 5-Cl | H | n-C₃F₇ |
| t-Bu | 3-Cl | H | H | i-C₃F₇ |
| propargyl | 3-Cl | H | H | Br |
| Et | 3-Cl | H | H | Cl |
| i-Pr | 3-Cl | H | H | SCF₃ |
| t-Bu | 3-Cl | 5-Br | Ph | CF₃ |
| cyclopropyl | 3-Cl | H | Ph | Cl |
| Et | 3-Cl | H | Ph | Br |
| i-Pr | 3-Br | H | 2-pyridyl | CF₃ |
| t-Bu | 3-Cl | H | 2-pyridyl | Cl |
| Me | 3-Cl | H | 2-ClPh | CF₃ |
| Et | 3-Cl | 5-Cl | 2-ClPh | OCF₃ |
| i-Pr | 3-Cl | H | 2-ClPh | Br |
| t-Bu | 3-I | H | 2-ClPh | Cl |
| Me | 3-Cl | 5-Me | 2-ClPh | SCHF₂ |
| propargyl | 3-Cl | H | 2-BrPh | CF₃ |
| i-Pr | 3-Cl | H | 2-MePh | CF₃ |
| t-Bu | 3-Cl | 5-CN | 2-CNPh | CF₃ |
| Me | 3-Cl | H | 2-FPh | CF₃ |
| Et | 3-Cl | H | 2,6-F₂Ph | CF₃ |
| i-Pr | 3-Cl | 5-Br | 2,4-F₂Ph | CF₃ |
| t-Bu | 3-F | H | 2,6-F₂Ph | CF₃ |
| Me | 3-Cl | 5-I | 2-MeOPh | CF₃ |
| Et | 3-Cl | H | 3-Cl-2-pyridyl | CF₃ |
| i-Pr | 3-CN | H | 2-Cl-2-pyridyl | OCF₃ |
| t-Bu | 3-Cl | H | 3-Cl-2-pyridyl | Br |
| propargyl | 3-Cl | H | 3-Cl-2-pyridyl | Cl |
| Et | 3-Cl | 5-Br | 3-Cl-2-pyridyl | SCHF₂ |
| i-Pr | 3-Cl | H | 3-F-2-pyridyl | CF₃ |
| t-Bu | 3-Br | H | 3-CF₃-2-pyridy; | CF₃ |
| Me | 3-Cl | H | 3-Me-2-pyridyl | CF₃ |
| Et | 3-Cl | H | 3-Br-2-pyridyl | CF₃ |
| i-Pr | 3-Cl | 5-Cl | 3-Br-2-pyridyl | OCF₃ |
| t-Bu | 3-Cl | H | 3-Br-2-pyridyl | Br |
| i-Pr | 3-Cl | H | 3-Br-2-pyridyl | Cl |
| Me | 6-Cl | H | H | CF₃ |
| Et | 6-Br | 4-Me | H | OCF₃ |
| i-Pr | 6-Cl | H | H | OCF₃ |
| t-Bu | 6-Cl | Cl | Me | Br |
| Me | 6-Cl | H | Et | Br |
| Et | 6-Cl | H | Me | Cl |
| i-Pr | 6-F | 4-Br | Et | Cl |
| t-Bu | 6-Cl | H | Me | I |
| propargyl | 6-Cl | H | Me | CF₃ |
| cyclopropyl | 6-Cl | H | Me | OCF₃ |
| i-Pr | 6-Cl | 4-Cl | Me | CF₃ |
| t-Bu | 6-Cl | H | Me | SCF₃ |
| Me | 6-Cl | H | Me | SCHF₂ |
| Et | 6-Cl | H | Me | OCHF₂ |
| i-Pr | 6-I | 4-CN | Me | CF₃ |
| t-Bu | 6-Cl | H | Me | C₂F₅ |
| propargyl | 6-Cl | H | Me | C₂F₅ |
| cyclopropyl | 6-Cl | H | Et | CF₃ |
| i-Pr | 6-Cl | H | n-Pr | CF₃ |
| t-Bu | 6-Cl | 4-Br | i-Pr | CF₃ |
| Me | 6-Cl | H | Cl | CF₃ |
| Et | 6-F | H | F | CF₃ |
| i-Pr | 6-Cl | H | Me | SMe |
| t-Bu | 6-Cl | 4-Cl | Me | OMe |
| Me | 6-Cl | H | Me | OEt |
| Et | 6-I | H | Me | n-C₃F₇ |
| i-Pr | 6-Cl | H | Me | i-C₃F₇ |
| t-Bu | 6-Cl | 4-F | Me | Et |
| propargyl | 6-Cl | H | Me | OCF₂CHF₂ |
| Et | 6-Cl | H | Me | SCF₂CHF₂ |
| i-Pr | 6-Cl | H | Me | SO₂Me |
| t-Bu | 6-Cl | 4-Cl | Me | SO₂CF₃ |
| Me | 6-Cl | H | CF₃ | CF₃ |
| Et | 6-Cl | H | CF₃ | Me |
| i-Pr | 6-Cl | H | OMe | CF₃ |
| t-Bu | 6-Br | H | H | CF₃ |
| cyclopropyl | 6-Cl | 4-Br | H | OCHF₂ |
| Et | 6-Cl | H | H | C₂F₅ |
| i-Pr | 6-Cl | H | H | C₂F₅ |
| t-Bu | 6-F | 4-Me | H | OCF₃ |
| Me | 6-Cl | H | H | OCF₂CHF₂ |
| Et | 6-Cl | H | H | SCF₂CHF₂ |
| i-Pr | 6-CN | 4-Cl | H | n-C₃F₇ |
| t-Bu | 6-Cl | H | H | i-C₃F₇ |
| propargyl | 6-Cl | H | H | Br |
| Et | 6-Cl | H | H | Cl |
| i-Pr | 6-Cl | H | H | SCF₃ |
| t-Bu | 6-Cl | 4-Br | Ph | CF₃ |
| cyclopropyl | 6-Cl | H | Ph | Cl |
| Et | 6-F | H | Ph | Br |
| i-Pr | 6-Cl | H | 2-pyridyl | CF₃ |
| t-Bui | 6-Cl | H | 2-pyridyl | Cl |
| Me | 6-Cl | H | 2-ClPh | CF₃ |
| Et | 6-Br | 4-Cl | 2-ClPh | OCF₃ |
| i-Pr | 6-Cl | H | 2-ClPh | Br |
| t-Bu | 6-Cl | H | 2-ClPh | Cl |
| Me | 6-Cl | H | 2-ClPh | SCHF₂ |
| propargyl | 6-Cl | H | 2-BrPh | CF₃ |
| i-Pr | 6-Br | H | 2-MePh | CF₃ |
| t-Bu | 6-Cl | 4-CN | 2-CNPh | CF₃ |
| Me | 6-Cl | H | 2-FPh | CF₃ |
| Et | 6-Cl | H | 2,6-F₂Ph | CF₃ |
| i-Pr | 6-Cl | 4-Br | 2,4-F₂Ph | CF₃ |
| t-Bu | 6-CN | H | 2,6-F₂Ph | CF₃ |
| Me | 6-Cl | 4-I | 2-MeOPh | CF₃ |
| Et | 6-Cl | H | 3-Cl-2-pyridyl | CF₃ |
| i-Pr | 6-Br | H | 3-Cl-2-pyridyl | OCF₃ |
| t-Bu | 6-Cl | H | 3-Cl-2-pyridyl | Br |
| propargyl | 6-Cl | H | 3-Cl-2-pyridyl | Cl |
| Et | 6-Cl | 4-Br | 3-Cl-2-pyridyl | SCHF₂ |
| i-Pr | 6-Cl | H | 3-F-2-pyridyl | CF₃ |
| t-Bu | 6-Cl | H | 3-CF₃-2-pyridyl | CF₃ |
| Me | 6-Cl | H | 3-Me-2-pyridyl | CF₃ |
| Et | 6-Cl | H | 3-Br-2-pyridyl | CF₃ |
| i-Pr | 6-Cl | 4-Cl | 3-Br-2-pyridyl | OCF₃ |
| t-Bu | 6-Cl | H | 3-Br-2-pyridyl | Br |
| i-Pr | 6-Cl | H | 3-Br-2-pyridyl | Cl |

TABLE 9

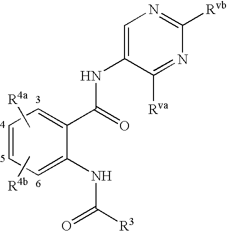

| R³ | R^{4a} | R^{4b} | R^{va} | R^{vb} |
|---|---|---|---|---|
| Me | 3-Me | H | H | CF₃ |
| Et | 3-Me | 5-Me | H | OCF₃ |
| i-Pr | 3-Me | H | H | OCF₃ |
| t-Bu | 3-Me | 5-Cl | Me | Br |
| Me | 3-Me | H | Et | Br |
| Et | 3-Me | H | Me | Cl |
| i-Pr | 3-Me | 5-Br | Et | Cl |
| t-Bu | 3-Me | H | Me | I |
| propargyl | 3-Me | H | Me | CF₃ |
| cyclopropyl | 3-Me | H | Me | OCF₃ |
| i-Pr | 3-Me | 5-Cl | Me | CF₃ |
| t-Bu | 3-Me | H | Me | SCF₃ |
| Me | 3-Me | 5-CN | Me | SCHF₂ |
| Et | 3-Me | H | Me | OCHF₂ |
| i-Pr | 3-Me | H | Me | CF₃ |
| t-Bu | 3-Me | H | Me | C₂F₅ |
| propargyl | 3-Me | H | Me | C₂F₅ |
| cyclopropyl | 3-Me | H | Et | CF₃ |
| i-Pr | 3-Me | H | n-Pr | CF₃ |
| t-Bu | 3-Me | 5-Br | i-Pr | CF₃ |
| Me | 3-Me | H | Cl | CF₃ |
| Et | 3-Me | H | F | CF₃ |
| i-Pr | 3-Me | H | Me | SMe |
| t-Bu | 3-Me | 5-Cl | Me | OMe |
| Me | 3-Me | H | Me | OEt |
| Et | 3-Me | H | Me | n-C₃F₇ |
| i-Pr | 3-Me | H | Me | i-C₃F₇ |
| t-Bu | 3-Me | 5-F | Me | Et |
| propargyl | 3-Me | H | Me | OCF₂CHF₂ |
| Et | 3-Me | H | Me | SCF₂CHF₂ |
| i-Pr | 3-Me | H | Me | SO₂Me |
| t-Bu | 3-Me | 5-Cl | Me | SO₂CF₃ |
| Me | 3-Me | H | CF₃ | CF₃ |
| Et | 3-Me | H | CF₃ | Me |
| i-Pr | 3-Me | H | OMe | CF₃ |
| t-Bu | 3-Me | H | H | CF₃ |
| cyclopropyl | 3-Me | 5-Br | H | OCHF₂ |
| Et | 3-Me | H | H | C₂F₅ |
| i-Pr | 3-Me | 5-Me | H | C₂F₅ |
| t-Bu | 3-Me | H | H | OCF₃ |
| Me | 3-Me | H | H | OCF₂CHF₂ |
| Et | 3-Me | H | H | SCF₂CHF₂ |
| i-Pr | 3-Me | 5-Cl | H | n-C₃F₇ |
| t-Bu | 3-Me | H | H | i-C₃F₇ |
| propargyl | 3-Me | H | H | Br |
| Et | 3-Me | H | H | Cl |
| i-Pr | 3-Me | H | H | SCF₃ |
| t-Bu | 3-Me | 5-Br | Ph | CF₃ |
| cyclopropyl | 3-Me | H | Ph | Cl |
| Et | 3-Me | H | Ph | Br |
| i-Pr | 3-Me | H | 2-pyridyl | CF₃ |
| t-Bu | 3-Me | H | 2-pyridyl | Cl |
| Me | 3-Me | H | 2-ClPh | CF₃ |
| Et | 3-Me | 5-Cl | 2-ClPh | OCF₃ |
| i-Pr | 3-Me | H | 2-ClPh | Br |
| t-Bu | 3-Me | H | 2-ClPh | Cl |
| Me | 3-Me | H | 2-ClPh | SCHF₂ |
| propargyl | 3-Me | H | 2-BrPh | CF₃ |
| i-Pr | 3-Me | 5-CN | 2-MePh | CF₃ |
| t-Bu | 3-Me | H | 2-CNPh | CF₃ |
| Me | 3-Me | H | 2-FPh | CF₃ |
| Et | 3-Me | H | 2,6-F₂Ph | CF₃ |
| i-Pr | 3-Me | 5-Br | 2,4-F₂Ph | CF₃ |
| t-Bu | 3-Me | H | 2,6-F₂Ph | CF₃ |
| Me | 3-Me | 5-I | 2-MeOPh | CF₃ |
| Et | 3-Me | H | 3-Cl-2-pyridyl | CF₃ |
| i-Pr | 3-Me | 5-Me | 3-Cl-2-pyridyl | OCF₃ |
| t-Bu | 3-Me | H | 3-Cl-2-pyridyl | Br |
| propargyl | 3-Me | H | 3-Cl-2-pyridyl | Cl |
| Et | 3-Me | 5-Br | 3-Cl-2-pyridyl | SCHF₂ |
| i-Pr | 3-Me | H | 3-F-2-pyridyl | CF₃ |
| t-Bu | 3-Me | H | 3-CF₃-2-pyridyl | CF₃ |
| Me | 3-Me | H | 3-Me-2-pyridyl | CF₃ |
| Et | 3-Me | H | 3-Br-2-pyridyl | CF₃ |
| i-Pr | 3-e | 5-Cl | 3-Br-2-pyridyl | OCF₃ |
| t-Bu | 3-Me | H | 3-Br-2-pyridyl | Br |
| i-Pr | 3-Me | H | 3-Br-2-pyridyl | Cl |
| Me | 6-Me | H | H | CF₃ |
| Et | 6-Me | 4-Me | H | OCF₃ |
| i-Pr | 6-Me | H | H | OCF₃ |
| t-Bu | 6-Me | Cl | Me | Br |
| Me | 6-Me | H | Et | Br |
| Et | 6-Me | H | Me | Cl |
| i-Pr | 6-Me | 4-Br | Et | Cl |
| t-Bu | 6-Me | H | Me | I |
| propargyl | 6-Me | H | Me | CF₃ |
| cyclopropyl | 6-Me | H | Me | OCF₃ |
| i-Pr | 6-Me | 4-Cl | Me | CF₃ |
| t-Bu | 6-Me | H | Me | SCF₃ |
| Me | 6-Me | H | Me | SCHF₂ |
| Et | 6-Me | H | Me | OCHF₂ |
| i-Pr | 6-Me | 4-CN | Me | CF₃ |
| t-Bu | 6-Me | H | Me | C₂F₅ |
| propargyl | 6-Me | H | Me | C₂F₅ |
| cyclopropyl | 6-Me | H | Et | CF₃ |
| i-Pr | 6-Me | H | n-Pr | CF₃ |
| t-Bu | 6-Me | 4-Br | i-Pr | CF₃ |
| Me | 6-Me | H | Cl | CF₃ |
| Et | 6-Me | H | F | CF₃ |
| i-Pr | 6-Me | H | Me | SMe |
| t-Bu | 6-Me | 4-Cl | Me | OMe |
| Me | 6-Me | H | Me | OEt |
| Et | 6-Me | H | Me | n-C₃F₇ |
| i-Pr | 6-Me | H | Me | i-C₃F₇ |
| t-Bu | 6-Me | 4-H | Me | Et |
| propargyl | 6-Me | H | Me | OCF₂CHF₂ |
| Et | 6-Me | H | Me | SCF₂CHF₂ |
| i-Pr | 6-Me | H | Me | SO₂Me |
| t-Bu | 6-Me | 4-Cl | Me | SO₂CF₃ |
| Me | 6-Me | H | CF₃ | CF₃ |
| Et | 6-Me | H | CF₃ | Me |
| i-Pr | 6-Me | H | OMe | CF₃ |
| t-Bu | 6-Me | H | H | CF₃ |
| cyclopropyl | 6-Me | 4-Br | H | OCHF₂ |
| Et | 6-Me | H | H | C₂F₅ |
| i-Pr | 6-Me | H | H | C₂F₅ |
| t-Bu | 6-Me | 4-Me | H | OCF₃ |
| Me | 6-Me | H | H | OCF₂CHF₂ |
| Et | 6-Me | H | H | SCF₂CHF₂ |
| i-Pr | 6-Me | 4-Cl | H | n-C₃H₇ |
| t-Bu | 6-Me | H | H | i-C₃F₇ |
| propargyl | 6-Me | H | H | Br |
| Et | 6-Me | H | H | Cl |
| i-Pr | 6-Me | H | H | SCF₃ |
| t-Bu | 6-Me | 4-Br | Ph | CF₃ |
| cyclopropyl | 6-Me | H | Ph | Cl |
| Et | 6-Me | H | Ph | Br |
| i-Pr | 6-Me | H | 2-pyridyl | CF₃ |
| t-Bu | 6-Me | H | 2-pyridyl | Cl |
| Me | 6-Me | H | 2-ClPh | CF₃ |
| Et | 6-Me | 4-Cl | 2-ClPh | OCF₃ |
| i-Pr | 6-Me | H | 2-ClPh | Br |
| t-Bu | 6-Me | 4-CN | 2-ClPh | Cl |
| Me | 6-Me | H | 2-ClPh | SCHF₂ |
| propargyl | 6-Me | H | 2-BrPh | CF₃ |
| i-Pr | 6-Me | H | 2-MePh | CF₃ |
| t-Bu | 6-Me | H | 2-CNPh | CF₃ |
| Me | 6-Me | H | 2-FPh | CF₃ |
| Et | 6-Me | H | 2,6-F₂Ph | CF₃ |
| i-Pr | 6-Me | 4-Br | 2,4-F₂Ph | CF₃ |
| t-Bu | 6-Me | H | 2,6-F₂Ph | CF₃ |
| Me | 6-Me | 4-I | 2-MeOPh | CF₃ |
| Et | 6-Me | H | 3-Cl-2-pyridyl | CF₃ |
| i-Pr | 6-Me | H | 3-Cl-2-pyridyl | OCF₃ |
| t-Bu | 6-Me | H | 3-Cl-2-pyridyl | Br |
| propargyl | 6-Me | H | 3-Cl-2-pyridyl | Cl |
| Et | 6-Me | 4-Br | 3-Cl-2-pyridyl | SCHF₂ |
| i-Pr | 6-Me | H | 3-F-2-pyridyl | CF₃ |
| t-Bu | 6-Me | H | 3-CF₃-2-pyridyl | CF₃ |
| Me | 6-Me | H | 3-Me-2-pyridyl | CF₃ |
| Et | 6-Me | H | 3-Br-2-pyridyl | CF₃ |
| i-Pr | 6-Me | 4-Cl | 3-Br-2-pyridyl | OCF₃ |
| t-Bu | 6-Me | H | 3-Br-2-pyridyl | Br |
| i-Pr | 6-Me | H | 3-Br-2-pyridyl | Cl |
| Me | 3-Cl | H | H | CF₃ |
| Et | 3-Br | 5-Me | H | OCF₃ |
| i-Pr | 3-Cl | H | H | OCF₃ |
| t-Bu | 3-Cl | 5-Cl | Me | Br |
| Me | 3-Cl | H | Et | Br |
| Et | 3-Cl | H | Me | Cl |
| i-Pr | 3-Cl | 5-Br | Et | Cl |
| t-Bu | 3-Cl | H | Me | I |
| propargyl | 3-Cl | H | Me | CF₃ |
| cyclopropyl | 3-Cl | H | Me | OCF₃ |
| i-Pr | 3-Cl | 5-Cl | Me | CF₃ |
| t-Bu | 3-Cl | H | Me | SCF₃ |
| Me | 3-F | H | Me | SCHF₂ |
| Et | 3-Cl | H | Me | OCHF₂ |
| i-Pr | 3-Cl | 5-CN | Me | CF₃ |
| t-Bu | 3-Cl | H | Me | C₂F₅ |
| propargyl | 3-Cl | H | Me | C₂F₅ |
| cyclopropyl | 3-Cl | H | Et | CF₃ |
| i-Pr | 3-Cl | H | n-Pr | CF₃ |
| t-Bu | 3-Cl | 5-Br | i-Pr | CF₃ |
| Me | 3-Cl | H | Cl | CF₃ |
| Et | 3-Br | H | F | CF₃ |
| i-Pr | 3-Cl | H | Me | SMe |
| t-Bu | 3-Cl | 5-Cl | Me | OMe |
| Me | 3-Cl | H | Me | OEt |
| Et | 3-Cl | H | Me | n-C₃F₇ |
| i-Pr | 3-Cl | H | Me | i-C₃F₇ |
| t-Bu | 3-Cl | 5-F | Me | Et |
| propargyl | 3-Cl | H | Me | OCF₂CHF₂ |
| Et | 3-Cl | H | Me | SCF₂CHF₂ |
| i-Pr | 3-Br | H | Me | SO₂Me |
| t-Bu | 3-Cl | 5-Cl | Me | SO₂CF₃ |
| Me | 3-Cl | H | CF₃ | CF₃ |
| Et | 3-CN | H | CF₃ | Me |
| i-Pr | 3-Cl | H | OMe | CF₃ |
| t-Bu | 3-Cl | H | H | CF₃ |
| cyclopropyl | 3-Cl | 5-Br | H | OCHF₂ |
| Et | 3-Cl | H | H | C₂F₅ |
| i-Pr | 3-Cl | H | H | C₂F₅ |
| t-Bu | 3-Cl | H | H | OCF₃ |
| Me | 3-F | H | H | OCF₂CHF₂ |
| Et | 3-Cl | H | H | SCF₂CHF₂ |
| i-Pr | 3-Cl | 5-Cl | H | n-C₃F₇ |
| t-Bu | 3-Cl | H | H | i-C₃F₇ |
| propargyl | 3-Cl | H | H | Br |
| Et | 3-Cl | H | H | Cl |
| i-Pr | 3-Cl | H | H | SCF₃ |
| t-Bu | 3-Cl | 5-Br | Ph | CF₃ |
| cyclopropyl | 3-Cl | H | Ph | Cl |
| Et | 3-Cl | H | Ph | Br |
| i-Pr | 3-Br | H | 2-pyridyl | CF₃ |
| t-Bu | 3-Cl | H | 2-pyridyl | Cl |
| Me | 3-Cl | H | 2-ClPh | CF₃ |
| Et | 3-Cl | 5-Cl | 2-ClPh | OCF₃ |
| i-Pr | 3-Cl | H | 2-ClPh | Br |
| t-Bu | 3-I | H | 2-ClPh | Cl |
| Me | 3-Cl | 5-Me | 2-ClPh | SCHF₂ |
| propargyl | 3-Cl | H | 2-BrPh | CF₃ |
| i-Pr | 3-Cl | H | 2-MePh | CF₃ |
| t-Bu | 3-Cl | 5-CN | 2-CNPh | CF₃ |
| Me | 3-Cl | H | 2-FPh | CF₃ |
| Et | 3-Cl | H | 2,6-F₂Ph | CF₃ |
| i-Pr | 3-Cl | 5-Br | 2,4-F₂Ph | CF₃ |
| t-Bu | 3-F | H | 2,5-F₂Ph | CF₃ |
| Me | 3-Cl | 5-I | 2-MeOPh | CF₃ |
| Et | 3-Cl | H | 3-Cl-2-pyridyl | CF₃ |
| i-Pr | 3-CN | H | 3-Cl-2-pyridyl | OCF₃ |
| t-Bu | 3-Cl | H | 3-Cl-2-pyridyl | Br |
| propargyl | 3-Cl | H | 3-Cl-2-pyridyl | Cl |
| Et | 3-Cl | 5-Br | 3-Cl-2-pyridyl | SCHF₂ |
| i-Pr | 3-Cl | H | 3-F-2-pyridyl | CF₃ |
| t-Bu | 3-Br | H | 3-CF₃-2-pyridyl | CF₃ |
| Me | 3-Cl | H | 3-Me-2-pyridyl | CF₃ |
| Et | 3-Cl | H | 3-Br-2-pyridyl | CF₃ |
| i-Pr | 3-Cl | 5-Cl | 3-Br-2-pyridyl | OCF₃ |
| t-Bu | 3-Cl | H | 3-Br-2-pyridyl | Br |
| i-Pr | 3-Cl | H | 3-Br-2-pyridyl | Cl |
| Me | 6-Cl | H | H | CF₃ |
| Et | 6-Br | 4-Me | H | OCF₃ |
| i-Pr | 6-Cl | H | H | OCF₃ |
| t-Bu | 6-Cl | Cl | Me | Br |
| Me | 6-Cl | H | Et | Br |
| Et | 6-Cl | H | Me | Cl |
| i-Pr | 6-F | 4-Br | Et | Cl |
| t-Bu | 6-Cl | H | Me | I |
| propargyl | 6-Cl | H | Me | CF₃ |
| cyclopropyl | 6-Cl | H | Me | OCF₃ |
| i-Pr | 6-Cl | 4-Cl | Me | CF₃ |
| t-Bu | 6-Cl | H | Me | SCF₃ |
| Me | 6-Cl | H | Me | SCHF₂ |
| Et | 6-Cl | H | Me | OCHF₂ |
| i-Pr | 6-I | 4-CN | Me | CF₃ |
| t-Bu | 6-Cl | H | Me | C₂F₅ |
| propargyl | 6-Cl | H | Me | C₂F₅ |
| cyclopropyl | 6-Cl | H | Et | CF₃ |
| i-Pr | 6-Cl | H | n-Pr | CF₃ |
| t-Bu | 6-Cl | 4-Br | i-Pr | CF₃ |
| Me | 6-Cl | H | Cl | CF₃ |
| Et | 6-F | H | F | CF₃ |
| i-Pr | 6-Cl | H | Me | SMe |
| t-Bu | 6-Cl | 4-Cl | Me | OMe |
| Me | 6-Cl | H | Me | OEt |
| Et | 6-I | H | Me | n-C₃F₇ |
| i-Pr | 6-Cl | H | Me | i-C₃F₇ |
| t-Bu | 6-Cl | 4-F | Me | Et |
| propargyl | 6-Cl | H | Me | OCF₂CHF₂ |
| Et | 6-Cl | H | Me | SCF₂CHF₂ |
| i-Pr | 6-Cl | H | Me | SO₂Me |
| t-Bu | 6-Cl | 4-Cl | Me | SO₂CF₃ |
| Me | 6-Cl | H | CF₃ | CF₃ |
| Et | 6-Cl | H | CF₃ | Me |
| i-Pr | 6-Cl | H | OMe | CF₃ |
| t-Bu | 6-Br | H | H | CF₃ |
| cyclopropyl | 6-Cl | 4-Br | H | OCHF₂ |
| Et | 6-Cl | H | H | C₂F₅ |
| i-Pr | 6-Cl | H | H | C₂F₅ |
| t-Bu | 6-F | 4-Me | H | OCF₃ |
| Me | 6-Cl | H | H | OCF₂CHF₂ |
| Et | 6-Cl | H | H | SCF₂CHF₂ |
| i-Pr | 6-CN | 4-Cl | H | n-C₃F₇ |
| t-Bu | 6-Cl | H | H | i-C₃F₇ |
| propargyl | 6-Cl | H | H | Br |
| Et | 6-Cl | H | H | Cl |
| i-Pr | 6-Cl | H | H | SCF₃ |
| t-Bu | 6-Cl | 4-Br | Ph | CF₃ |
| cyclopropyl | 6-Cl | H | Ph | Cl |
| Et | 6-F | H | Ph | Br |
| i-Pr | 6-Cl | H | 2-pyridyl | CF₃ |
| t-Bu | 6-Cl | H | 2-pyridyl | Cl |
| Me | 6-Cl | H | 2-ClPh | CF₃ |
| Et | 6-Br | 4-Cl | 2-ClPh | OCF₃ |
| i-Pr | 6-Cl | H | 2-ClPh | Br |
| t-Bu | 6-Cl | H | 2-ClPh | Cl |
| Me | 6-Cl | H | 2-ClPh | SCHF₂ |
| propargyl | 6-Cl | H | 2-BrPh | CF₃ |
| i-Pr | 6-Br | H | 2-MePh | CF₃ |
| t-Bu | 6-Cl | 4-CN | 2-CNPh | CF₃ |
| Me | 6-Cl | H | 2-FPh | CF₃ |
| Et | 6-Cl | H | 2,6-F₂Ph | CF₃ |
| i-Pr | 6-Cl | 4-Br | 2,4-F₂Ph | CF₃ |
| t-Bu | 6-CN | H | 2,6-F₂Ph | CF₃ |
| Me | 6-Cl | 4-I | 2-MeOPh | CF₃ |
| Et | 6-Cl | H | 3-Cl-2-pyridyl | CF₃ |
| i-Pr | 6-Br | H | 3-Cl-2-pyridyl | OCF₃ |
| t-Bu | 6-Cl | H | 3-Cl-2-pyridyl | Br |
| propargyl | 6-Cl | H | 3-Cl-2-pyridyl | Cl |
| Et | 6-Cl | 4-Br | 3-Cl-2-pyridyl | SCHF₂ |
| i-Pr | 6-Cl | H | 3-F-2-pyridyl | CF₃ |
| t-Bu | 6-Cl | H | 3-CF₃-2-pyridyl | CF₃ |
| Me | 6-Cl | H | 3-Me-2-pyridyl | CF₃ |
| Et | 6-Cl | H | 3-Br-2-pyridyl | CF₃ |
| i-Pr | 6-Cl | 4-Cl | 3-Br-2-pyridyl | OCF₃ |
| t-Bu | 6-Cl | H | 3-Br-2-pyridyl | Br |
| i-Pr | 6-Cl | H | 3-Br-2-pyridyl | Cl |

TABLE 10

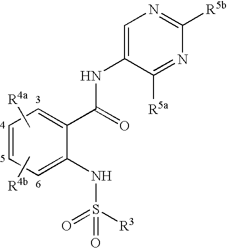

| R³ | R^{4a} | R^{4b} | R^{5a} | R^{5b} |
|---|---|---|---|---|
| Me | 3-Me | H | H | CF₃ |
| Et | 3-Me | 5-Me | H | OCF₃ |
| i-Pr | 3-Me | H | H | OCF₃ |
| t-Bu | 3-Me | 5-Cl | Me | Br |
| Me | 3-Me | H | Et | Br |
| Et | 3-Me | H | Me | Cl |
| i-Pr | 3-Me | 5-Br | H | Cl |
| t-Bu | 3-Me | H | Me | I |
| propargyl | 3-Me | H | Me | CF₃ |
| cyclopropyl | 3-Me | H | Me | OCF₃ |
| i-Pr | 3-Me | 5-Cl | Me | CF₃ |
| t-Bu | 3-Me | H | Me | SCF₃ |
| Me | 3-Me | 5-CN | Me | SCHF₂ |
| Et | 3-Me | H | Me | OCHF₂ |
| i-Pr | 3-Me | H | Me | CF₃ |
| t-Bu | 3-Me | H | Me | C₂F₅ |
| propargyl | 3-Me | H | Me | C₂F₅ |
| cyclopropyl | 3-Me | H | Et | CF₃ |
| i-Pr | 3-Me | H | n-Pr | CF₃ |
| t-Bu | 3-Me | 5-Br | i-Pr | CF₃ |
| Me | 3-Me | H | Cl | CF₃ |
| Et | 3-Me | H | F | CF₃ |
| i-Pr | 3-Me | H | Me | SMe |
| t-Bu | 3-Me | 5-Cl | Me | OMe |
| Me | 3-Me | H | Me | OEt |
| Et | 3-Me | H | Me | n-C₃F₇ |
| i-Pr | 3-Me | H | Me | i-C₃F₇ |
| t-Bu | 3-Me | 5-F | Me | Et |
| propargyl | 3-Me | H | Me | OCF₂CHF₂ |
| Et | 3-Me | H | Me | SCF₂CHF₂ |
| i-Pr | 3-Me | H | Me | SO₂Me |
| t-Bu | 3-Me | 5-Cl | Me | SO₂CF₃ |
| Me | 3-Me | H | CF₃ | CF₃ |
| Et | 3-Me | H | CF₃ | Me |
| i-Pr | 3-Me | H | OMe | CF₃ |
| t-Bu | 3-Me | H | H | CF₃ |
| cyclopropyl | 3-Me | 5-Br | H | OCHF₂ |
| Et | 3-Me | H | H | C₂F₅ |
| i-Pr | 3-Me | 5-Me | H | C₂F₅ |
| t-Bu | 3-Me | H | H | OCF₃ |
| Me | 3-Me | H | H | OCF₂CHF₂ |
| Et | 3-Me | H | H | SCF₂CHF₂ |
| i-Pr | 3-Me | 5-Cl | H | n-C₃F₇ |
| t-Bu | 3-Me | H | H | i-C₃F₇ |
| propargyl | 3-Me | H | H | Br |
| Et | 3-Me | H | H | Cl |
| i-Pr | 3-Me | H | H | SCF₃ |
| t-Bu | 3-Me | 5-Br | Ph | CF₃ |
| cyclopropyl | 3-Me | H | Ph | Cl |
| Et | 3-Me | H | Ph | Br |
| i-Pr | 3-Me | H | 2-pyridyl | CF₃ |
| t-Bu | 3-Me | H | 2-pyridyl | Cl |
| Me | 3-Me | H | 2-ClPh | CF₃ |
| Et | 3-Me | 5-Cl | 2-ClPh | OCF₃ |
| i-Pr | 3-Me | H | 2-ClPh | Br |
| t-Bu | 3-Me | H | 2-ClPh | Cl |
| Me | 3-Me | H | 2-ClPh | SCHF₂ |
| propargyl | 3-Me | H | 2-BrPh | CF₃ |
| i-Pr | 3-Me | 5-CN | 2-MePh | CF₃ |
| t-Bu | 3-Me | H | 2-CNPh | CF₃ |
| Me | 3-Me | H | 2-FPh | CF₃ |
| Et | 3-Me | H | 2,6-F₂Ph | CF₃ |
| i-Pr | 3-Me | 5-Br | 2,4-F₂Ph | CF₃ |
| t-Bu | 3-Me | H | 2,5-F₂Ph | CF₃ |
| Me | 3-Me | 5-I | 2-MeOPh | CF₃ |
| Et | 3-Me | H | 3-Cl-2-pyridyl | CF₃ |
| i-Pr | 3-Me | 5-Me | 3-Cl-2-pyridyl | OCF₃ |
| t-Bu | 3-Me | H | 3-Cl-2-pyridyl | Br |
| propargyl | 3-Me | H | 3-Cl-2-pyridyl | Cl |
| Et | 3-Me | 5-Br | 3-Cl-2-pyridyl | SCHF₂ |
| i-Pr | 3-Me | H | 3-F-2-pyridyl | CF₃ |
| t-Bu | 3-Me | H | 3-CF₃-2-pyridyl | CF₃ |
| Me | 3-Me | H | 3-Me-2-pyridyl | CF₃ |
| Et | 3-Me | H | 3-Br-2-pyridyl | CF₃ |
| i-Pr | 3-Me | 5-Cl | 3-Br-2-pyridyl | OCF₃ |
| t-Bu | 3-Me | H | 3-Br-2-pyridyl | Br |
| i-Pr | 3-Me | H | 3-Br-2-pyridyl | Cl |
| Me | 6-Me | H | H | CF₃ |
| Et | 6-Me | 4-Me | H | OCF₃ |
| i-Pr | 6-Me | H | H | OCF₃ |
| t-Bu | 6-Me | Cl | Me | Br |
| Me | 6-Me | H | Et | Br |
| Et | 6-Me | H | Me | Cl |
| i-Pr | 6-Me | 4-Br | Et | Cl |
| t-Bu | 6-Me | H | Me | I |
| propargyl | 6-Me | H | Me | CF₃ |
| cyclopropyl | 6-Me | H | Me | OCF₃ |
| i-Pr | 6-Me | 4-Cl | Me | CF₃ |
| t-Bu | 6-Me | H | Me | SCF₃ |
| Me | 6-Me | H | Me | SCHF₂ |
| Et | 6-Me | H | Me | OCHF₂ |
| i-Pr | 6-Me | 4-CN | Me | CF₃ |
| t-Bu | 6-Me | H | Me | C₂F₅ |
| propargyl | 6-Me | H | Me | C₂F₅ |
| cyclopropyl | 6-Me | H | Et | CF₃ |
| i-Pr | 6-Me | H | n-Pr | CF₃ |
| t-Bu | 6-Me | 4-Br | i-Pr | CF₃ |
| Me | 6-Me | H | Cl | CF₃ |
| Et | 6-Me | H | F | CF₃ |
| i-Pr | 6-Me | H | Me | SMe |
| t-Bu | 6-Me | 4-Cl | Me | OMe |
| Me | 6-Me | H | Me | OEt |
| Et | 6-Me | H | Me | n-C₃F₇ |
| i-Pr | 6-Me | H | Me | i-C₃F₇ |
| t-Bu | 6-Me | 4-F | Me | Et |
| propargyl | 6-Me | H | Me | OCF₂CHF₂ |
| Et | 6-Me | H | Me | SCF₂CHF₂ |
| i-Pr | 6-Me | H | Me | SO₂Me |
| t-Bu | 6-Me | 4-Cl | Me | SO₂CF₃ |
| Me | 6-Me | H | CF₃ | CF₃ |
| Et | 6-Me | H | CF₃ | Me |
| i-Pr | 6-Me | H | OMe | CF₃ |
| t-Bu | 6-Me | H | H | CF₃ |
| cyclopropyl | 6-Me | 4-Br | H | OCHF₂ |
| Et | 6-Me | H | H | C₂F₅ |
| i-Pr | 6-Me | H | H | C₂F₅ |
| t-Bu | 6-Me | 4-Me | H | OCF₃ |
| Me | 6-Me | H | H | OCF₂CHF₂ |
| Et | 6-Me | H | H | SCF₂CHF₂ |
| i-Pr | 6-Me | 4-Cl | H | n-C₃F₇ |
| t-Bu | 6-Me | H | H | i-C₃H₇ |
| propargyl | 6-Me | H | H | Br |
| Et | 6-Me | H | H | Cl |
| i-Pr | 6-Me | H | H | SCF₃ |
| t-Bu | 6-Me | 4-Br | Ph | CF₃ |
| cyclopropyl | 6-Me | H | Ph | Cl |
| Et | 6-Me | H | Ph | Br |
| i-Pr | 6-Me | H | 2-pyridyl | CF₃ |
| t-Bu | 6-Me | H | 2-pyridyl | Cl |
| Me | 6-Me | H | 2-ClPh | CF₃ |
| Et | 6-Me | 4-Cl | 2-ClPh | OCF₃ |
| i-Pr | 6-Me | H | 2-ClPh | Br |
| t-Bu | 6-Me | 4-CN | 2-ClPh | Cl |
| Me | 6-Me | H | 2-ClPh | SCHF₂ |
| propargyl | 6-Me | H | 2-BrPh | CF₃ |
| i-Pr | 6-Me | H | 2-MePh | CF₃ |
| t-Bu | 6-Me | H | 2-CNPh | CF₃ |
| Me | 6-Me | H | 2-FPh | CF₃ |
| Et | 6-Me | H | 2,6-F₂Ph | CF₃ |
| i-Pr | 6-Me | 4-Br | 2,4-F₂Ph | CF₃ |
| t-Bu | 6-Me | H | 2,6-F₂Ph | CF₃ |
| Me | 6-Me | 4-I | 2-MeOPh | CF₃ |
| Et | 6-Me | H | 3-Cl-2-pyridyl | CF₃ |
| i-Pr | 6-Me | H | 3-Cl-2-pyridyl | OCF₃ |
| t-Bu | 6-Me | H | 3-Cl-2-pyridyl | Br |
| propargyl | 6-Me | H | 3-Cl-2-pyridyl | Cl |
| Et | 6-Me | 4-Br | 3-Cl-2-pyridyl | SCHF₂ |
| i-Pr | 6-Me | H | 3-F-2-pyridyl | CF₃ |
| t-Bu | 6-Me | H | 3-CF₃-2-pyridyl | CF₃ |
| Me | 6-Me | H | 3-Me-2-pyridyl | CF₃ |
| Et | 6-Me | H | 3-Br-2-pyridyl | CF₃ |
| i-Pr | 6-Me | 4-Cl | 3-Br-2-pyridyl | OCF₃ |
| t-Bu | 6-Me | H | 3-Br-2-pyridyl | Br |
| i-Pr | 6-Me | H | 3-Br-2-pyridyl | Cl |
| Me | 3-Cl | H | H | CF₃ |
| Et | 3-Br | 5-Me | H | OCF₃ |
| i-Pr | 3-Cl | H | H | OCF₃ |
| t-Bu | 3-Cl | 5-Cl | Me | Br |
| e | 3-Cl | H | Et | Br |
| Et | 3-Cl | H | Me | Cl |
| i-Pr | 3-Cl | 5-Br | Et | Cl |
| t-Bu | 3-Cl | H | Me | I |
| propargyl | 3-Cl | H | Me | CF₃ |
| cyclopropyl | 3-Cl | H | Me | OCF₃ |
| i-Pr | 3-Cl | 5-Cl | Me | CF₃ |
| t-Bu | 3-Cl | H | Me | SCF₃ |
| Me | 3-F | H | Me | SCHF₂ |
| Et | 3-Cl | H | Me | OCHF₂ |
| i-Pr | 3-Cl | 5-CN | Me | CF₃ |
| t-Bu | 3-Cl | H | Me | C₂F₅ |
| propargyl | 3-Cl | H | Me | C₂F₅ |
| cyclopropyl | 3-Cl | H | Et | CF₃ |
| i-Pr | 3-Cl | H | n-Pr | CF₃ |
| t-Bu | 3-Cl | 5-Br | i-Pr | CF₃ |
| me | 3-Cl | H | Cl | CF₃ |
| Et | 3-Br | H | F | CF₃ |
| i-Pr | 3-Cl | H | Me | SMe |
| t-Bu | 3-Cl | 5-Cl | Me | OMe |
| Me | 3-Cl | H | Me | OEt |
| Et | 3-Cl | H | Me | n-C₃F₇ |
| i-Pr | 3-Cl | H | Me | i-C₃F₇ |
| t-Bu | 3-Cl | 5-F | Me | Et |
| propargyl | 3-Cl | H | Me | OCF₂CHF₂ |
| Et | 3-Cl | H | Me | SCF₂CHF₂ |
| i-Pr | 3-Br | H | Me | SO₂Me |
| t-Bu | 3-Cl | 5-Cl | Me | SO₂CF₃ |
| Me | 3-Cl | H | CF₃ | CF₃ |
| Et | 3-CN | H | CF₃ | Me |
| i-Pr | 3-Cl | H | OMe | CF₃ |
| t-Bu | 3-Cl | H | H | CF₃ |
| cyclopropyl | 3-Cl | 5-Br | H | OCHF₂ |
| Et | 3-Cl | H | H | C₂F₅ |
| i-Pr | 3-Cl | H | H | C₂F₅ |
| t-Bu | 3-Cl | H | H | OCF₃ |
| Me | 3-F | H | H | OCF₂CHF₂ |
| Et | 3-Cl | H | H | SCF₂CHF₂ |
| i-Pr | 3-Cl | 5-Cl | H | n-C₃F₇ |
| t-Bu | 3-Cl | H | H | i-C₃F₇ |
| propargyl | 3-Cl | H | H | Br |
| Et | 3-Cl | H | H | Cl |
| i-Pr | 3-Cl | H | H | SCF₃ |
| t-Bu | 3-Cl | 5-Br | Ph | CF₃ |
| cyclopropyl | 3-Cl | H | Ph | Cl |
| Et | 3-Cl | H | Ph | Br |
| i-Pr | 3-Br | H | 2-pyridyl | CF₃ |
| t-Bu | 3-Cl | H | 2-pyridyl | Cl |
| Me | 3-Cl | H | 2-ClPh | CF₃ |
| Et | 3-Cl | 5-Cl | 2-ClPh | OCF₃ |
| i-Pr | 3-Cl | H | 2-ClPh | Br |
| t-Bu | 3-I | H | 2-ClPh | Cl |
| Me | 3-Cl | 5-Me | 2-ClPh | SCHF₂ |
| propargyl | 3-Cl | H | 2-BrPh | CF₃ |
| i-Pr | 3-Cl | H | 2-MePh | CF₃ |
| t-Bu | 3-Cl | 5-CN | 2-CNPh | CF₃ |
| Me | 3-Cl | H | 2-FPh | CF₃ |
| Et | 3-Cl | H | 2,6-F₂Ph | CF₃ |
| i-Pr | 3-Cl | 5-Br | 2,4-F₂Ph | CF₃ |
| t-Bu | 3-F | H | 2,5-F₂Ph | CF₃ |
| Me | 3-Cl | 5-I | 2-MeOPh | CF₃ |
| Et | 3-Cl | H | 3-Cl-2-pyridyl | CF₃ |
| i-Pr | 3-CN | H | 3-Cl-2-pyridyl | OCF₃ |
| t-Bu | 3-Cl | H | 3-Cl-2-pyridyl | Br |
| propargyl | 3-Cl | H | 3-Cl-2-pyridyl | Cl |
| Et | 3-Cl | 5-Br | 3-Cl-2-pyridyl | SCHF₂ |
| i-Pr | 3-Cl | H | 3-F-2-pyridyl | CF₃ |
| t-Bu | 3-Br | H | 3-CF₃-2-pyridyl | CF₃ |
| Me | 3-Cl | H | 3-Me-2-pyridyl | CF₃ |
| Et | 3-Cl | H | 3-Br-2-pyridyl | CF₃ |
| i-Pr | 3-Cl | 5-Cl | 3-Br-2-pyridyl | OCF₃ |
| t-Bu | 3-Cl | H | 3-Br-2-pyridyl | Br |
| i-Pr | 3-Cl | H | 3-Br-2-pyridyl | Cl |
| Me | 6-Cl | H | H | CF₃ |
| Et | 6-Br | 4-Me | H | OCF₃ |
| i-Pr | 6-Cl | H | H | OCF₃ |
| t-Bu | 6-Cl | Cl | Me | Br |
| Me | 6-Cl | H | Et | Br |
| Et | 6-Cl | H | Me | Cl |
| i-Pr | 6-F | 4-Br | Et | Cl |
| t-Bu | 6-Cl | H | Me | I |
| propargyl | 6-Cl | H | Me | CF₃ |
| cyclopropyl | 6-Cl | H | Me | OCF₃ |
| i-Pr | 6-Cl | 4-Cl | Me | CF₃ |
| t-Bu | 6-Cl | H | Me | SCF₃ |
| Me | 6-Cl | H | Me | SCHF₂ |
| Et | 6-Cl | H | Me | OCHF₂ |
| i-Pr | 6-I | 4-CN | Me | CF₃ |
| t-Bu | 6-Cl | H | Me | C₂F₅ |
| propargyl | 6-Cl | H | Me | C₂F₅ |
| cyclopropyl | 6-Cl | H | Et | CF₃ |
| i-Pr | 6-Cl | H | n-Pr | CF₃ |
| t-Bu | 6-Cl | 4-Br | i-Pr | CF₃ |
| Me | 6-Cl | H | Cl | CF₃ |
| Et | 6-F | H | F | CF₃ |
| i-Pr | 6-Cl | H | Me | SMe |
| t-Bu | 6-Cl | 4-Cl | Me | OMe |
| Me | 6-Cl | H | Me | OEt |
| Et | 6-I | H | Me | n-C₃F₇ |
| i-Pr | 6-Cl | H | Me | i-C₃F₇ |
| t-Bu | 6-Cl | 4-F | Me | Et |
| propargyl | 6-Cl | H | Me | OCF₂CHF₂ |
| Et | 6-Cl | H | Me | SCF₂CHF₂ |
| i-Pr | 6-Cl | H | Me | SO₂Me |
| t-Bu | 6-Cl | 4-Cl | Me | SO₂CF₃ |
| Me | 6-Cl | H | CF₃ | CF₃ |
| Et | 6-Cl | H | CF₃ | Me |
| i-Pr | 6-Cl | H | OMe | CF₃ |
| t-Bu | 6-Br | H | H | CF₃ |
| cyclopropyl | 6-Cl | 4-Br | H | OCHF₂ |
| Et | 6-Cl | H | H | C₂₅ |
| i-Pr | 6-Cl | H | H | C₂F₅ |
| t-Bu | 6-F | 4-Me | H | OCF₃ |
| Me | 6-Cl | H | H | OCF₂CHF₂ |
| Et | 6-Cl | H | H | SCF₂CHF₂ |
| i-Pr | 6-CN | 4-Cl | H | n-C₃F₇ |
| t-Bu | 6-Cl | H | H | i-C₃F₇ |
| propargyl | 6-Cl | H | H | Br |
| Et | 6-Cl | H | H | Cl |
| i-Pr | 6-Cl | H | H | SCF₃ |
| t-Bu | 6-Cl | 4-Br | Ph | CF₃ |
| cyclopropyl | 6-Cl | H | Ph | Cl |
| Et | 6-F | H | Ph | Br |
| i-Pr | 6-Cl | H | 2-pyridyl | CF₃ |
| t-Bu | 6-Cl | H | 2-pyridyl | Cl |
| Me | 6-Cl | H | 2-ClPh | CF₃ |
| Et | 6-Br | 4-Cl | 2-ClPh | OCF₃ |
| i-Pr | 6-Cl | H | 2-ClPh | Br |
| t-Bu | 6-Cl | H | 2-ClPh | Cl |
| Me | 6-Cl | H | 2-ClPh | SCHF₂ |
| propargyl | 6-Cl | H | 2-BrPh | CF₃ |
| i-Pr | 6-Br | H | 2-MePh | CF₃ |
| t-Bu | 6-Cl | 4-CN | 2-CNPh | CF₃ |
| Me | 6-Cl | H | 2-FPh | CF₃ |
| Et | 6-Cl | H | 2,6-F₂Ph | CF₃ |
| i-Pr | 6-Cl | 4-Br | 2,4-F₂Ph | CF₃ |
| t-Bu | 6-CN | H | 2,6-F₂Ph | CF₃ |
| Me | 6-Cl | 4-I | 2-MeOPh | CF₃ |
| Et | 6-Cl | H | 3-Cl-2-pyridyl | CF₃ |
| i-Pr | 6-Br | H | 3-Cl-2-pyridyl | OCF₃ |
| t-Bu | 6-Cl | H | 3-Cl-2-pyridyl | Br |
| propargyl | 6-Cl | H | 3-Cl-2-pyridyl | Cl |
| Et | 6-Cl | 4-Br | 3-Cl-2-pyridyl | SCHF₂ |
| i-Pr | 6-Cl | H | 3-F-2-pyridyl | CF₃ |
| t-Bu | 6-Cl | H | 3-CF₃-2-pyridyl | CF₃ |
| Me | 6-Cl | H | 3-Me-2-pyridyl | CF₃ |
| Et | 6-Cl | H | 3-Br-2-pyridyl | CF₃ |
| i-Pr | 6-Cl | 4-Cl | 3-Br-2-pyridyl | OCF₃ |
| t-Bu | 6-Cl | H | 3-Br-2-pyridyl | Br |
| i-Pr | 6-Cl | H | 3-Br-2-pyridyl | Cl |

TABLE 11

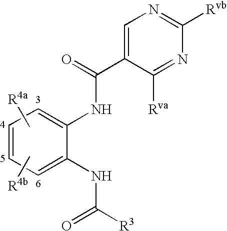

| R³ | R^{4a} | R^{4b} | R^{va} | R^{vb} |
|---|---|---|---|---|
| Me | 3-Me | H | H | CF₃ |
| Et | 3-Me | 5-Me | H | OCF₃ |
| i-Pr | 3-Me | H | H | OCF₃ |
| t-Bu | 3-Me | 5-Cl | Me | Br |
| Me | 3-Me | H | Et | Br |
| Et | 3-Me | H | Me | Cl |
| i-Pr | 3-Me | 5-Br | Et | Cl |
| t-Bu | 3-Me | H | Me | I |
| propargyl | 3-Me | H | Me | CF₃ |
| cyclopropyl | 3-Me | H | Me | OCF₃ |
| i-Pr | 3-Me | 5-Cl | Me | CF₃ |
| t-Bu | 3-Me | H | Me | SCF₃ |
| Me | 3-Me | 5-CN | Me | SCHF₂ |
| Et | 3-Me | H | Me | OCHF₂ |
| i-Pr | 3-Me | H | Me | CF₃ |
| t-Bu | 3-Me | H | Me | C₂F₅ |
| propargyl | 3-Me | H | Me | C₂F₅ |
| cyclopropyl | 3-Me | H | Et | CF₃ |
| i-Pr | 3-Me | H | n-Pr | CF₃ |
| t-Bu | 3-Me | 5-Br | i-Pr | CF₃ |
| Me | 3-Me | H | Cl | CF₃ |
| Et | 3-Me | H | F | CF₃ |
| i-Pr | 3-Me | H | Me | SMe |
| t-Bu | 3-Me | 5-Cl | Me | OMe |
| Me | 3-Me | H | Me | OEt |
| Et | 3-Me | H | Me | n-C₃F₇ |
| i-Pr | 3-Me | H | Me | i-C₃F₇ |
| t-Bu | 3-Me | 5-F | Me | Et |
| propargyl | 3-Me | H | Me | OCF₂CHF₂ |
| Et | 3-Me | H | Me | SCF₂CHF₂ |
| i-Pr | 3-Me | H | Me | SO₂Me |
| t-Bu | 3-Me | 5-Cl | Me | SO₂CF₃ |
| Me | 3-Me | H | CF₃ | CF₃ |
| Et | 3-Me | H | CF₃ | Me |
| i-Pr | 3-Me | H | OMe | CF₃ |
| t-Bu | 3-Me | H | H | CF₃ |
| cyclopropyl | 3-Me | 5-Br | H | OCHF₂ |
| Et | 3-Me | H | H | C₂F₅ |
| i-Pr | 3-Me | 5-Me | H | C₂F₅ |
| t-Bu | 3-Me | H | H | OCF₃ |
| Me | 3-Me | H | H | OCF₂CHF₂ |
| Et | 3-Me | H | H | SCF₂CHF₂ |
| i-Pr | 3-Me | 5-Cl | H | n-C₃F₇ |
| t-Bu | 3-Me | H | H | i-C₃F₇ |
| propargyl | 3-Me | H | H | Br |
| Et | 3-Me | H | H | Cl |
| i-Pr | 3-Me | H | H | SCF₃ |
| t-Bu | 3-Me | 5-Br | Ph | CF₃ |
| cyclopropyl | 3-Me | H | Ph | Cl |
| Et | 3-Me | H | Ph | Br |
| i-Pr | 3-Me | H | 2-pyridyl | CF₃ |
| t-Bu | 3-Me | H | 2-pyridyl | Cl |
| Me | 3-Me | H | 2-ClPh | CF₃ |
| Et | 3-Me | 5-Cl | 2-ClPh | OCF₃ |
| i-Pr | 3-Me | H | 2-ClPh | Br |
| t-Bu | 3-Me | H | 2-ClPh | Cl |
| Me | 3-Me | H | 2-ClPh | SCHF₂ |
| propargyl | 3-Me | H | 2-BrPh | CF₃ |
| i-Pr | 3-Me | 5-CN | 2-MePh | CF₃ |
| t-Bu | 3-Me | H | 2-CNPh | CF₃ |
| Me | 3-Me | H | 2-FPh | CF₃ |
| Et | 3-Me | H | 2,6-F₂Ph | CF₃ |
| i-Pr | 3-Me | 5-Br | 2,4-F₂Ph | CF₃ |
| t-Bu | 3-Me | H | 2,5-F₂Ph | CF₃ |
| Me | 3-Me | 5-I | 2-MeOPh | CF₃ |
| Et | 3-Me | H | 3-Cl-2-pyridyl | CF₃ |
| i-Pr | 3-Me | 5-Me | 3-Cl-2-pyridyl | OCF₃ |
| t-Bu | 3-Me | H | 3-Cl-2-pyridyl | Br |
| propargyl | 3-Me | H | 3-Cl-2-pyridyl | Cl |
| Et | 3-Me | 5-Br | 3-Cl-2-pyridyl | SCHF₂ |
| i-Pr | 3-Me | H | 3-F-2-pyridyl | CF₃ |
| t-Bu | 3-Me | H | 3-CF₃-2-pyridyl | CF₃ |
| Me | 3-Me | H | 3-Me-2-pyridyl | CF₃ |
| Et | 3-Me | H | 3-Br-2-pyridyl | CF₃ |
| i-Pr | 3-Me | 5-Cl | 3-Br-2-pyridyl | OCF₃ |
| t-Bu | 3-Me | H | 3-Br-2-pyridyl | Br |
| i-Pr | 3-Me | H | 3-Br-2-pyridyl | Cl |
| Me | 6-Me | H | H | CF₃ |
| Et | 6-Me | 4-Me | H | OCF₃ |
| i-Pr | 6-Me | H | H | OCF₃ |
| t-Bu | 6-Me | Cl | Me | Br |
| Me | 6-Me | H | Et | Br |
| Et | 6-Me | H | Me | Cl |
| i-Pr | 6-Me | 4-Br | Et | Cl |
| t-Bu | 6-Me | H | Me | I |
| propargyl | 6-Me | H | Me | CF₃ |
| cyclopropyl | 6-Me | H | Me | OCF₃ |
| i-Pr | 6-Me | 4-Cl | Me | CF₃ |
| t-Bu | 6-Me | H | Me | SCF₃ |
| Me | 6-Me | H | Me | SCHF₂ |
| Et | 6-Me | H | Me | OCHF₂ |
| i-Pr | 6-Me | 4-CN | Me | CF₃ |
| t-Bu | 6-Me | H | Me | C₂F₅ |
| propargyl | 6-Me | H | Me | C₂F₅ |
| cyclopropyl | 6-Me | H | Et | CF₃ |
| i-Pr | 6-Me | H | n-Pr | CF₃ |
| t-Bu | 6-Me | 4-Br | i-Pr | CF₃ |
| Me | 6-Me | H | Cl | CF₃ |
| Et | 6-Me | H | F | CF₃ |
| i-Pr | 6-Me | H | Me | SMe |
| t-Bu | 6-Me | 4-Cl | Me | OMe |
| Me | 6-Me | H | Me | OEt |
| Et | 6-Me | H | Me | n-C₃F₇ |
| i-Pr | 6-Me | H | Me | i-C₃F₇ |
| t-Bu | 6-Me | 4-F | Me | Et |
| propargyl | 6-Me | H | Me | OCF₂CHF₂ |
| Et | 6-Me | H | Me | SCF₂CHF₂ |
| i-Pr | 6-Me | H | Me | SO₂Me |
| t-Bu | 6-Me | 4-Cl | Me | SO₂CF₃ |
| Me | 6-Me | H | CF₃ | CF₃ |
| Et | 6-Me | H | CF₃ | Me |
| i-Pr | 6-Me | H | OMe | CF₃ |
| t-Bu | 6-Me | H | H | CF₃ |
| cyclopropyl | 6-Me | 4-Br | H | OCHF₂ |
| Et | 6-Me | H | H | C₂F₅ |
| i-Pr | 6-Me | H | H | C₂F₅ |
| t-Bu | 6-Me | 4-Me | H | OCF₃ |
| Me | 6-Me | H | H | OCF₂CHF₂ |
| Et | 6-Me | H | H | SCF₂CHF₂ |
| i-Pr | 6-Me | 4-Cl | H | n-C₃F₇ |
| t-Bu | 6-Me | H | H | i-C₃F₇ |
| propargyl | 6-Me | H | H | Br |
| Et | 6-Me | H | H | Cl |
| i-Pr | 6-Me | H | H | SCF₃ |
| t-Bu | 6-Me | 4-Br | Ph | CF₃ |
| cyclopropyl | 6-Me | H | Ph | Cl |
| Et | 6-Me | H | Ph | Br |
| i-Pr | 6-Me | H | 2-pyridyl | CF₃ |
| t-Bu | 6-Me | H | 2-pyridyl | Cl |
| Me | 6-Me | H | 2-ClPh | CF₃ |
| Et | 6-Me | 4-Cl | 2-ClPh | OCF₃ |
| i-Pr | 6-Me | H | 2-ClPh | Br |
| t-Bu | 6-Me | 4-CN | 2-ClPh | Cl |
| Me | 6-Me | H | 2-ClPh | SCHF₂ |
| propargyl | 6-Me | H | 2-BrPh | CF₃ |
| i-Pr | 6-Me | H | 2-MePh | CF₃ |
| t-Bu | 6-Me | H | 2-CNPh | CF₃ |
| Me | 6-Me | H | 2-FPh | CF₃ |
| Et | 6-Me | H | 2,6-F₂Ph | CF₃ |
| i-Pr | 6-Me | 4-Br | 2,4-F₂Ph | CF₃ |
| t-Bu | 6-Me | H | 2,6-F₂Ph | CF₃ |
| Me | 6-Me | 4-I | 2-MeOPh | CF₃ |
| Et | 6-Me | H | 3-Cl-2-pyridyl | CF₃ |
| i-Pr | 6-Me | H | 3-Cl-2-pyridyl | OCF₃ |
| t-Bu | 6-Me | H | 3-Cl-2-pyridyl | Br |
| propargyl | 6-Me | H | 3-Cl-2-pyridyl | Cl |
| Et | 6-Me | 4-Br | 3-Cl-2-pyridyl | SCHF₂ |
| i-Pr | 6-Me | H | 3-F-2-pyridyl | CF₃ |
| t-Bu | 6-Me | H | 3-CF₃-2-pyridyl | CF₃ |
| Me | 6-Me | H | 3-Me-2-pyridyl | CF₃ |
| Et | 6-Me | H | 3-Br-2-pyridyl | CF₃ |
| i-Pr | 6-Me | 4-Cl | 3-Br-2-pyridyl | OCF₃ |
| t-Bu | 6-Me | H | 3-Br-2-pyridyl | Br |
| i-Pr | 6-Me | H | 3-Br-2-pyridyl | Cl |
| Me | 3-Cl | H | H | CF₃ |
| Et | 3-Br | 5-Me | H | OCF₃ |
| i-Pr | 3-Cl | H | H | OCF₃ |
| t-Bu | 3-Cl | 5-Cl | Me | Br |
| Me | 3-Cl | H | Et | Br |
| Et | 3-Cl | H | Me | Cl |
| i-Pr | 3-Cl | 5-Br | Et | Cl |
| t-Bu | 3-Cl | H | Me | I |
| propargyl | 3-Cl | H | Me | CF₃ |
| cyclopropyl | 3-Cl | H | Me | OCF₃ |
| i-Pr | 3-Cl | 5-Cl | Me | CF₃ |
| t-Bu | 3-Cl | H | Me | SCF₃ |
| Me | 3-F | H | Me | SCHF₂ |
| Et | 3-Cl | H | Me | OCHF₂ |
| i-Pr | 3-Cl | 5-CN | Me | CF₃ |
| t-Bu | 3-Cl | H | Me | C₂F₅ |
| propargyl | 3-Cl | H | Me | C₂F₅ |
| cyclopropyl | 3-Cl | H | Et | CF₃ |
| i-Pr | 3-Cl | H | n-Pr | CF₃ |
| t-Bu | 3-Cl | 5-Br | i-Pr | CF₃ |
| Me | 3-Cl | H | Cl | CF₃ |
| Et | 3-Br | H | F | CF₃ |
| i-Pr | 3-Cl | H | Me | SMe |
| t-Bu | 3-Cl | 5-Cl | Me | OMe |
| Me | 3-Cl | H | Me | OEt |
| Et | 3-Cl | H | Me | n-C₃F₇ |
| i-Pr | 3-Cl | H | Me | i-C₃F₇ |
| t-Bu | 3-Cl | 5-F | Me | Et |
| propargyl | 3-Cl | H | Me | OCF₂CHF₂ |
| Et | 3-Cl | H | Me | SCF₂CHF₂ |
| i-Pr | 3-Br | H | Me | SO₂Me |
| t-Bu | 3-Cl | 5-Cl | Me | SO₂CF₃ |
| Me | 3-Cl | H | CF₃ | CF₃ |
| Et | 3-CN | H | CF₃ | Me |
| i-Pr | 3-Cl | H | OMe | CF₃ |
| t-Bu | 3-Cl | H | H | CF₃ |
| cyclopropyl | 3-Cl | 5-Br | H | OCHF₂ |
| Et | 3-Cl | H | H | C₂F₅ |
| i-Pr | 3-Cl | H | H | C₂F₅ |
| t-Bu | 3-Cl | H | H | OCF₃ |
| Me | 3-F | H | H | OCF₂CHF₂ |
| Et | 3-Cl | H | H | SCF₂CHF₂ |
| i-Pr | 3-Cl | 5-Cl | H | n-C₃H₇ |
| t-Bu | 3-Cl | H | H | i-C₃F₇ |
| propargyl | 3-Cl | H | H | Br |
| Et | 3-Cl | H | H | Cl |
| i-Pr | 3-Cl | H | H | SCF₃ |
| t-Bu | 3-Cl | 5-Br | Ph | CF₃ |
| cyclopropyl | 3-Cl | H | Ph | Cl |
| Et | 3-Cl | H | Ph | Br |
| i-Pr | 3-Br | H | 2-pyridyl | CF₃ |
| t-Bu | 3-Cl | H | 2-pyridyl | Cl |
| Me | 3-Cl | H | 2-ClPh | CF₃ |
| Et | 3-Cl | 5-Cl | 2-ClPh | OCF₃ |
| i-Pr | 3-Cl | H | 2-ClPh | Br |
| t-Bu | 3-I | H | 2-ClPh | Cl |
| Me | 3-Cl | 5-Me | 2-ClPh | SCHF₂ |
| propargyl | 3-Cl | H | 2-BrPh | CF₃ |
| i-Pr | 3-Cl | H | 2-MePh | CF₃ |
| t-Bu | 3-Cl | 5-CN | 2-CNPh | CF₃ |
| Me | 3-Cl | H | 2-FPh | CF₃ |
| Et | 3-Cl | H | 2,6-F₂Ph | CF₃ |
| i-Pr | 3-Cl | 5-Br | 2,4-F₂Ph | CF₃ |
| t-Bu | 3-F | H | 2,6-F₂Ph | CF₃ |
| Me | 3-Cl | 5-I | 2-MeOPh | CF₃ |
| Et | 3-Cl | H | 3-Cl-2-pyridyl | CF₃ |
| i-Pr | 3-CN | H | 3-Cl-2-pyridyl | OCF₃ |
| t-Bu | 3-Cl | H | 3-Cl-2-pyridyl | Br |
| propargyl | 3-Cl | H | 3-Cl-2-pyridyl | Cl |
| Et | 3-Cl | 5-Br | 3-Cl-2-pyridyl | SCHF₂ |
| i-Pr | 3-Cl | H | 3-F-2-pyridyl | CF₃ |
| t-Bu | 3-Br | H | 3-CF₃-2-pyridyl | CF₃ |
| Me | 3-Cl | H | 3-Me-2-pyridyl | CF₃ |
| Et | 3-Cl | H | 3-Br-2-pyridyl | CF₃ |
| i-Pr | 3-Cl | 5-Cl | 3-Br-2-pyridyl | OCF₃ |
| t-Bu | 3-Cl | H | 3-Br-2-pyridyl | Br |
| i-Pr | 3-Cl | H | 3-Br-2-pyridyl | Cl |
| Me | 6-Cl | H | H | CF₃ |
| Et | 6-Br | 4-Me | H | OCF₃ |
| i-Pr | 6-Cl | H | H | OCF₃ |
| t-Bu | 6-Cl | Cl | Me | Br |
| Me | 6-Cl | H | Et | Br |
| Et | 6-Cl | H | Me | Cl |
| i-Pr | 6-F | 4-Br | Et | Cl |
| t-Bu | 6-Cl | H | Me | I |
| propargyl | 6-Cl | H | Me | CF₃ |
| cyclopropyl | 6-Cl | H | Me | OCF₃ |
| i-Pr | 6-Cl | 4-Cl | Me | CF₃ |
| t-Bu | 6-Cl | H | Me | SCF₃ |
| Me | 6-Cl | H | Me | SCHF₂ |
| Et | 6-Cl | H | Me | OCHF₂ |
| i-Pr | 6-I | 4-CN | Me | CF₃ |
| t-Bu | 6-Cl | H | Me | C₂F₅ |
| propargyl | 6-Cl | H | Me | C₂F₅ |
| cyclopropyl | 6-Cl | H | Et | CF₃ |
| i-Pr | 6-Cl | H | n-Pr | CF₃ |
| t-Bu | 6-Cl | 4-Br | i-Pr | CF₃ |
| Me | 6-Cl | H | Cl | CF₃ |
| Et | 6-F | H | F | CF₃ |
| i-Pr | 6-Cl | H | Me | SMe |
| t-Bu | 6-Cl | 4-Cl | Me | OMe |
| Me | 6-Cl | H | Me | OEt |
| Et | 6-O | H | Me | n-C₃F₇ |
| i-Pr | 6-Cl | H | Me | i-C₃F₇ |
| t-Bu | 6-Cl | 4-F | Me | Et |
| propargyl | 6-Cl | H | Me | OCF₂CHF₂ |
| Et | 6-Cl | H | Me | SCF₂CHF₂ |
| i-Pr | 6-Cl | H | Me | SO₂Me |
| t-Bu | 6-Cl | 4-Cl | Me | SO₂CF₃ |
| Me | 6-Cl | H | CF₃ | CF₃ |
| Et | 6-Cl | H | CF₃ | Me |
| i-Pr | 6-Cl | H | OMe | CF₃ |
| t-Bu | 6-Br | H | H | CF₃ |
| cyclopropyl | 6-Cl | 4-Br | H | OCHF₂ |
| Et | 6-Cl | H | H | C₂F₅ |
| i-Pr | 6-Cl | H | H | C₂F₅ |
| t-Bu | 6-F | 4-Me | H | OCF₃ |
| Me | 6-Cl | H | H | OCF₂CHF₂ |
| Et | 6-Cl | H | H | SCF₂CHF₂ |
| i-Pr | 6-CN | 4-Cl | H | n-C₃F₈ |
| t-Bu | 6-Cl | H | H | i-C₃F₇ |
| propargyl | 6-Cl | H | H | Br |
| Et | 6-Cl | H | H | Cl |
| i-Pr | 6-Cl | H | H | SCF₃ |
| t-Bu | 6-Cl | 4-Br | Ph | CF₃ |
| cyclopropyl | 6-Cl | H | Ph | Cl |
| Et | 6-F | H | Ph | Br |
| i-Pr | 6-Cl | H | 2-pyridyl | CF₃ |
| t-Bu | 6-Cl | H | 2-pyridyl | Cl |
| Me | 6-Cl | H | 2-ClPh | CF₃ |
| Et | 6-Br | 4-Cl | 2-ClPh | OCF₃ |
| i-Pr | 6-Cl | H | 2-ClPh | Br |
| t-Bu | 6-Cl | H | 2-ClPh | Cl |
| Me | 6-Cl | H | 2-ClPh | SCHF₂ |
| propargyl | 6-Cl | H | 2-BrPh | CF₃ |
| i-Pr | 6-Br | H | 2-MePh | CF₃ |
| t-Bu | 6-Cl | 4-CN | 2-CNPh | CF₃ |
| Me | 6-Cl | H | 2-FPh | CF₃ |
| Et | 6-Cl | H | 2,6-F₂Ph | CF₃ |
| i-Pr | 6-Cl | 4-Br | 2,4-F₂Ph | CF₃ |
| t-Bu | 6-CN | H | 2,6-F₂Ph | CF₃ |
| Me | 6-Cl | 4-I | 2-MeOPh | CF₃ |
| Et | 6-Cl | H | 3-Cl-2-pyridyl | CF₃ |
| i-Pr | 6-Br | H | 3-Cl-2-pyridyl | OCF₃ |
| t-Bu | 6-Cl | H | 3-Cl-2-pyridyl | Br |
| propargyl | 6-Cl | H | 3-Cl-2-pyridyl | Cl |
| Et | 6-Cl | 4-Br | 3-Cl-2-pyridyl | SCHF₂ |
| i-Pr | 6-Cl | H | 3-F-2-pyridyl | CF₃ |
| t-Bu | 6-Cl | H | 3-CF₃-2-pyridyl | CF₃ |
| Me | 6-Cl | H | 3-Me-2-pyridyl | CF₃ |
| Et | 6-Cl | H | 3-Br-2-pyridyl | CF₃ |
| i-Pr | 6-Cl | 4-Cl | 3-Br-2-pyridyl | OCF₃ |
| t-Bu | 6-Cl | H | 3-Br-2-pyridyl | Br |
| i-Pr | 6-Cl | H | 3-Br-2-pyridyl | Cl |

TABLE 12

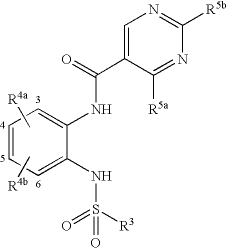

| R³ | R^{4a} | R^{4b} | R^{5a} | R^{5b} |
|---|---|---|---|---|
| Me | 3-Me | H | H | CF₃ |
| Et | 3-Me | 5-Me | H | OCF₃ |
| i-Pr | 3-Me | H | H | OCF₃ |
| t-Bu | 3-Me | 5-Cl | Me | Br |
| Me | 3-Me | H | Et | Br |
| Et | 3-Me | H | Me | Cl |
| i-Pr | 3-Me | 5-Br | Et | Cl |
| t-Bu | 3-Me | H | Me | I |
| propargyl | 3-Me | H | Me | CF₃ |
| cyclopropyl | 3-Me | H | Me | OCF₃ |
| i-Pr | 3-Me | 5-Cl | Me | CF₃ |
| t-Bu | 3-Me | H | Me | SCF₃ |
| Me | 3-Me | 5-CN | Me | SCHF₂ |
| Et | 3-Me | H | Me | OCHF₂ |
| i-Pr | 3-Me | H | Me | CF₃ |
| t-Bu | 3-Me | H | Me | C₂F₅ |
| propargyl | 3-Me | H | Me | C₂F₅ |
| cyclopropyl | 3-Me | H | Et | CF₃ |
| i-Pr | 3-Me | H | n-Pr | CF₃ |
| t-Bu | 3-Me | 5-Br | i-Pr | CF₃ |
| Me | 3-Me | H | Cl | CF₃ |
| Et | 3-Me | H | F | CF₃ |
| i-Pr | 3-Me | H | Me | SMe |
| t-Bu | 3-Me | 5-Cl | Me | OMe |
| Me | 3-Me | H | Me | OEt |
| Et | 3-Me | H | Me | n-C₃F₇ |
| i-Pr | 3-Me | H | Me | i-C₃F₇ |
| t-Bu | 3-Me | 5-F | Me | Et |
| propargyl | 3-Me | H | Me | OCF₂CHF₂ |
| Et | 3-Me | H | Me | SCF₂CHF₂ |
| i-Pr | 3-Me | H | Me | SO₂Me |
| t-Bu | 3-Me | 5-Cl | Me | SO₂CF₃ |
| Me | 3-Me | H | CF₃ | CF₃ |
| Et | 3-Me | H | CF₃ | Me |
| i-Pr | 3-Me | H | OMe | CF₃ |
| t-Bu | 3-Me | H | H | CF₃ |
| cyclopropyl | 3-Me | 5-Br | H | OCHF₂ |
| Et | 3-Me | H | H | C₂F₅ |
| i-Pr | 3-Me | 5-Me | H | C₂F₅ |
| t-Bu | 3-Me | H | H | OCF₃ |
| Me | 3-Me | H | H | OCF₂CHF₂ |
| Et | 3-Me | H | H | SCF₂CHF₂ |
| i-Pr | 3-Me | 5-Cl | H | n-C₃F₇ |
| t-Bu | 3-Me | H | H | i-C₃F₇ |
| propargyl | 3-Me | H | H | Br |
| Et | 3-Me | H | H | Cl |
| i-Pr | 3-Me | H | H | SCF₃ |
| t-Bu | 3-Me | 5-Br | Ph | CF₃ |
| cyclopropyl | 3-Me | H | Ph | Cl |
| Et | 3-Me | H | Ph | Br |
| i-Pr | 3-Me | H | 2-pyridyl | CF₃ |
| t-Bu | 3-Me | H | 2-pyridyl | Cl |
| Me | 3-Me | H | 2-ClPh | CF₃ |
| Et | 3-Me | 5-Cl | 2-ClPh | OCF₃ |
| i-Pr | 3-Me | H | 2-ClPh | Br |
| t-Bu | 3-Me | H | 2-ClPh | Cl |
| Me | 3-Me | H | 2-ClPh | SCHF₂ |
| propargyl | 3-Me | H | 2-BrPh | CF₃ |
| i-Pr | 3-Me | 5-CN | 2-MePh | CF₃ |
| t-Bu | 3-Me | H | 2-CNPh | CF₃ |
| Me | 3-Me | H | 2-FPh | CF₃ |
| Et | 3-Me | H | 2,6-F₂Ph | CF₃ |
| i-Pr | 3-Me | 5-Br | 2,4-F₂Ph | CF₃ |
| t-Bu | 3-Me | H | 2,6-F₂Ph | CF₃ |
| Me | 3-Me | 5-I | 2-MeOPh | CF₃ |
| Et | 3-Me | H | 3-Cl-2-pyridyl | CF₃ |
| i-Pr | 3-Me | 5-Me | 3-Cl-2-pyridyl | OCF₃ |
| t-Bu | 3-Me | H | 3-Cl-2-pyridyl | Br |
| propargyl | 3-Me | H | 3-Cl-2-pyridyl | Cl |
| Et | 3-Me | 5-Br | 3-Cl-2-pyridyl | SCHF₂ |
| i-Pr | 3-Me | H | 3-F-2-pyridyl | CF₃ |
| t-Bu | 3-Me | H | 3-CF₃-2-pyridyl | CF₃ |
| Me | 3-Me | H | 3-Me-2-pyridyl | CF₃ |
| Et | 3-Me | H | 3-Me-2-pyridyl | CF₃ |
| i-Pr | 3-Me | 5-Cl | 3-Br-2-pyridyl | OCF₃ |
| t-Bu | 3-Me | H | 3-Br-2-pyridyl | Br |
| i-Pr | 3-Me | H | 3-Br-2-pyridyl | Cl |
| Me | 6-Me | H | H | CF₃ |
| Et | 6-Me | 4-Me | H | OCF₃ |
| i-Pr | 6-Me | H | H | OCF₃ |
| t-Bu | 6-Me | Cl | Me | Br |
| Me | 6-Me | H | Et | Br |
| Et | 6-Me | H | Me | Cl |
| i-Pr | 6-Me | 4-Br | Et | Cl |
| t-Bu | 6-Me | H | Me | I |
| propargyl | 6-Me | H | Me | CF₃ |
| cyclopropyl | 6-Me | H | Me | OCF₃ |
| i-Pr | 6-Me | 4-Cl | Me | CF₃ |
| t-Bu | 6-Me | H | Me | SCF₃ |
| Me | 6-Me | H | Me | SCHF₂ |
| Et | 6-Me | H | Me | OCHF₂ |
| i-Pr | 6-Me | 4-CN | Me | CF₃ |
| t-Bu | 6-Me | H | Me | C₂F₅ |
| propargyl | 6-Me | H | Me | C₂F₅ |
| cyclopropyl | 6-Me | H | Et | CF₃ |
| i-Pr | 6-Me | H | n-Pr | CF₃ |
| t-Bu | 6-Me | 4-Br | i-Pr | CF₃ |
| Me | 6-Me | H | Cl | CF₃ |
| Et | 6-Me | H | F | CF₃ |
| i-Pr | 6-Me | H | Me | SMe |
| t-Bu | 6-Me | 4-Cl | Me | OMe |
| Me | 6-Me | H | Me | OEt |
| Et | 6-Me | H | Me | n-C₃F₇ |
| i-Pr | 6-Me | H | Me | i-C₃F₇ |
| t-Bu | 6-Me | 4-F | Me | Et |
| propargyl | 6-Me | H | Me | OCF₂CHF₂ |
| Et | 6-Me | H | Me | SCF₂CHF₂ |
| i-Pr | 6-Me | H | Me | SO₂Me |
| t-Bu | 6-Me | 4-Cl | Me | SO₂CF₃ |
| Me | 6-Me | H | CF₃ | CF₃ |
| Et | 6-Me | H | CF₃ | Me |
| i-Pr | 6-Me | H | OMe | CF₃ |
| t-Bu | 6-Me | H | H | CF₃ |
| cyclopropyl | 6-Me | 4-Br | H | OCHF₂ |
| Et | 6-Me | H | H | C₂F₅ |
| i-Pr | 6-Me | H | H | C₂F₅ |
| t-Bu | 6-Me | 4-Me | H | OCF₃ |
| Me | 6-Me | H | H | OCF₂CHF₂ |
| Et | 6-Me | H | H | SCF₂CHF₂ |
| i-Pr | 6-Me | 4-Cl | H | n-C₃F₇ |
| t-Bu | 6-Me | H | H | i-C₃F₇ |
| propargyl | 6-Me | H | H | Br |
| Et | 6-Me | H | H | Cl |
| i-Pr | 6-Me | H | H | SCF₃ |
| t-Bu | 6-Me | 4-Br | Ph | CF₃ |
| cyclopropyl | 6-Me | H | Ph | Cl |
| Et | 6-Me | H | Ph | Br |
| i-Pr | 6-Me | H | 2-pyridyl | CF₃ |
| t-Bu | 6-Me | H | 2-pyridyl | Cl |
| Me | 6-Me | H | 2-ClPh | CF₃ |
| Et | 6-Me | 4-Cl | 2-ClPh | OCF₃ |
| i-Pr | 6-Me | H | 2-ClPh | Br |
| t-Bu | 6-Me | 4-CN | 2-ClPh | Cl |
| Me | 6-Me | H | 2-ClPh | SCHF₂ |
| propargyl | 6-Me | H | 2-BrPh | CF₃ |
| i-Pr | 6-Me | H | 2-MePh | CF₃ |
| t-Bu | 6-Me | H | 2-CNPh | CF₃ |
| Me | 6-Me | H | 2-FPh | CF₃ |
| Et | 6-Me | H | 2,6-F₂Ph | CF₃ |
| i-Pr | 6-Me | 4-Br | 2,4-F₂Ph | CF₃ |
| t-Bu | 6-Me | H | 2,6-F₂Ph | CF₃ |
| Me | 6-Me | 4-I | 2-MeOPh | CF₃ |
| Et | 6-Me | H | 3-Cl-2-pyridyl | CF₃ |
| i-Pr | 6-Me | H | 3-Cl-2-pyridyl | OCF₃ |
| t-Bu | 6-Me | H | 3-Cl-2-pyridyl | Br |
| propargyl | 6-Me | H | 3-Cl-2-pyridyl | Cl |
| Et | 6-Me | 4-Br | 3-Cl-2-pyridyl | SCHF₂ |
| i-Pr | 6-Me | H | 3-F-2-pyridyl | CF₃ |
| t-Bu | 6-Me | H | 3-CF₃-2-pyridyl | CF₃ |
| Me | 6-Me | H | 3-Me-2-oyridy; | CF₃ |
| Et | 6-Me | H | 3-Br-2-pyridyl | CF₃ |
| i-Pr | 6-Me | 4-Cl | 3-Br-2-pyridyl | OCF₃ |
| t-Bu | 6-Me | H | 3-Br-2-pyridyl | Br |
| i-Pr | 6-Me | H | 3-Br-2-pyridyl | Cl |
| Me | 3-Cl | H | H | CF₃ |
| Et | 3-Br | 5-Me | H | OCF₃ |
| i-Pr | 3-Cl | H | H | OCF₃ |
| t-Bu | 3-Cl | 5-Cl | Me | Br |
| Me | 3-Cl | H | Et | Br |
| Et | 3-Cl | H | Me | Cl |
| i-Pr | 3-Cl | 5-Br | Et | Cl |
| t-Bu | 3-Cl | H | Me | I |
| propargyl | 3-Cl | H | Me | CF₃ |
| cyclopropyl | 3-Cl | H | Me | OCF₃ |
| i-Pr | 3-Cl | 5-Cl | Me | CF₃ |
| t-Bu | 3-Cl | H | Me | SCF₃ |
| Me | 3-F | H | Me | SCHF₂ |
| Et | 3-Cl | H | Me | OCHF₂ |
| i-Pr | 3-Cl | 5-CN | Me | CF₃ |
| t-Bu | 3-Cl | H | Me | C₂F₅ |
| propargyl | 3-Cl | H | Me | C₂F₅ |
| cyclopropyl | 3-Cl | H | Et | CF₃ |
| i-Pr | 3-Cl | H | n-Pr | CF₃ |
| t-Bu | 3-Cl | 5-Br | i-Pr | CF₃ |
| Me | 3-Cl | H | Cl | CF₃ |
| Et | 3-Br | H | F | CF₃ |
| i-Pr | 3-Cl | H | Me | SMe |
| t-Bu | 3-Cl | 5-Cl | Me | OMe |
| Me | 3-Cl | H | Me | OEt |
| Et | 3-Cl | H | Me | n-C₃F₇ |
| i-Pr | 3-Cl | H | Me | i-C₃F₇ |
| t-Bu | 3-Cl | 5-F | Me | Et |
| propargyl | 3-Cl | H | Me | OCF₂CHF₂ |
| Et | 3-Cl | H | Me | SCF₂CHF₂ |
| i-Pr | 3-Br | H | Me | SO₂Me |
| t-Bu | 3-Cl | 5-Cl | Me | SO₂CF₃ |
| Me | 3-Cl | H | CF₃ | CF₃ |
| Et | 3-CN | H | CF₃ | Me |
| i-Pr | 3-Cl | H | OMe | CF₃ |
| t-Bu | 3-Cl | H | H | CF₃ |
| cyclopropyl | 3-Cl | 5-Br | H | OCHF₂ |
| Et | 3-Cl | H | H | C₂F₅ |
| i-Pr | 3-Cl | H | H | C₂F₅ |
| t-Bu | 3-Cl | H | H | OCF₃ |
| Me | 3-F | H | H | OCF₂CHF₂ |
| Et | 3-Cl | H | H | SCF₂CHF₂ |
| i-Pr | 3-Cl | 5-Cl | H | n-C₃F₇ |
| t-Bu | 3-Cl | H | H | i-C₃F₇ |
| propargyl | 3-Cl | H | H | Br |
| Et | 3-Cl | H | H | Cl |
| i-Pr | 3-Cl | H | H | SCF₃ |
| t-Bu | 3-Cl | 5-Br | Ph | CF₃ |
| cyclopropyl | 3-Cl | H | Ph | Cl |
| Et | 3-Cl | H | Ph | Br |
| i-Pr | 3-Br | H | 2-pyridyl | CF₃ |
| t-Bu | 3-Cl | H | 2-pyridyl | Cl |
| Me | 3-Cl | H | 2-ClPh | CF₃ |
| Et | 3-Cl | 5-Cl | 2-ClPh | OCF₃ |
| i-Pr | 3-Cl | H | 2-ClPh | Br |
| t-Bu | 3-I | H | 2-ClPh | Cl |
| Me | 3-Cl | 5-Me | 2-ClPh | SCHF₂ |
| propargyl | 3-Cl | H | 2-BrPh | CF₃ |
| i-Pr | 3-Cl | H | 2-MePh | CF₃ |
| t-Bu | 3-Cl | 5-CN | 2-CNPh | CF₃ |
| Me | 3-Cl | H | 2-FPh | CF₃ |
| Et | 3-Cl | H | 2,6-F₂Ph | CF₃ |
| i-Pr | 3-Cl | 5-Br | 2,4-F₂Ph | CF₃ |
| t-Bu | 3-F | H | 2,6-F₂Ph | CF₃ |
| Me | 3-Cl | 5-I | 2-MeOPh | CF₃ |
| Et | 3-Cl | H | 3-Cl-2-pyridyl | CF₃ |
| i-Pr | 3-CN | H | 3-Cl-2-pyridyl | OCF₃ |
| t-Bu | 3-Cl | H | 3-Cl-2-pyridyl | Br |
| propargyl | 3-Cl | H | 3-Cl-2-pyridyl | Cl |
| Et | 3-Cl | 5-Br | 3-Cl-2-pyridyl | SCHF₂ |
| i-Pr | 3-Cl | H | 3-F-2-pyridyl | CF₃ |
| t-Bu | 3-Br | H | 3-CF₃-2-pyridyl | CF₃ |
| Me | 3-Cl | H | 3-Me-2-pyridyl | CF₃ |
| Et | 3-Cl | H | 3-Br-2-pyridyl | CF₃ |
| i-Pr | 3-Cl | 5-Cl | 3-Br-2-pyridyl | OCF₃ |
| t-Bu | 3-Cl | H | 3-Br-2-pyridyl | Br |
| i-Pr | 3-Cl | H | 3-Br-2-pyridyl | Cl |
| Me | 6-Cl | H | H | CF₃ |
| Et | 6-Br | 4-Me | H | OCF₃ |
| i-Pr | 6-Cl | H | H | OCF₃ |
| t-Bu | 6-Cl | Cl | Me | Br |
| Me | 6-Cl | H | Et | Br |
| Et | 6-Cl | H | Me | Cl |
| i-Pr | 6-F | 4-Br | Et | Cl |
| t-Bu | 6-Cl | H | Me | I |
| propargyl | 6-Cl | H | Me | CF₃ |
| cyclopropyl | 6-Cl | H | Me | OCF₃ |
| i-Pr | 6-Cl | 4-Cl | Me | CF₃ |
| t-Bu | 6-Cl | H | Me | SCF₃ |
| Me | 6-Cl | H | Me | SCHF₂ |
| Et | 6-Cl | H | Me | OCHF₂ |
| i-Pr | 6-I | 4-CN | Me | CF₃ |
| t-Bu | 6-Cl | H | Me | C₂F₅ |
| propargyl | 6-Cl | H | Me | C₂F₅ |
| cyclopropyl | 6-Cl | H | Et | CF₃ |
| i-Pr | 6-Cl | H | n-Pr | CF₃ |
| t-Bu | 6-Cl | 4-Br | i-Pr | CF₃ |
| Me | 6-Cl | H | Cl | CF₃ |
| Et | 4-F | H | F | CF₃ |
| i-Pr | 6-Cl | H | Me | SMe |
| t-Bu | 6-Cl | 4-Cl | Me | OMe |
| Me | 6-Cl | H | Me | OEt |
| Et | 6-I | H | Me | n-C₃F₇ |
| i-Pr | 6-Cl | H | Me | i-C₃F₇ |
| t-Bu | 6-Cl | 4-F | Me | Et |
| propargyl | 6-Cl | H | Me | OCF₂CHF₂ |
| Et | 6-Cl | H | Me | SCF₂CHF₂ |
| i-Pr | 6-Cl | H | Me | SO₂Me |
| t-Bu | 6-Cl | 4-Cl | Me | SO₂CF₃ |
| Me | 6-Cl | H | CF₃ | CF₃ |
| Et | 6-Cl | H | CF₃ | Me |
| i-Pr | 6-Cl | H | OMe | CF₃ |
| t-Bu | 6-Br | H | H | CF₃ |
| cyclopropyl | 6-Cl | 4-Br | H | OCHF₂ |
| Et | 6-Cl | H | H | C₂F₅ |
| i-Pr | 6-Cl | H | H | C₂F₅ |
| t-Bu | 6-F | 4-Me | H | OCF₃ |
| Me | 6-Cl | H | H | OCF₂CHF₂ |
| Et | 6-Cl | H | H | SCF₂CHF₂ |
| i-Pr | 6-CN | 4-Cl | H | n-C₃F₇ |
| t-Bu | 6-Cl | H | H | i-C₃F₇ |
| propargyl | 6-Cl | H | H | Br |
| Et | 6-Cl | H | H | Cl |
| i-Pr | 6-Cl | H | H | SCF₃ |
| t-Bu | 6-Cl | 4-Br | Ph | CF₃ |
| cyclopropyl | 6-Cl | H | Ph | Cl |
| Et | 6-F | H | Ph | Br |
| i-Pr | 6-Cl | H | 2-pyridyl | CF₃ |
| t-Bu | 6-Cl | H | 2-pyridyl | Cl |
| Me | 6-Cl | H | 2-ClPh | CF₃ |
| Et | 6-Br | 4-Cl | 2-ClPh | OCF₃ |
| i-Pr | 6-Cl | H | 2-ClPh | Br |
| t-Bu | 6-Cl | H | 2-ClPh | Cl |
| Me | 6-Cl | H | 2-ClPh | SCHF₂ |
| propargyl | 6-Cl | H | 2-BrPh | CF₃ |
| i-Pr | 6-Br | H | 2-MePh | CF₃ |
| t-Bu | 6-Cl | 4-CN | 2-CNPh | CF₃ |
| Me | 6-Cl | H | 2-FPh | CF₃ |
| Et | 6-Cl | H | 2,6-F₂Ph | CF₃ |
| i-Pr | 6-Cl | 4-Br | 2,4-F₂Ph | CF₃ |
| t-Bu | 6-CN | H | 2,6-F₂Ph | CF₃ |
| Me | 6-Cl | 4-I | 2-MeOPh | CF₃ |
| Et | 6-Cl | H | 3-Cl-2-pyridyl | CF₃ |
| i-Pr | 6-Br | H | 3-Cl-2-pyridyl | OCF₃ |
| t-Bu | 6-Cl | H | 3-Cl-2-pyridyl | Br |
| propargyl | 6-Cl | H | 3-Cl-2-pyridyl | Cl |
| Et | 6-Cl | 4-Br | 3-Cl-2-pyridyl | SCHF₂ |
| i-Pr | 6-Cl | H | 3-F-2-pyridyl | CF₃ |
| t-Bu | 6-Cl | H | 3-CF₃-2-pyridyl | CF₃ |
| Me | 6-Cl | H | 3-Me-2-pyridyl | CF₃ |
| Et | 6-Cl | H | 3-Br-2-pyridyl | CF₃ |
| i-Pr | 6-Cl | 4-Cl | 3-Br-2-pyridyl | OCF₃ |
| t-Bu | 6-Cl | H | 3-Br-2-pyridyl | Br |
| i-Pr | 6-Cl | H | 3-Br-2-pyridyl | Cl |

TABLE 13

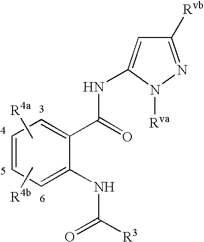

| R³ | R^{4a} | R^{4b} | R^{va} | R^{vb} |
|---|---|---|---|---|
| Me | 3-Me | H | H | CF₃ |
| Et | 3-Me | 5-Me | H | OCF₃ |
| i-Pr | 3-Me | H | H | OCF₃ |
| t-Bu | 3-Me | 5-Cl | Me | Br |
| Me | 3-Me | H | Et | Br |
| Et | 3-Me | H | Me | Cl |
| i-Pr | 3-Me | 5-Br | Et | Cl |
| t-Bu | 3-Me | H | Me | I |
| propargyl | 3-Me | H | Me | CF₃ |
| cyclopropyl | 3-Me | H | Me | OCF₃ |
| i-Pr | 3-Me | 5-Cl | Me | CF₃ |
| t-Bu | 3-Me | H | Me | SCF₃ |
| Me | 3-Me | 5-CN | Me | SCHF₂ |
| Et | 3-Me | H | Me | OCHF₂ |
| i-Pr | 3-Me | H | Me | CF₃ |
| t-Bu | 3-Me | H | Me | C₂F₅ |
| propargyl | 3-Me | H | Me | C₂F₅ |
| cyclopropyl | 3-Me | H | Et | CF₃ |
| i-Pr | 3-Me | H | n-Pr | CF₃ |
| t-Bu | 3-Me | 5-Br | i-Pr | CF₃ |
| Me | 3-Me | H | i-Pr | OCF₃ |
| Et | 3-Me | H | Me | SMe |
| i-Pr | 3-Me | H | Me | OMe |
| t-Bu | 3-Me | 5-Cl | Me | OEt |
| Me | 3-Me | H | Me | n-C₃F₇ |
| Et | 3-Me | H | Me | i-C₃F₇ |
| i-Pr | 3-Me | H | Me | Et |
| t-Bu | 3-Me | 5-F | Me | OCF₂CHF₂ |
| propargyl | 3-Me | H | Me | SCF₂CHF₂ |
| Et | 3-Me | H | Me | SO₂Me |
| i-Pr | 3-Me | H | Me | SO₂CF₃ |
| t-Bu | 3-Me | 5-Cl | CHF₂ | CF₃ |
| Me | 3-Me | H | CHF₂ | Me |
| Et | 3-Me | H | Ph | CF₃ |
| i-Pr | 3-Me | H | Ph | Cl |
| t-Bu | 3-Me | H | Ph | Br |
| cyclopropyl | 3-Me | 5-Br | 2-pyridyl | CF₃ |
| Et | 3-Me | H | 2-pyridyl | Cl |
| i-Pr | 3-Me | 5-Me | 2-ClPh | CF₃ |
| t-Bu | 3-Me | H | 2-ClPh | OCF₃ |
| Me | 3-Me | H | 2-ClPh | Br |
| Et | 3-Me | H | 2-ClPh | Cl |
| i-Pr | 3-Me | 5-Cl | 2-ClPh | SCHF₂ |
| t-Bu | 3-Me | H | 2-BrPh | CF₃ |
| propargyl | 3-Me | H | 2-MePh | CF₃ |
| Et | 3-Me | H | 2-CNPh | CF₃ |
| i-Pr | 3-Me | H | 2-FPh | CF₃ |
| t-Bu | 3-Me | 5-Br | 2,6-F₂Ph | CF₃ |
| cyclopropyl | 3-Me | H | 2,4-F₂Ph | CF₃ |
| Et | 3-Me | H | 2,5-F₂Ph | CF₃ |
| i-Pr | 3-Me | H | 2-MeOPh | CF₃ |
| t-Bu | 3-Me | H | 3-Cl-2-pyridyl | CF₃ |
| Me | 3-Me | H | 3-Cl-2-pyridyl | OCF₃ |
| Et | 3-Me | 5-Cl | 3-Cl-2-pyridyl | Br |
| i-Pr | 3-Me | H | 3-Cl-2-pyridyl | Cl |
| t-Bu | 3-Me | H | 3-Cl-2-pyridyl | SCHF₂ |
| Me | 3-Me | H | 3-F-2-pyridyl | CF₃ |
| propargyl | 3-Me | H | 3-CF₃-2-pyridyl | CF₃ |
| i-Pr | 3-Me | 5-CN | 3-Me-2-pyridyl | CF₃ |
| t-Bu | 3-Me | H | 3-Br-2-pyridyl | CF₃ |
| Me | 3-Me | H | 3-Br-2-pyridyl | OCF₃ |
| Et | 3-Me | H | 3-Br-2-pyridyl | Br |
| i-Pr | 3-Me | 5-Br | 3-Br-2-pyridyl | Cl |
| Me | 6-Me | H | H | CF₃ |
| Et | 6-Me | 4-Me | H | OCF₃ |
| i-Pr | 6-Me | H | H | OCF₃ |
| t-Bu | 6-Me | Cl | Me | Br |
| Me | 6-Me | H | Et | Br |
| Et | 6-Me | H | Me | Cl |
| i-Pr | 6-Me | 4-Br | Et | Cl |
| t-Bu | 6-Me | H | Me | I |
| propargyl | 6-Me | H | Me | CF₃ |
| cyclopropyl | 6-Me | H | Me | OCF₃ |
| i-Pr | 6-Me | 4-Cl | Me | CF₃ |
| t-Bu | 6-Me | H | Me | SCF₃ |
| Me | 6-Me | H | Me | SCHF₂ |
| Et | 6-Me | H | Me | OCHF₂ |
| i-Pr | 6-Me | 4-CN | Me | CF₃ |
| t-Bu | 6-Me | H | Me | C₂F₅ |
| propargyl | 6-Me | H | Me | C₂F₅ |
| cyclopropyl | 6-Me | H | Et | CF₃ |
| i-Pr | 6-Me | H | n-Pr | CF₃ |
| t-Bu | 6-Me | 4-Br | i-Pr | CF₃ |
| Me | 6-Me | H | Me | SMe |
| Et | 6-Me | H | Me | OMe |
| i-Pr | 6-Me | H | Me | OEt |
| t-Bu | 6-Me | 4-Cl | Me | n-C₃F₇ |
| Me | 6-Me | H | Me | i-C₃F₇ |
| Et | 6-Me | H | Me | Et |
| i-Pr | 6-Me | H | Me | OCF₂CHF₂ |
| t-Bu | 6-Me | 4-F | Me | SCF₂CHF₂ |
| propargyl | 6-Me | H | Me | SO₂Me |
| Et | 6-Me | H | Me | SO₂CF₃ |
| i-Pr | 6-Me | H | CF₃ | CF₃ |
| t-Bu | 6-Me | 4-Cl | CF₃ | Me |
| Me | 6-Me | H | Ph | CF₃ |
| Et | 6-Me | H | Ph | Cl |
| i-Pr | 6-Me | H | Ph | Br |
| t-Bu | 6-Me | H | 2-pyridyl | CF₃ |
| cyclopropyl | 6-Me | 4-Br | 2-pyridyl | Cl |
| Et | 6-Me | H | 2-ClPh | CF₃ |
| i-Pr | 6-Me | H | 2-ClPh | OCF₃ |
| t-Bu | 6-Me | 4-Me | 2-ClPh | Br |
| Me | 6-Me | H | 2-ClPh | Cl |
| Et | 6-Me | H | 2-ClPh | SCHF₂ |
| i-Pr | 6-Me | 4-Cl | 2-BrPh | CF₃ |
| t-Bu | 6-Me | H | 2-MePh | CF₃ |
| propargyl | 6-Me | H | 2-CNPh | CF₃ |
| Et | 6-Me | H | 2-FPh | CF₃ |
| i-Pr | 6-Me | H | 2,6-F₂Ph | CF₃ |
| t-Bu | 6-Me | 4-Br | 2,4-F₂Ph | CF₃ |
| cyclopropyl | 6-Me | H | 2,5-F₂Ph | CF₃ |
| Et | 6-Me | H | 2-MeOPh | CF₃ |
| i-Pr | 6-Me | H | 3-Cl-2-pyridyl | CF₃ |
| t-Bu | 6-Me | H | 3-Cl-2-pyridyl | OCF₃ |
| Me | 6-Me | H | 3-Cl-2-pyridyl | Br |
| Et | 6-Me | 4-Cl | 3-Cl-2-pyridyl | Cl |
| i-Pr | 6-Me | H | 3-Cl-2-pyridyl | SCHF₂ |
| t-Bu | 6-Me | 4-CN | 3-F-2-pyridyl | CF₃ |
| Me | 6-Me | H | 3-CF₃-2-pyridyl | CF₃ |
| propargyl | 6-Me | H | 3-Me-2-pyridyl | CF3 |
| i-Pr | 6-Me | H | 3-Br-2-pyridyl | CF3 |
| t-Bu | 6-Me | H | 3-Br-2-pyridyl | OCF3 |
| Me | 6-Me | H | 3-Br-2-pyridyl | Br |
| Et | 6-Me | H | 3-Br-2-pyridyl | Cl |
| Me | 3-Cl | H | Me | Br |
| Et | 3-Br | 5-Me | Et | Br |
| i-Pr | 3-Cl | H | Me | Cl |
| t-Bu | 3-Cl | 5-Cl | Et | Cl |
| Me | 3-Cl | H | Me | I |
| Et | 3-Cl | H | Me | CF₃ |
| i-Pr | 3-Cl | 5-Br | Me | OCF₃ |
| t-Bu | 3-Cl | H | Me | CF₃ |
| propargyl | 3-Cl | H | Me | SCF₃ |
| cyclopropyl | 3-Cl | H | Me | SCHF₂ |
| i-Pr | 3-Cl | 5-Cl | Me | OCHF₂ |
| t-Bu | 3-Cl | H | Mc | CF₃ |
| Me | 3-F | H | Me | C₂F₅ |
| Et | 3-Cl | H | Me | C₂F₅ |
| i-Pr | 3-Cl | 5-CN | Et | CF₃ |
| t-Bu | 3-Cl | H | n-Pr | CF₃ |
| propargyl | 3-Cl | H | i-Pr | CF₃ |
| cyclopropyl | 3-Cl | H | Me | SMe |
| i-Pr | 3-Cl | H | Me | OMe |
| t-Bu | 3-Cl | 5-Br | Me | OEt |
| Me | 3-Cl | H | Me | n-C₃F₇ |
| Et | 3-Br | H | Me | i-C₃F₇ |
| i-Pr | 3-Cl | H | Me | Et |
| t-Bu | 3-Cl | 5-Cl | Me | OCF₂CHF₂ |
| Me | 3-Cl | H | Me | SCF₂CHF₂ |
| Et | 3-Cl | H | Me | SO₂Me |
| i-Pr | 3-Cl | H | Me | SO₂CF₃ |
| t-Bu | 3-Cl | 5-F | CF₃ | CF₃ |
| propargyl | 3-Cl | H | CF₃ | Me |
| Et | 3-Cl | H | Ph | CF₃ |
| i-Pr | 3-Br | H | Ph | Cl |
| t-Bu | 3-Cl | 5-Cl | Ph | Br |
| Me | 3-Cl | H | 2-pyridyl | CF₃ |
| Et | 3-CN | H | 2-pyridyl | Cl |
| i-Pr | 3-Cl | H | 2-ClPh | CF₃ |
| t-Bu | 3-Cl | H | 2-ClPh | OCF₃ |
| cyclopropyl | 3-Cl | 5-Br | 2-ClPh | Br |
| Et | 3-Cl | H | 2-ClPh | Cl |
| i-Pr | 3-Cl | H | 2-Clph | OCF₃ |
| t-Bu | 3-Cl | H | 2-BrPh | CF₃ |
| Me | 3-F | H | 2-MePh | CF₃ |
| Et | 3-Cl | H | 2-CNPh | CF₃ |
| i-Pr | 3-Cl | 5-Cl | 2-FPh | CF₃ |
| t-Bu | 3-Cl | H | 2,6-F₂Ph | CF₃ |
| propargyl | 3-Cl | H | 2,4-F₂Ph | CF₃ |
| Et | 3-Cl | H | 2,5-F₂Ph | CF₃ |
| i-Pr | 3-Cl | H | 2-MeOPh | CF₃ |
| t-Bu | 3-Cl | 5-Br | 3-Cl-2-pyridyl | CF₃ |
| cyclopropyl | 3-Cl | H | 3-Cl-2-pyridyl | OCF₃ |
| Et | 3-Cl | H | 3-Cl-2-pyridyl | Br |
| i-Pr | 3-Br | H | 3-Cl-2-pyridyl | Cl |
| t-Bu | 3-Cl | H | 3-Cl-2-pyridyl | SCHF₂ |
| Me | 3-Cl | H | 3-F-2-pyridyl | CF₃ |
| Et | 3-Cl | 5-Cl | 3-CF₃-2-pyridyl | CF₃ |
| i-Pr | 3-Cl | H | 3-Me-2-pyridyl | CF₃ |
| t-Bu | 3-I | H | 3-Br-2-pyridyl | CF₃ |
| Me | 3-Cl | 5-Me | 3-Br-2-pyridyl | OCF₃ |
| propargyl | 3-Cl | H | 3-Br-2-pyridyl | Br |
| i-Pr | 3-Cl | H | 3-Br-2-pyridyl | Cl |
| Me | 6-Cl | H | Et | Br |
| Et | 6-Br | 4-Me | Me | Cl |
| i-Pr | 6-Cl | H | Et | Cl |
| t-Bu | 6-Cl | Cl | Me | I |
| Me | 6-Cl | H | Me | CF₃ |
| Et | 6-Cl | H | Me | OCF₃ |
| i-Pr | 6-F | 4-Br | Me | CF₃ |
| t-Bu | 6-Cl | H | Me | SCF₃ |
| propargyl | 6-Cl | H | Me | SCHF₂ |
| cyclopropyl | 6-Cl | H | Me | OCHF₂ |
| i-Pr | 6-Cl | 4-Cl | Me | CF₃ |
| t-Bu | 6-Cl | H | Me | C₂F₅ |
| Me | 6-Cl | H | Me | C₂F₅ |
| Et | 6-Cl | H | Et | CF₃ |
| i-Pr | 6-I | 4-CN | n-Pr | CF₃ |
| t-Bu | 6-Cl | H | i-Pr | CF₃ |
| propargyl | 6-Cl | H | Me | SMe |
| cyclopropyl | 6-Cl | H | Me | OMe |
| i-Pr | 6-Cl | H | Me | OEt |
| t-Bu | 6-Cl | 4-Br | Me | n-C₃F₇ |
| Me | 6-Cl | H | Me | i-C₃F₇ |
| Et | 6-F | H | Me | Et |
| i-Pr | 6-Cl | H | Me | OCF₂CHF₂ |
| t-Bu | 6-Cl | 4-Cl | Me | SCF₂CHF₂ |
| Me | 6-Cl | H | Me | SO₂Me |
| Et | 6-I | H | Me | SO₂CF₃ |
| i-Pr | 6-Cl | H | CF₃ | CF₃ |
| t-Bu | 6-Cl | 4-F | CF₃ | Me |
| propargyl | 6-Cl | H | Ph | CF₃ |
| Et | 6-Cl | H | Ph | Cl |
| i-Pr | 6-Cl | H | Ph | Br |
| t-Bu | 6-Cl | 4-Cl | 2-pyridyl | CF₃ |
| Me | 6-Cl | H | 2-pyridyl | Cl |
| Et | 6-Cl | H | 2-ClPh | CF₃ |
| i-Pr | 6-Cl | H | 2-ClPh | OCF₃ |
| t-Bu | 6-Br | H | 2-ClPh | Br |
| cyclopropyl | 6-Cl | 4-Br | 2-ClPh | Cl |
| Et | 6-Cl | H | 2-ClPh | SCHF₂ |
| i-Pr | 6-Cl | H | 2-BrPh | CF₃ |
| t-Bu | 6-F | 4-Me | 2-MePh | CF₃ |
| Me | 6-Cl | H | 2-CNPh | CF₃ |
| Et | 6-Cl | H | 2-FPh | CF₃ |
| i-Pr | 6-CN | 4-Cl | 2,6-F₂Ph | CF₃ |
| t-Bu | 6-Cl | H | 2,4-F₂Ph | CF₃ |
| propargyl | 6-Cl | H | 2,5-F₂Ph | CF₃ |
| Et | 6-Cl | H | 2-MeOPh | CF₃ |
| i-Pr | 6-Cl | H | 3-Cl-2-pyridyl | CF₃ |
| t-Bu | 6-Cl | 4-Br | 3-Cl-2-pyridyl | OCF₃ |
| cyclopropyl | 6-Cl | H | 3-Cl-2-pyridyl | Br |
| Et | 6-F | H | 3-Cl-2-pyridyl | Cl |
| i-Pr | 6-Cl | H | 3-Cl-2-pyridyl | SCHF₂ |
| t-Bu | 6-Cl | H | 3-F-2-pyridyl | CF₃ |
| Me | 6-Cl | H | 3-CF₃-2-pyridyl | CF₃ |
| Et | 6-Br | 4-Cl | 3-Me-2-pyridyl | CF₃ |
| i-Pr | 6-Cl | H | 3-Br-2-pyridyl | CF₃ |
| t-Bu | 6-Cl | H | 3-Br-2-pyridyl | OCF₃ |
| Me | 6-Cl | H | 3-Br-2-pyridyl | Br |
| propargyl | 6-Cl | H | 3-Br-2-pyridyl | Cl |

TABLE 14

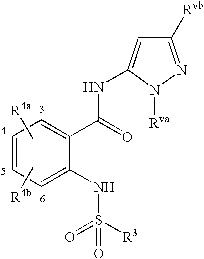

| R³ | R^{4a} | R^{4b} | R^{va} | R^{vb} |
|---|---|---|---|---|
| Me | 3-Me | H | H | CF₃ |
| Et | 3-Me | 5-Me | H | OCF₃ |
| i-Pr | 3-Me | H | H | OCF₃ |
| t-Bu | 3-Me | 5-Cl | Me | Br |
| Me | 3-Me | H | Et | Br |
| Et | 3-Me | H | Me | Cl |
| i-Pr | 3-Me | 5-Br | Et | Cl |
| t-Bu | 3-Me | H | Me | I |
| propargyl | 3-Me | H | Me | CF₃ |
| cyclopropyl | 3-Me | H | Me | OCF₃ |
| i-Pr | 3-Me | 5-Cl | Me | CF₃ |
| t-Bu | 3-Me | H | Me | SCF₃ |
| Me | 3-Me | 5-CN | Me | SCHF₂ |
| Et | 3-Me | H | Me | OCHF₂ |
| i-Pr | 3-Me | H | Me | CF₃ |
| t-Bu | 3-Me | H | Me | C₂F₅ |
| propargyl | 3-Me | H | Me | C₂F₅ |
| cyclopropyl | 3-Me | H | Et | CF₃ |
| i-Pr | 3-Me | H | n-Pr | CF₃ |
| t-Bu | 3-Me | 5-Br | i-Pr | CF₃ |
| Me | 3-Me | H | i-Pr | OCF₃ |
| Et | 3-Me | H | Me | SMe |
| i-Pr | 3-Me | H | Me | OMe |
| t-Bu | 3-Me | 5-Cl | Me | OEt |
| Me | 3-Me | H | Me | n-C₃F₇ |
| Et | 3-Me | H | Me | i-C₃F₇ |
| i-Pr | 3-Me | H | Me | Et |
| t-Bu | 3-Me | 5-F | Me | OCF₂CHF₂ |
| propargyl | 3-Me | H | Me | SCF₂CHF₂ |
| Et | 3-Me | H | Me | SO₂Me |
| i-Pr | 3-Me | H | Me | SO₂CF₃ |
| t-Bu | 3-Me | 5-Cl | CHF₂ | CF₃ |
| Me | 3-Me | H | CHF₂ | Me |
| Et | 3-Me | H | Ph | CF₃ |
| i-Pr | 3-Me | H | Ph | Cl |
| t-Bu | 3-Me | H | Ph | Br |
| cyclopropyl | 3-Me | 5-Br | 2-pyridyl | CF₃ |
| Et | 3-Me | H | 2-pyridyl | Cl |
| i-Pr | 3-Me | 5-Me | 2-ClPh | CF₃ |
| t-Bu | 3-Me | H | 2-ClPh | OCF₃ |
| Me | 3-Me | H | 2-ClPh | Br |
| Et | 3-Me | H | 2-ClPh | Cl |
| i-Pr | 3-Me | 5-Cl | 2-ClPh | SCHF₂ |
| t-Bu | 3-Me | H | 2-BrPh | CF₃ |
| propargyl | 3-Me | H | 2-MePh | CF₃ |
| Et | 3-Me | H | 2-CNPh | CF₃ |
| i-Pr | 3-Me | H | 2-FPh | CF₃ |
| t-Bu | 3-Me | 5-Br | 2,6-F₂Ph | CF₃ |
| cyclopropyl | 3-Me | H | 2,4-F₂Ph | CF₃ |
| Et | 3-Me | H | 2,5-F₂Ph | CF₃ |
| i-Pr | 3-Me | H | 2-MeOPh | CF₃ |
| t-Bu | 3-Me | H | 3-Cl-2-pyridyl | CF₃ |
| Me | 3-Me | H | 3-Cl-2-pyridyl | OCF₃ |
| Et | 3-Me | 5-Cl | 3-Cl-2-pyridyl | Br |
| i-Pr | 3-Me | H | 3-Cl-2-pyridyl | Cl |
| t-Bu | 3-Me | H | 3-Cl-2-pyridyl | SCHF₂ |
| Me | 3-Me | H | 3-F-2-pyridyl | CF₃ |
| propargyl | 3-Me | H | 3-CF₃-2-pyridyl | CF₃ |
| i-Pr | 3-Me | 5-CN | 3-Me-2-pyridyl | CF₃ |
| t-Bu | 3-Me | H | 3-Br-2-pyridyl | CF₃ |
| Me | 3-Me | H | 3-Br-2-pyridyl | OCF₃ |
| Et | 3-Me | H | 3-Br-2-pyridyl | Br |
| i-Pr | 3-Me | 5-Br | 3-Br-2-pyridyl | Cl |
| Me | 6-Me | H | H | CF₃ |
| Et | 6-Me | 4-Me | H | OCF₃ |
| i-Pr | 6-Me | H | H | OCF₃ |
| t-Bu | 6-Me | Cl | Me | Br |
| Me | 6-Me | H | Et | Br |
| Et | 6-Me | H | Me | Cl |
| i-Pr | 6-Me | 4-Br | Et | Cl |
| t-Bu | 6-Me | H | Me | I |
| propargyl | 6-Me | H | Me | CF₃ |
| cyclopropyl | 6-Me | H | Me | OCF₃ |
| i-Pr | 6-Me | 4-Cl | Me | CF₃ |
| t-Bu | 6-Me | H | Me | SCF₃ |
| Me | 6-Me | H | Me | SCHF₂ |
| Et | 6-Me | H | Me | OCHF₂ |
| i-Pr | 6-Me | 4-CN | Me | CF₃ |
| t-Bu | 6-Me | H | Me | C₂F₅ |
| propargyl | 6-Me | H | Me | C₂F₅ |
| cyclopropyl | 6-Me | H | Et | CF₃ |
| i-Pr | 6-Me | H | n-Pr | CF₃ |
| t-Bu | 6-Me | 4-Br | i-Pr | CF₃ |
| Me | 6-Me | H | Me | SMe |
| Et | 6-Me | H | Me | OMe |
| i-Pr | 6-Me | H | Me | OEt |
| t-Bu | 6-Me | 4-Cl | Me | n-C₃F₇ |
| Me | 6-Me | H | Me | i-C₃F₇ |
| Et | 6-Me | H | Me | Et |
| i-Pr | 6-Me | H | Me | OCF₂CHF₂ |
| t-Bu | 6-Me | 4-F | Me | SCF₂CHF₂ |
| propargyl | 6-Me | H | Me | SO₂Me |
| Et | 6-Me | H | Me | SO₂CF₃ |
| i-Pr | 6-Me | H | CF₃ | CF₃ |
| t-Bu | 6-Me | 4-Cl | CF₃ | Me |
| Me | 6-Me | H | Ph | CF₃ |
| Et | 6-Me | H | Ph | Cl |
| i-Pr | 6-Me | H | Ph | Br |
| t-Bu | 6-Me | H | 2-pyridyl | CF₃ |
| cyclopropyl | 6-Me | 4-Br | 2-pyridyl | Cl |
| Et | 6-Me | H | 2-ClPh | CF₃ |
| i-Pr | 6-Me | H | 2-ClPh | OCF₃ |
| t-Bu | 6-Me | 4-Me | 2-ClPh | Br |
| Me | 6-Me | H | 2-ClPh | Cl |
| Et | 6-Me | H | 2-ClPh | SCHF₂ |
| i-Pr | 6-Me | 4-Cl | 2-BrPh | CF₃ |
| t-Bu | 6-Me | H | 2-MePh | CF₃ |
| propargyl | 6-Me | H | 2-CNPh | CF₃ |
| Et | 6-Me | H | 2-FPh | CF₃ |
| i-Pr | 6-Me | H | 2,6-F₂Ph | CF₃ |
| t-Bu | 6-Me | 4-Br | 2,4-F₂Ph | CF₃ |
| cyclopropyl | 6-Me | H | 2,5-F₂Ph | CF₃ |
| Et | 6-Me | H | 2-MeOPh | CF₃ |
| i-Pr | 6-Me | H | 3-Cl-2-pyridyl | CF₃ |
| t-Bu | 6-Me | H | 3-Cl-2-pyridyl | OCF₃ |
| Me | 6-Me | H | 3-Cl-2-pyridyl | Br |
| Et | 6-Me | 4-Cl | 3-Cl-2-pyridyl | Cl |
| i-Pr | 6-Me | H | 3-Cl-2-pyridyl | SCHF₂ |
| t-Bu | 6-Me | 4-CN | 3-F-2-pyridyl | CF₃ |
| Me | 6-Me | H | 3-CF₃-2-pyridyl | CF₃ |
| propargyl | 6-Me | H | 3-Me-2-pyridyl | CF₃ |
| i-Pr | 6-Me | H | 3-Br-2-pyridyl | CF₃ |
| t-Bu | 6-Me | H | 3-Br-2-pyridyl | OCF₃ |
| Me | 6-Me | H | 3-Br-2-pyridyl | Br |
| Et | 6-Me | H | 3-Br-2-pyridyl | Cl |
| Me | 3-Cl | H | Me | Br |
| Et | 3-Br | 5-Me | Et | Br |
| i-Pr | 3-Cl | H | Me | Cl |
| t-Bu | 3-Cl | 5-Cl | Et | Cl |
| Me | 3-Cl | H | Me | I |
| Et | 3-Cl | H | Me | CF₃ |
| i-Pr | 3-Cl | 5-Br | Me | OCF₃ |
| t-Bu | 3-Cl | H | Me | CF₃ |
| propargyl | 3-Cl | H | Me | SCF₃ |
| cyclopropyl | 3-Cl | H | Me | SCHF₂ |
| i-Pr | 3-Cl | 5-Cl | Me | OCHF₂ |
| t-Bu | 3-Cl | H | Me | CF₃ |
| Me | 3-F | H | Me | C₂F₅ |
| Et | 3-Cl | H | Me | C₂F₅ |
| i-Pr | 3-Cl | 5-CN | Et | CF₃ |
| t-Bu | 3-Cl | H | n-Pr | CF₃ |
| propargyl | 3-Cl | H | i-Pr | CF₃ |
| cyclopropyl | 3-Cl | H | Me | SMe |
| i-Pr | 3-Cl | H | Me | OMe |
| t-Bu | 3-Cl | 5-Br | Me | OEt |
| Me | 3-Cl | H | Me | n-C₃F₇ |
| Et | 3-Br | H | Me | i-C₃F₇ |
| i-Pr | 3-Cl | H | Me | Et |
| t-Bu | 3-Cl | 5-Cl | Me | OCF₂CHF₂ |
| Me | 3-Cl | H | Me | SCF₂CHF₂ |
| Et | 3-Cl | H | Me | SO₂Me |
| i-Pr | 3-Cl | H | Me | SO₂CF₃ |
| t-Bu | 3-Cl | 5-F | CF₃ | CF₃ |
| propargyl | 3-Cl | H | CF₃ | Me |
| Et | 3-Cl | H | Ph | CF₃ |
| i-Pr | 3-Br | H | Ph | Cl |
| t-Bu | 3-Cl | 5-Cl | Ph | Br |
| Me | 3-Cl | H | 2-pyridyl | CF₃ |
| Et | 3-CN | H | 2-pyridyl | Cl |
| i-Pr | 3-Cl | H | 2-ClPh | CF₃ |
| t-Bu | 3-Cl | H | 2-ClPh | OCF₃ |
| cyclopropyl | 3-Cl | 5-Br | 2-ClPh | Br |
| Et | 3-Cl | H | 2-ClPh | Cl |
| i-Pr | 3-Cl | H | 2-ClPh | OCF₃ |
| t-Bu | 3-Cl | H | 2-BrPh | CF₃ |
| Me | 3-F | H | 2-MePh | CF₃ |
| Et | 3-Cl | H | 2-CNPh | CF₃ |
| i-Pr | 3-Cl | S-Cl | 2-FPh | CF₃ |
| t-Bu | 3-Cl | H | 2,6-F₂Ph | CF₃ |
| propargyl | 3-Cl | H | 2,4-F₂Ph | CF₃ |
| Et | 3-Cl | H | 2,5-F₂Ph | CF₃ |
| i-Pr | 3-Cl | H | 2-MeOPh | CF₃ |
| t-Bu | 3-Cl | 5-Br | 3-Cl-2-pyridyl | CF₃ |
| cyclopropyl | 3-Cl | H | 3-Cl-2-pyridyl | OCF₃ |
| Et | 3-Cl | H | 3-Cl-2-pyridyl | Br |
| i-Pr | 3-Br | H | 3-Cl-2-pyridyl | Cl |
| t-Bu | 3-Cl | H | 3-Cl-2-pyridyl | SCHF₂ |
| Me | 3-Cl | H | 3-F-2-pyridyl | CF₃ |
| Et | 3-Cl | 5-Cl | 3-CF₃-2-pyridyl | CF₃ |
| i-Pr | 3-Cl | H | 3-Me-2-pyridyl | CF₃ |
| t-Bu | 3-I | H | 3-Br-2-pyridyl | CF₃ |
| Me | 3-Cl | 5-Me | 3-Br-2-pyridyl | OCF₃ |
| propargyl | 3-Cl | H | 3-Br-2-pyridyl | Br |
| i-Pr | 3-Cl | H | 3-Br-2-pyridyl | Cl |
| Me | 6-Cl | H | Et | Br |
| Et | 6-Br | 4-Me | Me | Cl |
| i-Pr | 6-Cl | H | Et | Cl |
| t-Bu | 6-Cl | Cl | Me | I |
| Me | 6-Cl | H | Me | CF₃ |
| Et | 6-Cl | H | Me | OCF₃ |
| i-Pr | 6-F | 4-Br | Me | CF₃ |
| t-Bu | 6-Cl | H | Me | SCF₃ |
| propargyl | 6-Cl | H | Me | SCHF₂ |
| cyclopropyl | 6-Cl | H | Me | OCHF₂ |
| i-Pr | 6-Cl | 4-Cl | Me | CF₃ |
| t-Bu | 6-Cl | H | Me | C₂F₅ |
| Me | 6-Cl | H | Me | C₂F₅ |
| Et | 6-Cl | H | Et | CF₃ |
| i-Pr | 6-I | 4-CN | n-Pr | CF₃ |
| t-Bu | 6-Cl | H | i-Pr | CF₃ |
| propargyl | 6-Cl | H | Me | SMe |
| cyclopropyl | 6-Cl | H | Me | OMe |
| i-Pr | 6-Cl | H | Me | OEt |
| t-Bu | 6-Cl | 4-Br | Me | n-C₃F₇ |
| Me | 6-Cl | H | Me | i-C₃F₇ |
| Et | 6-F | H | Me | Et |
| i-Pr | 6-Cl | H | Me | OCF₂CHF₂ |
| t-Bu | 6-Cl | 4-Cl | Me | SCF₂CHF₂ |
| Me | 6-Cl | H | Me | SO₂Me |
| Et | 6-I | H | Me | SO₂CF₃ |
| i-Pr | 6-Cl | H | CF₃ | CF₃ |
| t-Bu | 6-Cl | 4-F | CF₃ | Me |
| propargyl | 6-Cl | H | Ph | CF₃ |
| Et | 6-Cl | H | Ph | Cl |
| i-Pr | 6-Cl | H | Ph | Br |
| t-Bu | 6-Cl | 4-Cl | 2-pyridyl | CF₃ |
| Me | 6-Cl | H | 2-pyridyl | Cl |
| Et | 6-Cl | H | 2-ClPh | CF₃ |
| i-Pr | 6-Cl | H | 2-ClPh | OCF₃ |
| t-Bu | 6-Br | H | 2-ClPh | Br |
| cyclopropyl | 6-Cl | 4-Br | 2-ClPh | Cl |
| Et | 6-Cl | H | 2-ClPh | SCHF₂ |
| i-Pr | 6-Cl | H | 2-BrPh | CF₃ |
| t-Bu | 6-F | 4-Me | 2-MePh | CF₃ |
| Me | 6-Cl | H | 2-CNPh | CF₃ |
| Et | 6-Cl | H | 2-FPh | CF₃ |
| i-Pr | 6-CN | 4-Cl | 2,6-F₂Ph | CF₃ |
| t-Bu | 6-Cl | H | 2,4-F₂Ph | CF₃ |
| propargyl | 6-Cl | H | 2,5-F₂Ph | CF₃ |
| Et | 6-Cl | H | 2-MeOPh | CF₃ |
| i-Pr | 6-Cl | H | 3-Cl-2-pyridyl | CF₃ |
| t-Bu | 6-Cl | 4-Br | 3-Cl-2-pyridyl | OCF₃ |
| cyclopropyl | 6-Cl | H | 3-Cl-2-pyridyl | Br |
| Et | 6-F | H | 3-Cl-2-pyridyl | Cl |
| i-Pr | 6-Cl | H | 3-Cl-2-pyridyl | SCHF₂ |
| t-Bu | 6-Cl | H | 3-F-2-pyridyl | CF₃ |
| Me | 6-Cl | H | 3-CF₃-2-pyridyl | CF₃ |
| Et | 6-Br | 4-Cl | 3-Me-2-pyridyl | CF₃ |
| i-Pr | 6-Cl | H | 3-Br-2-pyridyl | CF₃ |
| t-Bu | 6-Cl | H | 3-Br-2-pyridyl | OCF₃ |
| Me | 6-Cl | H | 3-Br-2-pyridyl | Br |
| propargyl | 6-Cl | H | 3-Br-2-pyridyl | Cl |

TABLE 15

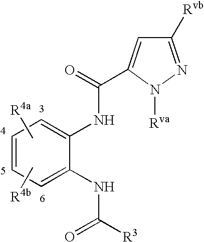

| R³ | R^{4a} | R^{4b} | R^{4a} | R^{vb} |
|---|---|---|---|---|
| Me | 3-Me | H | H | CF₃ |
| Et | 3-Me | 5-Me | H | OCF₃ |
| i-Pr | 3-Me | H | H | OCF₃ |
| t-Bu | 3-Me | S-Cl | Me | Br |
| Me | 3-Me | H | Et | Br |
| Et | 3-Me | H | Me | Cl |
| i-Pr | 3-Me | 5-Br | Et | Cl |
| t-Bu | 3-Me | H | Me | I |
| propargyl | 3-Me | H | Me | CF₃ |
| cyclopropyl | 3-Me | H | Me | OCF₃ |
| i-Pr | 3-Me | 5-Cl | Me | CF₃ |
| t-Bu | 3-Me | H | Me | SCF₃ |
| Me | 3-Me | 5-CN | Me | SCHF₂ |
| Et | 3-Me | H | Me | OCHF₂ |
| i-Pr | 3-Me | H | Me | CF₃ |
| t-Bu | 3-Me | H | Me | C₂F₅ |
| propargyl | 3-Me | H | Me | C₂F₅ |
| cyclopropyl | 3-Me | H | Et | CF₃ |
| i-Pr | 3-Me | H | n-Pr | CF₃ |
| t-Bu | 3-Me | 5-Br | i-Pr | CF₃ |
| Me | 3-Me | H | t-Pr | OCF₃ |
| Et | 3-Me | H | Me | SMe |
| i-Pr | 3-Me | H | Me | OMe |
| t-Bu | 3-Me | 5-Cl | Me | OEt |
| Me | 3-Me | H | Me | n-C₃F₇ |
| Et | 3-Me | H | Me | i-C₃F₇ |
| i-Pr | 3-Me | H | Me | Et |
| t-Bu | 3-Me | 5-F | Me | OCF₂CHF₂ |
| prapargyl | 3-Me | H | Me | SCF₂CHF₂ |
| Et | 3-Me | H | Me | SO₂Me |
| i-Pr | 3-Me | H | Me | SO₂CF₃ |
| t-Bu | 3-Me | 5-Cl | CHF₂ | CF₃ |
| Me | 3-Me | H | CHF₂ | Me |
| Et | 3-Me | H | Ph | CF₃ |
| i-Pr | 3-Me | H | Ph | Cl |
| t-Bu | 3-Me | H | Ph | Br |
| cyclopropyl | 3-Me | 5-Br | 2-pyridyl | CF₃ |
| Et | 3-Me | H | 2-pyridyl | Cl |
| i-Pr | 3-Me | 5-Me | 2-ClPh | CF₃ |
| t-Bu | 3-Me | H | 2-ClPh | OCF₃ |
| Me | 3-Me | H | 2-ClPh | Br |
| Et | 3-Me | H | 2-ClPh | Cl |
| i-Pr | 3-Me | 5-Cl | 2-ClPh | SCHF₂ |
| t-Bu | 3-Me | H | 2-BrPh | CF₃ |
| propargyl | 3-Me | H | 2-MePh | CF₃ |
| Et | 3-Me | H | 2-CNPh | CF₃ |
| i-Pr | 3-Me | H | 2-FPh | CF₃ |
| t-Bu | 3-Me | 5-Br | 2,6-F₂Ph | CF₃ |
| cycloprapyl | 3-Me | H | 2,4-F₂Ph | CF₃ |
| Et | 3-Me | H | 2,5-F₂Ph | CF₃ |
| i-Pr | 3-Me | H | 2-MeOPh | CF₃ |
| t-Bu | 3-Me | H | 3-Cl-2-pyridyl | CF₃ |
| Me | 3-Me | H | 3-Cl-2-pyridyl | OCF₃ |
| Et | 3-Me | 5-Cl | 3-Cl-2-pyridyl | Br |
| i-Pr | 3-Me | H | 3-Cl-2-pyridyl | Cl |
| t-Bu | 3-Me | H | 3-Cl-2-pyridyl | SCHF₂ |
| Me | 3-Me | H | 3-F-2-pyridyl | CF₃ |
| propargyl | 3-Me | H | 3-CF₃-2-pyridyl | CF₃ |
| i-Pr | 3-Me | 5-CN | 3-Me-2-pyridyl | CF₃ |
| t-Bu | 3-Me | H | 3-Br-2-pyridyl | CF₃ |
| Me | 3-Me | H | 3-Br-2-pyridyl | OCF₃ |
| Et | 3-Me | H | 3-Br-2-pyridyl | Br |
| i-Pr | 3-Me | 5-Br | 3-Br-2-pyridyl | Cl |
| Me | 6-Me | H | H | CF₃ |
| Et | 6-Me | 4-Me | H | OCF₃ |
| i-Pr | 6-Me | H | H | OCF₃ |
| t-Bu | 6-Me | Cl | Me | Br |
| Me | 6-Me | H | Et | Br |
| Et | 6-Me | H | Me | Cl |
| i-Pr | 6-Me | 4-Br | Et | Cl |
| t-Bu | 6-Me | H | Me | I |
| propargyl | 6-Me | H | Me | CF₃ |
| cyclopropyl | 6-Me | H | Me | OCF₃ |
| i-Pr | 6-Me | 4-Cl | Me | CF₃ |
| t-Bu | 6-Me | H | Me | SCF₃ |
| Me | 6-Me | H | Me | SCHF₂ |
| Et | 6-Me | H | Me | OCHF₂ |
| i-Pr | 6-Me | 4-CN | Me | CF₃ |
| t-Bu | 6-Me | H | Me | C₂F₅ |
| propargyl | 6-Me | H | Me | C₂F₅ |
| cyclopropyl | 6-Me | H | Et | CF₃ |
| i-Pr | 6-Me | H | n-Pr | CF₃ |
| t-Bu | 6-Me | 4-Br | i-Pr | CF₃ |
| Me | 6-Me | H | Me | SMe |
| Et | 6-Me | H | Me | OMe |
| i-Pr | 6-Me | H | Me | OEt |
| t-Bu | 6-Me | 4-Cl | Me | n-C₃F₇ |
| Me | 6-Me | H | Me | i-C₃F₇ |
| Et | 6-Me | H | Me | Et |
| i-Pr | 6-Me | H | Me | OCF₂CHF₂ |
| t-Bu | 6-Me | 4-F | Me | SCF₂CHF₂ |
| propargyl | 6-Me | H | Me | SO₂Me |
| Et | 6-Me | H | Me | SO₂CF₃ |
| i-Pr | 6-Me | H | CF₃ | CF₃ |
| t-Bu | 6-Me | 4-Cl | CF₃ | Me |
| Me | 6-Me | H | Ph | CF₃ |
| Et | 6-Me | H | Ph | Cl |
| i-Pr | 6-Me | H | Ph | Br |
| t-Bu | 6-Me | H | 2-pyridyl | CF₃ |
| cyclopropyl | 6-Me | 4-Br | 2-pyridyl | Cl |
| Et | 6-Me | H | 2-ClPh | CF₃ |
| i-Pr | 6-Me | H | 2-ClPh | OCF₃ |
| t-Bu | 6-Me | 4-Me | 2-ClPh | Br |
| Me | 6-Me | H | 2-ClPh | Cl |
| Et | 6-Me | H | 2-ClPh | SCHF₂ |
| i-Pr | 6-Me | 4-Cl | 2-BrPh | CF₃ |
| t-Bu | 6-Me | H | 2-MePh | CF₃ |
| propargyl | 6-Me | H | 2-CNPh | CF₃ |
| Et | 6-Me | H | 2-FPh | CF₃ |
| i-Pr | 6-Me | H | 2,6-F₂Ph | CF₃ |
| t-Bu | 6-Me | 4-Br | 2,4-F₂Ph | CF₃ |
| cyclopropyl | 6-Me | H | 2,5-F₂Ph | CF₃ |
| Et | 6-Me | H | 2-MeOPh | CF₃ |
| i-Pr | 6-Me | H | 3-Cl-2-pyridyl | CF₃ |
| t-Bu | 6-Me | H | 3-Cl-2-pyridyl | OCF₃ |
| Me | 6-Me | H | 3-Cl-2-pyridyl | Br |
| Et | 6-Me | 4-Cl | 3-Cl-2-pyridyl | Cl |
| i-Pr | 6-Me | H | 3-Cl-2-pyridyl | SCHF₂ |
| t-Bu | 6-Me | 4-CN | 3-F-2-pyridyl | CF₃ |
| Me | 6-Me | H | 3-CF₃-2-pyridyl | CF₃ |
| propargyl | 6-Me | H | 3-Me-2-pyridyl | CF₃ |
| i-Pr | 6-Me | H | 3-Br-2-pyridyl | CF₃ |
| t-Bu | 6-Me | H | 3-Br-2-pyridyl | OCF₃ |
| Me | 6-Me | H | 3-Br-2-pyridyl | Br |
| Et | 6-Me | H | 3-Br-2-pyridyl | Cl |
| Me | 3-Cl | H | Me | Br |
| Et | 3-Br | 5-Me | Et | Br |
| i-Pr | 3-Cl | H | Me | Cl |
| t-Bu | 3-Cl | 5-Cl | Et | Cl |
| Me | 3-Cl | H | Me | I |
| Et | 3-Cl | H | Me | CF₃ |
| i-Pr | 3-Cl | 5-Br | Me | OCF₃ |
| t-Bu | 3-Cl | H | Me | CF₃ |
| propargyl | 3-Cl | H | Me | SCF₃ |
| cyclopropyl | 3-Cl | H | Me | SCHF₂ |
| i-Pr | 3-Cl | 5-Cl | Me | OCHF₂ |
| t-Bu | 3-Cl | H | Me | CF₃ |
| Me | 3-F | H | Me | C₂F₅ |
| Et | 3-Cl | H | Me | C₂F₅ |
| i-Pr | 3-Cl | 5-CN | Et | CF₃ |
| t-Bu | 3-Cl | H | n-Pr | CF₃ |
| propargyl | 3-Cl | H | i-Pr | CF₃ |
| cyclopropyl | 3-Cl | H | Me | SMe |
| i-Pr | 3-Cl | H | Me | OMe |
| t-Bu | 3-Cl | 5-Br | Me | OEt |
| Me | 3-Cl | H | Me | n-C₃F₇ |
| Et | 3-Br | H | Me | i-C₃F₇ |
| i-Pr | 3-Cl | H | Me | Et |
| t-Bu | 3-Cl | 5-Cl | Me | OCF₂CHF₂ |
| Me | 3-Cl | H | Me | SCF₂CHF₂ |
| Et | 3-Cl | H | Me | SO₂Me |
| i-Pr | 3-Cl | H | Me | SO₂CF₃ |
| t-Bu | 3-Cl | 5-F | CF₃ | CF₃ |
| propargyl | 3-Cl | H | CF₃ | Me |
| Et | 3-Cl | H | Ph | CF₃ |
| i-Pr | 3-Br | H | Ph | Cl |
| t-Bu | 3-Cl | 5-Cl | Ph | Br |
| Me | 3-Cl | H | 2-pyridyl | CF₃ |
| Et | 3-CN | H | 2-pyridyl | Cl |
| i-Pr | 3-Cl | H | 2-ClPh | CF₃ |
| t-Bu | 3-Cl | H | 2-ClPh | OCF₃ |
| cyclopropyl | 3-Cl | 5-Br | 2-ClPh | Br |
| Et | 3-Cl | H | 2-ClPh | Cl |
| i-Pr | 3-Cl | H | 2-ClPh | OCF₃ |
| t-Bu | 3-Cl | H | 2-BrPh | CF₃ |
| Me | 3-F | H | 2-MePh | CF₃ |
| Et | 3-Cl | H | 2-CNPh | CF₃ |
| i-Pr | 3-Cl | 5-Cl | 2-FPh | CF₃ |
| t-Bu | 3-Cl | H | 2,6-F₂Ph | CF₃ |
| propargyl | 3-Cl | H | 2,4-F₂Ph | CF₃ |
| Et | 3-Cl | H | 2,5-F₂Ph | CF₃ |
| i-Pr | 3-Cl | H | 2-MeOPh | CF₃ |
| t-Bu | 3-Cl | 5-Br | 3-Cl-2-pyridyl | CF₃ |
| cyclopropyl | 3-Cl | H | 3-Cl-2-pyridyl | OCF₃ |
| Et | 3-Cl | H | 3-Cl-2-pyridyl | Br |
| i-Pr | 3-Br | H | 3-Cl-2-pyridyl | Cl |
| t-Bu | 3-Cl | H | 3-Cl-2-pyridyl | SCHF₂ |
| Me | 3-Cl | H | 3-F-2-pyridyl | CF₃ |
| Et | 3-Cl | 5-Cl | 3-CF₃-2-pyridyl | CF₃ |
| i-Pr | 3-Cl | H | 3-Me-2-pyridyl | CF₃ |
| t-Bu | 3-I | H | 3-Br-2-pyridyl | CF₃ |
| Me | 3-Cl | 5-Me | 3-Br-2-pyridyl | OCF₃ |
| propargyl | 3-Cl | H | 3-Br-2-pyridyl | Br |
| i-Pr | 3-Cl | H | 3-Br-2-pyridyl | Cl |
| Me | 6-Cl | H | Et | Br |
| Et | 6-Br | 4-Me | Me | Cl |
| i-Pr | 6-Cl | H | Et | Cl |
| t-Bu | 6-Cl | Cl | Me | I |
| Me | 6-Cl | H | Me | CF₃ |
| Et | 6-Cl | H | Me | OCF₃ |
| i-Pr | 6-F | 4-Br | Me | CF₃ |
| t-Bu | 6-Cl | H | Me | SCF₃ |
| propargyl | 6-Cl | H | Me | SCHF₂ |
| cyclopropyl | 6-Cl | H | Me | OCHF₂ |
| i-Pr | 6-Cl | 4-Cl | Me | CF₃ |
| t-Bu | 6-Cl | H | Me | C₂F₅ |
| Me | 6-Cl | H | Me | C₂F₅ |
| Et | 6-Cl | H | Et | CF₃ |
| i-Pr | 6-I | 4-CN | n-Pr | CF₃ |
| t-Bu | 6-Cl | H | i-Pr | CF₃ |
| propargyl | 6-Cl | H | Me | SMe |
| cyclopropyl | 6-Cl | H | Me | OMe |
| i-Pr | 6-Cl | H | Me | OEt |
| t-Bu | 6-Cl | 4-Br | Me | n-C₃F₇ |
| Me | 6-Cl | H | Me | i-C₃F₇ |
| Et | 6-F | H | Me | Et |
| i-Pr | 6-Cl | H | Me | OCF₂CHF₂ |
| t-Bu | 6-Cl | 4-Cl | Me | SCF₂CHF₂ |
| Me | 6-Cl | H | Me | SO₂Me |
| Et | 6-I | H | Me | SO₂CF₃ |
| i-Pr | 6-Cl | H | CF₃ | CF₃ |
| t-Bu | 6-Cl | 4-F | CF₃ | Me |
| propargyl | 6-Cl | H | Ph | CF₃ |
| Et | 6-Cl | H | Ph | Cl |
| i-Pr | 6-Cl | H | Ph | Br |
| t-Bu | 6-Cl | 4-Cl | 2-pyridyl | CF₃ |
| Me | 6-Cl | H | 2-pyridyl | Cl |
| Et | 6-Cl | H | 2-ClPh | CF₃ |
| i-Pr | 6-Cl | H | 2-ClPh | OCF₃ |
| t-Bu | 6-Br | H | 2-ClPh | Br |
| cyclopropyl | 6-Cl | 4-Br | 2-ClPh | Cl |
| Et | 6-Cl | H | 2-ClPh | SCHF₂ |
| i-Pr | 6-Cl | H | 2-BrPh | CF₃ |
| t-Bu | 6-F | 4-Me | 2-MePh | CF₃ |
| Me | 6-Cl | H | 2-CNPh | CF₃ |
| Et | 6-Cl | H | 2-FPh | CF₃ |
| i-Pr | 6-CN | 4-Cl | 2,6-F₂Ph | CF₃ |
| t-Bu | 6-Cl | H | 2,4-F₂Ph | CF₃ |
| propargyl | 6-Cl | H | 2,5-F₂Ph | CF₃ |
| Et | 6-Cl | H | 2-MeOPh | CF₃ |
| i-Pr | 6-Cl | H | 3-Cl-2-pyridyl | CF₃ |
| t-Bu | 6-Cl | 4-Br | 3-Cl-2-pyridyl | OCF₃ |
| cyclopropyl | 6-Cl | H | 3-Cl-2-pyridyl | Br |
| Et | 6-F | H | 3-Cl-2-pyridyl | Cl |
| i-Pr | 6-Cl | H | 3-Cl-2-pyridyl | SCHF₂ |
| t-Bu | 6-Cl | H | 3-F-2-pyridyl | CF₃ |
| Me | 6-Cl | H | 3-CF3-2-pyridyl | CF₃ |
| Et | 6-Br | 4-Cl | 3-Me-2-pyridyl | CF₃ |
| i-Pr | 6-Cl | H | 3-Br-2-pyridyl | CF₃ |
| t-Bu | 6-Cl | H | 3-Br-2-pyridyl | OCF₃ |
| Me | 6-Cl | H | 3-Br-2-pyridyl | Br |
| propargyl | 6-Cl | H | 3-Br-2-pyridyl | Cl |

TABLE 16

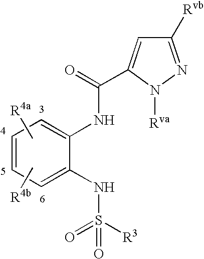

| R³ | R^{4a} | R^{4b} | R^{va} | R^{vb} |
|---|---|---|---|---|
| Me | 3-Me | H | H | CF₃ |
| Et | 3-Me | 5-Me | H | OCF₃ |
| i-Pr | 3-Me | H | H | OCF₃ |
| t-Bu | 3-Me | 5-Cl | Me | Br |
| Me | 3-Me | H | Et | Br |
| Et | 3-Me | H | Me | Cl |
| i-Pr | 3-Me | 5-Br | Et | Cl |
| t-Bu | 3-Me | H | Me | I |
| propargyl | 3-Me | H | Me | CF₃ |
| cyclopropyl | 3-Me | H | Me | OCF₃ |
| i-Pr | 3-Me | 5-Cl | Me | CF₃ |
| t-Bu | 3-Me | H | Me | SCF₃ |
| Me | 3-Me | 5-CN | Me | SCHF₂ |
| Et | 3-Me | H | Me | OCHF₂ |
| i-Pr | 3-Me | H | Me | CF₃ |
| t-Bu | 3-Me | H | Me | C₂F₅ |
| propargyl | 3-Me | H | Me | C₂F₅ |
| cyclopropyl | 3-Me | H | Et | CF₃ |
| i-Pr | 3-Me | H | n-Pr | CF₃ |
| t-Bu | 3-Me | 5-Br | i-Pr | CF₃ |
| Me | 3-Me | H | i-Pr | OCF₃ |
| Et | 3-Me | H | Me | SMe |
| i-Pr | 3-Me | H | Me | OMe |
| t-Bu | 3-Me | 5-Cl | Me | OEt |
| Me | 3-Me | H | Me | n-C₃F₇ |
| Et | 3-Me | H | Me | i-C₃F₇ |
| i-Pr | 3-Me | H | Me | Et |
| t-Bu | 3-Me | 5-F | Me | OCF₂CHF₂ |
| propargyl | 3-Me | H | Me | SCF₂CHF₂ |
| Et | 3-Me | H | Me | SO₂Me |
| i-Pr | 3-Me | H | Me | SO₂CF₃ |
| t-Bu | 3-Me | 5-Cl | CHF₂ | CF₃ |
| Me | 3-Me | H | CHF₂ | Me |
| Et | 3-Me | H | Ph | CF₃ |
| i-Pr | 3-Me | H | Ph | Cl |
| t-Bu | 3-Me | H | Ph | Br |
| cyclopropyl | 3-Me | 5-Br | 2-pyridyl | CF₃ |
| Et | 3-Me | H | 2-pyridyl | Cl |
| i-Pr | 3-Me | 5-Me | 2-ClPh | CF₃ |
| t-Bu | 3-Me | H | 2-ClPh | OCF₃ |
| Me | 3-Me | H | 2-ClPh | Br |
| Et | 3-Me | H | 2-ClPh | Cl |
| i-Pr | 3-Me | 5-Cl | 2-ClPh | SCHF₂ |
| t-Bu | 3-Me | H | 2-BrPh | CF₃ |
| propargyl | 3-Me | H | 2-MePh | CF₃ |
| Et | 3-Me | H | 2-CNPh | CF₃ |
| i-Pr | 3-Me | H | 2-FPh | CF₃ |
| t-Bu | 3-Me | 5-Br | 2,6-F₂Ph | CF₃ |
| cyclopropyl | 3-Me | H | 2,4-F₂Ph | CF₃ |
| Et | 3-Me | H | 2,5-F₂Ph | CF₃ |
| i-Pr | 3-Me | H | 2-MeOPh | CF₃ |
| t-Bu | 3-Me | H | 3-Cl-2-pyridyl | CF₃ |
| Me | 3-Me | H | 3-Cl-2-pyridyl | OCF₃ |
| Et | 3-Me | 5-Cl | 3-Cl-2-pyridyl | Br |
| i-Pr | 3-Me | H | 3-Cl-2-pyridyl | Cl |
| t-Bu | 3-Me | H | 3-Cl-2-pyridyl | SCHF₂ |
| Me | 3-Me | H | 3-F-2-pyridyl | CF₃ |
| propargyl | 3-Me | H | 3-CF₃-2-pyridyl | CF₃ |
| i-Pr | 3-Me | 5-CN | 3-Me-2-pyridyl | CF₃ |
| t-Bu | 3-Me | H | 3-Br-2-pyridyl | CF₃ |
| Me | 3-Me | H | 3-Br-2-pyridyl | OCF₃ |
| Et | 3-Me | H | 3-Br-2-pyridyl | Br |
| i-Pr | 3-Me | 5-Br | 3-Br-2-pyridyl | Cl |
| Me | 6-Me | H | H | CF₃ |
| Et | 6-Me | 4-Me | H | OCF₃ |
| i-Pr | 6-Me | H | H | OCF₃ |
| t-Bu | 6-Me | Cl | Me | Br |
| Me | 6-Me | H | Et | Br |
| Et | 6-Me | H | Me | Cl |
| i-Pr | 6-Me | 4-Br | Et | Cl |
| t-Bu | 6-Me | H | Me | I |
| propargyl | 6-Me | H | Me | CF₃ |
| cyclopropyl | 6-Me | H | Me | OCF₃ |
| i-Pr | 6-Me | 4-Cl | Me | CF₃ |
| t-Bu | 6-Me | H | Me | SCF₃ |
| Me | 6-Me | H | Me | SCHF₂ |
| Et | 6-Me | H | Me | OCHF₂ |
| i-Pr | 6-Me | 4-CN | Me | CF₃ |
| t-Bu | 6-Me | H | Me | C₂F₅ |
| propargyl | 6-Me | H | Me | C₂F₅ |
| cyclopropyl | 6-Me | H | Et | CF₃ |
| i-Pr | 6-Me | H | n-Pr | CF₃ |
| t-Bu | 6-Me | 4-Br | i-Pr | CF₃ |
| Me | 6-Me | H | Me | SMe |
| Et | 6-Me | H | Me | OMe |
| i-Pr | 6-Me | H | Me | OEt |
| t-Bu | 6-Me | 4-Cl | Me | n-C₃F₇ |
| Me | 6-Me | H | Me | i-C₃F₇ |
| Et | 6-Me | H | Me | Et |
| i-Pr | 6-Me | H | Me | OCF₂CHF₂ |
| t-Bu | 6-Me | 4-F | Me | SCF₂CHF₂ |
| propargyl | 6-Me | H | Me | SO₂Me |
| Et | 6-Me | H | Me | SO₂CF₃ |
| i-Pr | 6-Me | H | CF₃ | CF₃ |
| t-Bu | 6-Me | 4-Cl | CF₃ | Me |
| Me | 6-Me | H | Ph | CF₃ |
| Et | 6-Me | H | Ph | Cl |
| i-Pr | 6-Me | H | Ph | Br |
| t-Bu | 6-Me | H | 2-pyridyl | CF₃ |
| cyclopropyl | 6-Me | 4-Br | 2-pyridyl | Cl |
| Et | 6-Me | H | 2-ClPh | CF₃ |
| i-Pr | 6-Me | H | 2-ClPh | OCF₃ |
| t-Bu | 6-Me | 4-Me | 2-ClPh | Br |
| Me | 6-Me | H | 2-ClPh | Cl |
| Et | 6-Me | H | 2-ClPh | SCHF₂ |
| i-Pr | 6-Me | 4-Cl | 2-BrPh | CF₃ |
| t-Bu | 6-Me | H | 2-MePh | CF₃ |
| propargyl | 6-Me | H | 2-CNPh | CF₃ |
| Et | 6-Me | H | 2-FPh | CF₃ |
| i-Pr | 6-Me | H | 2,6-F₂Ph | CF₃ |
| t-Bu | 6-Me | 4-Br | 2,4-F₂Ph | CF₃ |
| cyclopropyl | 6-Me | H | 2,5-F₂Ph | CF₃ |
| Et | 6-Me | H | 2-MeOPh | CF₃ |
| i-Pr | 6-Me | H | 3-Cl-2-pyridyl | CF₃ |
| t-Bu | 6-Me | H | 3-Cl-2-pyridyl | OCF₃ |
| Me | 6-Me | H | 3-Cl-2-pyridyl | Br |
| Et | 6-Me | 4-Cl | 3-Cl-2-pyridyl | Cl |
| i-Pr | 6-Me | H | 3-Cl-2-pyridyl | SCHF₂ |
| t-Bu | 6-Me | 4-CN | 3-F-2-pyridyl | CF₃ |
| Me | 6-Me | H | 3-CF₃-2-pyridyl | CF₃ |
| propargyl | 6-Me | H | 3-Me-2-pyridyl | CF₃ |
| i-Pr | 6-Me | H | 3-Br-2-pyridyl | CF₃ |
| t-Bu | 6-Me | H | 3-Br-2-pyridyl | OCF₃ |
| Me | 6-Me | H | 3-Br-2-pyridyl | Br |
| Et | 6-Me | H | 3-Br-2-pyridyl | Cl |
| Me | 3-Cl | H | Me | Br |
| Et | 3-Br | 5-Me | Et | Br |
| i-Pr | 3-Cl | H | Me | Cl |
| t-Bu | 3-Cl | 5-Cl | Et | Cl |
| Me | 3-Cl | H | Me | I |
| Et | 3-Cl | H | Me | CF₃ |
| i-Pr | 3-Cl | 5-Br | Me | OCF₃ |
| t-Bu | 3-Cl | H | Me | CF₃ |
| propargyl | 3-Cl | H | Me | SCF₃ |
| cyclopropyl | 3-Cl | H | Me | SCHF₂ |
| i-Pr | 3-Cl | 5-Cl | Me | OCHF₂ |
| t-Bu | 3-Cl | H | Me | CF₃ |
| Me | 3-F | H | Me | C₂F₅ |
| Et | 3-Cl | H | Me | C₂F₅ |
| i-Pr | 3-Cl | 5-CN | Et | CF₃ |
| t-Bu | 3-Cl | H | n-Pr | CF₃ |
| propargyl | 3-Cl | H | i-Pr | CF₃ |
| cyclopropyl | 3-Cl | H | Me | SMe |
| i-Pr | 3-Cl | H | Me | OMe |
| t-Bu | 3-Cl | 5-Br | Me | OEt |
| Me | 3-Cl | H | Me | n-C₃F₇ |
| Et | 3-Br | H | Me | i-C₃F₇ |
| i-Pr | 3-Cl | H | Me | Et |
| t-Bu | 3-Cl | 5-Cl | Me | OCF₂CHF₂ |
| Me | 3-Cl | H | Me | SCF₂CHF₂ |
| Et | 3-Cl | H | Me | SO₂Me |
| i-Pr | 3-Cl | H | Me | SO₂CF₃ |
| t-Bu | 3-Cl | 5-F | CF₃ | CF₃ |
| propargyl | 3-Cl | H | CF₃ | Me |
| Et | 3-Cl | H | Ph | CF₃ |
| i-Pr | 3-Br | H | Ph | Cl |
| t-Bu | 3-Cl | 5-Cl | Ph | Br |
| Me | 3-Cl | H | 2-pyridyl | CF₃ |
| Et | 3-CN | H | 2-pyridyl | Cl |
| i-Pr | 3-Cl | H | 2-ClPh | CF₃ |
| t-Bu | 3-Cl | H | 2-ClPh | OCF₃ |
| cyclopropyl | 3-Cl | 5-Br | 2-ClPh | Br |
| Et | 3-Cl | H | 2-ClPh | Cl |
| i-Pr | 3-Cl | H | 2-ClPh | OCF₃ |
| t-Bu | 3-Cl | H | 2-BrPh | CF₃ |
| Me | 3-F | H | 2-MePh | CF₃ |
| Et | 3-Cl | H | 2-CNPh | CF₃ |
| i-Pr | 3-Cl | 5-Cl | 2-FPh | CF₃ |
| t-Bu | 3-Cl | H | 2,6-F₂Ph | CF₃ |
| propargyl | 3-Cl | H | 2,4-F₂Ph | CF₃ |
| Et | 3-Cl | H | 2,5-F₂Ph | CF₃ |
| i-Pr | 3-Cl | H | 2-MeOPh | CF₃ |
| t-Bu | 3-Cl | 5-Br | 3-Cl-2-pyridyl | CF₃ |
| cyclopropyl | 3-Cl | H | 3-Cl-2-pyridyl | OCF₃ |
| Et | 3-Cl | H | 3-Cl-2-pyridyl | Br |
| i-Pr | 3-Br | H | 3-Cl-2-pyridyl | Cl |
| t-Bu | 3-Cl | H | 3-Cl-2-pyridyl | SCHF₂ |
| Me | 3-Cl | H | 3-F-2-pyridyl | CF₃ |
| Et | 3-Cl | 5-Cl | 3-CF₃-2-pyridyl | CF₃ |
| i-Pr | 3-Cl | H | 3-Me-2-pyridyl | CF₃ |
| t-Bu | 3-I | H | 3-Br-2-pyridyl | CF₃ |
| Me | 3-Cl | 5-Me | 3-Br-2-pyridyl | OCF₃ |
| propargyl | 3-Cl | H | 3-Br-2-pyridyl | Br |
| i-Pr | 3-Cl | H | 3-Br-2-pyridyl | Cl |
| Me | 6-Cl | H | Et | Br |
| Et | 6-Br | 4-Me | Me | Cl |
| i-Pr | 6-Cl | H | Et | Cl |
| t-Bu | 6-Cl | Cl | Me | I |
| Me | 6-Cl | H | Me | CF₃ |
| Et | 6-Cl | H | Me | OCF₃ |
| i-Pr | 6-F | 4-Br | Me | CF₃ |
| t-Bu | 6-Cl | H | Me | SCF₃ |
| propargyl | 6-Cl | H | Me | SCHF₂ |
| cyclopropyl | 6-Cl | H | Me | OCHF₂ |
| i-Pr | 6-Cl | 4-Cl | Me | CF₃ |
| t-Bu | 6-Cl | H | Me | C₂F₅ |
| Me | 6-Cl | H | Me | C₂F₅ |
| Et | 6-Cl | H | Et | CF₃ |
| i-Pr | 6-I | 4-CN | n-Pr | CF₃ |
| t-Bu | 6-Cl | H | i-Pr | CF₃ |
| propargyl | 6-Cl | H | Me | SMe |
| cyclopropyl | 6-Cl | H | Me | OMe |
| i-Pr | 6-Cl | H | Me | OEt |
| t-Bu | 6-Cl | 4-Br | Me | n-C₃F₇ |
| Me | 6-Cl | H | Me | i-C₃F₇ |
| Et | 6-F | H | Me | Et |
| i-Pr | 6-Cl | H | Me | OCF₂CHF₂ |
| t-Bu | 6-Cl | 4-Cl | Me | SCF₂CHF₂ |
| Me | 6-Cl | H | Me | SO₂Me |
| Et | 6-I | H | Me | SO₂CF₃ |
| i-Pr | 6-Cl | H | CF₃ | CF₃ |
| t-Bu | 6-Cl | 4-F | CF₃ | Me |
| propargyl | 6-Cl | H | Ph | CF₃ |
| Et | 6-Cl | H | Ph | Cl |
| i-Pr | 6-Cl | H | Ph | Br |
| t-Bu | 6-Cl | 4-Cl | 2-pyridyl | CF₃ |
| Me | 6-Cl | H | 2-pyridyl | Cl |
| Et | 6-Cl | H | 2-ClPh | CF₃ |
| i-Pr | 6-Cl | H | 2-ClPh | OCF₃ |
| t-Bu | 6-Br | H | 2-ClPh | Br |
| cyclopropyl | 6-Cl | 4-Br | 2-ClPh | Cl |
| Et | 6-Cl | H | 2-ClPh | SCHF₂ |
| i-Pr | 6-Cl | H | 2-BrPh | CF₃ |
| t-Bu | 6-F | 4-Me | 2-MePh | CF₃ |
| Me | 6-Cl | H | 2-CNPh | CF₃ |
| Et | 6-Cl | H | 2-FPh | CF₃ |
| i-Pr | 6-CN | 4-Cl | 2,6-F₂Ph | CF₃ |
| t-Bu | 6-Cl | H | 2,4-F₂Ph | CF₃ |
| propargyl | 6-Cl | H | 2,5-F₂Ph | CF₃ |
| Et | 6-Cl | H | 2-MeOPh | CF₃ |
| i-Pr | 6-Cl | H | 3-Cl-2-pyridyl | CF₃ |
| t-Bu | 6-Cl | 4-Br | 3-Cl-2-pyridyl | OCF₃ |
| cyclopropyl | 6-Cl | H | 3-Cl-2-pyridyl | Br |
| Et | 6-F | H | 3-Cl-2-pyridyl | Cl |
| i-Pr | 6-Cl | H | 3-Cl-2-pyridyl | SCHF₂ |
| t-Bu | 6-Cl | H | 3-F-2-pyridyl | CF₃ |
| Me | 6-Cl | H | 3-CF₃-2-pyridyl | CF₃ |
| Et | 6-Br | 4-Cl | 3-Me-2-pyridyl | CF₃ |
| i-Pr | 6-Cl | H | 3-Br-2-pyridyl | CF₃ |
| t-Bu | 6-Cl | H | 3-Br-2-pyridyl | OCF₃ |
| Me | 6-Cl | H | 3-Br-2-pyridyl | Br |
| propargyl | 6-Cl | H | 3-Br-2-pyridyl | Cl |

TABLE 17

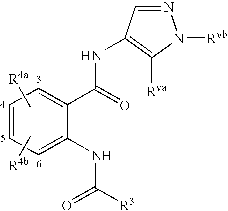

| R³ | R^{4a} | R^{4b} | R^{va} | R^{vb} |
|---|---|---|---|---|
| Me | 3-Me | H | H | CHF₂ |
| Et | 3-Me | 5-Me | H | CH₂CF₃ |
| i-Pr | 3-Me | H | H | CH₂CF₃ |
| t-Bu | 3-Me | 5-Cl | Me | CH₂CF₃ |
| Me | 3-Me | H | Et | CH₂CF₃ |
| Et | 3-Me | H | Me | CF₂CHF₂ |
| i-Pr | 3-Me | 5-Br | Et | CHF₂ |
| t-Bu | 3-Me | H | Me | CHF₂ |
| propargyl | 3-Me | H | Me | CBrF₂ |
| cyclopropyl | 3-Me | H | Me | CH₂F |
| i-Pr | 3-Me | 5-Cl | Me | CH₂CF₃ |
| t-Bu | 3-Me | H | Me | Et |
| Me | 3-Me | 5-CN | Me | n-Pr |
| Et | 3-Me | H | Me | CH₂C₂F₅ |
| i-Pr | 3-Me | H | Me | CH₂CF₃ |
| t-Bu | 3-Me | H | Me | CF₃ |
| propargyl | 3-Me | H | Me | C₂F₅ |
| cyclopropyl | 3-Me | H | Et | CHF₂ |
| i-Pr | 3-Me | H | n-Pr | CH₂CF₃ |
| t-Bu | 3-Me | 5-Br | i-Pr | CHF₂ |
| Me | 3-Me | H | Cl | CH₂CF₃ |
| Et | 3-Me | H | F | CH₂CF₃ |
| i-Pr | 3-Me | H | Me | CH₂Cl |
| t-Bu | 3-Me | 5-Cl | Me | CClF₂ |
| Me | 3-Me | H | Me | CH₂CH₂Cl |
| Et | 3-Me | H | Me | n-C₃F₇ |
| i-Pr | 3-Me | H | Me | i-C₃F₇ |
| t-Bu | 3-Me | 5-F | Me | Allyl |
| propargyl | 3-Me | H | Et | CF₂CHF₂ |
| Et | 3-Me | H | Et | i-C₃F₇ |
| i-Pr | 3-Me | H | n-Pr | CF₂CHF₂ |
| t-Bu | 3-Me | 5-Cl | i-Pr | CF₂CHF₂ |
| Me | 3-Me | H | CF₃ | CF₂CHF₂ |
| Et | 3-Me | H | CF₃ | Me |
| i-Pr | 3-Me | H | OMe | CH₂CF₃ |
| t-Bu | 3-Me | H | H | CH₂CF₃ |
| cyclopropyl | 3-Me | 5-Br | H | CH₂CF₃ |
| Et | 3-Me | H | H | C₂F₅ |
| i-Pr | 3-Me | 5-Me | H | C₂F₅ |
| t-Bu | 3-Me | H | H | C₂F₅ |
| Me | 3-Me | H | H | CF₂CHF₂ |
| Et | 3-Me | H | i-Pr | CH₂CF₃ |
| i-Pr | 3-Me | 5-Cl | H | n-C₃F₇ |
| t-Bu | 3-Me | H | H | i-C₃F₇ |
| propargyl | 3-Me | H | Ph | CH₂CF₃ |
| Et | 3-Me | H | Ph | CF₂CHF₂ |
| i-Pr | 3-Me | H | Ph | CHF₂ |
| t-Bu | 3-Me | 5-Br | 2-pyridyl | CH₂CHF₂ |
| cyclopropyl | 3-Me | H | 2-pyridyl | CF₂CHF₂ |
| Et | 3-Me | H | 2-ClPh | CH₂CF₃ |
| i-Pr | 3-Me | H | 2-ClPh | CF₂CHF₂ |
| t-Bu | 3-Me | H | 2-ClPh | CHF₂ |
| Me | 3-Me | H | 2-ClPh | Et |
| Et | 3-Me | 5-Cl | 2-ClPh | CBrF₂ |
| i-Pr | 3-Me | H | 2-BrPh | CH₂CF₃ |
| t-Bu | 3-Me | H | 2-MePh | CF₂CHF₂ |
| Me | 3-Me | H | 2-CNPh | CH₂CF₃ |
| propargyl | 3-Me | H | 2-FPh | CH₂CF₃ |
| i-Pr | 3-Me | 5-CN | 2,6-F₂Ph | CF₂CHF₂ |
| t-Bu | 3-Me | H | 2,4-F₂Ph | CH₂CF₃ |
| Me | 3-Me | H | 2,5-F₂Ph | CH₂CF₃ |
| Et | 3-Me | H | 2-MeOPh | CF₂CHF₂ |
| i-Pr | 3-Me | 5-Br | 3-Cl-2-pyridyl | CH₂CF₃ |
| t-Bu | 3-Me | H | 3-Cl-2-pyridyl | CF₂CHF₂ |
| Me | 3-Me | 5-I | 3-Cl-2-pyridyl | CF₃ |
| Et | 3-Me | H | 3-Cl-2-pyridyl | CHF₂ |
| i-Pr | 3-Me | 5-Me | 3-Cl-2-pyridyl | CBrF₂ |
| t-Bu | 3-Me | H | 3-F-2-pyridyl | CH₂CF₃ |
| propargyl | 3-Me | H | 3-CF₃-2-pyridyl | CF₂CHF₂ |
| Et | 3-Me | 5-Br | 3-Me-2-pyridyl | CH₂CF₃ |
| i-Pr | 3-Me | H | 3-Br-2-pyridyl | CF₃ |
| t-Bu | 3-Me | H | 3-Br-2-pyridyl | CH₂CF₃ |
| Me | 3-Me | H | 3-Br-2-pyridyl | CF₂CHF₂ |
| Et | 3-Me | H | 3-Br-2-pyridyl | CClF₂ |
| Me | 6-Me | H | H | CHF₂ |
| Et | 6-Me | 4-Me | H | CH₂CF₃ |
| i-Pr | 6-Me | H | H | CH₂CF₃ |
| t-Bu | 6-Me | Cl | Me | CH₂CF₃ |
| Me | 6-Me | H | Et | CH₂CF₃ |
| Et | 6-Me | H | Me | CF₂CHF₂ |
| i-Pr | 6-Me | 4-Br | Et | CHF₂ |
| t-Bu | 6-Me | H | Me | CHF₂ |
| propargyl | 6-Me | H | Me | CBrF₂ |
| cyclopropyl | 6-Me | H | Me | CH₂F |
| i-Pr | 6-Me | 4-Cl | Me | CH₂CF₃ |
| t-Bu | 6-Me | H | Me | Et |
| Me | 6-Me | H | Me | n-Pr |
| Et | 6-Me | H | Me | CH₂C₂F₅ |
| i-Pr | 6-Me | 4-CN | Me | CH₂CF₃ |
| t-Bu | 6-Me | H | Me | CF₃ |
| propargyl | 6-Me | H | Me | C₂F₅ |
| cyclopropyl | 6-Me | H | Et | CHF₂ |
| i-Pr | 6-Me | H | n-Pr | CH₂CF₃ |
| t-Bu | 6-Me | 4-Br | i-Pr | CHF₂ |
| Me | 6-Me | H | Cl | CH₂CF₃ |
| Et | 6-Me | H | F | CH₂CF₃ |
| i-Pr | 6-Me | H | Me | CH₂Cl |
| t-Bu | 6-Me | 4-Cl | Me | CClF₂ |
| Me | 6-Me | H | Me | CH₂CH₂Cl |
| Et | 6-Me | H | Me | n-C₃F₇ |
| i-Pr | 6-Me | H | Me | i-C₃F₇ |
| t-Bu | 6-Me | 4-F | Me | Allyl |
| propargyl | 6-Me | H | Me | CF₂CHF₂ |
| Et | 6-Me | H | Me | i-C₃F₇ |
| i-Pr | 6-Me | H | Me | CF₂CHF₂ |
| t-Bu | 6-Me | 4-Cl | Me | CF₂CHF₂ |
| Me | 6-Me | H | CF₃ | CF₂CHF₂ |
| Et | 6-Me | H | CF₃ | Me |
| i-Pr | 6-Me | H | OMe | CH₂CF₃ |
| t-Bu | 6-Me | H | H | CH₂CF₃ |
| cyclopropyl | 6-Me | 4-Br | H | CH₂CF₃ |
| Et | 6-Me | H | H | C₂F₅ |
| i-Pr | 6-Me | H | H | C₂F₅ |
| t-Bu | 6-Me | 4-Me | H | C₂F₅ |
| Me | 6-Me | H | H | CF₂CHF₂ |
| Et | 6-Me | H | H | CH₂CF₃ |
| i-Pr | 6-Me | 4-Cl | H | n-C₃F₇ |
| t-Bu | 6-Me | H | H | i-C₃H₇ |
| propargyl | 6-Me | H | H | CH₂CF₃ |
| Et | 6-Me | H | H | CF₂CHF₂ |
| i-Pr | 6-Me | H | H | CHF₂ |
| t-Bu | 6-Me | 4-Br | Ph | CH₂CF₃ |
| cyclopropyl | 6-Me | H | Ph | CF₂CHF₂ |
| Et | 6-Me | H | Ph | CH₂CF₃ |
| i-Pr | 6-Me | H | 2-pyridyl | CF₂CHF₂ |
| t-Bu | 6-Me | H | 2-pyrisyl | CHF₂ |
| Me | 6-Me | H | 2-ClPh | Et |
| Et | 6-Me | 4-Cl | 2-ClPh | CBrF₂ |
| i-Pr | 6-Me | H | 2-ClPh | CH₂CF₃ |
| t-Bu | 6-Me | 4-CN | 2-ClPh | CF₂CHF₂ |
| Me | 6-Me | H | 2-ClPh | CH₂CF₃ |
| propargyl | 6-Me | H | 2-BrPh | CH₂CF₃ |
| i-Pr | 6-Me | H | 2-MePh | CF₂CHF₂ |
| t-Bu | 6-Me | H | 2-CNPh | CH₂CF₃ |
| Me | 6-Me | H | 2-FPh | CH₂CF₃ |
| Et | 6-Me | H | 2,6-F₂Ph | CF₂CHF₂ |
| i-Pr | 6-Me | 4-Br | 2,4-F₂Ph | CH₂CF₃ |
| t-Bu | 6-Me | H | 2,5-F₂Ph | CF₂CHF₂ |
| Me | 6-Me | 4-I | 2-MeOPh | CF₃ |
| Et | 6-Me | H | 3-Cl-2-pyridyl | CHF₂ |
| i-Pr | 6-Me | H | 3-Cl-2-pyridyl | CBrF₂ |
| t-Bu | 6-Me | H | 3-Cl-2-pyridyl | CH₂CF₃ |
| propargyl | 6-Me | H | 3-Cl-2-pyridyl | CF₂CHF₂ |
| Et | 6-Me | 4-Br | 3-Cl-2-pyridyl | CH₂CF₃ |
| i-Pr | 6-Me | H | 3-F-2-pyridyl | CF₃ |
| t-Bu | 6-Me | H | 3-CF₃-2-pyridyl | CH₂CF₃ |
| Me | 6-Me | H | 3-Me-2-pyridyl | CF₂CHF₂ |
| Et | 6-Me | H | 3-Br-2-pyridyl | CClF₂ |
| i-Pr | 6-Me | 4-Cl | 3-Br-2-pyridyl | CH₂CF₃ |
| t-Bu | 6-Me | H | 3-Br-2-pyridyl | CF₃ |
| i-Pr | 6-Me | H | 3-Br-2-pyridyl | CF₂CHF₂ |
| Me | 3-Cl | H | H | CHF₂ |
| Et | 3-Br | 5-Me | H | CH₂CF₃ |
| i-Pr | 3-Cl | H | H | CH₂CF₃ |
| t-Bu | 3-Cl | 5-Cl | Me | CH₂CF₃ |
| Me | 3-Cl | H | Et | CH₂CF₃ |
| Et | 3-Cl | H | Me | CF₂CHF₂ |
| i-Pr | 3-Cl | 5-Br | Et | CHF₂ |
| t-Bu | 3-Cl | H | Me | CHF₂ |
| propargyl | 3-Cl | H | Me | CBrF₂ |
| cyclopropyl | 3-Cl | H | Me | CH₂F |
| i-Pr | 3-Cl | 5-Cl | Me | CH₂CF₃ |
| t-Bu | 3-Cl | H | Me | Et |
| Me | 3-F | H | Me | n-Pr |
| Et | 3-Cl | H | Me | CH₂C₂F₅ |
| i-Pr | 3-Cl | 5-CN | Me | CH₂CF₃ |
| t-Bu | 3-Cl | H | Me | CF₃ |
| propargyl | 3-Cl | H | Me | C₂F₅ |
| cyclopropyl | 3-Cl | H | Et | CHF₂ |
| i-Pr | 3-Cl | H | n-Pr | CH₂CF₃ |
| t-Bu | 3-Cl | 5-Br | i-Pr | CHF₂ |
| Me | 3-Cl | H | Cl | CH₂CF₃ |
| Et | 3-Br | H | F | CH₂CF₃ |
| i-Pr | 3-Cl | H | Me | CH₂Cl |
| t-Bu | 3-Cl | 5-Cl | Me | CClF₂ |
| Me | 3-Cl | H | Me | CH₂CH₂Cl |
| Et | 3-Cl | H | Me | n-C₃F₇ |
| i-Pr | 3-Cl | H | Me | i-C₃F₇ |
| propargyl | 3-Cl | 5-F | Me | Allyl |
| propargyl | 3-Cl | H | Me | CF₂CHF₂ |
| Et | 3-Cl | H | Me | i-C₃F₇ |
| i-Pr | 3-Br | H | Me | CF₂CHF₂ |
| t-Bu | 3-Cl | 5-Cl | Me | CF₂CHF₂ |
| Me | 3-Cl | H | CF₃ | CF₂CHF₂ |
| Et | 3-CN | H | CF₃ | Me |
| i-Pr | 3-Cl | H | OMe | CH₂CF₃ |
| t-Bu | 3-Cl | H | H | CH₂CF₃ |
| cyclopropyl | 3-Cl | 5-Br | H | CH₂CF₃ |
| Et | 3-Cl | H | H | C₂F₅ |
| i-Pr | 3-Cl | H | H | C₂F₅ |
| t-Bu | 3-Cl | H | H | C₂F₅ |
| Me | 3-F | H | H | CF₂CHF₂ |
| Et | 3-Cl | H | H | CH₂CF₃ |
| i-Pr | 3-Cl | 5-Cl | H | n-C₃F₇ |
| t-Bu | 3-Cl | H | H | i-C₃F₇ |
| propargyl | 3-Cl | H | H | CH₂CF₃ |
| Et | 3-Cl | H | H | CF₂CHF₂ |
| i-Pr | 3-Cl | H | H | CHF₂ |
| t-Bu | 3-Cl | 5-Br | Ph | CH₂CF₃ |
| cyclopropyl | 3-Cl | H | Ph | CF₂CHF₂ |
| Et | 3-Cl | H | Ph | CH₂CF₃ |
| i-Pr | 3-Br | H | 2-pyridyl | CF₂CHF₂ |
| t-Bu | 3-Cl | H | 2-pyridyl | CHF₂ |
| Me | 3-Cl | H | 2-ClPh | Et |
| Et | 3-Cl | 5-Cl | 2-ClPh | CBrF₂ |
| i-Pr | 3-Cl | H | 2-ClPh | CH₂CF₃ |
| t-Bu | 3-I | H | 2-ClPh | CF₂CHF₂ |
| Me | 3-Cl | 5-Me | 2-ClPh | CH₂CF₃ |
| propargyl | 3-Cl | H | 2-BrPh | CH₂CF₃ |
| i-Pr | 3-Cl | H | 2-MePh | CF₂CHF₂ |
| t-Bu | 3-Cl | 5-CN | 2-CNPh | CH₂CF₃ |
| Me | 3-Cl | H | 2-FPh | CH₂CF₃ |
| Et | 3-Cl | H | 2,6-F₂Ph | CF₂CHF₂ |
| i-Pr | 3-Cl | 5-Br | 2,4-F₂Ph | CH₂CF₃ |
| t-Bu | 3-F | H | 2,5-F₂Ph | CF₂CHF₂ |
| Me | 3-Cl | 5-I | 2-MeOPh | CF₃ |
| Et | 3-Cl | H | 3-Cl-2-pyridyl | CHF₂ |
| i-Pr | 3-CN | H | 3-Cl-2-pyridyl | CBrF₂ |
| t-Bu | 3-Cl | H | 3-Cl-2-pyridyl | CH₂CF₃ |
| propargyl | 3-Cl | H | 3-Cl-2-pyridyl | CF₂CHF₂ |
| Et | 3-Cl | 5-Br | 3-Cl-2-pyridyl | CH₂CF₃ |
| i-Pr | 3-Cl | H | 3-F-2-pyridyl | CF₃ |
| t-Bu | 3-Br | H | 3-CF₃-2-pyridyl | CH₂CF₃ |
| Me | 3-Cl | H | 3-Me-2-pyridyl | CF₂CHF₂ |
| Et | 3-Cl | H | 3-Br-2-pyridyl | CClF₂ |
| i-Pr | 3-Cl | 5-Cl | 3-Br-2-pyridyl | CH₂CF₃ |
| t-Bu | 3-Cl | H | 3-Br-2-pyridyl | CF₃ |
| i-Pr | 3-Cl | H | 3-Br-2-pyridyl | CF₂CHF₂ |
| Me | 6-Cl | H | Et | CHF₂ |
| Et | 6-Br | 4-Me | Me | CH₂CF₃ |
| i-Pr | 6-Cl | H | Et | CH₂CF₃ |
| t-Bu | 6-Cl | Cl | Me | CH₂CF₃ |
| Me | 6-Cl | H | Me | CH₂CF₃ |
| Et | 6-Cl | H | Me | CF₂CHF₂ |
| i-Pr | 6-F | 4-Br | Me | CHF₂ |
| t-Bu | 6-Cl | H | Me | CHF₂ |
| propargyl | 6-Cl | H | Me | CBrF₂ |
| cyclopropyl | 6-Cl | H | Me | CH₂F |
| i-Pr | 6-Cl | 4-Cl | Me | CH₂CF₃ |
| t-Bu | 6-Cl | H | Me | Et |
| Me | 6-Cl | H | Me | n-Pr |
| Et | 6-Cl | H | Et | CH₂C₂F₅ |
| i-Pr | 6-I | 4-CN | n-Pr | CH₂CF₃ |
| t-Bu | 6-Cl | H | i-Pr | CF₃ |
| propargyl | 6-Cl | H | Cl | C₂F₅ |
| cyclopropyl | 6-Cl | H | F | CHF₂ |
| i-Pr | 6-Cl | H | Me | CH₂CF₃ |
| t-Bu | 6-Cl | 4-Br | Me | CHF₂ |
| Me | 6-Cl | H | Me | CH₂CF₃ |
| Et | 6-F | H | Me | CH₂CF₃ |
| i-Pr | 6-Cl | H | Me | CH₂Cl |
| t-Bu | 6-Cl | 4-Cl | Me | CClF₂ |
| Me | 6-Cl | H | Me | CH₂CH₂Cl |
| Et | 6-I | H | Me | n-C₃F₇ |
| i-Pr | 6-Cl | H | Me | i-C₃F₇ |
| t-Bu | 6-Cl | 4-F | Me | Allyl |
| propargyl | 6-Cl | H | CF₃ | CF₂CHF₂ |
| Et | 6-Cl | H | CF₃ | i-C₃F₇ |
| i-Pr | 6-Cl | H | OMe | CF₂CHF₂ |
| t-Bu | 6-Cl | 4-Cl | H | CF₂CHF₂ |
| Me | 6-Cl | H | H | CF₂CHF₂ |
| Et | 6-Cl | H | H | Me |
| i-Pr | 6-Cl | H | H | CH₂CF₃ |
| t-Bu | 6-Br | H | H | CH₂CF₃ |
| cyclopropyl | 6-Cl | 4-Br | H | CH₂CF₃ |
| Et | 6-Cl | H | H | C₂F₅ |
| i-Pr | 6-Cl | H | H | C₂F₅ |
| t-Bu | 6-F | 4-Me | H | C₂F₅ |
| Me | 6-Cl | H | H | CF₂CHF₂ |
| Et | 6-Cl | H | H | CH₂CF₃ |
| i-Pr | 6-CN | 4-Cl | H | n-C₃F₇ |
| t-Bu | 6-Cl | H | Ph | i-C₃F₇ |
| propargyl | 6-Cl | H | Ph | CH₂CF₃ |
| Et | 6-Cl | H | Ph | CF₂CHF₂ |
| i-Pr | 6-Cl | H | 2-pyridyl | CHF₂ |
| t-Bu | 6-Cl | 4-Br | 2-pyridyl | CH₂CF₃ |
| cyclopropyl | 6-Cl | H | 2-ClPh | CF₂CHF₂ |
| Et | 6-F | H | 2-ClPh | CH₂CF₃ |
| i-Pr | 6-Cl | H | 2-ClPh | CF₂CHF₂ |
| t-Bu | 6-Cl | H | 2-ClPh | CHF₂ |
| Me | 6-Cl | H | 2-ClPh | Et |
| Et | 6-Br | 4-Cl | 2-BrPh | CBrF₂ |
| i-Pr | 6-Cl | H | 2-MePh | CH₂CF₃ |
| t-Bu | 6-Cl | H | 2-CNPh | CF₂CHF₂ |
| Me | 6-Cl | H | 2-FPh | CH₂CF₃ |
| propargyl | 6-Cl | H | 2,6-F₂Ph | CH₂CF₃ |
| i-Pr | 6-Br | H | 2,4-F₂Ph | CF₂CHF₂ |
| t-Bu | 6-Cl | 4-CN | 2,5-F₂Ph | CH₂CF₃ |
| Me | 6-Cl | H | 2-MeOPh | CH₂CF₃ |
| Et | 6-Cl | H | 3-Cl-2-pyridyl | CF₂CHF₂ |
| i-Pr | 6-Cl | 4-Br | 3-Cl-2-pyridyl | CH₂CF₃ |
| t-Bu | 6-CN | H | 3-Cl-2-pyridyl | CF₂CHF₂ |
| Me | 6-Cl | 4-I | 3-Cl-2-pyridyl | CF₃ |
| Et | 6-Cl | H | 3-Cl-2-pyridyl | CHF₂ |
| i-Pr | 6-Br | H | 3-F-2-pyridyl | CBrF₂ |
| t-Bu | 6-Cl | H | 3-CF₃-2-pyridyl | CH₂CF₃ |
| propargyl | 6-Cl | H | 3-Me-2-pyridyl | CF₂CHF₂ |
| Et | 6-Cl | 4-Br | 3-Br-2-pyridyl | CH₂CF₃ |
| i-Pr | 6-Cl | H | 3-Br-2-pyridyl | CF₃ |
| t-Bu | 6-Cl | H | 3-Br-2-pyridyl | CH₂CF₃ |
| Me | 6-Cl | H | 3-Br-2-pyridyl | CF₂CHF₂ |

TABLE 18

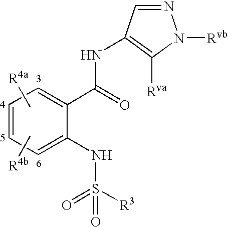

| R³ | R^{4a} | R^{4b} | R^{va} | R^{vb} |
|---|---|---|---|---|
| Me | 3-Me | H | H | CHF₂ |
| Et | 3-Me | 5-Me | H | CH₂CF₃ |
| i-Pr | 3-Me | H | H | CH₂CF₃ |
| t-Bu | 3-Me | 5-Cl | Me | CH₂CF₃ |
| Me | 3-Me | H | Et | CH₂CF₃ |
| Et | 3-Me | H | Me | CF₂CHF₂ |
| i-Pr | 3-Me | 5-Br | Et | CHF₂ |
| t-Bu | 3-Me | H | Me | CHF₂ |
| propargyl | 3-Me | H | Me | CBrF₂ |
| cyclopropyl | 3-Me | H | Me | CH₂F |
| i-Pr | 3-Me | 5-Cl | Me | CH₂CF₃ |
| t-Bu | 3-Me | H | Me | Et |
| Me | 3-Me | 5-CN | Me | n-Pr |
| Et | 3-Me | H | Me | CH₂C₂F₅ |
| i-Pr | 3-Me | H | Me | CH₂CF₃ |
| t-Bu | 3-Me | H | Me | CF₃ |
| propargyl | 3-Me | H | Me | C₂F₅ |
| cyclopropyl | 3-Me | H | Et | CHF₂ |
| i-Pr | 3-Me | H | n-Pr | CH₂CF₃ |
| t-Bu | 3-Me | 5-Br | i-Pr | CHF₂ |
| Me | 3-Me | H | Cl | CH₂CF₃ |
| Et | 3-Me | H | F | CH₂CF₃ |
| i-Pr | 3-Me | H | Me | CH₂Cl |
| t-Bu | 3-Me | 5-Cl | Me | CClF₂ |
| Me | 3-Me | H | Me | CH₂CH₂Cl |
| Et | 3-Me | H | Me | n-C₃F₇ |
| i-Pr | 3-Me | H | Me | i-C₃F₇ |
| t-Bu | 3-Me | 5-F | Me | Allyl |
| propargyl | 3-Me | H | Et | CF₂CHF₂ |
| Et | 3-Me | H | Et | i-C₃F₇ |
| i-Pr | 3-Me | H | n-Pr | CF₂CHF₂ |
| t-Bu | 3-Me | 5-Cl | i-Pr | CF₂CHF₂ |
| Me | 3-Me | H | CF₃ | CF₂CHF₂ |
| Et | 3-Me | H | CF₃ | Me |
| i-Pr | 3-Me | H | OMe | CH₂CF₃ |
| t-Bu | 3-Me | H | H | CH₂CF₃ |
| cyclopropyl | 3-Me | 5-Br | H | CH₂CF₃ |
| Et | 3-Me | H | H | C₂F₅ |
| i-Pr | 3-Me | 5-Me | H | C₂F₅ |
| t-Bu | 3-Me | H | H | C₂F₅ |
| Me | 3-Me | H | H | CF₂CHF₂ |
| Et | 3-Me | H | i-Pr | CH₂CF₃ |
| i-Pr | 3-Me | 5-Cl | H | n-C₃F₇ |
| t-Bu | 3-Me | H | H | i-C₃F₇ |
| propargyl | 3-Me | H | Ph | CH₂CF₃ |
| Et | 3-Me | H | Ph | CF₂CHF₂ |
| i-Pr | 3-Me | H | Ph | CHF₂ |
| t-Bu | 3-Me | 5-Br | 2-pyridyl | CH₂CF₃ |
| cyclopropyl | 3-Me | H | 2-pyridyl | CF₂CHF₂ |
| Et | 3-Me | H | 2-ClPh | CH₂CF₃ |
| i-Pr | 3-Me | H | 2-ClPh | CF₂CHF₂ |
| t-Bu | 3-Me | H | 2-ClPh | CHF₂ |
| Me | 3-Me | H | 2-ClPh | Et |
| Et | 3-Me | 5-Cl | 2-ClPh | CBrF₂ |
| i-Pr | 3-Me | H | 2-BrPh | CH₂CF₃ |
| t-Bu | 3-Me | H | 2-MePh | CF₂CHF₂ |
| Me | 3-Me | H | 2-CNPh | CH₂CF₃ |
| propargyl | 3-Me | H | 2-FPh | CH₂CF₃ |
| i-Pr | 3-Me | 5-CN | 2,6-F₂Ph | CF₂CHF₂ |
| t-Bu | 3-Me | H | 2,4-F₂Ph | CH₂CF₃ |
| Me | 3-Me | H | 2,5-F₂Ph | CH₂CF₃ |
| Et | 3-Me | H | 2-MeOPh | CF₂CHF₂ |
| i-Pr | 3-Me | 5-Br | 3-Cl-2-pyridyl | CH₂CF₃ |
| t-Bu | 3-Me | H | 3-Cl-2-pyridyl | CF₂CHF₂ |
| Me | 3-Me | 5-I | 3-Cl-2-pyridyl | CF₃ |
| Et | 3-Me | H | 3-Cl-2-pyridyl | CHF₂ |
| i-Pr | 3-Me | 5-Me | 3-Cl-2-pyridyl | CBrF₂ |
| t-Bu | 3-Me | H | 3-F-2-pyridyl | CH₂CF₃ |
| propargyl | 3-Me | H | 3-CF₃-2-pyridyl | CF₂CHF₂ |
| Et | 3-Me | 5-Br | 3-Me-2-pyridyl | CH₂CF₃ |
| i-Pr | 3-Me | H | 3-Br-2-pyridyl | CF₃ |
| t-Bu | 3-Me | H | 3-Br-2-pyridyl | CH₂CF₃ |
| Me | 3-Me | H | 3-Br-2-pyridyl | CF₂CHF₂ |
| Et | 3-Me | H | 3-Br-2-pyridyl | CClF₂ |
| Me | 6-Me | H | H | CHF₂ |
| Et | 6-Me | 4-Me | H | CH₂CF₃ |
| i-Pr | 6-Me | H | H | CH₂CF₃ |
| t-Bu | 6-Me | Cl | Me | CH₂CF₃ |
| Me | 6-Me | H | Et | CH₂CF₃ |
| Et | 6-Me | H | Me | CF₂CHF₂ |
| i-Pr | 6-Me | 4-Br | Et | CHF₂ |
| t-Bu | 6-Me | H | Me | CHF₂ |
| propargyl | 6-Me | H | Me | CBrF₂ |
| cyclopropyl | 6-Me | H | Me | CH₂F |
| i-Pr | 6-Me | 4-Cl | Me | CH₂CF₃ |
| t-Bu | 6-Me | H | Me | Et |
| Me | 6-Me | H | Me | n-Pr |
| Et | 6-Me | H | Me | CH₂C₂F₅ |
| i-Pr | 6-Me | 4-CN | Me | CH₂CF₃ |
| t-Bu | 6-Me | H | me | CF₃ |
| propargyl | 6-Me | H | me | C₂F₅ |
| cyclopropyl | 6-Me | H | Et | CHF₂ |
| i-Pr | 6-Me | H | n-Pr | CH₂CF₃ |
| t-Bu | 6-Me | 4-Br | i-Pr | CHF₂ |
| Me | 6-Me | H | Cl | CH₂CF₃ |
| Et | 6-Me | H | F | CH₂CF₃ |
| i-Pr | 6-Me | H | Me | CH₂Cl |
| t-Bu | 6-Me | 4-Cl | Me | CClF₂ |
| Me | 6-Me | H | Me | CH₂CH₂Cl |
| Et | 6-Me | H | Me | n-C₃F₇ |
| i-Pr | 6-Me | H | Me | i-C₃F₇ |
| t-Bu | 6-Me | 4-F | Me | Allyl |
| propargyl | 6-Me | H | Me | CF₂CHF₂ |
| Et | 6-Me | H | Me | i-C₃F₇ |
| i-Pr | 6-Me | H | Me | CF₂CHF₂ |
| t-Bu | 6-Me | 4-Cl | Me | CF₂CHF₂ |
| Me | 6-Me | H | CF₃ | CF₂CHF₂ |
| Et | 6-Me | H | CF₃ | Me |
| i-Pr | 6-Me | H | OMe | CH₂CF₃ |
| t-Bu | 6-Me | H | H | CH₂CF₃ |
| cyclopropyl | 6-Me | 4-Br | H | CH₂CF₃ |
| Et | 6-Me | H | H | C₂F₅ |
| i-Pr | 6-Me | H | H | C₂F₅ |
| t-Bu | 6-Me | 4-Me | H | C₂F₅ |
| Me | 6-Me | H | H | CF₂CHF₂ |
| Et | 6-Me | H | H | CH₂CF₃ |
| i-Pr | 6-Me | 4-Cl | H | n-C₃F₇ |
| t-Bu | 6-Me | H | H | i-C₃F₇ |
| propargyl | 6-Me | H | H | CH₂CF₃ |
| Et | 6-Me | H | H | CF₂CHF₂ |
| i-Pr | 6-Me | H | H | CHF₂ |
| t-Bu | 6-Me | 4-Br | Ph | CH₂CF₃ |
| cyclopropyl | 6-Me | H | Ph | CF₂CHF₂ |
| Et | 6-Me | H | Ph | CH₂CF₃ |
| i-Pr | 6-Me | H | 2-pyridyl | CF₂CHF₂ |
| t-Bu | 6-Me | H | 2-pyridyl | CHF₂ |
| Me | 6-Me | H | 2-ClPh | Et |
| Et | 6-Me | 4-Cl | 2-ClPh | CBrF₂ |
| i-Pr | 6-Me | H | 2-ClPh | CH₂CF₃ |
| t-Bu | 6-Me | 4-CN | 2-ClPh | CF₂CHF₂ |
| Me | 6-Me | H | 2-ClPh | CH₂CF₃ |
| propargyl | 6-Me | H | 2-BrPh | CH₂CF₃ |
| i-Pr | 6-Me | H | 2-MePh | CF₂CHF₂ |
| t-Bu | 6-Me | H | 2-CNPh | CH₂CF₃ |
| Me | 6-Me | H | 2-FPh | CH₂CF₃ |
| Et | 6-Me | H | 2,6-F₂Ph | CF₂CHF₂ |
| i-Pr | 6-Me | 4-Br | 2,4-F₂Ph | CH₂CF₃ |
| t-Bu | 6-Me | H | 2,5-F₂Ph | CF₂CHF₂ |
| Me | 6-Me | 4-I | 2-MeOPh | CF₃ |
| Et | 6-Me | H | 3-Cl-2-pyridyl | CHF₂ |
| i-Pr | 6-Me | H | 3-Cl-2-pyridyl | CBrF₂ |
| t-Bu | 6-Me | H | 3-Cl-2-pyridyl | CH₂CF₃ |
| propargyl | 6-Me | H | 3-Cl-2-pyridyl | CF₂CHF₂ |
| Et | 6-Me | 4-Br | 3-Cl-2-pyridyl | CH₂CF₃ |
| i-Pr | 6-Me | H | 3-F-2-pyridyl | CF₃ |
| t-Bu | 6-Me | H | 3-CF₃-2-pyridyl | CH₂CF₃ |
| Me | 6-Me | H | 3-Me-2-pyridyl | CF₂CHF₂ |
| Et | 6-Me | H | 3-Br-2-pyridyl | CClF₂ |
| i-Pr | 6-Me | 4-Cl | 3-Br-2-pyridyl | CH₂CF₃ |
| t-Bu | 6-Me | H | 3-Br-2-pyridyl | CF₃ |
| i-Pr | 6-Me | H | 3-Br-2-pyridyl | CF₂CHF₂ |
| Me | 3-Cl | H | H | CHF₂ |
| Et | 3-Br | 5-Me | H | CH₂CF₃ |
| i-Pr | 3-Cl | H | H | CH₂CF₃ |
| t-Bu | 3-Cl | 5-Cl | Me | CH₂CF₃ |
| Me | 3-Cl | H | Et | CH₂CF₃ |
| Et | 3-Cl | H | Me | CF₂CHF₂ |
| i-Pr | 3-Cl | 5-Br | Et | CHF₂ |
| t-Bu | 3-Cl | H | Me | CHF₂ |
| propargyl | 3-Cl | H | Me | CBrF₂ |
| cyclopropyl | 3-Cl | H | Me | CH₂F |
| i-Pr | 3-Cl | 5-Cl | Me | CH₂CF₃ |
| t-Bu | 3-Cl | H | Me | Et |
| Me | 3-F | H | Me | n-Pr |
| Et | 3-Cl | H | Me | CH₂C₂F₅ |
| i-Pr | 3-Cl | 5-CN | Me | CH₂CF₃ |
| t-Bu | 3-Cl | H | Me | CF₃ |
| propargyl | 3-Cl | H | Me | C₂F₅ |
| cyclopropyl | 3-Cl | H | Et | CHF₂ |
| i-Pr | 3-Cl | H | n-Pr | CH₂CF₃ |
| t-Bu | 3-Cl | 5-Br | i-Pr | CHF₂ |
| Me | 3-Cl | H | Cl | CH₂CF₃ |
| Et | 3-Br | H | F | CH₂CF₃ |
| i-Pr | 3-Cl | H | Me | CH₂Cl |
| t-Bu | 3-Cl | 5-Cl | Me | CClF₂ |
| Me | 3-Cl | H | Me | CH₂CH₂Cl |
| Et | 3-Cl | H | Me | n-C₃F₇ |
| i-Pr | 3-Cl | H | Me | i-C₃F₇ |
| t-Bu | 3-Cl | 5-F | Me | Allyl |
| propargyl | 3-Cl | H | Me | CF₂CHF₂ |
| Et | 3-Cl | H | Me | i-C₃F₇ |
| i-Pr | 3-Br | H | Me | CF₂CHF₂ |
| t-Bu | 3-Cl | 5-Cl | Me | CF₂CHF₂ |
| Me | 3-Cl | H | CF₃ | CF₂CHF₂ |
| Et | 3-CN | H | CF₃ | Me |
| i-Pr | 3-Cl | H | OMe | CH₂CF₃ |
| t-Bu | 3-Cl | H | H | CH₂CF₃ |
| cyclopropyl | 3-Cl | 5-Br | H | CH₂CF₃ |
| Et | 3-Cl | H | H | C₂F₅ |
| i-Pr | 3-Cl | H | H | C₂F₅ |
| t-Bu | 3-Cl | H | H | C₂F₅ |
| Me | 3-F | H | H | CF₂CHF₂ |
| Et | 3-Cl | H | H | CH₂CF₃ |
| i-Pr | 3-Cl | 5-Cl | H | n-C₃F₇ |
| t-Bu | 3-Cl | H | H | i-C₃F₇ |
| propargyl | 3-Cl | H | H | CH₂CF₃ |
| Et | 3-Cl | H | H | CF₂CHF₂ |
| i-Pr | 3-Cl | H | H | CHF₂ |
| t-Bu | 3-Cl | 5-Br | Ph | CH₂CF₃ |
| cyclopropyl | 3-Cl | H | Ph | CF₂CHF₂ |
| Et | 3-Cl | H | Ph | CH₂CF₃ |
| i-Pr | 3-Br | H | 2-pyridyl | CF₂CHF₂ |
| t-Bu | 3-Cl | H | 2-pyridyl | CHF₂ |
| Me | 3-Cl | H | 2-ClPh | Et |
| Et | 3-Cl | 5-Cl | 2-ClPh | CBrF₂ |
| i-Pr | 3-Cl | H | 2-ClPh | CH₂CF₃ |
| t-Bu | 3-I | H | 2-ClPh | CF₂CHF₂ |
| Me | 3-Cl | 5-Me | 2-ClPh | CH₂CF₃ |
| propargyl | 3-Cl | H | 2-BrPh | CH₂CF₃ |
| i-Pr | 3-Cl | H | 2-MePh | CF₂CHF₂ |
| t-Bu | 3-Cl | 5-CN | 2-CNPh | CH₂CF₃ |
| Me | 3-Cl | H | 2-FPh | CH₂CF₃ |
| Et | 3-Cl | H | 2,6-F₂Ph | CF₂CHF₂ |
| i-Pr | 3-Cl | 5-Br | 2,4-F₂Ph | CH₂CF₃ |
| t-Bu | 3-F | H | 2,5-F₂Ph | CF₂CHF₂ |
| Me | 3-Cl | 5-I | 2-MeOPh | CF₃ |
| Et | 3-Cl | H | 3-Cl-2-pyridyl | CHF₂ |
| i-Pr | 3-CN | H | 3-Cl-2-pyridyl | CBrF₂ |
| t-Bu | 3-Cl | H | 3-Cl-2-pyridyl | CH₂CF₃ |
| propargyl | 3-Cl | H | 3-Cl-2-pyridyl | CF₂CHF₂ |
| Et | 3-Cl | 5-Br | 3-Cl-2-pyridyl | CH₂CF₃ |
| i-Pr | 3-Cl | H | 3-F-2-pyridyl | CF₃ |
| t-Bu | 3-Br | H | 3-CF₃-2-pyridyl | CH₂CF₃ |
| Me | 3-Cl | H | 3-Me-2-pyridyl | CF₂CHF₂ |
| Et | 3-Cl | H | 3-Br-2-pyridyl | CClF₂ |
| i-Pr | 3-Cl | 5-Cl | 3-Br-2-pyridyl | CH₂CF₃ |
| t-Bu | 3-Cl | H | 3-Br-2-pyridyl | CF₃ |
| i-Pr | 3-Cl | H | 3-Br-2-pyridyl | CF₂CHF₂ |
| Me | 6-Cl | H | Et | CHF₂ |
| Et | 6-Br | 4-Me | Me | CH₂CF₃ |
| i-Pr | 6-Cl | H | Et | CH₂CF₃ |
| t-Bu | 6-Cl | Cl | Me | CH₂CF₃ |
| Me | 6-Cl | H | Me | CH₂CF₃ |
| Et | 6-Cl | H | Me | CF₂CHF₂ |
| i-Pr | 6-F | 4-Br | Me | CHF₂ |
| t-Bu | 6-Cl | H | Me | CHF₂ |
| propargyl | 6-Cl | H | Me | CBrF₂ |
| cyclopropyl | 6-Cl | H | Me | CH₂F |
| i-Pr | 6-Cl | 4-Cl | Me | CH₂CF₃ |
| t-Bu | 6-Cl | H | Me | Et |
| Me | 6-Cl | H | Me | n-Pr |
| Et | 6-Cl | H | Et | CH₂C₂F₅ |
| i-Pr | 6-I | 4-CN | n-Pr | CH₂CF₃ |
| t-Bu | 6-Cl | H | i-Pr | CF₃ |
| propargyl | 6-Cl | H | Cl | C₂F₅ |
| cyclopropyl | 6-Cl | H | F | CHF₂ |
| i-Pr | 6-Cl | H | Me | CH₂CF₃ |
| t-Bu | 6-Cl | 4-Br | Me | CHF₂ |
| Me | 6-Cl | H | Me | CH₂CF₃ |
| Et | 6-F | H | Me | CH₂CF₃ |
| i-Pr | 6-Cl | H | Me | CH₂Cl |
| t-Bu | 6-Cl | 4-Cl | Me | CClF₂ |
| Me | 6-Cl | H | Me | CH₂CH₂Cl |
| Et | 6-I | H | Me | n-C₃F₇ |
| i-Pr | 6-Cl | H | Me | i-C₃F₇ |
| t-Bu | 6-Cl | 4-F | Me | Allyl |
| propargyl | 6-Cl | H | CF₃ | CF₂CHF₂ |
| Et | 6-Cl | H | CF₃ | i-C₃F₇ |
| i-Pr | 6-Cl | H | OMe | CF₂CHF₂ |
| t-Bu | 6-Cl | 4-Cl | H | CF₂CHF₂ |
| Me | 6-Cl | H | H | CF₂CHF₂ |
| Et | 6-Cl | H | H | Me |
| i-Pr | 6-Cl | H | H | CH₂CF₃ |
| t-Bu | 6-Br | H | H | CH₂CF₃ |
| cyclopropyl | 6-Cl | 4-Br | H | CH₂CF₃ |
| Et | 6-Cl | H | H | C₂F₅ |
| i-Pr | 6-Cl | H | H | C₂F₅ |
| t-Bu | 6-F | 4-Me | H | C₂F₅ |
| Me | 6-Cl | H | H | CF₂CHF₂ |
| Et | 6-Cl | H | H | CH₂CF₃ |
| i-Pr | 6-CN | 4-Cl | H | n-C₃F₇ |
| t-Bu | 6-Cl | H | Ph | i-C₃F₇ |
| propargyl | 6-Cl | H | Ph | CH₂CF₃ |
| Et | 6-Cl | H | Ph | CF₂CHF₂ |
| i-Pr | 6-Cl | H | 2-pyridyl | CHF₂ |
| t-Bu | 6-Cl | 4-Br | 2-pyridyl | CH₂CF₃ |
| cyclopropyl | 6-Cl | H | 2-ClPh | CF₂CHF₂ |
| Et | 6-F | H | 2-ClPh | CH₂CF₃ |
| i-Pr | 6-Cl | H | 2-ClPh | CF₂CHF₂ |
| t-Bu | 6-Cl | H | 2-ClPh | CHF₂ |
| Me | 6-Cl | H | 2-ClPh | Et |
| Et | 6-Br | 4-Cl | 2-BrPh | CBrF₂ |
| i-Pr | 6-Cl | H | 2-MePh | CH₂CF₃ |
| t-Bu | 6-Cl | H | 2-CNPh | CF₂CHF₂ |
| Me | 6-Cl | H | 2-FPh | CH₂CF₃ |
| propargyl | 6-Cl | H | 2,6-F₂Ph | CH₂CF₃ |
| i-Pr | 6-Br | H | 2,4-F₂Ph | CF₂CHF₂ |
| t-Bu | 6-Cl | 4-CN | 2,5-F₂Ph | CH₂CF₃ |
| Me | 6-Cl | H | 2-MeOPh | CH₂CF₃ |
| Et | 6-Cl | H | 3-Cl-2-pyridyl | CF₂CHF₂ |
| i-Pr | 6-Cl | 4-Br | 3-Cl-2-pyridyl | CH₂CF₃ |
| t-Bu | 6-CN | H | 3-Cl-2-pyridyl | CF₂CHF₂ |
| Me | 6-Cl | 4-I | 2-Cl-2-pyridyl | CF₃ |
| Et | 6-Cl | H | 3-Cl-2-pyridyl | CHF₂ |
| i-Pr | 6-Br | H | 3-F-2-pyridyl | CBrF₂ |
| t-Bu | 6-Cl | H | 3-CF₃-2-pyridyl | CH₂CF₃ |
| propargyl | 6-Cl | H | 3-Me-2-pyridyl | CF₂CHF₂ |
| Et | 6-Cl | 4-Br | 3-Br-2-pyridyl | CH₂CF₃ |
| i-Pr | 6-Cl | H | 3-Br-2-pyridyl | CF₃ |
| t-Bu | 6-Cl | H | 3-Br-2-pyridyl | CH₂CF₃ |
| Me | 6-Cl | H | 3-Br-2-pyridyl | CF₂CHF₂ |

TABLE 19

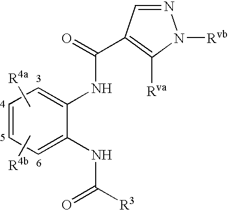

| R³ | R^{4a} | R^{4b} | R^{va} | R^{vb} |
|---|---|---|---|---|
| Me | 3-Me | H | H | CHF₂ |
| Et | 3-Me | 5-Me | H | CH₂CF₃ |
| i-Pr | 3-Me | H | H | CH₂CF₃ |
| t-Bu | 3-Me | 5-Cl | Me | CH₂CF₃ |
| Me | 3-Me | H | Et | CH₂CF₃ |
| Et | 3-Me | H | Me | CF₂CHF₂ |
| i-Pr | 3-Me | 5-Br | Et | CHF₂ |
| t-Bu | 3-Me | H | Me | CHF₂ |
| propargyl | 3-Me | H | Me | CBrF₂ |
| cyclopropyl | 3-Me | H | Me | CH₂F |
| i-Pr | 3-Me | 5-Cl | Me | CH₂CF₃ |
| t-Bu | 3-Me | H | Me | Et |
| Me | 3-Me | 5-CN | Me | n-Pr |
| Et | 3-Me | H | Me | CH₂C₂F₅ |
| i-Pr | 3-Me | H | Me | CH₂CF₃ |
| t-Bu | 3-Me | H | Me | CF₃ |
| propargyl | 3-Me | H | Me | C₂F₅ |
| cyclopropyl | 3-Me | H | Et | CHF₂ |
| i-Pr | 3-Me | H | n-Pr | CH₂CF₃ |
| t-Bu | 3-Me | 5-Br | i-Pr | CHF₂ |
| Me | 3-Me | H | Cl | CH₂CF₃ |
| Et | 3-Me | H | F | CH₂CF₃ |
| i-Pr | 3-Me | H | Me | CH₂Cl |
| t-Bu | 3-Me | 5-Cl | Me | CClF₂ |
| Me | 3-Me | H | Me | CH₂CH₂Cl |
| Et | 3-Me | H | Me | n-C₃F₇ |
| i-Pr | 3-Me | H | Me | i-C₃F₇ |
| t-Bu | 3-Me | 5-F | Me | Allyl |
| propargyl | 3-Me | H | Et | CF₂CHF₂ |
| Et | 3-Me | H | Et | i-C₃F₇ |
| i-Pr | 3-Me | H | n-Pr | CF₂CHF₂ |
| t-Bu | 3-Me | 5-Cl | i-Pr | CF₂CHF₂ |
| Me | 3-Me | H | CF₃ | CF₂CHF₂ |
| Et | 3-Me | H | CF₃ | Me |
| i-Pr | 3-Me | H | OMe | CH₂CF₃ |
| t-Bu | 3-Me | H | H | CH₂CF₃ |
| cyclopropyl | 3-Me | 5-Br | H | CH₂CF₃ |
| Et | 3-Me | H | H | C₂F₅ |
| i-Pr | 3-Me | 5-Me | H | C₂F₅ |
| t-Bu | 3-Me | H | H | C₂F₅ |
| Me | 3-Me | H | H | CF₂CHF₂ |
| Et | 3-Me | H | i-Pr | CH₂CF₃ |
| i-Pr | 3-Me | 5-Cl | H | n-C₃F₇ |
| t-Bu | 3-Me | H | H | i-C₃F₇ |
| propargyl | 3-Me | H | Ph | CH₂CF₃ |
| Et | 3-Me | H | Ph | CF₂CHF₂ |
| i-Pr | 3-Me | H | Ph | CHF₂ |
| t-Bu | 3-Me | 5-Br | 2-pyridyl | CH₂CF₃ |
| cyclopropyl | 3-Me | H | 2-pyridyl | CF₂CHF₂ |
| Et | 3-Me | H | 2-ClPh | CH₂CF₃ |
| i-Pr | 3-Me | H | 2-ClPh | CF₂CHF₂ |
| t-Bu | 3-Me | H | 2-ClPh | CHF₂ |
| Me | 3-Me | H | 2-ClPh | Et |
| Et | 3-Me | 5-Cl | 2-ClPh | CBrF₂ |
| i-Pr | 3-Me | H | 2-BrPh | CH₂CF₃ |
| t-Bu | 3-Me | H | 2-MePh | CF₂CHF₂ |
| Me | 3-Me | H | 2-CNPh | CH₂CF₃ |
| propargyl | 3-Me | H | 2-FPh | CH₂CF₃ |
| i-Pr | 3-Me | 5-CN | 2,6-F₂Ph | CF₂CHF₂ |
| t-Bu | 3-Me | H | 2,4-F₂Ph | CH₂CF₃ |
| Me | 3-Me | H | 2,5-F₂Ph | CH₂CF₃ |
| Et | 3-Me | H | 2-MeOPh | CF₂CHF₂ |
| i-Pr | 3-Me | 5-Br | 3-Cl-2-pyridyl | CH₂CF₃ |
| t-Bu | 3-Me | H | 3-Cl-2-pyridyl | CF₂CHF₂ |
| Me | 3-Me | 5-I | 3-Cl-2-pyridyl | CF₃ |
| Et | 3-Me | H | 3-Cl-2-pyridyl | CHF₂ |
| i-Pr | 3-Me | 5-Me | 3-Cl-2-pyridyl | CBrF₂ |
| t-Bu | 3-Me | H | 3-F-2-pyridyl | CH₂CF₃ |
| propargyl | 3-Me | H | 3-CF₃-2-pyridyl | CF₂CHF₂ |
| Et | 3-Me | 5-Br | 3-Me-2-pyridyl | CH₂CF₃ |
| i-Pr | 3-Me | H | 3-Br-2-pyridyl | CF₃ |
| t-Bu | 3-Me | H | 3-Br-2-pyridyl | CH₂CF₃ |
| Me | 3-Me | H | 3-Br-2-pyridyl | CF₂CHF₂ |
| Et | 3-Me | H | 3-Br-2-pyridyl | CClF₂ |
| Me | 6-Me | H | H | CHF₂ |
| Et | 6-Me | 4-Me | H | CH₂CF₃ |
| i-Pr | 6-Me | H | H | CH₂CF₃ |
| t-Bu | 6-Me | Cl | Me | CH₂CF₃ |
| Me | 6-Me | H | Et | CH₂CF₃ |
| Et | 6-Me | H | Me | CF₂CHF₂ |
| i-Pr | 6-Me | 4-Br | Et | CHF₂ |
| t-Bu | 6-Me | H | Me | CHF₂ |
| propargyl | 6-Me | H | Me | CBrF₂ |
| cyclopropyl | 6-Me | H | Me | CH₂F |
| i-Pr | 6-Me | 4-Cl | Me | CH₂CF₃ |
| t-Bu | 6-Me | H | Me | Et |
| Me | 6-Me | H | Me | n-Pr |
| Et | 6-Me | H | Me | CH₂C₂F₅ |
| i-Pr | 6-Me | 4-CN | Me | CH₂CF₃ |
| t-Bu | 6-Me | H | Me | CF₃ |
| propargyl | 6-Me | H | Me | C₂F₅ |
| cyclopropyl | 6-Me | H | Et | CHF₂ |
| i-Pr | 6-Me | H | n-Pr | CH₂CF₃ |
| t-Bu | 6-Me | 4-Br | i-Pr | CHF₂ |
| Me | 6-Me | H | Cl | CH₂CF₃ |
| Et | 6-Me | H | F | CH₂CF₃ |
| i-Pr | 6-Me | H | Me | CH₂Cl |
| t-Bu | 6-Me | 4-Cl | Me | CClF₂ |
| Me | 6-Me | H | Me | CH₂CH₂Cl |
| Et | 6-Me | H | Me | n-C₃F₇ |
| i-Pr | 6-Me | H | Me | i-C₃F₇ |
| t-Bu | 6-Me | 4-F | Me | Allyl |
| propargyl | 6-Me | H | Me | CF₂CHF₂ |
| Et | 6-Me | H | Me | i-C₃F₇ |
| i-Pr | 6-Me | H | Me | CF₂CHF₂ |
| t-Bu | 6-Me | 4-Cl | Me | CF₂CHF₂ |
| Me | 6-Me | H | CF₃ | CF₂CHF₂ |
| Et | 6-Me | H | CF₃ | Me |
| i-Pr | 6-Me | H | OMe | CH₂CF₃ |
| t-Bu | 6-Me | H | H | CH₂CF₃ |
| cyclopropyl | 6-Me | 4-Br | H | CH₂CF₃ |
| Et | 6-Me | H | H | C₂F₅ |
| i-Pr | 6-Me | H | H | C₂F₅ |
| t-Bu | 6-Me | 4-Me | H | C₂F₅ |
| Me | 6-Me | H | H | CF₂CHF₂ |
| Et | 6-Me | H | H | CH₂CF₃ |
| i-Pr | 6-Me | 4-Cl | H | n-C₃F₇ |
| t-Bu | 6-Me | H | H | i-C₃F₇ |
| propargyl | 6-Me | H | H | CH₂CF₃ |
| Et | 6-Me | H | H | CF₂CHF₂ |
| i-Pr | 6-Me | H | H | CHF₂ |
| t-Bu | 6-Me | 4-Br | Ph | CH₂CF₃ |
| cyclopropyl | 6-Me | H | Ph | CF₂CHF₂ |
| Et | 6-Me | H | Ph | CH₂CF₃ |
| i-Pr | 6-Me | H | 2-pyridyl | CF₂CHF₂ |
| t-Bu | 6-Me | H | 2-pyridyl | CHF₂ |
| Me | 6-Me | H | 2-ClPh | Et |
| Et | 6-Me | 4-Cl | 2-ClPh | CBrF₂ |
| i-Pr | 6-Me | H | 2-ClPh | CH₂CF₃ |
| t-Bu | 6-Me | 4-CN | 2-ClPh | CF₂CHF₂ |
| Me | 6-Me | H | 2-ClPh | CH₂CF₃ |
| propargyl | 6-Me | H | 2-BrPh | CH₂CF₃ |
| i-Pr | 6-Me | H | 2-MePh | CF₂CHF₂ |
| t-Bu | 6-Me | H | 2-CNPh | CH₂CF₃ |
| Me | 6-Me | H | 2-FPh | CH₂CF₃ |
| Et | 6-Me | H | 2,6-F₂Ph | CF₂CHF₂ |
| i-Pr | 6-Me | 4-Br | 2,4-F₂Ph | CH₂CF₃ |
| t-Bu | 6-Me | H | 2,5-F₂Ph | CF₂CHF₂ |
| Me | 6-Me | 4-I | 2-MeOPh | CF₃ |
| Et | 6-Me | H | 3-Cl-2-pyridyl | CHF₂ |
| i-Pr | 6-Me | H | 3-Cl-2-pyridyl | CBrF₂ |
| t-Bu | 6-Me | H | 3-Cl-2-pyridyl | CH₂CF₃ |
| propargyl | 6-Me | H | 3-Cl-2-pyridyl | CF₂CHF₂ |
| Et | 6-Me | 4-Br | 3-Cl-2-pyridyl | CH₂CF₃ |
| i-Pr | 6-Me | H | 3-F-2-pyridyl | CF₃ |
| t-Bu | 6-Me | H | 3-CF₃-2-pyridyl | CH₂CF₃ |
| Me | 6-Me | H | 3-Me-2-pyridyl | CF₂CHF₂ |
| Et | 6-Me | H | 3-Br-2-pyridyl | CClF₂ |
| i-Pr | 6-Me | 4-Cl | 3-Br-2-pyridyl | CH₂CF₃ |
| t-Bu | 6-Me | H | 3-Br-2-pyridyl | CF₃ |
| i-Pr | 6-Me | H | 3-Br-2-pyridyl | CF₂CHF₂ |
| Me | 3-Cl | H | H | CHF₂ |
| Et | 3-Br | 5-Me | H | CH₂CF₃ |
| i-Pr | 3-Cl | H | H | CH₂CF₃ |
| t-Bu | 3-Cl | 5-Cl | Me | CH₂CF₃ |
| Me | 3-Cl | H | Et | CH₂CF₃ |
| Et | 3-Cl | H | Me | CF₂CHF₂ |
| i-Pr | 3-Cl | 5-Br | Et | CHF₂ |
| t-Bu | 3-Cl | H | Me | CHF₂ |
| propargyl | 3-Cl | H | Me | CBrF₂ |
| cyclopropyl | 3-Cl | H | Me | CH₂F |
| i-Pr | 3-Cl | 5-Cl | Me | CH₂CF₃ |
| t-Bu | 3-Cl | H | Me | Et |
| Me | 3-F | H | Me | n-Pr |
| Et | 3-Cl | H | Me | CH₂C₂F₅ |
| i-Pr | 3-Cl | 5-CN | Me | CH₂CF₃ |
| t-Bu | 3-Cl | H | Me | CF₃ |
| propargyl | 3-Cl | H | Me | C₂F₅ |
| cyclopropyl | 3-Cl | H | Et | CHF₂ |
| i-Pr | 3-Cl | H | n-Pr | CH₂CF₃ |
| t-Bu | 3-Cl | 5-Br | i-Pr | CHF₂ |
| Me | 3-Cl | H | Cl | CH₂CF₃ |
| Et | 3-Br | H | F | CH₂CF₃ |
| i-Pr | 3-Cl | H | Me | CH₂Cl |
| t-Bu | 3-Cl | 5-Cl | Me | CClF₂ |
| Me | 3-Cl | H | Me | CH₂CH₂Cl |
| Et | 3-Cl | H | Me | n-C₃F₇ |
| i-Pr | 3-Cl | H | Me | i-C₃F₇ |
| t-Bu | 3-Cl | 5-F | Me | Allyl |
| propargyl | 3-Cl | H | Me | CF₂CHF₂ |
| Et | 3-Cl | H | Me | i-C₃F₇ |
| i-Pr | 3-Br | H | Me | CF₂CHF₂ |
| t-Bu | 3-Cl | 5-Cl | Me | CF₂CHF₂ |
| Me | 3-Cl | H | CF₃ | CF₂CHF₂ |
| Et | 3-CN | H | CF₃ | Me |
| i-Pr | 3-Cl | H | OMe | CH₂CF₃ |
| t-Bu | 3-Cl | H | H | CH₂CF₃ |
| cyclopropyl | 3-Cl | 5-Br | H | CH₂CF₃ |
| Et | 3-Cl | H | H | C₂F₅ |
| i-Pr | 3-Cl | H | H | C₂F₅ |
| t-Bu | 3-Cl | H | H | C₂F₅ |
| Me | 3-F | H | H | CF₂CHF₂ |
| Et | 3-Cl | H | H | CH₂CF₃ |
| i-Pr | 3-Cl | 5-Cl | H | n-C₃F₇ |
| t-Bu | 3-Cl | H | H | i-C₃F₇ |
| propargyl | 3-Cl | H | H | CH₂CF₃ |
| Et | 3-Cl | H | H | CF₂CHF₂ |
| i-Pr | 3-Cl | H | H | CHF₂ |
| t-Bu | 3-Cl | 5-Br | Ph | CH₂CF₃ |
| cyclopropyl | 3-Cl | H | Ph | CF₂CHF₂ |
| Et | 3-Cl | H | Ph | CH₂CF₃ |
| i-Pr | 3-Br | H | 2-pyridyl | CF₂CHF₂ |
| t-Bu | 3-Cl | H | 2-pyridyl | CHF₂ |
| Me | 3-Cl | H | 2-ClPh | Et |
| ERt | 3-Cl | 5-Cl | 2-ClPh | CBrF₂ |
| i-Pr | 3-Cl | H | 2-ClPh | CH₂CF₃ |
| t-Bu | 3-I | H | 2-ClPh | CF₂CHF₂ |
| Me | 3-Cl | 5-Me | 2-ClPh | CH₂CF₃ |
| propargyl | 3-Cl | H | 2-BrPh | CH₂CF₃ |
| i-Pr | 3-Cl | H | 2-MePh | CF₂CHF₂ |
| t-Bu | 3-Cl | 5-CN | 2-CNPh | CH₂CF₃ |
| Me | 3-Cl | H | 2-FPh | CH₂CF₃ |
| Et | 3-Cl | H | 2,6-F₂Ph | CF₂CHF₂ |
| i-Pr | 3-Cl | 5-Br | 2,4-F₂Ph | CH₂CF₃ |
| t-Bu | 3-F | H | 2,5-F₂Ph | CF₂CHF₂ |
| Me | 3-Cl | 5-I | 2-MeOPh | CF₃ |
| Et | 3-Cl | H | 3-Cl-2-pyridyl | CHF₂ |
| i-Pr | 3-Cn | H | 3-Cl-2-pyridyl | CBrF₂ |
| t-Bu | 3-Cl | H | 3-Cl-2-pyridyl | CH₂CF₃ |
| propargyl | 3-Cl | H | 3-Cl-2-pyridyl | CF₂CHF₂ |
| Et | 3-Cl | 5-Br | 3-Cl-2-pyridyl | CH₂CF₃ |
| i-Pr | 3-Cl | H | 3-F-2-pyridyl | CF₃ |
| t-Bu | 3-Br | H | 3-CF₃-2-pyridyl | CH₂CF₃ |
| Me | 3-Cl | H | 3-Me-2-pyridyl | CF₂CHF₂ |
| Et | 3-Cl | H | 3-Br-2-pyridyl | CClF₂ |
| i-Pr | 3-Cl | 5-Cl | 3-Br-2-pyridyl | CH₂CF₃ |
| t-Bu | 3-Cl | H | 3-Br-2-pyridyl | CF₃ |
| i-Pr | 3-Cl | H | 3-Br-2-pyridyl | CF₂CHF₂ |
| Me | 6-Cl | H | Et | CHF₂ |
| Et | 6-Br | 4-Me | Me | CH₂CF₃ |
| i-Pr | 6-Cl | H | Et | CH₂CF₃ |
| t-Bu | 6-Cl | Cl | Me | CH₂CF₃ |
| Me | 6-Cl | H | Me | CH₂CF₃ |
| Et | 6-Cl | H | Me | CF₂CHF₂ |
| i-Pr | 6-F | 4-Br | Me | CHF₂ |
| t-Bu | 6-Cl | H | Me | CHF₂ |
| propargyl | 6-Cl | H | Me | CBrF₂ |
| cyclopropyl | 6-Cl | H | Me | CH₂F |
| i-Pr | 6-Cl | 4-Cl | Me | CH₂CF₃ |
| t-Bu | 6-Cl | H | Me | Et |
| Me | 6-Cl | H | Me | n-Pr |
| Et | 6-Cl | H | Et | CH₂C₂F₅ |
| i-Pr | 6-I | 4-CN | n-Pr | CH₂CF₃ |
| t-Bu | 6-Cl | H | i-Pr | CF₃ |
| propargyl | 6-Cl | H | Cl | C₂F₅ |
| cyclopropyl | 6-Cl | H | F | CHF₂ |
| i-Pr | 6-Cl | H | Me | CH₂CF₃ |
| t-Bu | 6-Cl | 4-Br | Me | CHF₂ |
| Me | 6-Cl | H | Me | CH₂CF₃ |
| Et | 6-F | H | Me | CH₂CF₃ |
| i-Pr | 6-Cl | H | Me | CH₂Cl |
| t-Bu | 6-Cl | 4-Cl | Me | CClF₂ |
| Me | 6-Cl | H | Me | CH₂CH₂Cl |
| Et | 6-I | H | Me | n-C₃F₇ |
| i-Pr | 6-Cl | H | Me | i-C₃F₇ |
| t-Bu | 6-Cl | 4-F | Me | Allyl |
| propargyl | 6-Cl | H | CF₃ | CF₂CHF₂ |
| Et | 6-Cl | H | CF₃ | i-C₃F₇ |
| i-Pr | 6-Cl | H | OMe | CF₂CHF₂ |
| t-Bu | 6-Cl | 4-Cl | H | CF₂CHF₂ |
| Me | 6-Cl | H | H | CF₂CHF₂ |
| Et | 6-Cl | H | H | Me |
| i-Pr | 6-Cl | H | H | CH₂CF₃ |
| t-Bu | 6-Br | H | H | CH₂CF₃ |
| cyclopropyl | 6-Cl | 4-Br | H | CH₂CF₃ |
| Et | 6-Cl | H | H | C₂F₅ |
| i-Pr | 6-Cl | H | H | C₂F₅ |
| t-Bu | 6-F | 4-Me | H | C₂F₅ |
| Me | 6-Cl | H | H | CF₂CHF₂ |
| Et | 6-Cl | H | H | CH₂CF₃ |
| i-Pr | 6-CN | 4-Cl | H | n-C₃F₇ |
| t-Bu | 6-Cl | H | Ph | i-C₃F₇ |
| propargyl | 6-Cl | H | Ph | CH₂CF₃ |
| Et | 6-Cl | H | Ph | CF₂CHF₂ |
| i-Pr | 6-Cl | H | 2-pyridyl | CHF₂ |
| t-Bu | 6-Cl | 4-Br | 2-pyridyl | CH₂CF₃ |
| cyclopropyl | 6-Cl | H | 2-ClPh | CF₂CHF₂ |
| Et | 6-F | H | 2-ClPh | CH₂CF₃ |
| i-Pr | 6-Cl | H | 2-ClPh | CF₂CHF₂ |
| t-Bu | 6-Cl | H | 2-ClPh | CHF₂ |
| Me | 6-Cl | H | 2-ClPh | Et |
| Et | 6-Br | 4-Cl | 2-BrPh | CBrF₂ |
| i-Pr | 6-Cl | H | 2-MePh | CH₂CF₃ |
| t-Bu | 6-Cl | H | 2-CNPh | CF₂CHF₂ |
| Me | 6-CL | H | 2-FPh | CH₂CF₃ |
| propargyl | 6-Cl | H | 2,6-F₂Ph | CH₂CF₃ |
| i-Pr | 6-Br | H | 2,4-F₂Ph | CF₂CHF₂ |
| t-Bu | 6-Cl | 4-CN | 2,5-F₂Ph | CH₂CF₃ |
| Me | 6-Cl | H | 2-MeOPh | CH₂CF₃ |
| Et | 6-Cl | H | 3-Cl-2-pyridyl | CF₂CHF₂ |
| i-Pr | 6-Cl | 4-Br | 3-Cl-2-pyridyl | CH₂CF₃ |
| t-Bu | 6-CN | H | 3-Cl-2-pyridyl | CF₂CHF₂ |
| Me | 6-Cl | 4-I | 3-Cl-2-pyridyl | CF₃ |
| Et | 6-Cl | H | 3-Cl-2-pyridyl | CHF₂ |
| i-Pr | 6-Br | H | 3-F-2-pyridyl | CBrF₂ |
| t-Bu | 6-Cl | H | 3-CF₃-2-pyridyl | CH₂CF₃ |
| propargyl | 6-Cl | H | 3-Me-2-pyridyl | CF₂CHF₂ |
| Et | 6-Cl | 4-Br | 3-Br-2-pyridyl | CH₂CF₃ |
| i-Pr | 6-Cl | H | 3-Br-2-pyridyl | CF₃ |
| t-Bu | 6-Cl | H | 3-Br-2-pyridyl | CH₂CF₃ |
| Me | 6-Cl | H | 3-Br-2-pyridyl | CF₂CHF₂ |

TABLE 20

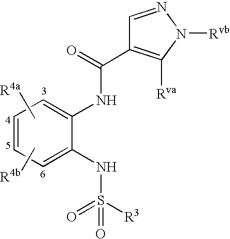

| R³ | R^{4a} | R^{4b} | R^{va} | R^{vb} |
|---|---|---|---|---|
| Me | 3-Me | H | H | CHF₂ |
| Et | 3-Me | 5-Me | H | CH₂CF₃ |
| i-Pr | 3-Me | H | H | CH₂CF₃ |
| t-Bu | 3-Me | 5-Cl | Me | CH₂CF₃ |
| Me | 3-Me | H | Et | CH₂CF₃ |
| Et | 3-Me | H | Me | CF₂CHF₂ |
| i-Pr | 3-Me | 5-Br | Et | CHF₂ |
| t-Bu | 3-Me | H | Me | CHF₂ |
| propargyl | 3-Me | H | Me | CBrF₂ |
| cyclopropyl | 3-Me | H | Me | CH₂F |
| i-Pr | 3-Me | 5-Cl | Me | CH₂CF₃ |
| t-Bu | 3-Me | H | Me | Et |
| Me | 3-Me | 5-CN | Me | n-Pr |
| Et | 3-Me | H | Me | CH₂C₂F₅ |
| i-Pr | 3-Me | H | Me | CH₂CF₃ |
| t-Bu | 3-Me | H | Me | CF₃ |
| propargyl | 3-Me | H | Me | C₂F₅ |
| cyclopropyl | 3-Me | H | Et | CHF₂ |
| i-Pr | 3-Me | H | n-Pr | CH₂CF₃ |
| t-Bu | 3-Me | 5-Br | i-Pr | CHF₂ |
| Me | 3-Me | H | Cl | CH₂CF₃ |
| Et | 3-Me | H | F | CH₂CF₃ |
| i-Pr | 3-Me | H | Me | CH₂Cl |
| t-Bu | 3-Me | 5-Cl | Me | CClF₂ |
| Me | 3-Me | H | Me | CH₂CH₂Cl |
| Et | 3-Me | H | Me | n-C₃F₇ |
| i-Pr | 3-Me | H | Me | i-C₃F₇ |
| t-Bu | 3-Me | 5-F | Me | Allyl |
| propargyl | 3-Me | H | Et | CF₂CHF₂ |
| Et | 3-Me | H | Et | i-C₃F₇ |
| i-Pr | 3-Me | H | n-Pr | CF₂CHF₂ |
| t-Bu | 3-Me | 5-Cl | i-Pr | CF₂CHF₂ |
| Me | 3-Me | H | CF₃ | CF₂CHF₂ |
| Et | 3-Me | H | CF₃ | Me |
| i-Pr | 3-Me | H | OMe | CH₂CF₃ |
| t-Bu | 3-Me | H | H | CH₂CF₃ |
| cyclopropyl | 3-Me | 5-Br | H | CH₂CF₃ |
| Et | 3-Me | H | H | C₂F₅ |
| i-Pr | 3-Me | 5-Me | H | C₂F₅ |
| t-Bu | 3-Me | H | H | C₂F₅ |
| Me | 3-Me | H | H | CF₂CHF₂ |
| Et | 3-Me | H | i-Pr | CH₂CF₃ |
| i-Pr | 3-Me | 5-Cl | H | n-C₃F₇ |
| t-Bu | 3-Me | H | H | i-C₃F₇ |
| propargyl | 3-Me | H | Ph | CH₂CF₃ |
| Et | 3-Me | H | Ph | CF₂CHF₂ |
| i-Pr | 3-Me | H | Ph | CHF₂ |
| t-Bu | 3-Me | 5-Br | 2-pyridyl | CH₂CF₃ |
| cyclopropyl | 3-Me | H | 2-pyridyl | CF₂CHF₂ |
| Et | 3-Me | H | 2-ClPh | CH₂CF₃ |
| i-Pr | 3-Me | H | 2-ClPh | CF₂CHF₂ |
| t-Bu | 3-Me | H | 2-ClPh | CHF₂ |
| Me | 3-Me | H | 2-ClPh | Et |
| Et | 3-Me | 5-Cl | 2-ClPh | CBrF₂ |
| i-Pr | 3-Me | H | 2-BrPh | CH₂CF₃ |
| t-Bu | 3-Me | H | 2-MePh | CF₂CHF₂ |
| Me | 3-Me | H | 2-CNPh | CH₂CF₃ |
| propargyl | 3-Me | H | 2-FPh | CH₂CF₃ |
| i-Pr | 3-Me | 5-CN | 2,6-F₂Ph | CF₂CHF₂ |
| t-Bu | 3-Me | H | 2,4-F₂Ph | CH₂CF₃ |
| Me | 3-Me | H | 2,5-F₂Ph | CH₂CF₃ |
| Et | 3-Me | H | 2-MeOPh | CF₂CHF₂ |
| i-Pr | 3-Me | 5-Br | 3-Cl-2-pyridyl | CH₂CF₃ |
| t-Bu | 3-Me | H | 3-Cl-2-pyridyl | CF₂CHF₂ |
| Me | 3-Me | 5-I | 3-Cl-2-pyridyl | CF₃ |
| Et | 3-Me | H | 3-Cl-2-pyridyl | CHF₂ |
| i-Pr | 3-Me | 5-Me | 3-Cl-2-pyridyl | CBrF₂ |
| t-Bu | 3-Me | H | 3-F-2-pyridyl | CH₂CF₃ |
| propargyl | 3-Me | H | 3-CF₃-2-pyridyl | CF₂CHF₂ |
| Et | 3-Me | 5-Br | 3-Me-2-pyridyl | CH₂CF₃ |
| i-Pr | 3-Me | H | 3-Br-2-pyridyl | CF₃ |
| t-Bu | 3-Me | H | 3-Br-2-pyridyl | CH₂CF₃ |
| Me | 3-Me | H | 3-Br-2-pyridyl | CF₂CHF₂ |
| Et | 3-Me | H | 3-Br-2-pyridyl | CClF₂ |
| Me | 6-Me | H | H | CHF₂ |
| Et | 6-Me | 4-Me | H | CH₂CF₃ |
| i-Pr | 6-Me | H | H | CH₂CF₃ |
| t-Bu | 6-Me | Cl | Me | CH₂CF₃ |
| Me | 6-Me | H | Et | CH₂CF₃ |
| Et | 6-Me | H | Me | CF₂CHF₂ |
| i-Pr | 6-Me | 4-Br | Et | CHF₂ |
| t-Bu | 6-Me | H | Me | CHF₂ |
| propargyl | 6-Me | H | Me | CBrF₂ |
| cyclopropyl | 6-Me | H | Me | CH₂F |
| i-Pr | 6-Me | 4-Cl | Me | CH₂CF₃ |
| t-Bu | 6-Me | H | Me | Et |
| Me | 6-Me | H | Me | n-Pr |
| Et | 6-Me | H | Me | CH₂C₂F₅ |
| i-Pr | 6-Me | 4-CN | Me | CH₂CF₃ |
| t-Bu | 6-Me | H | Me | CF₃ |
| propargyl | 6-Me | H | Me | C₂F₅ |
| cyclopropyl | 6-Me | H | Et | CHF₂ |
| i-Pr | 6-Me | H | n-Pr | CH₂CF₃ |
| t-Bu | 6-Me | 4-Br | i-Pr | CHF₂ |
| Me | 6-Me | H | Cl | CH₂CF₃ |
| Et | 6-Me | H | F | CH₂CF₃ |
| i-Pr | 6-Me | H | Me | CH₂Cl |
| t-Bu | 6-Me | 4-Cl | Me | CClF₂ |
| Me | 6-Me | H | Me | CH₂CH₂Cl |
| Et | 6-Me | H | Me | n-C₃F₇ |
| i-Pr | 6-Me | H | Me | i-C₃F₇ |
| t-Bu | 6-Me | 4-F | Me | Allyl |
| propargyl | 6-Me | H | Me | CF₂CHF₂ |
| Et | 6-Me | H | Me | i-C₃F₇ |
| i-Pr | 6-Me | H | Me | CF₂CHF₂ |
| t-Bu | 6-Me | 4-Cl | Me | CF₂CHF₂ |
| Me | 6-Me | H | CF₃ | CF₂CHF₂ |
| Et | 6-Me | H | CF₃ | Me |
| i-Pr | 6-Me | H | OMe | CH₂CF₃ |
| t-Bu | 6-Me | H | H | CH₂CF₃ |
| cyclopropyl | 6-Me | 4-Br | H | CH₂CF₃ |
| Et | 6-Me | H | H | C₂F₅ |
| i-Pr | 6-Me | H | H | C₂F₅ |
| t-Bu | 6-Me | 4-Me | H | C₂F₅ |
| Me | 6-Me | H | H | CF₂CHF₂ |
| Et | 6-Me | H | H | CH₂CF₃ |
| i-Pr | 6-Me | 4-Cl | H | n-C₃F₇ |
| t-Bu | 6-Me | H | H | i-C₃F₇ |
| propargyl | 6-Me | H | H | CH₂CF₃ |
| Et | 6-Me | H | H | CF₂CHF₂ |
| i-Pr | 6-Me | H | H | CHF₂ |
| t-Bu | 6-Me | 4-Br | Ph | CH₂CF₃ |
| cyclopropyl | 6-Me | H | Ph | CF₂CHF₂ |
| Et | 6-Me | H | Ph | CH₂CF₃ |
| i-Pr | 6-Me | H | 2-pyridyl | CF₂CHF₂ |
| t-Bu | 6-Me | H | 2-pyridyl | CHF₂ |
| Me | 6-Me | H | 2-ClPh | Et |
| Et | 6-Me | 4-Cl | 2-ClPh | CBrF₂ |
| i-Pr | 6-Me | H | 2-ClPh | CH₂CF₃ |
| t-Bu | 6-Me | 4-CN | 2-ClPh | CF₂CHF₂ |
| Me | 6-Me | H | 2-ClPh | CH₂CF₃ |
| propargyl | 6-Me | H | 2-BrPh | CH₂CF₃ |
| i-Pr | 6-Me | H | 2-MePh | CF₂CHF₂ |
| t-Bu | 6-Me | H | 2-CNPh | CH₂CF₃ |
| Me | 6-Me | H | 2-FPh | CH₂CF₃ |
| Et | 6-Me | H | 2,6-F₂Ph | CF₂CHF₂ |
| i-Pr | 6-Me | 4-Br | 2,4-F₂Ph | CH₂CF₃ |
| t-Bu | 6-Me | H | 2,5-F₂Ph | CF₂CHF₂ |
| Me | 6-Me | 4-I | 2-MeOPh | CF₃ |
| Et | 6-Me | H | 3-Cl-2-pyridyl | CHF₂ |
| i-Pr | 6-Me | H | 3-Cl-2-pyridyl | CBrF₂ |
| t-Bu | 6-Me | H | 3-Cl-2-pyridyl | CH₂CF₃ |
| propargyl | 6-Me | H | 3-Cl-2-pyridyl | CF₂CHF₂ |
| Et | 6-Me | 4-Br | 3-Cl-2-pyridyl | CH₂CF₃ |
| i-Pr | 6-Me | H | 3-F-2-pyridyl | CF₃ |
| t-Bu | 6-Me | H | 3-CF₃-2-pyridyl | CH₂CF₃ |
| Me | 6-Me | H | 3-Me-2-pyridyl | CF₂CHF₂ |
| Et | 6-Me | H | 3-Br-2-pyridyl | CClF₂ |
| i-Pr | 6-Me | 4-Cl | 3-Br-2-pyridyl | CH₂CF₃ |
| t-Bu | 6-Me | H | 3-Br-2-pyridyl | CF₃ |
| i-Pr | 6-Me | H | 3-Br-2-pyridyl | CF₂CHF₂ |
| Me | 3-Cl | H | H | CHF₂ |
| Et | 3-Br | 5-Me | H | CH₂CF₃ |
| i-Pr | 3-Cl | H | H | CH₂CF₃ |
| t-Bu | 3-Cl | 5-Cl | Me | CH₂CF₃ |
| Me | 3-Cl | H | Et | CH₂CF₃ |
| Et | 3-Cl | H | Me | CF₂CHF₂ |
| i-Pr | 3-Cl | 5-Br | Et | CHF₂ |
| t-Bu | 3-Cl | H | Me | CHF₂ |
| propargyl | 3-Cl | H | Me | CBrF₂ |
| cyclopropyl | 3-Cl | H | Me | CH₂F |
| i-Pr | 3-Cl | 5-Cl | Me | CH₂CF₃ |
| t-Bu | 3-Cl | H | Me | Et |
| Me | 3-F | H | Me | n-Pr |
| Et | 3-Cl | H | Me | CH₂C₂F₅ |
| i-Pr | 3-Cl | 5-CN | Me | CH₂CF₃ |
| t-Bu | 3-Cl | H | Me | CF₃ |
| propargyl | 3-Cl | H | Me | C₂F₅ |
| cyclopropyl | 3-Cl | H | Et | CHF₂ |
| i-Pr | 3-Cl | H | n-Pr | CH₂CF₃ |
| t-Bu | 3-Cl | 5-Br | i-Pr | CHF₂ |
| Me | 3-Cl | H | Cl | CH₂CF₃ |
| Et | 3-Br | H | F | CH₂CF₃ |
| i-Pr | 3-Cl | H | Me | CH₂Cl |
| t-Bu | 3-Cl | 5-Cl | Me | CClF₂ |
| Me | 3-Cl | H | Me | CH₂CH₂Cl |
| Et | 3-Cl | H | Me | n-C₃F₇ |
| i-Pr | 3-Cl | H | Me | i-C₃F₇ |
| t-Bu | 3-Cl | 5-F | Me | Allyl |
| propargyl | 3-Cl | H | Me | CF₂CHF₂ |
| Et | 3-Cl | H | Me | i-C₃F₇ |
| i-Pr | 3-Br | H | Me | CF₂CHF₂ |
| t-Bu | 3-Cl | 5-Cl | Me | CF₂CHF₂ |
| Me | 3-Cl | H | CF₃ | CF₂CHF₂ |
| Et | 3-CN | H | CF₃ | Me |
| i-Pr | 3-Cl | H | OMe | CH₂CF₃ |
| t-Bu | 3-Cl | H | H | CH₂CF₃ |
| cyclopropyl | 3-Cl | 5-Br | H | CH₂CF₃ |
| Et | 3-Cl | H | H | C₂F₅ |
| i-Pr | 3-Cl | H | H | C₂F₅ |
| t-Bu | 3-Cl | H | H | C₂F₅ |
| Me | 3-F | H | H | CF₂CHF₂ |
| Et | 3-Cl | H | H | CH₂CF₃ |
| i-Pr | 3-Cl | 5-Cl | H | n-C₃F₇ |
| t-Bu | 3-Cl | H | H | i-C₃F₇ |
| propargyl | 3-Cl | H | H | CH₂CF₃ |
| Et | 3-Cl | H | H | CF₂CHF₂ |
| i-Pr | 3-Cl | H | H | CHF₂ |
| t-Bu | 3-Cl | 5-Br | Ph | CH₂CF₃ |
| cyclopropyl | 3-Cl | H | Ph | CF₂CHF₂ |
| Et | 3-Cl | H | Ph | CH₂CF₃ |
| i-Pr | 3-Br | H | 2-pyridyl | CF₂CHF₂ |
| t-Bu | 3-Cl | H | 2-pyridyl | CHF₂ |
| Me | 3-Cl | H | 2-ClPh | Et |
| Et | 3-Cl | 5-Cl | 2-ClPh | CBrF₂ |
| i-Pr | 3-Cl | H | 2-ClPh | CH₂CF₃ |
| t-Bu | 3-I | H | 2-ClPh | CF₂CHF₂ |
| Me | 3-Cl | 3-Me | 2-ClPh | CH₂CF₃ |
| propargyl | 3-Cl | H | 2-BrPh | CH₂CF₃ |
| i-Pr | 3-Cl | H | 2-MePh | CF₂CHF₂ |
| t-Bu | 3-Cl | 5-CN | 2-CNPh | CH₂CF₃ |
| Me | 3-Cl | H | 2-FPh | CH₂CF₃ |
| Et | 3-Cl | H | 2,6-F₂Ph | CF₂CHF₂ |
| i-Pr | 3-Cl | 5-Br | 2,4-F₂Ph | CH₂CF₃ |
| t-Bu | 3-F | H | 2,5-F₂Ph | CF₂CHF₂ |
| Me | 3-Cl | 5-I | 2-MeOPh | CF₃ |
| Et | 3-Cl | H | 3-Cl-2-pyridyl | CHF₂ |
| i-Pr | 3-CN | H | 3-Cl-2-pyridyl | CBrF₂ |
| t-Bu | 3-Cl | H | 3-Cl-2-pyridyl | CH₂CF₃ |
| propargyl | 3-Cl | H | 3-Cl-2-pyridyl | CF₂CHF₂ |
| Et | 3-Cl | 5-Br | 3-Cl-2-pyridyl | CH₂CF₃ |
| i-Pr | 3-Cl | H | 3-F-2-pyridyl | CF₃ |
| t-Bu | 3-Br | H | 3-CF₃-2-pyridyl | CH₂CF₃ |
| Me | 3-Cl | H | 3-Me-2-pyridyl | CF₂CHF₂ |
| Et | 3-Cl | H | 3-Br-2-pyridyl | CClF₂ |
| i-Pr | 3-Cl | 5-Cl | 3-Br-2-pyridyl | CH₂CF₃ |
| t-Bu | 3-Cl | H | 3-Br-2-pyridyl | CF₃ |
| i-Pr | 3-Cl | H | 3-Br-2-pyridyl | CF₂CHF₂ |
| Me | 6-Cl | H | Et | CHF₂ |
| Et | 6-Br | 4-Me | Me | CH₂CF₃ |
| i-Pr | 6-Cl | H | Et | CH₂CF₃ |
| t-Bu | 6-Cl | Cl | Me | CH₂CF₃ |
| Me | 6-Cl | H | Me | CH₂CF₃ |
| Et | 6-Cl | H | Me | CF₂CHF₂ |
| i-Pr | 6-F | 4-Br | Me | CHF₂ |
| t-Bu | 6-Cl | H | Me | CHF₂ |
| propargyl | 6-Cl | H | Me | CBrF₂ |
| cyclopropyl | 6-Cl | H | Me | CH₂F |
| i-Pr | 6-Cl | 4-Cl | Me | CH₂CF₃ |
| t-Bu | 6-Cl | H | Me | Et |
| Me | 6-Cl | H | Me | n-Pr |
| Et | 6-Cl | H | Et | CH₂C₂F₅ |
| i-Pr | 6-I | 4-CN | n-Pr | CH₂CF₃ |
| t-Bu | 6-Cl | H | i-Pr | CF₃ |
| propargyl | 6-Cl | H | Cl | C₂F₅ |
| cyclopropyl | 6-Cl | H | F | CHF₂ |
| i-Pr | 6-Cl | H | Me | CH₂CF₃ |
| t-Bu | 6-Cl | 4-Br | Me | CHF₂ |
| Me | 6-Cl | H | Me | CH₂CF₃ |
| Et | 6-F | H | Me | CH₂CF₃ |
| i-Pr | 6-Cl | H | Me | CH₂Cl |
| t-Bu | 6-Cl | 4-Cl | Me | CClF₂ |
| Me | 6-Cl | H | Me | CH₂CH₂Cl |
| Et | 6-I | H | Me | n-C₃F₇ |
| i-Pr | 6-Cl | H | Me | i-C₃F₇ |
| t-Bu | 6-Cl | 4-F | Me | Allyl |
| propargyl | 6-Cl | H | CF₃ | CF₂CHF₂ |
| Et | 6-Cl | H | CF₃ | i-C₃F₇ |
| i-Pr | 6-Cl | H | OMe | CF₂CHF₂ |
| t-Bu | 6-Cl | 4-Cl | H | CF₂CHF₂ |
| Me | 6-Cl | H | H | CF₂CHF₂ |
| Et | 6-Cl | H | H | Me |
| i-Pr | 6-Cl | H | H | CH₂CF₃ |
| t-Bu | 6-Br | H | H | CH₂CF₃ |
| cyclapropyl | 6-Cl | 4-Br | H | CH₂CF₃ |
| Et | 6-Cl | H | H | C₂F₅ |
| i-Pr | 6-Cl | H | H | C₂F₅ |
| t-Bu | 6-F | 4-Me | H | C₂F₅ |
| Me | 6-Cl | H | H | CF₂CHF₂ |
| Et | 6-Cl | H | H | CH₂CF₃ |
| i-Pr | 6-CN | 4-Cl | H | n-C₃F₇ |
| t-Bu | 6-Cl | H | Ph | i-C₃F₇ |
| propargyl | 6-Cl | H | Ph | CH₂CF₃ |
| Et | 6-Cl | H | Ph | CF₂CHF₂ |
| i-Pr | 6-Cl | H | 2-pyridyl | CHF₂ |
| t-Bu | 6-Cl | 4-Br | 2-pyridyl | CH₂CF₃ |
| cyclopropyl | 6-Cl | H | 2-ClPh | CF₂CHF₂ |
| Et | 6-F | H | 2-ClPh | CH₂CF₃ |
| i-Pr | 6-Cl | H | 2-ClPh | CF₂CHF₂ |
| t-Bu | 6-Cl | H | 2-ClPh | CHF₂ |
| Me | 6-Cl | H | 2-ClPh | Et |
| Et | 6-Br | 4-Cl | 2-BrPh | CBrF₂ |
| i-Pr | 6-Cl | H | 2-MePh | CH₂CF₃ |
| t-Bu | 6-Cl | H | 2-CNPh | CF₂CHF₂ |
| Me | 6-Cl | H | 2-FPh | CH₂CF₃ |
| propargyl | 6-Cl | H | 2,6-F₂Ph | CH₂CF₃ |
| i-Pr | 6-Br | H | 2,4-F₂Ph | CF₂CHF₂ |
| t-Bu | 6-Cl | 4-CN | 2,5-F₂Ph | CH₂CF₃ |
| Me | 6-Cl | H | 2-MeOPh | CH₂CF₃ |
| Et | 6-Cl | H | 3-Cl-2-pyridyl | CF₂CHF₂ |
| i-Pr | 6-Cl | 4-Br | 3-Cl-2-pyridyl | CH₂CF₃ |
| t-Bu | 6-CN | H | 3-Cl-2-pyridyl | CF₂CHF₂ |
| Me | 6-Cl | 4-I | 3-Cl-2-pyridyl | CF₃ |
| Et | 6-Cl | H | 3-Cl-2-pyridyl | CHF₂ |
| i-Pr | 6-Br | H | 3-F-2-pyridyl | CBrF₂ |
| t-Bu | 6-Cl | H | 3-CF₃-2-pyridyl | CH₂CF₃ |
| propargyl | 6-Cl | H | 3-Me-2-pyridyl | CF₂CHF₂ |
| Et | 6-Cl | 4-Br | 3-Br-2-pyridyl | CH₂CF₃ |
| i-Pr | 6-Cl | H | 3-Br-2-pyridyl | CF₃ |
| t-Bu | 6-Cl | H | 3-Br-2-pyridyl | CH₂CF₃ |
| Me | 6-Cl | H | 3-Br-2-pyridyl | CF₂CHF₂ |

### BIOLOGICAL EXAMPLES OF THE INVENTION

Formulation/Utility

Compounds of this invention will generally be used as a formulation or composition with an agriculturally suitable carrier comprising at least one of a liquid diluent, a solid diluent or a surfactant. The formulation or composition ingredients are selected to be consistent with the physical properties of the active ingredient, mode of application and environmental factors such as soil type, moisture and temperature. Useful formulations include liquids such as solutions (including emulsifiable concentrates), suspensions, emulsions (including microemulsions and/or suspoemulsions) and the like which optionally can be thickened into gels. Useful formulations further include solids such as dusts, powders, granules, pellets, tablets, films, and the like which can be water-dispersible (“wettable”) or water-soluble. Active ingredient can be (micro)encapsulated and further formed into a suspension or solid formulation; alternatively the entire formulation of active ingredient can be encapsulated (or “overcoated”). Encapsulation can control or delay release of the active ingredient. Sprayable formulations can be extended in suitable media and used at spray volumes from about one to several hundred liters per hectare. High-strength compositions are primarily used as intermediates for further formulation.

The formulations will typically contain effective amounts of active ingredient, diluent and surfactant within the following approximate ranges that add up to 100 percent by weight.

| | Weight Percent | | |
|---|---|---|---|
| | Active | | |
| | Ingredient | Diluent | Surfactant |
| Water-Dispersible and Water- | 5-90 | 0-94 | 1-15 |
| soluble Granules, Tablets | | | |
| and Powders. | | | |
| Suspensions, Emulsions, | 5-50 | 40-95 | 0-15 |
| Solutions (including | | | |
| Emulsifiable Concentrates) | | | |
| Dusts | 1-25 | 70-99 | 0-5 |
| Granules and Pellets | 0.01-99 | 5-99.99 | 0-15 |
| High Strength Compositions | 90-99 | 0-10 | 0-2 |

Typical solid diluents are described in Watkins, et al., Handbook of insecticide Dust Diluents and Carriers, 2nd Ed., Dorland Books, Caldwell, N.J. Typical liquid diluents are described in Marsden, Solvents Guide, 2nd Ed., Interscience, New York, 1950. McCutcheon's Detergents and Emulsifiers Annual, Allured Publ. Corp., Ridgewood, N.J., as well as Sisely and Wood, Encyclopedia of Surface Active Agents, Chemical Publ. Co., Inc., New York, 1964, list surfactants and recommended uses. All formulations can contain minor amounts of additives to reduce foam, caking, corrosion, microbiological growth and the like, or thickeners to increase viscosity.

Surfactants include, for example, polyethoxylated alcohols, polyethoxylated alkylphenols, polyethoxylated sorbitan fatty acid esters, dialkyl sulfosuccinates, alkyl sulfates, alkylbenzene sulfonates, organosilicones, NN-dialkyltaurates, lignin sulfonates, naphthalene sulfonate formaldehyde condensates, polycarboxylates, and polyoxy-ethylene/polyoxypropylene block copolymers. Solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Liquid diluents include, for example, water, N,N-dimethylformamide, dimethyl sulfoxide, N-alkylpyrrolidone, ethylene glycol, polypropylene glycol, paraffins, alkylbenzenes, alkylnaphthalenes, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, and alcohols such as methanol, cyclohexanol, decanol and tetrahydrofurfuryl alcohol.

Solutions, including emulsifiable concentrates, can be prepared by simply mixing the ingredients. Dusts and powders can be prepared by blending and, usually, grinding as in a hammer mill or fluid-energy mill. Suspensions are usually prepared by wet-milling; see, for example, U.S. Pat. No. 3,060,084. Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, N.Y., 1963, pages 8-57 and following, and PCT Publication WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 1041; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; and Hance et al., Weed Control Handbook, 8th Ed., Blackwell Scientific Publications, Oxford, 1989.

In the following Examples, all percentages are by weight and all formulations are prepared in conventional ways. Compound numbers refer to compounds in Index Table A.

### Example A

| Wettable Powder | |
|---|---|
| Compound 1 | 65.0% |
| dodecylphenol polyethylene glycol ether | 2.0% |
| sodium ligninsulfonate | 4.0% |
| sodium silicoaluminate | 6.0% |
| montmorillonite (calcined) | 23.0%. |

### Example B

| Granule | |
|---|---|
| Compound 7 | 10.0% |
| attapulgite granules (low volatile matter, | 90.0%. |
| 0.71/0.30 mm; U.S.S. No. 25-50 sieves) | |

### Example C

| Extruded Pellet | |
|---|---|
| Compound 1 | 25.0% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0%. |

### Example D

| Emulsifiable Concentrate | |
|---|---|
| Compound 7 | 20.0% |
| blend of oil soluble sulfonates | 10.0% |
| and polyoxyethylene ethers | |
| isophorone | 70.0%. |

### Example E

| Granule | |
|---|---|
| Compound 1 | 0.5% |
| cellulose | 2.5% |
| lactose | 4.0% |
| cornmeal | 93.0%. |

Compounds of this invention are characterized by favorable metabolic and/or soil residual patterns and exhibit activity controlling a spectrum of agronomic and non-agronomic invertebrate pests. (In the context of this disclosure “invertebrate pest control” means inhibition of invertebrate pest development (including mortality) that causes significant reduction in feeding or other injury or other damage caused by the pest; related expressions are defined analogously.) As referred to in this disclosure, the term “invertebrate pest” includes arthropods, gastropods and nematodes of economic importance as pests. The term “arthropod” includes insects, mites, spiders, scorpions, centipedes, millipedes, pill bugs and symphylans. The term “gastropod” includes snails, slugs and other Stylommatophora. The term “nematode” includes all of the helminths, such as: roundworms, heartworms, and phytophagous nematodes (Nematoda), flukes (Tematoda), Acanthocephala, and tapeworms (Cestoda). Those skilled in the art will recognize that not all compounds are equally effective against all pests. Compounds of this invention display activity against economically important agronomic, forest, greenhouse, nursery, ornamentals, food and fiber, public and animal health, domestic and commercial structure, household, and stored product pests. These include larvae of the order Lepidoptera, such as armyworms, cutworms, loopers, and heliothines in the family Noctuidae (e.g., fall armyworm (Spodoptera fugiperda J. E. Smith), beet armyworm (Spodoptera exigua Hübner), black cutworm (Agrotis ipsilon Hufnagel), cabbage looper (Trichoplusia ni Hübner), tobacco budworm (Heliothis virescens Fabricius)); borers, casebearers, webworms, coneworms, cabbageworms and skeletonizers from the family Pyralidae (e.g., European corn borer (Ostrinia nubilalis Hübner), navel orangeworm (Amyelois transitella Walker), corn root webworm (Crambus caliginosellus Clemens), sod webworm (Herpetogramma licarsisalis Walker)); leafrollers, budworms, seed worms, and fruit worms in the family Tortricidae (e.g., codling moth (Cydia pomonella Linnaeus), grape berry moth (Endopiza viteana Clemens), oriental fruit moth (Grapholita molesta Busck)); and many other economically important lepidoptera (e.g., diamondback moth (Plutella xylostella Linnaeus), pink bollworm (Pectinophora gossypiella Saunders), gypsy moth (Lymantria dispar Linnaeus)); nymphs and adults of the order Blattodea including cockroaches from the families Blattellidae and Blattidae (e.g., oriental cockroach (Blatta orientalis Linnaeus), Asian cockroach (Blatella asahinai Mizukubo), German cockroach (Blattella germanica Linnaeus), brownbanded cockroach (Supella longipalpa Fabricius), American cockroach (Periplaneta americana Linnaeus), brown cockroach (Penplaneta brunnea Burmeister), Madeira cockroach (Leucophaea maderae Fabricius)); foliar feeding larvae and adults of the order Coleoptera including weevils from the families Anthribidae, Bruchidae, and Curculionidae (e.g., boll weevil (Anthonomus grandis Boheman), rice water weevil (Lissorhoptrus oryzophilus Kuschel), granary weevil (Sitophilus granarius Linnaeus), rice weevil (Sitophilus oryzae Linnaeus)); flea beetles, cucumber beetles, rootworms, leaf beetles, potato beetles, and leafminers in the family Chrysomelidae (e.g., Colorado potato beetle (Leptinotarsa decemlineata Say), western corn rootworm (Diabrotica virgifera LeConte)); chafers and other beetles from the family Scaribaeidae (e.g., Japanese beetle (Popillia japonica Newman) and European chafer (Rhizotrogus majalis Razoumowsky)); carpet beetles from the family Dermestidae; wireworms from the family Elateridae; bark beetles from the family Scolytidae and flour beetles from the family Tenebrionidae. In addition it includes: adults and larvae of the order Dermaptera including earwigs from the family Forficulidae (e.g., European earwig (Forficula auricularia Linnaeus), black earwig (Chelisoches morio Fabricius)); adults and nymphs of the orders Hemiptera and Homoptera such as, plant bugs from the family Miridae, cicadas from the family Cicadidae, leafhoppers (e.g. Empoasca spp.) from the family Cicadellidae, planthoppers from the families Fulgoroidae and Delphacidae, treehoppers from the family Membracidae, psyllids from the family Psyllidae, whiteflies from the family Aleyrodidae, aphids from the family Aphididae, phylloxera from the family Phylloxeridae, mealybugs from the family Pseudococcidae, scales from the families Coccidae, Diaspididae and Margarodidae, lace bugs from the family Tingidae, stink bugs from the family Pentatomidae, cinch bugs (e.g., Blissus spp.) and other seed bugs from the family Lygaeidae, spittlebugs from the family Cercopidae squash bugs from the family Coreidae, and red bugs and cotton stainers from the family Pyrrhocoridae. Also included are adults and larvae of the order Acari (mites) such as spider mites and red mites in the family Tetranychidae (e.g., European red mite (Panonychus ulmi Koch), two spotted spider mite (Tetranychus urticae Koch), McDaniel mite (Tetranychus mcdanieli McGregor)), flat mites in the family Tenuipalpidae (e.g., citrus flat mite (Brevipalpus lewisi McGregor)), rust and bud mites in the family Eriophyidae and other foliar feeding mites and mites important in human and animal health, i.e. dust mites in the family Epidermoptidae, follicle mites in the family Demodicidae, grain mites in the family Glycyphagidae, ticks in the order Ixodidae (e.g., deer tick (Ixodes scapularis Say), Australian paralysis tick (Ixodes holocyclus Neumann), American dog tick (Dermacentor variabilis Say), lone star tick (Amblyomma americanum Linnaeus) and scab and itch mites in the families Psoroptidae, Pyemotidae, and Sarcoptidae; adults and immatures of the order Orthoptera including grasshoppers, locusts and crickets (e.g., migratory grasshoppers (e.g., Melanoplus sanguinipes Fabricius, M. differentialis Thomas), American grasshoppers (e.g., Schistocerca americana Drury), desert locust (Schistocerca gregaria Forskal), migratory locust (Locusta migratoria Linnaeus), house cricket (Acheta domesticus Linnaeus), mole crickets (Gryllotalpa spp.)); adults and immatures of the order Diptera including leafminers, midges, fruit flies (Tephritidae), frit flies (e.g., Oscinella frit Linnaeus), soil maggots, house flies (e.g., Musca domestica Linnaeus), lesser house flies (e.g., Fannia canicularis Linnaeus, F. femoralis Stein), stable flies (e.g., Stomoxys calcitrans Linnaeus), face flies, hom flies, blow flies (e.g., Chrysomya spp., Phormia spp.), and other muscoid fly pests, horse flies (e.g., Tabanus spp.), bot flies (e.g., Gastrophilus spp., Oestrus spp.), cattle grubs (e.g., Hypoderma spp.), deer flies (e.g., Chrysops spp.), keds (e.g., Melophagus ovinus Linnaeus) and other Brachycera, mosquitoes (e.g., Aedes spp., Anopheles spp., Culex spp.), black flies (e.g., Prosimulium spp., Simulium spp.), biting midges, sand flies, sciarids, and other Nematocera; adults and immatures of the order Thysanoptera including onion thrips (Thrips tabaci Lindeman) and other foliar feeding thrips; insect pests of the order Hymenoptera including ants (e.g., red carpenter ant (Camponotus ferrugineus Fabricius), black carpenter ant (Camponotus pennsylvanicus De Geer), Pharaoh ant (Monomorium pharaonis Linnaeus), little fire ant (Wasmannia auropunctata Roger), fire ant (Solenopsis geminata Fabricius), red imported fire ant (Solenopsis invicta Buren), Argentine ant (Iridomyrmex humilis Mayr), crazy ant (Paratrechina longicornis Latreille), pavement ant (Tetramorium caespitum Linnaeus), cornfield ant (Lasius alienus Förster), odorous house ant (Tapinoma sessile Say)), bees (including carpenter bees), hornets, yellow jackets and wasps; insect pests of the order Isoptera including the eastern subterranean termite (Reticulitermes flavipes Kollar), western subterranean termite (Reticulitermes hesperus Banks), Formosan subterranean termite (Coptotermes formosanus Shiraki), West Indian drywood termite (Incisitermes immigrans Snyder) and other termites of economic importance; insect pests of the order Thysanura such as silverfish (Lepisma saccharina Linnaeus) and firebrat (Thermobia domestica Packard); insect pests of the order Mallophaga and including the head louse (Pediculus humanus capitis De Geer), body louse (Pediculus humanus humanus Linnaeus), chicken body louse (Menacanthus stramineus Nitszch), dog biting louse (Trichodectes canis De Geer), fluff louse (Goniocotes gallinae De Geer), sheep body louse (Bovicola ovis Schrank), short-nosed cattle louse (Haematopinus eurysternus Nitzsch), long-nosed cattle louse (Linognathus vituli Linnaeus) and other sucking and chewing parasitic lice that attack man and animals; insect pests of the order Siphonoptera including the oriental rat flea (Xenopsylla cheopis Rothschild), cat flea (Ctenocephalides felis Bouche), dog flea (Ctenocephalides canis Curtis), hen flea (Ceratophyllus gallinae Schrank), sticktight flea (Echidnophaga gallinacea Westwood), human flea (Pulex irritans Linnaeus) and other fleas afflicting mammals and birds. Additional arthropod pests covered include: spiders in the order Araneae such as the brown recluse spider (Loxosceles reclusa Gertsch & Mulaik) and the black widow spider (Latrodectus mactans Fabricius), and centipedes in the order Scutigeromorpha such as the house centipede (Scutigera coleoptrata Linnaeus). Activity also includes members of the Classes Nematoda, Cestoda, Trematoda, and Acanthocephala including economically important members of the orders Strongylida, Ascaridida, Oxyurida, Rhabditida, Spirurida, and Enoplida such as but not limited to economically important agricultural pests (i.e. root knot nematodes in the genus Meloidogyne, lesion nematodes in the genus Pratylenchus, stubby root nematodes in the genus Trichodorus, etc.) and animal and human health pests (i.e. all economically important flukes, tapeworms, and roundworms, such as Strongylus vulgaris in horses, Toxocara canis in dogs, Haemonchus contortus in sheep, Dirofilaria immitis Leidy in dogs, Anoplocephala perfoliata in horses, Fasciola hepatica Linnaeus in ruminants, etc.).

Compounds of the invention show particularly high activity against pests in the order Lepidoptera (e.g., Alabama argillacea Hubner (cotton leaf worm), Archips argyrospila Walker (fruit tree leaf roller), A. rosana Linnaeus (European leaf roller) and other Archips species, Chilo suppressalis Walker (rice stem borer), Cnaphalocrosis medinalis Guenee (rice leaf roller), Crambus caliginosellus Clemens (corn root webworm), Crambus teterrellus Zincken (bluegrass webworm), Cydia pomonella Linnaeus (codling moth), Earias insulana Boisduval (spiny bollworm), Earias vittella Fabricius (spotted bollworm), Helicoverpa armigera Hübner (American bollworm), Helicoverpa zea Boddie (corn earworm), Heliothis virescens Fabricius (tobacco budworm), Herpetogramma licarsisalis Walker (sod webworm), Lobesia botrana Denis & Schiffemmuller (grape berry moth), Pectinophora gossypiella Saunders (pink bollworm), Phyllocnistis citrella Stainton (citrus leafininer), Pieris brassicae Linnaeus (large white butterfly), Pieris rapae Linnaeus (small white butterfly), Plutella xylostella Linnaeus (diamondback moth), Spodoptera exigua Hübner (beet armyworm), Spodoptera litura Fabricius (tobacco cutworm, cluster caterpillar), Spodoptera fugiperda J. E. Smith (fall arnyworm), Trichoplusia ni Hübner (cabbage looper) and Tuta absoluta Meyrick (tomato leafminer)). Compounds of the invention also have commercially significant activity on members from the order Homoptera including: Acyrthisiphon pisum Harris (pea aphid), Aphis craccivora Koch (cowpea aphid), Aphis fabae Scopoli (black bean aphid), Aphis gossypii Glover (cotton aphid, melon aphid), Aphis pomi De Geer (apple aphid), Aphis spiraecola Patch (spirea aphid), Aulacorthum solani Kaltenbach (foxglove aphid), Chaetosiphon fragaefolii Cockerell (strawberry aphid), Diuraphis noxia Kurdjumov/Mordvilko (Russian wheat aphid), Dysaphis plantaginea Paaserini (rosy apple aphid), Eriosoma lanigerum Hausmann (woolly apple aphid), Hyalopterus pruni Geoffroy (mealy plum aphid), Lipaphis erysimi Kaltenbach (turnip aphid), Metopolophium dirrhodum Walker (cereal aphid), Macrosipum euphorbiae Thomas (potato aphid), Myzus persicae Sulzer (peach-potato aphid, green peach aphid), Nasonovia ribisnigri Mosley (lettuce aphid), Pemphigus spp. (root aphids and gall aphids), Rhopalosiphum maidis Fitch (corn leaf aphid), Rhopalosiphum padi Linnaeus (bird cherry-oat aphid), Schizaphis graminum Rondani (greenbug), Sitobion avenae Fabricius (English grain aphid), Therloaphis maculata Buckton (spotted alfalfa aphid), Toxoptera aurantii Boyer de Fonscolombe (black citrus aphid), and Toxoptera citricida Kirkaldy (brown citrus aphid); Adelges spp. (adelgids); Phylloxera devastatrix Pergande (pecan phylloxera); Bemisia tabaci Gennadius (tobacco whitefly, sweetpotato whitefly), Bemisia argentifolii Bellows & Perring (silverleaf whitefly), Dialeurodes citri Ashmead (citrus whitefly) and Trialeurodes vaporariorum Westwood (greenhouse whitefly); Empoasca fabae Harris (potato leafhopper), Laodelphax striatellus Fallen (smaller brown planthopper), Macrolestes quadrilineatus Forbes (aster leafhopper), Nephotettix cinticeps Uhler (green leafhopper), Nephotettix nigropictus Stål (rice leafhopper), Nilaparvata lugens Stål (brown planthopper), Peregrinus maidis Ashmead (corn planthopper), Sogatella furcifera Horvath (white-backed planthopper), Sogatodes orizicola Muir (rice delphacid), Typhlocyba pomaria McAtee white apple leafhopper, Erythroneoura spp. (grape leafhoppers); Magicidada septendecim Linnaeus (periodical cicada); Icerya purchasi Maskell (cottony cushion scale), Quadraspidiotus perniciosus Comstock (San Jose scale); Planococcus citri Risso (citrus mealybug); Pseudococcus spp. (other mealybug complex); Cacopsylla pyricola Foerster (pear psylla), Trioza diospyri Ashmead (persimmon psylla). These compounds also have activity on members from the order Hemiptera including: Acrosternum hilare Say (green stink bug), Anasa tristis De Geer (squash bug), Blissus leucopterus leucopterus Say (chinch bug), Corythuca gossypii Fabricius (cotton lace bug), Cyrtopeltis modesta Distant (tomato bug), Dysdercus suturellus Herrich-Schäffer (cotton stainer), Euchistus servus Say (brown stink bug), Euchistus variolarius Palisot de Beauvois (one-spotted stink bug), Graptosthetus spp. (complex of seed bugs), Leptoglossus corculus Say (leaf-footed pine seed bug), Lygus lineolaris Palisot de Beauvois (tarnished plant bug), Nezara viridula Linnaeus (southern green stink bug), Oebalus pugnax Fabricius (rice stink bug), Oncopeltus fasciatus Dallas (large milkweed bug), Pseudatomoscelis seriatus Reuter (cotton fleahopper). Other insect orders controlled by compounds of the invention include Thysanoptera (e.g., Frankliniella occidentalis Pergande (western flower thrip), Scirthothrips citri Moulton (citrus thrip), Sericothrips variabilis Beach (soybean thrip), and Thrips tabaci Lindeman (onion thrip); and the order Coleoptera (e.g., Leptinotarsa decemlineata Say (Colorado potato beetle), Epilachna varivestis Mulsant (Mexican bean beetle) and wireworms of the genera Agriotes, Athous or Limonius).

Compounds of this invention can also be mixed with one or more other biologically active compounds or agents including insecticides, fungicides, nematocides, bactericides, acaricides, growth regulators such as rooting stimulants, chemosterilants, semiochemicals, repellents, attractants, pheromones, feeding stimulants, other biologically active compounds or entomopathogenic bacteria, virus or fungi to form a multi-component pesticide giving an even broader spectrum of agricultural utility. Thus compositions of the present invention can further comprise a biologically effective amount of at least one additional biologically active cmpound or agent. Examples of such biologically active compounds or agents with which compounds of this invention can be formulated are: insecticides such as abamectin, acephate, acetamiprid, avermectin, azadirachtin, azinphos-methyl, bifenthrin, binfenazate, buprofezin, carbofuran, chlorfenapyr, chlorfluazuron, chlorpyrifos, chlorpyrifos-methyl, chromafenozide, clothianidin, cyfluthrin, beta-cyfluthrin, cyhalothrin, lambda-cyhalothrin, cypermethrin, cyromazine, deltamethrin, diafenthiuron, diazinon, diflubenzuron, dimethoate, diofenolan, emamectin, endosulfan, esfenvalerate, ethiprole, fenothicarb, fenoxycarb, fenpropathrin, fenproximate, fenvalerate, fipronil, flonicamid, flucythrinate, tau-fluvalinate, flufenoxuron, fonophos, halofenozide, hexaflumuron, imidacloprid, indoxacarb, isofenphos, lufenuron, malathion, metaldehyde, methamidophos, methidathion, methomyl, methoprene, methoxychlor, monocrotophos, methoxyfenozide, nithiazin, novaluron, oxamyl, parathion, parathion-methyl, permethrin, phorate, phosalone, phosmet, phosphamidon, pirimicarb, profenofos, pymetrozine, pyridalyl, pyriproxyfen, rotenone, spinosad, sulprofos, tebufenozide, teflubenzuron, tefluthrin, terbufos, tetrachlorvinphos, thiacloprid, thiamethoxam, thiodicarb, thiosultap-sodium, tralomethrin, trichlorfon and triflunuron; fungicides such as acibenzolar, azoxystrobin, benomyl, blasticidin-S, Bordeaux mixture (tribasic copper sulfate), bromuconazole, carpropamid, captafol, captan, carbendazim, chloroneb, chlorothalonil, copper oxychloride, copper salts, cyflufenamid, cymoxanil, cyproconazole, cyprodinil, (S)-3,5-dichloro-N-(3-chloro-1-ethyl-1-methyl-2-oxopropyl)-4-methylbenzamide (RH 7281), diclocymet (S-2900), diclomezine, dicloran, difenoconazole, (S)-3,5-dihydro-5-methyl-2-(methylthio)-5-phenyl-3-(phenylamino)-4H-imidazol-4-one (RP 407213), dimethomorph, dimoxystrobin, diniconazole, diniconazole-M, dodine, edifenphos, epoxiconazole, famoxadone, fenamidone, fenarimol, fenbuconazole, fencaramid (SZX0722), fenpiclonil, fenpropidin, fenpropimorph, fentin acetate, fentin hydroxide, fluazinam, fludioxonil, flumetover (RPA 403397), fluquinconazole, flusilazole, flutolanil, flutriafol, folpet, fosetyl-aluminum, furalaxyl, furametapyr (S-82658), hexaconazole, ipconazole, iprobenfos, iprodione, isoprothiolane, kasugamycin, kresoxim-methyl, mancozeb, maneb, mefenoxam, mepronil, metalaxyl, metconazole, metomino-strobin/fenominostrobin (SSF-126), myclobutanil, neo-asozin (ferric methanearsonate), oxadixyl, penconazole, pencycuron, probenazole, prochloraz, propamocarb, propiconazole, pyrifenox, pyraclostrobin, pyrimethanil, pyroquilon, quinoxyfen, spiroxamine, sulfur, tebuconazole, tetraconazole, thiabendazole, thifluzamide, thiophanate-methyl, thiram, tiadinil, triadimefon, triadimenol, tricyclazole, trifloxystrobin, triticonazole, validamycin and vinclozolin; nematocides such as aldicarb, oxamyl and fenamiphos; bactericides such as streptomycin; acaricides such as amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben and tebufenpyrad; and biological agents such as Bacillus thuringiensis including ssp. aizawai and kurstaki, Bacillus thuringiensis delta endotoxin, baculovirus, and entomopathogenic bacteria, virus and fingi.

A general reference for these agricultural protectants is The Pesticide Manual, 12th Edition, C. D. S. Tomlin, Ed., British Crop Protection Council, Farnham, Surrey, U.K., 2000.

Of note are compositions comprising (in addition to the Formula I component and any surfactant and/or diluent) at least one additional biologically active compound or agent selected from the group consisting of abamectin, acephate, acetamiprid, amidoflumet, avermectin, azadirachtin, azinphos-methyl, bifenthrin, binfenazate, buprofezin, carbofuran, chlorfenapyr, chlorfluazuron, chlorpyrifos, chlorpyrifos-methyl, chromafenozide, clothianidin, cyfluthrin, beta-cyfluthrin, cyhalothrin, lambda-cyhalothrin, cypermethrin, cyromazine, deltamethrin, diafenthiuron, diazinon, diflubenzuron, dimethoate, diofenolan, emamectin, endosulfan, esfenvalerate, ethiprole, fenothicarb, fenoxycarb, fenpropathrin, fenvalerate, fipronil, flonicamid, flucythrinate, tau-fluvalinate, flufenoxuron, fonophos, halofenozide, hexaflumuron, imidacloprid, indoxacarb, isofenphos, lufenuron, malathion, metaldehyde, methamidophos, methidathion, methomyl, methoprene, methoxychlor, monocrotophos, methoxyfenozide, nithiazin, novaluron, oxamyl, parathion, parathion-methyl, permethrin, phorate, phosalone, phosmet, phosphamidon, pirimicarb, profenofos, pymetrozine, pyridalyl, pyriproxyfen, rotenone, spinosad, sulprofos, tebufenozide, teflubenzuron, tefluthrin, terbufos, tetrachlorvinphos, thiacloprid, thiamethoxan, thiodicarb, thiosultap-sodium, tralomethrin, trichlorfon and triflumuron, aldicarb, oxamyl, fenamiphos, amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben, tebufenpyrad, Bacillus thuringiensis including ssp. aizawai and kurstaki, Bacillus thuringiensis delta endotoxin, baculovirus, and entomopathogehic bacteria, virus and fungi.

Preferred insecticides and acaricides for mixing with compounds of this invention include pyrethroids such as cypermethrin, cyhalothrin, cyfluthrin and beta-cyfluthrin, esfenvalerate, fenvalerate and tralomethrin; carbamates such as fenothicarb, methomyl, oxamyl and thiodicarb; neonicotinoids such as clothianidin, imidacloprid and thiacloprid, neuronal sodium channel blockers such as indoxacarb, insecticidal macrocyclic lactones such as spinosad, abamectin, avermectin and emamectin; γ-aminobutyric acid (GABA) antagonists such as endosulfan, ethiprole and fipronil; insecticidal ureas such as flufenoxuron and triflumuron, juvenile hormone mimics such as diofenolan and pyriproxyfen; pymetrozine; and amitraz. Preferred biological agents for mixing with compounds of this invention include Bacillus thuringiensis and Bacillus thuringiensis delta endotoxin as well as naturally occurring and genetically modified viral insecticides including members of the family Baculoviridae as well as entomophagous fungi.

Most preferred mixtures include a mixture of a compound of this invention with cyhalothrin; a mixture of a compound of this invention with beta-cyfluthrin; a mixture of a compound of this invention with esfenvalerate; a mixture of a compound of this invention with methomyl; a mixture of a compound of this invention with imidacloprid; a mixture of a compound of this invention with thiacloprid; a mixture of a compound of this invention with indoxacarb; a mixture of a compound of this invention with abamectin; a mixture of a compound of this invention with endosulfan; a mixture of a compound of this invention with ethiprole; a mixture of a compound of this invention with fipronil; a mixture of a compound of this invention with flufenoxuron; a mixture of a compound of this invention with pyriproxyfen; a mixture of a compound of this invention with pymetrozine; a mixture of a compound of this invention with amitraz; a mixture of a compound of this invention with Bacillus thuringiensis and a mixture of a compound of this invention with Bacillus thuringiensis delta endotoxin.

In certain instances, combinations with other invertebrate pest control compounds or agents having a similar spectrum of control but a different mode of action will be particularly advantageous for resistance management. Thus, compositions of the present invention can further comprise a biologically effective amount of at least one additional invertebrate pest control compound or agent having a similar spectrum of control but a different mode of action. Contacting a plant genetically modified to express a plant protection compound (e.g., protein) or the locus of the plant with a biologically effective amount of a compound of invention can also provide a broader spectrum of plant protection and be advantageous for resistance management.

Invertebrate pests are controlled in agronomic and nonagronomic applications by applying one or more of the compounds of this invention, in an effective amount, to the environment of the pests including the agronomic and/or nonagronomic locus of infestation, to the area to be protected, or directly on the pests to be controlled. Thus, the present invention further comprises a method for controlling an invertebrate pest, comprising contacting the invertebrate pest or its environment with a biologically effective amount of one or more of the compounds of the invention, or with a composition comprising at least one such compound, or with a composition comprising at least one such compound and an effective amount of at least one additional biologically active compound or agent. Examples of suitable compositions comprising a compound of the invention and an effective amount of at least one additional biologically active compound or agent include granular compositions wherein the additional biologically active compound or agent is present on the same granule as the compound of the invention or on granules separate from those of the compound of this invention.

A preferred method of contact is by spraying. Alternatively, a granular composition comprising a compound of the invention can be applied to the plant foliage or the soil. Compounds of this invention are also effectively delivered through plant uptake by contacting the plant with a composition comprising a compound of this invention applied as a soil drench of a liquid formulation, a granular formulation to the soil, a nursery box treatment or a dip of transplants. Compounds are also effective by topical application of a composition comprising a compound of this invention to the locus of infestation. Other methods of contact include application of a compound or a composition of the invention by direct and residual sprays, aerial sprays, gels, seed coatings, microencapsulations, systemic uptake, baits, eartags, boluses, foggers, fumigants, aerosols, dusts and many others. The compounds of this invention may also be impregnated into materials for fabricating invertebrate control devices (e.g., insect netting).

The compounds of this invention can be incorporated into baits that are consumed by the invertebrates or within devices such as traps and the like. Granules or baits comprising between 0.01-5% active ingredient, 0.05-10% moisture retaining agent(s) and 40-99% vegetable flour are effective in controlling soil insects at very low application rates, particularly at doses of active ingredient that are lethal by ingestion rather than by direct contact.

The compounds of this invention can be applied in their pure state, but most often application will be of a formulation comprising one or more compounds with suitable carriers, diluents, and surfactants and possibly in combination with a food depending on the contemplated end use. A preferred method of application involves spraying a water dispersion or refined oil solution of the compounds. Combinations with spray oils, spray oil concentrations, spreader stickers, adjuvants, other solvents, and synergists such as piperonyl butoxide often enhance compound efficacy.

The rate of application required for effective control (i.e. “biologically effective amount”) will depend on such factors as the species of invertebrate to be controlled, the pest's life cycle, fife stage, its size, location, time of year, host crop or animal, feeding behavior, mating behavior, ambient moisture, temperature, and the like. Under normal circumstances, application rates of about 0.01 to 2 kg of active ingredient per hectare are sufficient to control pests in agronomic ecosystems, but as little as 0.0001 kg/hectare may be sufficient or as much as 8 kg/hectare may be required. For nonagronomic applications, effective use rates will range from about 1.0 to 50 mg/square meter but as little as 0.1 mg/square meter may be sufficient or as much as 150 mg/square meter may be required. One skilled in the art can easily determine the biologically effective amount necessary for the desired level of invertebrate pest control.

The following Tests in the Biological Examples of the Invention demonstrate the efficacy of methods of the invention for protecting plants from specific arthropod pests. “Control efficacy” represents inhibition of arthropod development (including mortality) that causes significantly reduced feeding. The pest control protection afforded by the compounds is not limited, however, to these species. See Index Table A for compound descriptions. The following abbreviations are used in the Index Table which follows: t is tertiary, n is normal, i is iso, s is secondary, c is cyclo, Me is methyl, Et is ethyl, Pr is propyl and Bu is butyl; accordingly i-Pr is isopropyl, s-Bu is secondary butyl, etc. The abbreviation “Ex.” stands for “Example” and is followed by a number indicating in which example the compound is prepared.

Index TABLE A

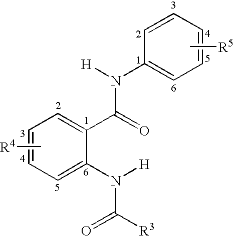

| Compound | R³ | R⁴ | R⁵ | m.p. ° C. |
|---|---|---|---|---|
| 1 | t-Bu | H | 2,3-diMe | 208-209 |
| 2 | i-Pr | H | 4-OCF₃ | 160-161 |
| 3 (Ex. 4) | i-Pr | 5-Cl | 4-OCF₃ | 230-233 |
| 4 | Me | 5-Me | 4-OCF₃ | 224-225 |
| 5 | Me | 5-Me | 2-Me, 4-Cl | 114-116 |
| 6 | i-Pr | 5-Cl | 2-Me, 4-Cl | >250 |
| 7 (Ex. 3) | i-Pr | 2-Me | 2-Me, 4-OCF₃ | 230 |
| 8 | t-Bu | 2-Me | 2-Me, 4-OCF₃ | 200-203 |
| 9 (Ex. 2) | i-Pr | 2-Me | 2-Me, 4-CF₃ | 230 |
| 10 | i-Pr | 5-NO₂ | 4-CF₃ | Solid |
| 11 | 4-CF₃-Ph | 5-Me | 2-Me | >250 |

Index TABLE B

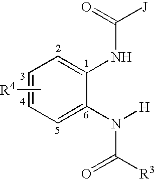

| Compound | R³ | R⁴ | J | m.p. ° C. |
|---|---|---|---|---|
| 12 | t-Bu | H | 2,3-diMe-Ph | 161-164 |
| 13 | t-Bu | H | 2-CF₃-Ph | 173-174 |
| 14 | i-Pr | H | 2,4-F-Ph | 148 |
| 15 | i-Pr | H | 2,3-diMe-Ph | 169-171 |
| 16 | t-Bu | H | 2,4-diF-Ph | 146-149 |
| 17 | i-Pr | 5-Me | 2,3-diMe-Ph | 202-205 |
| 18 | i-Pr | 5-Me | 2,6-diCl-Ph | 230 |
| 19 | i-Pr | 5-Me | 2,4-diF-Ph | 196 |
| 20 | Me | H | 2-F-Ph | Solid |
| 21 | i-Pr | 5-Cl | 2-Me, 4-Cl, 6-NC(O)CF₃ | 203 |
| 22 | i-Pr | 5-Cl | 2-Me, 4-Cl, 6-NC(O)CH₃ | >250 |
| 23 | t-Bu | 5-Me | 3-CF₃-Ph | solid |
| 24 | t-Bu | 5-Me | 2-F, 5-CF₃-Ph | solid |
| 25 | t-Bu | 5-Me | 4-CF₃-Ph | solid |
| 26 | t-Bu | 5-Me | 4-OCF₃-Ph | solid |
| 27 | i-Pr | 5-Me | 4-CF₃-Ph | solid |
| 28 | i-Pr | 5-Me | 3-CF₃-Ph | solid |
| 29 | t-Bu | 5-Me | 4-CF₃-Ph | solid |
| 30 | t-Bu | 5-Me | 4-OCF₃-Ph | solid |
| 31 | i-Pr | 5-Me | 2-F, 5-CF₃-Ph | solid |
| 32 | i-Pr | 5-Me | 4-OCF₃-Ph | solid |
| 33 | i-Pr | 5-Me | 4-CF₃-Ph | solid |
| 34 | t-Bu | 5-Me | 3-CF₃-Ph | solid |

INDEX TABLE C

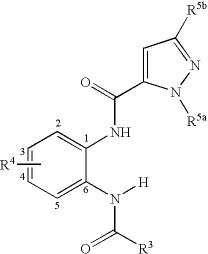

| Compound | R³ | R⁴ | R^{5a} | R^{5b} | m.p. ° C. |
|---|---|---|---|---|---|
| 35 (Ex. 1) | i-Pr | 5-Me | 2-Cl-Ph | CF₃ | Solid |
| 36 | Me | 5-Me | 3-Cl-2-Pyridyl | CF₃ | 204-205 |
| 37 (Ex. 6) | i-Pr | 5-Me | 3-Cl-2-Pyridyl | CF₃ | 219-220 |
| 38 | NHEt | 5-Me | 3-Cl-2-Pyridyl | CF₃ | 185-186 |
| 39 | NHi-Pr | 5-Me | 3-Cl-2-Pyridyl | CF₃ | 191-192 |
| 40 | t-Bu | 5-Me | 3-Cl-2-Pyridyl | CF₃ | 205-206 |
| 41 | Me | 5-Me | 3-Cl-2-Pyridyl | Cl | 201-202 |
| 42 | i-Pr | 5-Me | 3-Cl-2-Pyridyl | Cl | 229-230 |
| 43 | NHEt | 5-Me | 3-Cl-2-Pyridyl | Cl | 187-188 |
| 44 | NHi-Pr | 5-Me | 3-Cl-2-Pyridyl | Cl | 195-196 |
| 45 | t-Bu | 5-Me | 3-Cl-2-Pyridyl | Cl | 201-202 |
| 46 | Me | 5-Me | 3-Cl-2-Pyridyl | Br | 176-177 |
| 47 | i-Pr | 5-Me | 3-Cl-2-Pyridyl | Br | 237-238 |
| 48 | NHEt | 5-Me | 3-Cl-2-Pyridyl | Br | 176-177 |
| 49 | NHi-Pr | 5-Me | 3-Cl-2-Pyridyl | Br | 192-193 |
| 50 | t-Bu | 5-Me | 3-Cl-2-Pyridyl | Br | 196-197 |
| 51 | i-Pr | 2-Me | 3-Cl-2-Pyridyl | Br | 190-191 |
| 52 | i-Pr | 2-Me | 3-Cl-2-Pyridyl | Cl | 185-186 |
| 53 (Ex. 5) | i-Pr | 2-Me | 3-Cl-2-Pyridyl | CF₃ | 215-217 |
| 54 | Me | 2-Me | 3-Cl-2-Pyridyl | CF₃ | 167-168 |

INDEX TABLE D

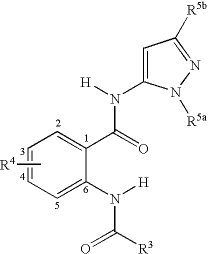

| Compound | R³ | R⁴ | R^{5a} | R^{5b} | m.p. ° C. |
|---|---|---|---|---|---|
| 55 | Me | 5-Me | 2-Cl-Ph | CF₃ | 194-195 |
| 56 | i-Pr | 5-Me | 2-Cl-Ph | CF₃ | 244-246 |
| 57 | t-Bu | 5-Me | 2-Cl-Ph | CF₃ | 260 |
| 58 | Et | 5-Me | 2-Cl-Ph | CF₃ | 236-237 |
| 59 | i-Pr | 2-Me | 2-Cl-Ph | CF₃ | 203-205 |
| 60 | t-Bu | 2-Me | 2-Cl-Ph | CF₃ | 232-233 |
| 61 | Et | 2-Me | 2-Cl-Ph | CF₃ | 170-172 |
| 62 | Me | 2-Me | 2-Cl-Ph | CF₃ | 212-213 |
| 63 | Me | 5-Me | 3-Cl-2-Pyridyl | CF₃ | 192-193 |
| 64 | Me | 2-Me | 3-Cl-2-Pyridyl | CF₃ | 236 |
| 65 (Ex. 7) | i-Pr | 2-Me | 3-Cl-2-Pyridyl | CF₃ | 198 |

### BIOLOGICAL EXAMPLES OF THE INVENTION

### Test

For evaluating control of diamondback moth (Plutella xylostella) the test unit consisted of a small open container with a 12-14-day-old radish plant inside. This was pre-infested with 10-15 neonate larvae on a piece of insect diet by use of a core sampler to remove a plug from a sheet of hardened insect diet having many larvae growing on it and transfer the plug containing larvae and diet to the test unit. The larvae moved onto the test plant as the diet plug dried out.

The compounds were formulated using a solution containing 10% acetone, 90% water and 300 ppm X-77® Spreader Lo-Foam Formula non-ionic surfactant containing alkylarylpolyoxyethylene, free fatty acids, glycols and isopropanol (Loveland Industries, Inc.). The formulated compounds were applied in 1 mL of liquid through a SUJ2 atomizer nozzle with ⅛ JJ custom body (Spraying Systems Co.) positioned 1.27 cm (0.5 inches) above the top of each test unit. All experimental compounds in this screen were sprayed at 50 ppm and replicated three times. After spraying of the formulated test compound, each test unit was allowed to dry for 1 hour and then a black, screened cap was placed on top. The test units were held for 6 days in a growth chamber at 25° C. and 70% relative humidity. Plant feeding damage was then visually assessed.

Of the compounds tested, the following provided excellent levels of plant protection (30% or less feeding damage): 11, 37, 39, 43, 47, 48, 51, 52, 53 and 63.

What is claimed is:

1. A method for controlling an invertebrate pest comprising:
contacting the invertebrate pest or its environment with a biologically effective amount of a compound of Formula I including all geometric and stereoisomers, an N-oxide thereof or an agriculturally suitable salt thereof 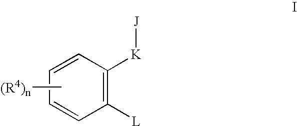
wherein
J is a phenyl ring, a naphthyl ring system, a 5- or 6-membered heteroaromatic ring or an aromatic 8-, 9- or 10-membered fused heterobicyclic ring system wherein each ring or ring system is optionally substituted with 1 to 4 R⁵;
K is —C(=A)NR²— or —NR²C(=A)-;
L is —NR¹C(═B)—R³ or —NR¹SO₂—R³;
A and B are independently O or S;
R¹ is H; or C₁-C₆ alkyl, C₂-C₆ alkenyl, C₂-C₆ alkynyl or C₃-C₆ cycloalkyl, each optionally substituted with one or more substituents selected from the group consisting of halogen, CN, NO₂, hydroxy, C₁-C₄ alkoxy, C₁-C₄ alkylthio, C₁-C₄ alkylsulfinyl, C₁-C₄ alkylsulfonyl, C₂-C₄ alkoxycarbonyl, C₁-C₄ alkylamino, C₂-C₈ dialkylatnino and C₃-C₆ cycloalkylamino; or
R¹ is C₂-C₆ alkylcarbonyl, C₂-C₆ alkoxycarbonyl, C₂-C₆ alkylaminocarbonyl or C₃-C₈ dialkylaminocarbonyl;
R² is H, C₁-C₆ alkyl, C₂-C₆ alkenyl, C₂-C₆ alkyl, C₃-C₆ cycloalkyl, C₁-C₄ alkoxy, C₁-C₄ alkylamino, C₂-C₈ dialkylamino, C₃-C₆ cycloalkylamino, C₂-C₆ alkoxycarbonyl or C₂-C₆ alkylcarbonyl;
R³ is C₁-C₆ alkyl, C₂-C₆ alkenyl, C₂-C₆ alkynyl or C₃-C₆ cycloalkyl, each optionally substituted with one or more substituents selected from the group consisting of halogen, CN, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₂-C₆ alkoxycarbonyl, C₂-C₆ alkylcarbonyl, C₃-C₆ trialkylsilyl, phenyl phenoxy and 5- or 6-membered heteroaromatic rings, each phenyl, phenoxy and 5- or 6-membered heteroaromatic ring optionally substituted with one to three substituents independently selected from R⁶; C₁-C₄ alkoxy, C₁-C₄ alkylamino; C₂-C₈ dialkylamino; C₁-C₄ alkoxy(C₁-C₄ alkyl)amino; C₃-C₆ cycloalkylamino; C₂-C₆ alkoxycarbonyl or C₂-C₆ alkylcarbonyl; or
R¹ and R³ can be taken together with —NC(═B)— or —NSO₂— moiety to which they are attached to form a ring comprising 2 to 6 atoms of carbon and optionally one additional atom of nitrogen, sulfur or oxygen, said ring optionally substituted with 1 to 4 substituents selected from the group consisting of C₁-C₂ alkyl, halogen, CN, NO₂ and C₁-C₂ alkoxy;
each R⁴ is independently H, C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₃-C₆ trialkylsilyl, or a phenyl ring optionally substituted with one to three substituents independently selected from R⁶;
each R⁵ is independently C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, CO₂H, CONH₂, NO₂, hydroxy, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl, C₃-C₆ trialkylsilyl; or
each R⁵ is independently a phenyl, benzyl, benzoyl, phenoxy, 5- or 6-membered heteroaromatic ring or an aromatic 8-, 9- or 10-membered fused heterobicyclic ring system, each phenyl, benzyl, benzoyl, phenoxy, heteroaromatic ring and aromatic fused heterobicyclic ring system optionally substituted with one to three substituents independently selected from R⁶; or
two R⁵ groups when attached to adjacent carbon atoms can be taken together as —OCF₂O—, —CF₂CF20— or —OCF₂CF₂O—;
each R⁶ is independently C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl; and
n is 1, 2, 3 or 4;
provided that L is other than —NHC(═O)—R³ and R³ is other than C₁-C₆ alkyl substituted with one or more fluorine moieties.

2. The method of claim 1 wherein K is —C(=A)NR²— and A and B are both O.

3. The method of claim 1 wherein K is —NR²C(=A)— and A and B are both O.

4. The method of claim 2 or claim 3 wherein
J is a phenyl ring or a 5- or 6-membered heteroaromatic ring selected from the group consisting of J-1, J-2, J-3 and J-4, each J ring optionally substituted with 1 to 3 R⁵ 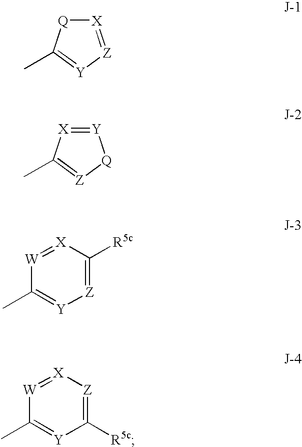
Q is O, S or NR^{5c};
W, X, Y and Z are independently N or CR^{5c}, provided that in J-3 and J-4 at least one of W, X, Y or Z is N;
R¹ and R² are each independently H, C₁-C₄ alkyl, C₂-C₄ alkenyl, C₂-C₄ alkynyl, C₃-C₆ cycloalkyl, C₂-C₆ alkylcarbonyl or C₂-C₆ alkoxycarbonyl;
R³ is C₁-C₆ alkyl, C₂-C₆ alkenyl, C₂-C₆ alkynyl or C₃-C₆ cycloalkyl each optionally substituted with one or more substituents selected from the group consisting of halogen, CN, C₁-C₂ alkoxy, C₁-C₂ alkylthio, C₁-C₂ alkylsulfinyl and C₁-C₂ alkylsulfonyl;
each R⁴ is independently C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl or C₁-C₄ haloalkylsulfonyl;
each R⁵ is independently C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₂-C₄ alkoxycarbonyl or C₃-C₈ dialkylaminocarbonyl; or
each R⁵ is independently a phenyl, benzyl or a 5- or 6-membered heteroaromatic ring, each ring optionally substituted with one to three substituents independently selected from R⁶; or
two R⁵ groups when attached to adjacent carbon atoms can be taken together as —OCF₂O—, —CF₂CF₂O— or —OCF₂CF₂O—;
R^{5c} is H or R⁵;
each R⁶ is independently C₁-C₄ alkyl, C₂-C₄ alkenyl, C₂-C₄ alkynyl, C₃-C₆ cycloalkyl, C₁-C₄ haloalkyl, C₂-C₄ haloalkenyl, C₂-C₄ haloalkynyl, C₃-C₆ halocycloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ alkylamino, C₂-C₈ dialkylamino, C₃-C₆ cycloalkylamino, C₃-C₆ (alkyl)cycloalkylamino, C₂-C₄ alkylcarbonyl, C₂-C₆ alkoxycarbonyl, C₂-C₆ alkylaminocarbonyl, C₃-C₈ dialkylaminocarbonyl or C₃-C₆ trialkylsilyl; and
n is 1 or 2.

5. The method of claim 4 wherein
each R⁵ is R^{5a} or R^{5b};
J is substituted with R^{5a} and optionally substituted with 1 to 2 R^{5b};
R¹ and R² are each independently H or C₁-C₄ alkyl;
R³ is C₁-C₄ alkyl optionally substituted with halogen, CN, OCH₃, or S(O)ₚCH₃;
R^{5a} group is attached to the J at the position ortho to K;
R^{5a} and R^{5b} are each independently C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₂-C₄ alkoxycarbonyl or C₃-C₈ dialkylaminocarbonyl; or a phenyl, benzyl, or a 5- or 6-membered heteroaromatic ring, each ring optionally substituted with one to three substituents independently selected from R⁶;
each R⁶ is independently halogen, CN, NO₂, C₁-C₄ alkyl, C₂-C₄ alkenyl, C₂-C₄ alkynyl, C₃-C₆ cycloalkyl, C₁-C₄ haloalkyl, C₁-C₄ alkoxy or C₁-C₄ haloalkoxy, and
p is 0, 1 or 2.

6. The method of claim 5 wherein J is phenyl, pyrazole, pyrrole, pyridine or pyrimidine.

7. The method of claim 6 wherein
R¹ and R² are each H;
one R⁴ is selected from the group consisting of C₁-C₃ alkyl, CF₃, OCF₃, OCHF₂, S(O)ₚCF₃, S(O)ₚCHF₂ and halogen and an optional second R⁴ is selected from the group consisting of halogen, C₁-C₃ alkyl and C₁-C₃ haloalkyl.

8. The method of claim 7 wherein
J is J-1;
Q is NR^{5a};
X is N or CH;
Y is CH;
Z is CR^{5b};
R^{5a} is a phenyl or 2-pyridyl ring substituted with one or two substituents selected from the group consisting of halogen, C₁-C₄ alkyl, C₁-C₄ haloalkyl or C₁-C₄ haloalkoxy; and
R^{5b} is halogen or CF₃.

9. A compound of Formula I including all geometric and stereoisomers, N-oxides or agriculturally suitable salts thereof 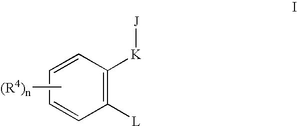
wherein:
J is a phenyl ring, a naphthyl ring system, a 5- or 6-membered heteroaromatic ring or an aromatic 8-, 9- or 10-membered fused heterobicyclic ring system wherein each ring or ring system is substituted with one R^{5a} and optionally substituted with 1 to 3 R^{5b};
K is —C(=A)NR²— or —NR²C(-A)-;
L is —NR¹C(═B)—R³ or —NR¹SO₂—R³;
A and B are independently O or S;
R¹ is H or CL-C₄ alkyl;
R² is H or C₁-C₄ alkyl;
R³ is C₁-C₄ alkyl optionally substituted with halogen, CN, OCH₃, or S(O)ₚCH₃;
each R⁴ is independently C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl or C₁-C₄ haloalkylsulfonyl;
R^{5a} and R^{5b} are each independently C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₂-C₄ alkoxycarbonyl or C₃-C₈ dialkylaminocarbonyl; or a phenyl, benzyl, or a 5- or 6-membered heteroaromatic ring, each phenyl, benzyl, and heteroaromatic ring optionally substituted with one to three substituents independently selected from R⁶;
R^{5a} is attached to the J at a position ortho to K;
each R⁶ is independently halogen, CN, NO₂, C₁-C₄ alkyl, C₂-C₄ alkenyl, C₂-C₄ alkynyl, C₃-C₆ cycloalkyl, C₁-C₄ haloalkyl, C₁-C₄ alkoxy or C₁-C₄ haloalkoxy;
n is 1, 2, 3 or 4; and
pis0, 1 or 2;
provided that L is other than —NHC(═O)R³ and R³ is other than C₁-C₆ alkyl substituted with one or more fluorine moieties.

10. The compound of claim 9 wherein
J is a phenyl ring ora 5-or 6-membered heteroaromatic ring selected from the group consisting of J-1, J-2, J-3 and J-4, each J ring substituted R⁵a with and optionally with 1 to 2 R^{5b} 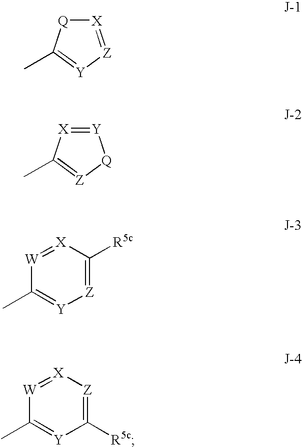
Q is O, S or NR^{5c};
W, X, Y and Z are independently N or CR^{5c}, provided that in J-3 and J-4 at least one of W, X, Y or Z is N;
R¹ and R² are each independently H or C₁-C₄ alkyl;
R³ is C₁-C₄ alkyl optionally substituted with halogen, CN, OCH₃, or S(O)ₚCH₃;
each R⁴ is independently C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl or C₁-C₄ haloalkylsulfonyl;
R^{5a} is attached to the J at the position ortho to K;
R^{5a} and R^{5b} are each independently C₁-C₄ alkyl, C₁-C₄ haloalkyl, halogen, CN, NO₂, C₁-C₄ alkoxy, C₁-C₄ haloalkoxy, C₁-C₄ alkylthio, C₁-C₄ alkylsulfinyl, C₁-C₄alkylsulfonyl, C₁-C₄ haloalkylthio, —C₁-C₄ haloalkylsulfinyl, C₁-C₄ haloalkylsulfonyl, C₂-C₄ alkoxycarbonyl or C₃-C₈ dialkylaminocarbonyl; or a phenyl, benzyl, or a 5- or 6-membered heteroaromatic ring, each ring optionally substituted with one to three substituents independently selected from R⁶;
R^{5c} is H or one of the R^{5b} substituents;
each R⁶ is independently halogen, CN, NO₂, C₁-C₄ alkyl, C₂-C₄ alkenyl, C₂-C₄ alkynyl, C₃-C₆ cycloalkyl, C₁-C₄ haloalkyl, C₁-C₄ alkoxy or C₁-C₄ haloalkoxy; and
n is 1 or 2.

11. The compound of claim 10 wherein J is J is phenyl, pyrazole, pyrrole, pyridine or pyrimidine.

12. The compound of claim 11 wherein
R¹ and R² are each H;
one R⁴ is selected from the group consisting of C₁-C₃ alkyl, CF₃, OCF₃, OCHF₂, S(O)ₚCF₃, S(O)ₚCHF₂ and halogen and an optional second R⁴ is selected from the group consisting of halogen, C₁-C₃ alkyl and C₁-C₃ haloalkyl.

13. The compound of claim 12 wherein
J is J-1;
Q is NR^{5a};
X is N or CH;
Y is CH;
Z is CR^{5b};
R^{5a} is a phenyl or 2-pyridyl ring substituted with one or two substituents selected from the group consisting of halogen, C₁-C₄ alkyl, C₁-C₄ haloalkyl or C₁-C₄ haloalkoxy; and
R^{5b} is halogen or CF₃.

14. A composition for controlling an invertebrate pest comprising:
a biologically effective amount of a compound of Formula I according to claim 1, an N-oxide thereof or an agriculturally suitable salt thereof; and
at least one additional component selected from the group consisting of surfactants, solid diluents and liquid diluents.

15. The composition of claim 14 further comprising an effective amount of at least one additional biologically active compound or agent.

16. The composition of claim 15 wherein the at least one additional biologically active compound or agent is selected from the group consisting of pyrethroids, carbamates, neonicotinoids, neuronal sodium channel blockers, insecticidal macrocyclic lactones, γ-aminobutyric acid (GABA) antagonists, insecticidal ureas and juvenile hormone mimics.

17. The composition of claim 14 further comprising at least one additional biologically active compound or agent selected from the group consisting of abamectin, acephate, acetamiprid, amidoflumet, avermectin, azadirachtin, azinphos-methyl, bifenthrin, binfenazate, buprofezin, carbofuran, chlorfenapyr, chlorfluazuron, chlorpyrifos, chlorpyrifos-methyl, chromafenozide, clothianidin, cyfluthrin, beta-cyfluthrin, cyhalothrin, lambda-cyhalothrin, cypermethrin, cyromazine, deltamethrin, diafenthiuron, diazinon, diflubenzuron, dimethoate, diofenolan, emamectin, endosulfan, esfenvalerate, ethiprole, fenothicarb, fenoxycarb, fenpropathrin, fenvalerate, fipronil, flonicamid, flucythrinate, tau-fluvalinate, flufenoxuron, fonophos, halofenozide, hexaflumuron, imidacloprid, indoxacarb, isofenphos, lufenuron, malathion, metaldehyde, methamidophos, methidathion, methomyl, methoprene, methoxychlor, monocrotophos, methoxyfenozide, nithiazin, novaluron, oxamyl, parathion, parathion-methyl, permethrin, phorate, phosalone, phosmet, phosphamidon, pirimicarb, profenofos, pymetrozine, pyridalyl, pyriproxyfen, rotenone, spinosad, sulprofos, tebufenozide, teflubenzuron, tefluthrin, terbufos, tetrachlorvinphos, thiacloprid, thiamethoxam, thiodicarb, thiosultap-sodium, tralomethrin, trichlorfon and triflumuron, aldicarb, oxamyl, fenamiphos, amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben, tebufenpyrad; and biological agents such as Bacillus thuringiensis including ssp. aizawai and kurstaki, Bacillus thuringiensis delta endotoxin, baculovirus, and entomopathogenic bacteria, virus and fungi.

18. The composition of claim 14 further comprising at least one additional biologically active compound or agent selected from the group consisting of cypermethrin, cyhalothrin, cyfluthrin and beta-cyfluthrin, esfenvalerate, fenvalerate, tralomethrin, fenothicarb, methomyl, oxamyl, thiodicarb, clothianidin, imidacloprid, thiacloprid, indoxacarb, spinosad, abamectin, avennectin, emamectin, endosulfan, ethiprole, fipronil, flufenoxuron, triflumuron, diofenolan, pyriproxyfen, pymetrozine, amitraz, Bacillus thuringiensis, Bacillus thuringiensis delta endotoxin and entomophagous fungi.
